(19) United States
(12) Patent Application Publication
(10) Pub. No.: US 2025/0351832 A1
(43) Pub. Date: Nov. 20, 2025

(54) PHYTOCHEMICALS AS BIOPESTICIDES AND BIOSTIMULANTS

(71) Applicant: KAY BEE BIO ORGANICS PVT. LTD., Phaltan (IN)

(72) Inventors: Sachin Babanrao YADAV, Phaltan (IN); Tejas Pandurang JADHAV, Phaltan (IN); Ashant Hanumant SABLE, Phaltan (IN)

(21) Appl. No.: 19/182,874

(22) Filed: Apr. 18, 2025

(30) Foreign Application Priority Data
May 20, 2024 (IN) 202421039226

(51) Int. Cl. A01N 65/10; A01N 65/06; A01N 65/22; A01N 65/24; A01N 65/28; A01N 65/36; A01N 65/44; A01N 65/48; A01P 5/00; A01P 7/04

(52) U.S. Cl. CPC A01N 65/10; A01N 65/06; A01N 65/22; A01N 65/24; A01N 65/28; A01N 65/36; A01N 65/44; A01N 65/48; A01P 5/00; A01P 7/04

(57) ABSTRACT

The present invention discloses the phytochemicals extracted from plants as bio-pesticides and bio-stimulant, its composition and method of controlling various harmful organisms without being toxic to humans.

### RELATED APPLICATIONS

The present application claims priority to Indian Patent Application number 202421039226, filed on May 20, 2024, which is incorporated herein by reference in its entirety.

### TECHNICAL FIELD OF THE INVENTION

The present invention relates to the phytochemicals extracted from plants as bio-pesticides and biostimulants, its composition and method of controlling various harmful organisms without being toxic to humans.

### BACKGROUND OF THE INVENTION

Synthetic pesticides in general are toxic and their harmful residues contaminate crops, soil, water and cause huge damage to the environment. They also adversely affect non-target organisms like pollinators, fish, birds, animals, humans and their excessive use results in increased resistance in pests. Thus, pest management relying heavily on synthetic pesticides has serious limitations in terms of handling hazards, toxic residues in food, high persistence and threat to both humans and environment.

Plants are known to produce bio-chemicals to cope with the pathogens competing plant species, and herbivorous insects and vertebrates. Phytochemicals are observed to be considerably less toxic, less persistent and biodegradable. There are patents and review articles on insect control chemicals derived from plants.

EP3766349A1 discloses a method capable of controlling various harmful organisms comprising applying 3-endo-[2-propoxy-4-(trifluoromethyl) phenoxy]-9-[5-(trifluoromethyl)-2-pyridyloxy]-9-azabicyclo[3.3.1]nonane to an object in combination with an insecticidal or acaricidal active ingredient. the insecticidal or acaricidal active ingredient is at least one selected from the group consisting of (1) acetylcholinesterase inhibitor, (2) GABA-gated chloride ion channel blocker, (3) sodium channel modulator, (5) nicotinic acetylcholine receptor allosteric modulator, (6) glutamate-gated chloride ion channel allosteric modulator, (7) juvenile hormone analogs, (8) other non-specific (multi-site) inhibitors, (9) chordotonal organ TRPV channel modulator, (10) acari growth inhibitor, (11) microorganism-derived insect midgut inner membrane disrupting agent, (12) mitochondrial ATP synthase inhibitor, (13) oxidative phosphorylation uncoupler that disrupts proton gradient, (14) nicotinic acetylcholine receptor channel blocker, (15) chitin biosynthesis inhibitor type 0, (16) chitin biosynthesis inhibitor type 1, (17) diptera insect molting inhibitor, (18) molting hormone receptor agonist, (19) octopamine receptor agonist, (20) mitochondrial electron transport chain complex III inhibitor, (21) mitochondrial electron transport chain complex I inhibitor, (22) voltage-dependent sodium channel blocker, (23) acetyl COA carboxylase inhibitor, (24) mitochondrial electron transport chain complex IV inhibitor, (25) mitochondrial electron transport chain complex II inhibitor, (28) ryanodine receptor modulator, (29) chordotonal organ modulator, (30) GABA-gated chloride ion (chlorine ion) channel allosteric modulator, and (UN) agent with unclear action mechanism.

An article titled “Phytochemicals for pest management” by SO Duke published in Planta Med 2008; 74-L16, summarizes phytochemicals derived from plants as biopesticides. The article discloses 9,10-anthraquinone derivative for use in aquaculture to selectively control undesirable blue-green algae, natural triketones from oil of manuka (Leptospermum scoparium), sampangine from the bark of the Cleistopholis patens tree was sufficiently fungitoxic to be patented as an agricultural fungicide, sesquiterpenoid vulgarone B to be as active against two important snail pests as metaldehyde, apiol from Lomatium hultenii against termiticidal compounds from plant sources.

Few of the phytochemicals extracted from the plants/herbs as biopesticides and biostimulants though are known in the art, the present inventors felt that there is a scope to provide the phytochemicals and its composition thereof as bio-pesticides and bio stimulants having improved activity towards the insects. The phytochemicals and its composition thereof as bio-pesticides and bio stimulants of the present invention are observed to be highly toxic to the insects only without causing any harm to humans and the environment. This remains the objective of the invention.

### SUMMARY OF THE INVENTION

In accordance with the above, the present invention provides an effective, safe and environment friendly bio-pesticide and bio-stimulant comprising blend of phytochemicals selected from the group consisting of (i) (un)substituted or substituted alkaloids, (ii) (un)substituted or substituted terpenoids and cyclic ketones, (iii) (un)substituted or substituted, saturated or unsaturated aldehydes, ketones, amides, acids or esters; (iv) (un)substituted or substituted aryl or heteoaryl or cyclic or fused aryls; (v) (un)substituted or substituted heterocyclic compounds which may be fused; (vi) (un)substituted or substituted quinolones and isoquinolines; (vii) essential oils alone or combinations thereof.

In an aspect, the phytochemicals of the present invention may be in the form of salts, solvates, hydrates, isomers or its enantiomers.

In an aspect, the phytochemicals of the present invention as bio-stimulant and bio pesticides comprises one or more of camphor, eugenol, citral, thymol, Piperine; Cuminaldehyde; ethyl chavicol; Swainsonine; Ferulic Acid; Parthenin; Turmerones; Carvacrol; D-limonene; Gingerol; β-Asarone; Menthol; Capsaicin; p-Cymene; Palmitic acid; Ellagic acid; 2-undecanone; Chavibetol; Thymoquinone; Berberine; Isoquinoline; Alpha-pinene; 1,8 cineole; Camphene in an amount ranging between 0.001% to 65%.

In another aspect, the present invention provides a biopesticidal and bio-stimulant composition of the said phytochemicals together with agriculturally acceptable excipients or additives in suitable amounts.

In a preferred aspect, the present invention provides a biopesticidal and bio-stimulant composition comprising two or more phytochemicals selected from the group consisting of:
i. Camphor at a concentration in a range of 0.001-7.0%, more preferably 3.5%;
ii. Eugenol at a concentration in a range of 0.001-10.0%, more preferably 8.0%;
iii. Citral at a concentration in a range of 0.001-15%, more preferably 12.5%;
iv. Thymol at a concentration in a range of 0.001-13%, more preferably 9.3%;
v. Piperine at a concentration in a range of 0.001-10%, more preferably 7.4%;
vi. Cuminaldehyde at a concentration in a range of 0.001-10%, more preferably 3.3%;
vii. Methyl chavicol at a concentration in a range of 0.001-9.0%, more preferably 5.0%;
viii. Swainsonine at a concentration in a range of 0.001-8.0%, more preferably 3.0%;
ix. Ferulic Acid at a concentration in a range of 0.001-8.0%, more preferably 4.0%;
x. Parthenin at a concentration in a range of 0.001-7.0%, more preferably 3.6%;
xi. Turmerones at a concentration in a range of 0.001-8.0%, more preferably 3.7%;
xii. Carvacrol at a concentration in a range of 0.001-10.0%, more preferably 7.3%;
xiii. D-limonene at a concentration in a range of 0.001-8.0%, more preferably 2.7%;
xiv. Gingerol at a concentration in a range of 0.001-8.0%, more preferably 6.8%;
xv. β-Asarone at a concentration in a range of 0.001-9.0%, more preferably 3.0%;
xvi. Menthol at a concentration in a range of 0.001-9.0%, more preferably 5.3%;
xvii. Capsaicin at a concentration in a range of 0.001-8.0%, more preferably 2.2%;
xviii. p-Cymene at a concentration in a range of 0.001-15%, more preferably 2.8%;
xix. Palmitic acid at a concentration in a range of 0.001-8.0%, more preferably 1.2%;
XX. Ellagic acid at a concentration in a range of 0.001-8.0%, more preferably 1.6%;
xxi. 2-undecanone at a concentration in a range of 0.001-8.0%, more preferably 2.4%;
xxii. Chavibetol at a concentration in a range of 0.001-7.0%, more preferably 1.0%;
xxiii. Thymoquinone at a concentration in a range of 0.001-8.0%, more preferably 1.0%;
xxiv. Berberine at a concentration in a range of 0.001-8.0%, more preferably 1.2%;
XXV. Isoquinoline at a concentration in a range of 0.001-9.0%, more preferably 2.0%;
xxvi. Alpha-pinene at a concentration in a range of 0.001-13%, more preferably 3.0%;
xxvii. 1,8 cineole at a concentration in a range of 0.001-7.0%, more preferably 2.8%; and
xxviii. camphene at a concentration in a range of 0.001-7.0%, more preferably 1.2%; together with agriculturally acceptable excipients or additives.

In another aspect, the excipients are selected from binders, diluents, surfactants, emulsifiers, carriers, lubricants, pH adjusters, colorants, essential oils and the like.

In yet another aspect, the emulsifier is selected from group consisting of Span 80, polysorbate 80, polysorbate 60, Gaur gum, ethoxylated castor oil, Polyorganosiloxane, soy lecithin, carrageenan, mono- and diglycerides, carboxymethylcellulose, and the like in a range of 0.1-13%, more preferably 7.0%.

In another aspect, the surfactant is selected from the group consisting of Sodium oleoyl amino fatty acid, Sodium dodecyl sulphate, Polyoxyl 35 hydrogenated castor oil, Sodium N methyl N-Oleyl taurate, Sodium alkyl naphthalene sulfonate and the like in a range of 0.1-15%, more preferably 8.0%.

In another aspect, the solvents are selected from one or more water, Dimethyl sulfoxide (DMSO), Benzyl acetate, N-methyl pyrrolidinone, Diacetone alcohol, N-Ethyl-2 pyrrolidone (NEP) and the like in a range of 15-55%, more preferably 30%.

In another aspect, the carriers are selected from at least one substantially water-miscible co-solvent, preferably selected from the group of N-methylpyrrolidinone; dimethylsulphoxide; dimethylfonnamide C9; methyl ethyl ketone, Ethylene Glycol Diacetate, dimethylisosorbide isophorone; acetophenone; cyclohexanone; Diacetone alcohol 1,3-dimethyl-2-imidazolidonone; ethylene, propylene, and butylene carbonates; lactate esters; Methyl oleate, dimethyl and diethylcarbonates; alkylglycol ethers; glycols, including propylene, carbapol 940 and biodiesel and the like in a range of 15-55%, more preferably 35%.

In another aspect, the essential oils are selected from the group consisting of seed oil of Essential oil of Ferula asafoetida, Orange oil, camphor, thyme, clove, pepper, spearmint, citronella, cassia, orange oil, star anise, cedar wood, peppermint, ginger, turmeric and bay leaf and the like in a range of 0.1-15%, more preferably 6.0%.

In another aspect, the composition of the present invention has a particle size in the range of 10-1000 nanometer.

In another aspect, the present invention provides a biopesticidal and bio-stimulant composition comprising:
i. Eugenol in the range of 0.001 to 10%;
ii. Thymol in the range of 0.001 to 13%;
iii. Clove oil in the range of 0.1 to 15%;
iv. Poly sorbate 80 in the range of 0.1 to 13%;
v. Sodium oleoyl amino fatty acid (Surfactant) in the range of 0.1 to 15%;
vi. Dimethyl sulfoxide (DMSO) in the range of 10.0 to 45%; and
vii. Benzyl acetate in the range of 15.0 to 55%.

In another aspect, the present invention provides a biopesticidal and bio-stimulant composition comprising:
i. Piperine in the range of 0.001 to 10%;
ii. Thymol in the range of 0.001 to 13%;
iii. Black pepper oil in the range of 0.1 to 15%;
iv. Span 80 in the range of 0.1 to 13%;
v. Sodium oleoyl amino fatty acid in the range of 0.1 to 15%;
vi. N-methyl pyrrolidinone in the range of 10.0 to 45%; and
vii. Benzyl acetate in the range of 15.0 to 55%.

In another aspect, the present invention provides a biopesticidal and bio-stimulant composition comprising:
i. Citral in the range of 0.001 to 15%;
ii. Thymol in the range of 0.001 to 13%;
iii. Thyme oil in the range of 0.001 to 13%;
iv. Span 80 in the range of 0.1 to 13%;
v. Sodium oleoyl amino fatty acid in the range of 0.1 to 15%;
vi. N-methyl pyrrolidinone in the range of 10.0 to 45%; and
vii. Diacetone alcohol in the range of 15.0 to 55%.

In another aspect, the present invention provides a biopesticidal and bio-stimulant composition comprising:
i. Citral in the range of 0.001 to 15%;
ii. Eugenol in the range of 0.001 to 13%;
iii. Basil oil in the range of 0.1 to 15%;
iv. polysorbate 80 (emulsifier) in the range of 0.1 to 13%;
v. Sodium oleoyl amino fatty acid in the range of 0.1 to 15%;
vi. N-methyl pyrrolidinone in the range of 10.0 to 45%; and
vii. Diacetone alcohol in the range of 15.0 to 55%;

In another aspect, the present invention provides a biopesticidal and bio-stimulant composition comprising:
i. Camphor in the range of 0.001 to 10%;
ii. Thymol in the range of 0.001 to 13%;
iii. Camphor oil in the range of 0.1 to 15%;
iv. Polysorbate 60 in the range of 0.1 to 13%;
v. Sodium oleoyl amino fatty acid in the range of 0.1 to 15%;
vi. N-methyl pyrrolidinone in the range of 10.0 to 45%; and
vii. Diacetone alcohol in the range of 15.0 to 55%.

In another aspect, the present invention provides a biopesticidal and bio-stimulant composition comprising:
i. Camphor in the range of 0.001 to 7%;
ii. Eugenol in the range of 0.001 to 10%;
iii. Thymol in the range of 0.001 to 13%;
iv. Piperine in the range of 0.001 to 8%;
v. Methyl chavicol in the range of 0.001 to 9%;
vi. Citral in the range of 0.001 to 15%;
vii. D-limonene in the range of 0.001 to 8%;
viii. Thymoquinone in the range of 0.001 to 8%;
ix. Capsaicin in the range of 0.001 to 8%;
x. Palmitic acid in the range of 0.001 to 8%;
xi. Essential oil of Ferula asafoetida in the range of 0.001 to 8%;
xii. Orange oil in the range of 0.1 to 15%;
xiii. Gaur gum in the range of 0.001 to 7.5%;
xiv. ethoxylated castor oil in the range of 0.001 to 10%;
xv. Sodium oleoyl amino fatty acid in the range of 0.1 to 15%
xvi. Dimethyl sulfoxide in the range of 10.0 to 35%; and
xvii. Benzyl acetate in the range of 10.0 to 35%.

In another aspect, the present invention provides a biopesticidal and bio-stimulant composition comprising:
i. Camphor in the range of 0.001 to 7%;
ii. Eugenol in the range of 0.001 to 10%;
iii. Thymol in the range of 0.001 to 13%;
iv. Piperine in the range of 0.001 to 8%;
v. Methyl chavicol in the range of 0.001 to 9%;
vi. Citral in the range of 0.001 to 15%;
vii. D-limonene in the range of 0.001 to 8%;
viii. Thymoquinone in the range of 0.001 to 8%;
ix. Capsaicin in the range of 0.001 to 8%;
x. Palmitic acid in the range of 0.001 to 8%;
xi. Essential oil of Ferula asafoetida in the range of 0.001 to 8%;
xii. Gaur gum in the range of 0.001 to 7.5%;
xiii. ethoxylated castor oil in the range of 0.001 to 10%;
xiv. Sodium oleoyl amino fatty acid in the range of 0.1 to 15%
xv. Dimethyl sulfoxide in the range of 10.0 to 35%; and
xvi. Benzyl acetate in the range of 10.0 to 35%.

In another aspect, the present invention provides a biopesticidal and bio-stimulant composition comprising:
i. Parthenin in the range of 0.001 to 7%;
ii. Carvacrol in the range of 0.001 to 10%;
iii. Thymol in the range of 0.001 to 13%;
iv. Gingerol in the range of 0.001 to 8%;
v. Menthol in the range of 0.001 to 9%;
vi. P-Cymene in the range of 0.001 to 15%;
vii. 2-Undecanone in the range of 0.001 to 8%;
viii. citral in the range of 0.001 to 15%;
ix. Ellagic acid in the range of 0.001 to 8%;
x. Swainsonine in the range of 0.001 to 8%;
xi. Polysorbate 80 in the range of 0.001 to 7.5%;
xii. ethoxylated castor oil in the range of 0.001 to 10%;
xiii. Sodium dodecyl sulfate in the range of 0.1 to 15%;
xiv. Dimethyl sulfoxide in the range of 10.0 to 35%; and
xv. N-methyl pyrrolidinone in the range of 10.0 to 35%

In another aspect, the present invention provides a biopesticidal and bio-stimulant composition comprising:
i. 1,8 cineole in the range of 0.001 to 7%;
ii. Eugenol in the range of 0.001 to 10%;
iii. Alpha-pine in the range of 0.001 to 13%;
iv. berberine in the range of 0.001 to 8%;
v. Isoquinoline in the range of 0.001 to 9%;
vi. camphor in the range of 0.001 to 15%;
vii. β-asarone in the range of 0.001 to 9%;
viii. Cuminaldehyde in the range of 0.001 to 10%;
ix. ar-Turmerone in the range of 0.001 to 8%;
x. Chavibetol in the range of 0.001 to 7%;
xi. Camphene in the range of 0.001 to 7%;
xii. Gaur gum in the range of 0.001 to 7.5%;
xiii. ethoxylated castor oil in the range of 0.001 to 10%;
xiv. Sodium oleoyl amino fatty acid in the range of 0.1 to 15%
xv. Dimethyl sulfoxide in the range of 10.0 to 35%; and
xvi. Benzyl acetate in the range of 10.0 to 35%.

In another aspect, the present invention provides a biopesticidal and bio-stimulant composition comprising:
i. Camphor in the range of 0.001 to 7%;
ii. Eugenol in the range of 0.001 to 10%;
iii. thymol in the range of 0.001 to 13%;
iv. piperine in the range of 0.001 to 8%;
v. Methyl chavicol in the range of 0.001 to 9%;
vi. Citral in the range of 0.001 to 15%;
vii. D-limonene in the range of 0.001 to 8%;
viii. thymoquinone in the range of 0.001 to 8%;
ix. capsaicin in the range of 0.001 to 8%;
x. Palmitic acid in the range of 0.001 to 8%;
xi. Essential oil of Ferula asafoetida in the range of 0.001 to 8%;
xii Span 80 in the range of 0.001 to 7.5%;
xiii. Polyoxyl 35 hydrogenated castor oil in the range of 0.001 to 10%;
xiv. ethoxylated castor oil in the range of 0.001 to 10%
xv. Sodium oleoyl amino fatty acid in the range of 0.1 to 15%;
xvi. Dimethyl sulfoxide in the range of 10.0 to 35%;
xvii. Benzyl acetate in the range of 10.0 to 35%; and
xviii. water in the range of 10.0 to 75%.

In another aspect, the present invention provides a biopesticidal and bio-stimulant composition comprising:
i. Camphor in the range of 0.001 to 7%;
ii. Eugenol in the range of 0.001 to 10%;
iii. thymol in the range of 0.001 to 13%;
iv. piperine in the range of 0.001 to 8%;
v. Methyl chavicol in the range of 0.001 to 9%;
vi. Citral in the range of 0.001 to 15%;
vii. Essential oil of Ferula asafoetida in the range of 0.001 to 8%;
viii. Orange oil in the range of 0.1 to 15%;
ix. Gaur gum in the range of 0.001 to 7.5%;
x. ethoxylated castor oil in the range of 0.001 to 10%;
xi. Sodium oleoyl amino fatty acid in the range of 0.1 to 15%
xii. Dimethyl sulfoxide in the range of 10.0 to 35%; and
xiii. N-Ethyl-2 pyrrolidone (NEP) in the range of 10.0 to 35%.

In another aspect, the present invention provides a biopesticidal and bio-stimulant composition comprising:
i. Camphor in the range of 0.001 to 7%;
ii. Eugenol in the range of 0.001 to 10%;
iii. thymol in the range of 0.001 to 15%;
piperine in the range of 0.001 to 12%; iv.
v. Methyl chavicol in the range of 0.001 to 10%;
vi. Citral in the range of 0.001 to 15%;
vii. D-limonene in the range of 0.001 to 10%;
viii. Fumed silica in the range of 0.001 to 5.0%;
ix. Sodium N methyl N-Oleyl taurate in the range of 0.001 to 6.0%;
x. Polyorganosiloxane in the range of 0.001 to 7.0%;
xi. Sodium alkyl naphthalene sulfonate in the range of 0.001 to 15%;
xii. starch in the range of 0.01 to 25%; and
xiii. Anhydrous lactose in the range of 65.0 to 75.0%

In another aspect, the present invention provides a process for preparation of the biopesticidal and bio-stimulant composition comprising:
a. Dissolving the emulsifier and surfactant in solvent to make inert mixture and agitating with homogenizer until a uniform blend is formed;
b. Adding the phytochemicals in given quantity to the blend formed in step (a) and homogenizing completely to make an emulsion concentration.
c. Stirring the mixture obtained in step (b) at 300-1000 RPM more specifically at 350-800 RPM at 25-55° C. in closed mixing vessel for continued stirring followed by homogenizing the mix with the homogenizer fitted towards the bottom of vessel and with the speed of 3700˜27000 rpm to reduce the particle size;
d. Passing the homogenized mixture obtained in step (c) through in line shear pump with 1800 RPM to 5800 RPM to reduce particle size to obtain the nano emulsion with particle size ranging from 10 to 1000 nano meter;
e. Passing the mixture obtained in step (d) through High-pressure homogenization to reduce the particle size below 100 nano meters;
f. Passing the mixture obtained in step (e) through sparkler filter having seven layers of membrane filters with pore size less than 1-2 micron to achieve desired filtration; and
g. Recovering the final product.
   OR
a. Blending the active ingredients with the excipients to form an uniform mixture;
b. Adding water to the mixture of step (a) and blending;
c. Transferring the wet mass of step (b) to a basket extruder and extruding the wet mass to a 0.8 mm screen and drying in a fluid bed followed by vacuum drying to obtain dry granules;
d. Separating the granules of step (c) to the desired range of 4 to 50 mesh; and
e. Recovering the final product.

In another aspect, the biopesticide and bio-stimulant composition of the present invention may be used in conjunction with the known insecticidal or acaricidal active ingredient.

In yet another aspect, the phytochemicals of the present invention may be used with the active ingredient contained in other agents such as fungicides, bactericides, nematocides, plant growth regulators, synergists, fertilizers, soil improvers, animal feeds and the like.

The composition of the present invention may be formulated into a known form such as wettable powder, granule, powder, tablet, emulsion, water-soluble agent, suspension, granule wettable powder, flowable agent, microcapsule, aerosol, propellant, spray, fogging agent, heating transpiration agent, smoking agent, baiting agent or the like.

In yet another aspect, the present invention provides a method for controlling or killing of the agricultural insects/pests comprising applying said phytochemical composition to the affected parts of the plants in suitable amount thereof.

### BRIEF DESCRIPTION OF DRAWINGS/FIGURES

FIG. 1 depicts Graphical representation of the in vitro bio-efficacy of plant extracted phytochemicals and its combinations against aphids.

FIG. 2 depicts Graphical representation of the in vitro bio-efficacy of plant extracted phytochemicals and its combinations against mite.

FIG. 3 depicts Graphical representation of the in vitro bio-efficacy of plant extracted phytochemicals and its combinations against mealy bugs.

FIG. 4 depicts Graphical representation of the in vitro bio-efficacy of plant extracted phytochemicals and its combinations against Helicoverpa armigera.

FIG. 5 depicts Graphical representation of the in vitro bio-efficacy of plant extracted phytochemicals and its combinations against Spodoptera litura.

FIG. 6 depicts Graphical representation of the in vitro bio-efficacy of plant extracted phytochemicals and its combinations against thrips.

FIG. 7 depicts Graphical representation of the in vitro bio-efficacy of plant extracted phytochemicals and its combinations against Alternaria alternata.

FIG. 8 depicts Graphical representation of the in vitro bio-efficacy of plant extracted phytochemicals and its combinations against Xanthomonas axanopodis pv. punicae.

FIG. 9 depicts Graphical representation of the effect of plant extracted phytochemicals and its combinations against aphids.

FIG. 10 depicts Graphical representation of the effect of plant extracted phytochemicals and its combinations against mite.

FIG. 11 depicts Graphical representation of the effect of plant extracted phytochemicals and its combinations against mealy bugs.

FIG. 12 depicts Graphical representation of the effect of plant extracted phytochemicals and its combinations against Helicoverpa armigera.

FIG. 13 depicts Graphical representation of the effect of plant extracted phytochemicals and its combinations against Spodoptera litura.

FIG. 14 depicts Graphical representation of the effect of plant extracted phytochemicals and its combinations against thrips.

FIG. 15 depicts Graphical representation of the effect of plant extracted phytochemicals and its combinations against Alternaria alternate.

FIG. 16 depicts Graphical representation of the effect of plant extracted phytochemicals and its combinations against Xanthomonas axanopodis pv. punicae.

FIG. 17 depicts Graphical representation of the effect of plant extracted phytochemicals and its combinations on growth of tomato seedlings.

FIG. 18 depicts Graphical representation of the effect of plant extracted phytochemicals and its combinations on growth of chili seedlings.

### DETAILED DESCRIPTION OF THE INVENTION

The invention will now be described in detail in its preferred and optional embodiments so that the various aspects of the invention will be fully understood without restricting the scope of the invention.

### Source and Geographical Origin of the Biological Material Used:

| Sr. | | | |
|---|---|---|---|
| No. | Plant | Source | Geographical origin |
| 1. | Cinnamomum | India | Subtropical regions of East Asia, |
| | camphora | | including countries such as China |
| 2. | Syzygium | India | native to the Maluku Islands, or |
| | aromaticum | | Moluccas, in Indone |
| 3. | Ociumum | India | native to Africa, Madagascar, |
| | gratissimum | | southern Asia |
| 4. | Thymus | India | native to southern Europe from the |
| | vulgaris | | western Mediterranean to southern |
| | | | Italy. |
| 5. | Piper longum | India | Native of India, |
| 6. | Cuminum | India | Native to the Irano-Turanian Region |
| | cyminum | | |
| 7. | Ocimum | India | native to tropical and subtropical |
| | sanctum | | regions of Australia, Malesia, Asia, |
| | | | and the western Pacific |
| 8. | Ipomoea carnea | India | Native to Brazil |
| 9. | Ferula asafoetida | India | Native to Afghanistan, Tajikistan, |
| | | | northern Pakistan and Kashmir. |
| 10. | Parthenium | India | India, Australia, and parts of Africa. |
| | hysterophorus | | |
| 11. | Curcuma longa | India | native to the Indian subcontinent and |
| | | | Southeast Asia |
| 12. | Origanum | India | Native to the Mediterranean region, |
| | vulgare | | but widely naturalised elsewhere in |
| | | | the temperate Northern Hemisphere. |
| 13. | Citrus sinensis | India | Southeast Asia |
| 14. | Zingiber | India | Asia |
| | officinale | | |
| 15. | Acorus calamus | India | In India, Nepal, central Asia, |
| | | | southern Russia and Siberia, Europe |
| | | | and North America |
| 16. | Mentha piperita | India | Indigenous to Europe and the Middle |
| | | | East |
| 17. | Capsicum | India | Native to Central and South America |
| | frutescens | | |
| 18. | Trachyspermum | India | Indigenous regions of India, Iran, |
| | ammi | | Afghanistan, and parts of northern |
| | | | Africa. |
| 19. | Cassia tora | India | Native to Central America |
| 20. | Punica granatum | India | originated from Afghanistan and Iran |
| 21. | Zanthoxylum | India | Pakistan across to Southeast Asia and |
| | armatum | | up to Korea and Japan. |
| 22. | Piper betle | India | native to Southeast Asia. |
| 23. | Nigella sativa | India | native to eastern Europe (Bulgaria |
| | | | and Romania) and western Asia |
| 24. | Berberis aristata | India | native to the Himalayas in India and |
| | | | in Nepal |
| 25. | Argemone | India | western United States, parts of |
| | mexicana | | Mexico, and many parts of India. |
| 26. | Rosmarinus | India | native to the Mediterranean region, |
| | officinalis | | |

For the purpose of present invention the term ‘phytochemicals’ and ‘active ingredients’ are used interchangeably and mean phytochemicals extracted from plants useful as bio-pesticides and biostimulants.

In an embodiment, the present invention relates to an effective, safe and environment friendly composition comprising blend of phytochemicals selected from the group consisting of (i) (un)substituted or substituted alkaloids, (ii) (un)substituted or substituted terpenoids and cyclic ketones, (iii) (un)substituted or substituted, saturated or unsaturated aldehydes, ketones, amides, acids or esters; (iv) (un)substituted or substituted aryl or heteoaryl or cyclic or fused aryls; (v) (un)substituted or substituted heterocyclic compounds which may be fused; (vi) (un)substituted or substituted quinolones and isoquinolines; (vii) essential oils alone or combinations thereof.

The phytochemicals of the present invention may be in the form of salts, solvates, hydrates, isomers or its enantiomers.

In a preferred embodiment, the phytochemicals of the present invention as bio pesticides and bio-stimulants comprises one or more of camphor, eugenol, citral, thymol, Piperine; Cuminaldehyde; ethyl chavicol; Swainsonine; Ferulic Acid; Parthenin; Turmerones; Carvacrol; D-limonene; Gingerol; β-Asarone; Menthol; Capsaicin; p-Cymene; Palmitic acid; Ellagic acid; 2-undecanone; Chavibetol; Thymoquinone; Berberine; Isoquinoline; Alpha-pinene; 1,8 cineole; Camphene in an amount ranging between 0.001% to 65%.

In an embodiment, the phytochemicals of the present invention comprises;

| Sr. | Phyto | Structure of Phyto | Molecular | Molecular |
|---|---|---|---|---|
| No. | Ingredient | Ingredient | Formula | Weight |
| 1. | Camphor | 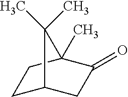 | C₁₀H₁₆O | 152.23 |
| 2. | Eugenol | 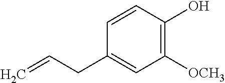 | C₁₀H₁₂O₂ | 164.20 |
| 3. | Citral | 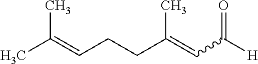 | C₁₀H₁₆O | 152.23 |
| 4. | Thymol | 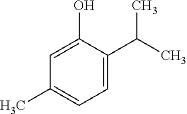 | C₁₀H₁₄O | 150.22 |
| 5. | Piperine | 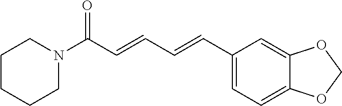 [SMILES: O=C(/C=C/C=C/c1ccc2c(c1)OCO2)N1CCCCC1] | C₁₇H₁₉NO₃ | 285.34 |
| 6. | Cuminaldehyde | 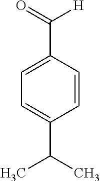 | C₁₀H₁₂O | 148.20 |
| 7. | Methyl chavicol | 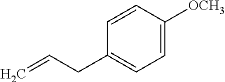 | C₁₀H₁₂O | 148.20 |
| 8. | Swainsonine | 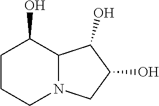 [SMILES: O[C@@H]1CCCN2C[C@@H](O)[C@@H](O)C12] | C₈H₁₅NO₃ | 173.21 |
| 9. | Ferulic Acid | 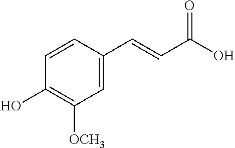 [SMILES: COc1cc(/C=C/C(=O)O)ccc1O] | C10H10O4 | 194.18 |
| 10. | Parthenin | 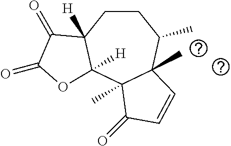 | C₁₅H₁₈O₄ | 262.30 |
| 11. | Turmerones | 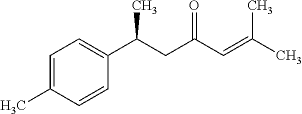 [SMILES: CC(C)=CC(=O)C[C@H](C)c1ccc(C)cc1] | C₁₅H₂₀O | 216.32 |
| 12. | Carvacrol | 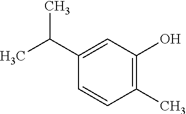 | C₁₀H₁₄O | 150.22 |
| 13. | D-limonene | 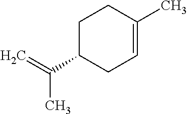 | C₁₀H₁₆ | 136.23 |
| 14. | Gingerol | 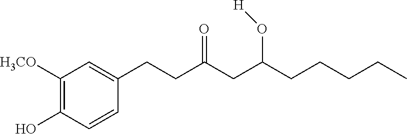 [SMILES: CCCCCC(O)CC(=O)CCc1ccc(O)c(OC)c1] | C₁₇H₂₆O₄ | 294.39 |
| 15. | β-Asarone | 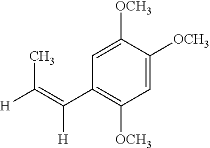 | C12H16O3 | 208.25 |
| 16. | Menthol | 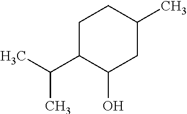 | C10H20O | 156.27 |
| 17. | Capsaicin | 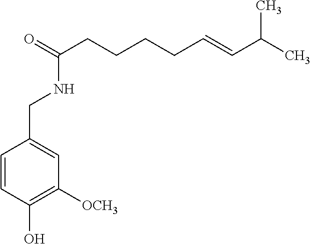 [SMILES: COc1cc(CNC(=O)CCCC/C=C/C(C)C)ccc1O] | C₁₈H₂₇NO₃ | 305.41 |
| 18. | p-Cymene | 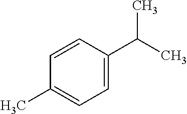 | C₁₀H₁₄ | 134.22 |
| 19. | Palmitic acid | 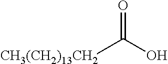 | C₁₆H₃₂O₂ | 256.42 |
| 20 | Ellagic acid | 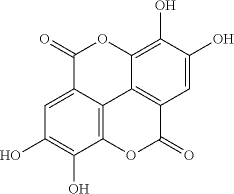 [SMILES: O=c1oc2c(O)c(O)cc3c(=O)oc4c(O)c(O)cc1c4c23] | C14H6O8 | 302.19 |
| 21. | 2-undecanone | 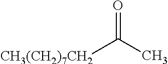 | C11H22O | 170.29 |
| 22. | Chavibetol | 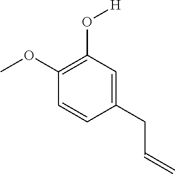 | C₁₀H₁₂O₂ | 164.20 |
| 23. | Thymoquinone | 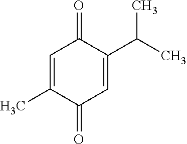 | C10H12O2 | 164.20 |
| 24 | Berberine | 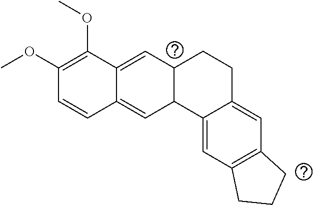 [SMILES: COc1ccc2c(c1OC)=CC1CCc3cc4c(cc3C1C=2)CCC4] | C₂₀H₁₈NO₄⁺ | 336.4 |
| 25. | Isoquinoline | 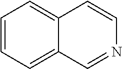 | C₉H₇N | 129.16 |
| 26. | Alpha-pinene | 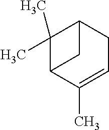 | C10H16 | 136.23 |
| 27. | 1,8 cineole | 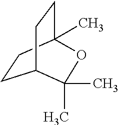 | C₁₀H₁₈O | 154.25 |
| 28. | camphene | 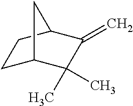 | C₁₀H₁₆ | 136.23 |

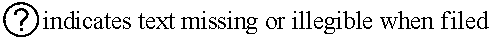

In another embodiment, the phytochemicals of the present invention are extracted from the plant parts as shown in the table below:

| | | | Plant Part |
|---|---|---|---|
| Sr. | | | Used for |
| No. | Phyto ingredient | Botanical Source | extraction |
| 1. | Camphor | Cinnamomum camphora | Bark |
| 2. | Eugenol | Syzygium aromaticum | Bud |
| 3. | Citral | Ociumum gratissimum | Aerial Part |
| 4. | Thymol | Thymus vulgaris | Aerial Part |
| 5. | Piperine | Piper longum | Fruit |
| 6. | Cuminaldehyde | Cuminum cyminum | Seed |
| 7. | Methyl chavicol | Ocimum sanctum | Aerial Part |
| 8. | Total Alkaloid | Ipomoea carnea | Leaves |
| | including swainsonine | | |
| 9. | Mixture of Essential | Ferula asafoetida | Stem |
| | oils and oleoresin | | |
| 10. | Parthenin | Parthenium hysterophorus | Aerial part |
| 11. | Essential oils and | Curcuma longa | Rhizome |
| | oleoresin | | |
| 12. | Carvacrol | Origanum vulgare | Aerial part |
| 13. | D-limonene | Citrus sinensis | Fruit |
| 14. | Gingerol | Zingiber officinale | Rhizome |
| 15. | β-Asarone | Acorus calamus | Rhizome |
| | Menthol | Mentha piperita | Aerial Part |
| 17. | Capsaicin | Capsicum frutescens | Fruit |
| 18. | p-Cymene | Trachyspermum ammi | Seeds |
| 19. | Palmitic acid | Cassia tora | Seeds |
| 20. | Ellagic acid | Punica granatum | Fruit peel |
| 21. | 2-undecanone | Zanthoxylum armatum | Fruit |
| 22. | Chavibetol | Piper betle | Leaves |
| 23. | Thymoquinone | Nigella sativa | Seeds |
| 24. | Berberine | Berberis aristata | Stem and |
| | | | Roots |
| 25. | Quaternary | Argemone mexicana | Whole plant |
| | isoquinoline alkaloids | | |
| 26. | Alpha-pinene | Rosmarinus officinalis | Aerial Part |
| 27. | 1,8 cineole | Rosmarinus officinalis | Aerial Part |
| 28. | camphene | Rosmarinus officinalis | Aerial Part |

In another embodiment, the phytochemicals of the present invention are extracted by the processes known in the art which include solvent extraction. Soxhlet extraction, Maceration, Steam/hydro distillation supercritical fluid extraction (SFE), ultrasound-assisted extraction (UAE), subcritical water extraction (SWE), and microwave-assisted extraction.

In general the solvent extraction process comprises the steps of;
i. Pulverizing the dry plant material;
ii. Extracting repeatedly the desired phytochemicals in the extractor using suitable solvent using methanol, hexane, acetone, ethyl acetate, butanol, and ethanol, wherein the solvent is used in the ratio ranging between 1:4 to 1:8; and
iii. Mixing the extracts obtained in step (ii) and distilling under vacuum to obtain the thick paste.

The Soxhlet extraction method for extracting the phytochemicals of the present invention comprising;
i. Placing a small, dried sample of the plant part in the extractor; and
ii. Repeatedly extracting the desired phytochemicals using the solvent selected from water, petroleum ether, or hexane until extraction is complete.

In an embodiment, the soxhlet extraction method is efficacious as it requires less solvent and is completed in less time.

Maceration is the process of breaking down or softening materials into fragments of plant biomass in a suitable solvent. This approach is employed for preserving the characteristic essence of extracts of some valued herbs that include extremely fragile, heat-sensitive, and volatile components.

Steam/hydro distillation is the process of extracting volatile chemicals from food or plants using distilled water. This procedure involves extracting volatile organic compounds using azeotropic distillation and non-volatile organic chemicals through boiling water. It consists of three processes: water penetration into solutes (hydrodiffusion) with short duration, high extraction yield, and the use of a non-toxic, environmentally acceptable solvent.

The steam distillation process includes, weighing exactly the fresh plant material to be uses and placing in a round-bottom flask, along with distilled water and a modest amount of anti-bombing substances which are minute grains that inhibit flushing when the sample begins to boil. The flask is gradually heated to about 80° C. while retaining a rubber cork and being connected to a condenser. When the mixture begins to boil, the essential oil is extracted from the test substrate. The essential oil extracted from the sample during heating is mixed with water vapour before being collected over the condenser using a receiver bottle. To prevent the essential oil from volatilizing, the condensate is cooled with chilled water. Following that, the condensate is moved to a separate funnel, where it is divided into two layers: oil and water, with the oil rising to the top due to its lower density than the water. The water is quickly emptied from the separating funnel by opening the tap, and the oil is collected in the sample bottle. The bottle is weighted and carefully sealed to prevent the essential oil from evaporating. This technique is repeated several times, one for each type of sample.

In a supercritical fluid extraction (SFE), CO2 is used as a supercritical fluid. The processing conditions, namely temperature and pressure, are determined by the nature and type of the extracts to be obtained; for example, low pressure (100 bar) is used to extract volatile oils/essential oils, polyphenols, and unsaturated fatty acids, whereas high pressure (more than 400 bar) is used to extract fixed and higher mass phytoingridents.

### Enrichment and Purification

The extract obtained from the above extraction process is then used for further enrichment and purification; enrichment is accomplished through the use of liquid-liquid extraction, in which the extract is dissolved in one solvent while the other solvent is chosen based on the phyto ingredient that needs to be separated; that is, the phyto molecule with a high affinity for a given solvent with a given polarity is chosen and used to enrich or purify the ingredient of interest.

Further purification is performed as needed using the silica gel column chromatography separation process. Column chromatography is a chromatography technology used for separation and purification. It is a technique in which the mobile phase is a liquid and the stationary phase consists of solid adsorbents such as silica gel and activated alumina powder. The active compound separation principle is affected by the polarity of the solvent and the activity of the adsorbents. The molecule separates well if the solvent's polarity is low and the adsorbent's activity is strong and high. Compound separation has poor outcomes when the solvent's polarity is high and the adsorbents are active. As a result, chemicals cannot be entirely separated or purified.

Quantitative analysis, such as mass spectroscopy, high pressure chromatography, and gas chromatography, is chosen to ensure the presence of the particular phyto component desired.

In yet another embodiment, the present invention relates to a biopesticidal and bio-stimulant composition of said phytochemicals together with agriculturally acceptable excipients or additives in suitable amounts.

In a preferred embodiment, the present invention provides a biopesticidal and bio-stimulant composition comprising two or more phytochemicals selected from the group consisting of:
i. Camphor at a concentration in a range of 0.001-7.0%, more preferably 3.5%;
ii. Eugenol at a concentration in a range of 0.001-10.0%, more preferably 8.0%;
iii. Citral at a concentration in a range of 0.001-15%, more preferably 12.5%;
iv. Thymol at a concentration in a range of 0.001-13%, more preferably 9.3%;
v. Piperine at a concentration in a range of 0.001-10%, more preferably 7.4%;
vi. Cuminaldehyde at a concentration in a range of 0.001-10%, more preferably 3.3%;
vii. Methyl chavicol at a concentration in a range of 0.001-9.0%, more preferably 5.0%;
viii. Swainsonine at a concentration in a range of 0.001-8.0%, more preferably 3.0%;
ix. Ferulic Acid at a concentration in a range of 0.001-8.0%, more preferably 4.0%;
x. Parthenin at a concentration in a range of 0.001-7.0%, more preferably 3.6%;
xi. Turmerones at a concentration in a range of 0.001-8.0%, more preferably 3.7%;
xii. Carvacrol at a concentration in a range of 0.001-10.0%, more preferably 7.3%;
xiii. D-limonene at a concentration in a range of 0.001-8.0%, more preferably 2.7%;
xiv. Gingerol at a concentration in a range of 0.001-8.0%, more preferably 6.8%;
xv. β-Asarone at a concentration in a range of 0.001-9.0%, more preferably 3.0%;
xvi. Menthol at a concentration in a range of 0.001-9.0%, more preferably 5.3%;
xvii. Capsaicin at a concentration in a range of 0.001-8.0%, more preferably 2.2%;
xviii. p-Cymene at a concentration in a range of 0.001-15%, more preferably 2.8%;
xix. Palmitic acid at a concentration in a range of 0.001-8.0%, more preferably 1.2%;
xx. Ellagic acid at a concentration in a range of 0.001-8.0%, more preferably 1.6%;
xxi. 2-undecanone at a concentration in a range of 0.001-8.0%, more preferably 2.4%;
xxii. Chavibetol at a concentration in a range of 0.001-7.0%, more preferably 1.0%;
xxiii. Thymoquinone at a concentration in a range of 0.001-8.0%, more preferably 1.0%;
xxiv. Berberine at a concentration in a range of 0.001-8.0%, more preferably 1.2%;
xxv. Isoquinoline at a concentration in a range of 0.001-9.0%, more preferably 2.0%;
xxvi. Alpha-pinene at a concentration in a range of 0.001-13%, more preferably 3.0%;
xxvii. 1,8 cineole at a concentration in a range of 0.001-7.0%, more preferably 2.8%; and
xxviii. camphene at a concentration in a range of 0.001-7.0%, more preferably 1.2%;
together with agriculturally acceptable excipients or additives.

In another aspect, the excipients are selected from binders, diluents, surfactants, emulsifiers, carriers, lubricants, pH adjusters, colorants, essential oils and the like.

In yet another embodiment, the emulsifier is selected from group consisting of Span 80, polysorbate 80, polysorbate 60, Gaur gum, ethoxylated castor oil, Polyorganosiloxane, soy lecithin, carrageenan, mono- and diglycerides, carboxymethylcellulose, and the like in a range of 0.1-13%, more preferably 7.0%.

In another embodiment, the surfactant is selected from the group consisting of Sodium oleoyl amino fatty acid, Sodium dodecyl sulphate, Polyoxyl 35 hydrogenated castor oil, Sodium N methyl N-Oleyl taurate, Sodium alkyl naphthalene sulfonate and the like in a range of 0.1-15%, more preferably 8.0%.

In another embodiment, the solvents are selected from one or more water, Dimethyl sulfoxide (DMSO), Benzyl acetate, N-methyl pyrrolidinone, Diacetone alcohol, N-Ethyl-2 pyrrolidone (NEP) and the like in a range of 15-55%, more preferably 30%.

In another embodiment, the carriers are selected from at least one substantially water-miscible co-solvent, preferably selected from the group of N-methylpyrrolidinone; dimethylsulphoxide; dimethylfonnamide C9; methyl ethyl ketone, Ethylene Glycol Diacetate, dimethylisosorbide isophorone; acetophenone; cyclohexanone; Diacetone alcohol 1,3-dimethyl-2-imidazolidonone; ethylene, propylene, and butylene carbonates; lactate esters; Methyl oleate, dimethyl and diethylcarbonates; alkylglycol ethers; glycols, including propylene, carbapol 940 and biodiesel and the like in a range of 15-55%, more preferably 35%.

In another embodiment, the essential oils are selected from the group consisting of seed oil of Essential oil of Ferula asafoetida, Orange oil, camphor, thyme, clove, pepper, spearmint, citronella, cassia, orange oil, star anise, cedar wood, peppermint, ginger, turmeric and bay leaf and the like in a range of 0.1-15%, more preferably 6.0%.

In another embodiment, the present invention provides a biopesticidal and bio-stimulant composition having a particle size in the range of 10-1000 nanometer.

In another embodiment, the composition has a particle size preferably in the range of 1-100 nanometer.

In another embodiment, the phytochemicals of the present invention are extracted by the processes known in the art which include solvent extraction, Soxhlet extraction, Maceration, Steam/hydro distillation supercritical fluid extraction (SFE), ultrasound-assisted extraction (UAE), subcritical water extraction (SWE), and microwave-assisted extraction.

The surfactants and emulsifier are selected from the following groups: Organic surfactants are made from natural polyglucose such as starch, sugar and coconut oil alcohol, alkylglucosides, alkylglucamides and sugar esters, Ethanolamine dodecyl sulfate, sodium dodecyl sulfate, potassium dodecyl phosphate, sulfonated castor oil, Kolliphor ELP (ELP), Kolliphor EL (EL), and Kolliphor RH40 (RH40) Span-20, 40, 60.65,80, poly sorbate-20, 40, 60, 65, 80, secondary alcohol polyoxyethylene ether linear Sodium alkylbenzene Sulfonate, sodium oleoylamino fatty acid, sodium N-oleoyl-N-methyl taurinate, sodium salt of C.-sulfo fatty acid methyl ester, N-acyl glutamate, triethanolamine polyoxyethylene fatty alcohol sulfate, fatty alcohol polyoxyethylene ether, sodium stearate, Sodium oleate, fatty acid alkanol amide, fatty acid polyoxyethylene ester, glyceryl oleate, glycerol trioleate, glyceryl Stearate, alkylphenol polyoxyetylene ether, coco fatty diethanolamide, coco fatty mono ethanol amide, castor oil polyoxyethylene ether, ethoxylated ammonium oleate, potassium oleate, potassium Stearate, Zinc Stearate, magnesium Stearate, polyoxyethylene fatty alcohol sodium sulfate, ethoxylated alkyl ester Sulfo Succinate, alkylbenzene Sulfonic acid, sodium alkyl Sulfonate, C.-alkene-Sulfonate, secondary alkane sulfonate, sodium dialkyl ester sulfonsuccinate, fatty alcohol polyethoxylate ether, fatty alcohol polyoxyethylene ether, fatty alcohol polyethoxylated, ether, fatty alcohol Polyoxyethylene ether.

The carriers are selected from at least one substantially water-miscible co-solvent, preferably selected from the group of N-methylpyrrolidinone; dimethylsulphoxide; dimethylfonnamide C9; methyl ethyl ketone, Ethylene Glycol Diacetate, dimethylisosorbide isophorone; acetophenone; cyclohexanone; Diacetone alcohol 1,3-dimethyl-2-imidazolidonone; ethylene, propylene, and butylene carbonates; lactate esters; Methyl oleate, dimethyl and diethylcarbonates; alkylglycol ethers; glycols, including propylene, carbapol 940 and biodiesel.

In an embodiment, the present invention provides a biopesticidal and bio-stimulant composition comprising:
i. Eugenol in the range of 0.001 to 10%;
ii. Thymol in the range of 0.001 to 13%;
iii. Clove oil in the range of 0.1 to 15%;
iv. Poly sorbate 80 in the range of 0.1 to 13%;
v. Sodium oleoyl amino fatty acid (Surfactant) in the range of 0.1 to 15%;
vi. Dimethyl sulfoxide (DMSO) in the range of 10.0 to 45%; and
vii. Benzyl acetate in the range of 15.0 to 55%.

In another embodiment, the present invention provides a biopesticidal and bio-stimulant composition comprising:
i. Piperine in the range of 0.001 to 10%;
ii. Thymol in the range of 0.001 to 13%;
iii. Black pepper oil in the range of 0.1 to 15%;
iv. Span 80 in the range of 0.1 to 13%;
v. Sodium oleoyl amino fatty acid in the range of 0.1 to 15%;
vi. N-methyl pyrrolidinone in the range of 10.0 to 45%; and
vii. Benzyl acetate in the range of 15.0 to 55%.

In yet another embodiment, the present invention provides a biopesticidal and bio-stimulant composition comprising:
i. Citral in the range of 0.001 to 15%;
ii. Thymol in the range of 0.001 to 13%;
iii. Thyme oil in the range of 0.001 to 13%;
iv. Span 80 in the range of 0.1 to 13%;
v. Sodium oleoyl amino fatty acid in the range of 0.1 to 15%;
vi. N-methyl pyrrolidinone in the range of 10.0 to 45%; and
vii. Diacetone alcohol in the range of 15.0 to 55%.

In another embodiment, the present invention provides a biopesticidal and bio-stimulant composition comprising:
i. Citral in the range of 0.001 to 15%;
ii. Eugenol in the range of 0.001 to 13%;
iii. Basil oil in the range of 0.1 to 15%;
iv. polysorbate 80 (emulsifier) in the range of 0.1 to 13%;
v. Sodium oleoyl amino fatty acid in the range of 0.1 to 15%;
vi. N-methyl pyrrolidinone in the range of 10.0 to 45%; and
vii. Diacetone alcohol in the range of 15.0 to 55%.

In another embodiment, the present invention provides a biopesticidal and bio-stimulant composition comprising:
i. Camphor in the range of 0.001 to 10%;
ii. Thymol in the range of 0.001 to 13%;
iii. Camphor oil in the range of 0.1 to 15%;
iv. Polysorbate 60 in the range of 0.1 to 13%;
v. Sodium oleoyl amino fatty acid in the range of 0.1 to 15%;
vi. N-methyl pyrrolidinone in the range of 10.0 to 45%; and
vii. Diacetone alcohol in the range of 15.0 to 55%.

In yet another embodiment, the present invention provides a biopesticidal and bio-stimulant composition comprising:
i. Camphor in the range of 0.001 to 7%;
ii. Eugenol in the range of 0.001 to 10%;
iii. Thymol in the range of 0.001 to 13%;
iv. Piperine in the range of 0.001 to 8%;
v. Methyl chavicol in the range of 0.001 to 9%;
vi. Citral in the range of 0.001 to 15%;
vii. D-limonene in the range of 0.001 to 8%;
viii. Thymoquinone in the range of 0.001 to 8%;
ix. Capsaicin in the range of 0.001 to 8%;
x. Palmitic acid in the range of 0.001 to 8%;
xi. Essential oil of Ferula asafoetida in the range of 0.001 to 8%;
xii. Orange oil in the range of 0.1 to 15%;
xiii. Gaur gum in the range of 0.001 to 7.5%;
xiv. ethoxylated castor oil in the range of 0.001 to 10%;
xv. Sodium oleoyl amino fatty acid in the range of 0.1 to 15%
xvi. Dimethyl sulfoxide in the range of 10.0 to 35%; and
xvii. Benzyl acetate in the range of 10.0 to 35%

In another embodiment, the present invention provides a biopesticidal and bio-stimulant composition comprising:
i. Camphor in the range of 0.001 to 7%;
ii. Eugenol in the range of 0.001 to 10%;
iii. Thymol in the range of 0.001 to 13%;
iv. Piperine in the range of 0.001 to 8%;
v. Methyl chavicol in the range of 0.001 to 9%;
vi. Citral in the range of 0.001 to 15%;
vii. D-limonene in the range of 0.001 to 8%;
viii. Thymoquinone in the range of 0.001 to 8%;
ix. Capsaicin in the range of 0.001 to 8%;
x. Palmitic acid in the range of 0.001 to 8%;
xi. Essential oil of Ferula asafoetida in the range of 0.001 to 8%;
xii. Gaur gum in the range of 0.001 to 7.5%;
xiii. ethoxylated castor oil in the range of 0.001 to 10%;
xiv. Sodium oleoyl amino fatty acid in the range of 0.1 to 15%
xv. Dimethyl sulfoxide in the range of 10.0 to 35%; and
xvi. Benzyl acetate in the range of 10.0 to 35%

In another embodiment, the present invention provides a biopesticidal and bio-stimulant composition comprising:
i. Parthenin in the range of 0.001 to 7%;
ii. Carvacrol in the range of 0.001 to 10%;
iii. Thymol in the range of 0.001 to 13%;
iv. Gingerol in the range of 0.001 to 8%;
v. Menthol in the range of 0.001 to 9%;
vi. P-Cymene in the range of 0.001 to 15%;
vii. 2-Undecanone in the range of 0.001 to 8%;
viii. citral in the range of 0.001 to 15%;
ix. Ellagic acid in the range of 0.001 to 8%;
x. Swainsonine in the range of 0.001 to 8%;
xi. Polysorbate 80 in the range of 0.001 to 7.5%;
xii. ethoxylated castor oil in the range of 0.001 to 10%;
xiii. Sodium dodecyl sulfate in the range of 0.1 to 15%;
xiv. Dimethyl sulfoxide in the range of 10.0 to 35%; and
xv. N-methyl pyrrolidinone in the range of 10.0 to 35%

In yet another embodiment, the present invention provides a biopesticidal and bio-stimulant composition comprising:
i. 1,8 cineole in the range of 0.001 to 7%;
ii. Eugenol in the range of 0.001 to 10%;
iii. Alpha-pine in the range of 0.001 to 13%;
iv. berberine in the range of 0.001 to 8%;
v. Isoquinoline in the range of 0.001 to 9%;
vi. camphor in the range of 0.001 to 15%;
vii. β-asarone in the range of 0.001 to 9%;
viii. Cuminaldehyde in the range of 0.001 to 10%;
ix. ar-Turmerone in the range of 0.001 to 8%;
x. Chavibetol in the range of 0.001 to 7%;
xi. Camphene in the range of 0.001 to 7%;
xii. Gaur gum in the range of 0.001 to 7.5%;
xiii. ethoxylated castor oil in the range of 0.001 to 10%;
xiv. Sodium oleoyl amino fatty acid in the range of 0.1 to 15%
xv. Dimethyl sulfoxide in the range of 10.0 to 35%; and
xvi. Benzyl acetate in the range of 10.0 to 35%

In another embodiment, the present invention provides a biopesticidal and bio-stimulant composition comprising:
i. Camphor in the range of 0.001 to 7%;
ii. Eugenol in the range of 0.001 to 10%;
iii. thymol in the range of 0.001 to 13%;
iv. piperine in the range of 0.001 to 8%;
v. Methyl chavicol in the range of 0.001 to 9%;
vi. Citral in the range of 0.001 to 15%;
vii. D-limonene in the range of 0.001 to 8%;
viii. thymoquinone in the range of 0.001 to 8%;
ix. capsaicin in the range of 0.001 to 8%;
x. Palmitic acid in the range of 0.001 to 8%;
xi. Essential oil of Ferula asafoetida in the range of 0.001 to 8%;
xii. Span 80 in the range of 0.001 to 7.5%;
xiii. Polyoxyl 35 hydrogenated castor oil in the range of 0.001 to 10%;
xiv. ethoxylated castor oil in the range of 0.001 to 10%
xv. Sodium oleoyl amino fatty acid in the range of 0.1 to 15%;
xvi. Dimethyl sulfoxide in the range of 10.0 to 35%;
xvii. Benzyl acetate in the range of 10.0 to 35%; and
xviii. water in the range of 10.0 to 75%.

In another embodiment, the present invention provides a biopesticidal and bio-stimulant composition comprising:
i. Camphor in the range of 0.001 to 7%;
ii. Eugenol in the range of 0.001 to 10%;
iii. thymol in the range of 0.001 to 13%;
iv. piperine in the range of 0.001 to 8%;
v. Methyl chavicol in the range of 0.001 to 9%;
vi. Citral in the range of 0.001 to 15%;
vii. Essential oil of Ferula asafoetida in the range of 0.001 to 8%;
viii. Orange oil in the range of 0.1 to 15%;
ix. Gaur gum in the range of 0.001 to 7.5%;
x. ethoxylated castor oil in the range of 0.001 to 10%;
xi. Sodium oleoyl amino fatty acid in the range of 0.1 to 15%
xii. Dimethyl sulfoxide in the range of 10.0 to 35%; and
xiii. N-Ethyl-2 pyrrolidone (NEP) in the range of 10.0 to 35%.

In another embodiment, the present invention provides a biopesticidal and bio-stimulant composition comprising:
i. Camphor in the range of 0.001 to 7%;
ii. Eugenol in the range of 0.001 to 10%;
iii. thymol in the range of 0.001 to 15%;
iv. piperine in the range of 0.001 to 12%;
v. Methyl chavicol in the range of 0.001 to 10%;
vi. Citral in the range of 0.001 to 15%;
vii. D-limonene in the range of 0.001 to 10%;
viii. Fumed silica in the range of 0.001 to 5.0%;
ix. Sodium N methyl N-Oleyl taurate in the range of 0.001 to 6.0%;
x. Polyorganosiloxane in the range of 0.001 to 7.0%;
xi. Sodium alkyl naphthalene sulfonate in the range of 0.001 to 15%;
xii. starch in the range of 0.01 to 25%; and
xiii. Anhydrous lactose in the range of 65.0 to 75.0%

In another embodiment, the present invention provides a biopesticidal and bio-stimulant composition comprising said phytochemicals with agriculturally acceptable excipients or additives with a synergistic biological action that efficiently controls a wide range of pests that cause crop destruction by taking direct action on them.

In another embodiment, the present invention provides a process for preparation of the biopesticidal and bio-stimulant composition comprising:
a. Dissolving the emulsifier and surfactant in solvent to make inert mixture and agitating with homogenizer until a uniform blend is formed;
b. Adding the phytochemicals in given quantity to the blend formed in step (a) and homogenizing completely to make an emulsion concentration.
c. Stirring the mixture obtained in step (b) at 300-1000 RPM more specifically at 350-800 RPM at 25-55° C. in closed mixing vessel for continued stirring followed by homogenizing the mix with the homogenizer fitted towards the bottom of vessel and with the speed of 3700˜27000 rpm to reduce the particle size;
d. Passing the homogenized mixture obtained in step (c) through in line shear pump with 1800 RPM to 5800 RPM to reduce particle size to obtain the nano emulsion with particle size ranging from 10 to 1000 nano meter;
e. Passing the mixture obtained in step (d) through High-pressure homogenization to reduce the particle size below 100 nano meters;
f. Passing the mixture obtained in step (e) through sparkler filter having seven layers of membrane filters with pore size less than 1-2 micron to achieve desired filtration; and
g. Recovering the final product.
   OR
a. Blending the active ingredients with the excipients to form an uniform mixture;
b. Adding water to the mixture of step (a) and blending;
c. Transferring the wet mass of step (b) to a basket extruder and extruding the wet mass to a 0.8 mm screen and drying in a fluid bed followed by vacuum drying to obtain dry granules;
d. Separating the granules of step (c) to the desired range of 4 to 50 mesh; and
e. Recovering the final product.

The high-pressure homogenization of step (e) is carried out at a speed of 4000 rpm to 10000 rpm and pressure up to 4,200 bar (60,000 psi).

In yet another embodiment, the emulsifier used in the process is selected from group consisting of Span 80, polysorbate 80, polysorbate 60, Gaur gum, ethoxylated castor oil, Polyorganosiloxane and the like in a range of 0.1-13%, more preferably 7.0%.

In another embodiment, the surfactant used in the process is selected from the group consisting of Sodium oleoyl amino fatty acid, Sodium dodecyl sulphate, Polyoxyl 35 hydrogenated castor oil, Sodium N methyl N-Oleyl taurate, Sodium alkyl naphthalene sulfonate and the like in a range of 0.1-15%, more preferably 8.0%.

In another embodiment, the solvents used in the process are selected from one or more water, Dimethyl sulfoxide (DMSO), Benzyl acetate, N-methyl pyrrolidinone, Diacetone alcohol, N-Ethyl-2 pyrrolidone (NEP) and the like in a range of 15-55%, more preferably 30%.

In another embodiment, the carriers used in the process are selected from at least one substantially water-miscible co-solvent, preferably selected from the group of N-methylpyrrolidinone; dimethylsulphoxide; dimethylfonnamide C9; methyl ethyl ketone, Ethylene Glycol Diacetate, dimethylisosorbide isophorone; acetophenone; cyclohexanone; Diacetone alcohol 1,3-dimethyl-2-imidazolidonone; ethylene, propylene, and butylene carbonates; lactate esters; Methyl oleate, dimethyl and diethylcarbonates; alkylglycol ethers; glycols, including propylene, carbapol 940 and biodiesel and the like in a range of 15-55%, more preferably 35%.

In another embodiment, the essential oils used in the process are selected from the group consisting of seed oil of Essential oil of Ferula asafoetida, Orange oil, camphor, thyme, clove, pepper, spearmint, citronella, cassia, orange oil, star anise, cedar wood, peppermint, ginger, turmeric and bay leaf and the like in a range of 0.1-15%, more preferably 6.0%.

In another embodiment, the further purification of Phyto ingredient is carried out by using liquid liquid extraction, various chromatograph techniques like silica gel chromatography, ion exchange chromatography and other purification like precipitation and crystallization.

In an embodiment, the particle size of the composition/formulation is reduced to the nano range for improved efficacy and penetration. The reduction in the particle size in the nano range is achieved by employing different modules such as a filter press, shear pump, homogenizer, and high pressure homogenization (pressure max up to 45,000 PSI) to create a nano formulation with an average particle size range of 10 to 1000 nm. Nano formulations are stable and may be obtained without the use of any additives or chemicals. Nanoparticles are obtained in the present invention employing mechanical methods with a temperature control system to maintain heat sensitive substances.

In another embodiment, the composition is provided at a concentration ranging between 0.1-3.5 ml/L.

In another embodiment, the biopesticidal and bio-stimulant composition of the present invention exhibits synergism at specific concentration and thereby controls the plant pests/insects and protects agriculture, horticulture, olericulture and floricultural crops.

The present inventors have compared the in vitro bio-efficacy of the present composition (Embodiments 1 to 12) with the bio-efficacy of individual phytochemicals and observed that the activity of the present embodiments 1 to 12 were significantly better than the bio-efficacy shown by individual phytochemicals. The results are illustrated in Examples 14 to 31.

The in vitro and in vivo bio-efficacy studies conducted on numerous crops demonstrated that the bio-efficacy is consistent and stable against various pests and crops.

In another embodiment, the composition of the present invention is useful for controlling plant pests and improving yield of crop plants.

In another embodiment, the biopesticidal and bio-stimulant composition of the present invention exhibits biostimulant activity and thereby improves plant growth and crop yield.

In an embodiment, the composition of the present invention may be applied by sprinkler application, sprayer application or drip application, more preferably by sprayer application such as foliar sprays, sprays to be applied to plants shoots and the like.

In yet another embodiment, the composition of the present invention is effective against agricultural pests such as insects, nematodes, mites, snails, slugs, sucking pest, caterpillar, pathogenic fungi, bacteria and the like.

In an embodiment, the composition of the present invention exhibits biostimulant activity and thereby improves plant growth and crop yield.

In an embodiment, the present invention provides a method for controlling or killing of the agricultural insects/pests comprising applying said phytochemical composition to the plant or to the affected parts of the plants in suitable amount thereof.

In the present invention, water is used as a carrier for water-based formulations, and for wettable powder formulations, one of the ingredients is chosen from the list below: lactose, anhydrous lactose, dextrose, calcium bentonite powder, sodium bentonite powder, white carbon, kaolin, precipitated calcium carbonate, cornflour, powdered sugar, potter's clay, and the like.

In another embodiment, the composition of the present invention may be used in conjunction with the known insecticidal or acaricidal active ingredient.

In yet another embodiment, the phytochemicals of the present invention may be used with the active ingredient contained in other agents such as fungicides, bactericide, nematicide, plant growth regulators, synergists, fertilizers, soil improvers, animal feeds and the like.

The phytochemicals/ingredients of the present invention comprising citral, camphor, methyl chavicol, and thymol provide synergistic effects when combined. They work together to assault digestive tracts of the insects/pets with the greatest ability by acting as anion channel-type receptors.

The phytoingredients of the present invention consisting of thymol and piperine exhibit high larvicidal activity by slowing the growth of early larvae and lowering hatching rates.

The phytoingredients Eugenol, 1,8 cineole, beta asarone cause paralysis in the insect when combined together.

The phytoingredients Gingerol, palmitic acid, and chavibetol owing to their chemical properties exhibit high repellent insect activity.

The phytoingredients Citral and thymol, when combined, impact the central nervous system of insects, causing paralysis and death.

The phytoingredients Isoquinoline, menthol and thymol demonstrate acaricidal activity by interfering with insect ovicidal properties and other activity like oviposition deterrence

The phytoingredients Piperine, berberine and menthol demonstrate strong antibacterial activity by altering membrane permeability.

The phytoingredients Parthenin, limonene and turmerone shows antifungal activity by inhibiting mycelia growth and spore production.

In an embodiment, the phytochemicals of the present invention function synergistically to repel pests through various pathways, including repellent, digestion, paralysis, and suffocation.

In another embodiment, the essential oils and botanical concretes of the present invention enhance the pesticidal action of the major pesticidal ingredients. Essential oils include Essential oil of Ferula asafoetida, Orange oil, camphor, thyme, clove, pepper, spearmint, citronella, cassia, star anise, cedar wood, peppermint, ginger, turmeric and bay leaf and the like in a range of 0.1-15%, more preferably 6.0%.

The biopesticdal and bio-stimulant composition of the present invention may be formulated into a known form such as wettable powder, granule, powder, tablet, emulsion, water-soluble agent, suspension, granule wettable powder, flowable agent, microcapsule, aerosol, propellant, spray, fogging agent, heating transpiration agent, smoking agent, baiting agent or the like.

In yet another aspect, the present invention provides a method for controlling or killing of the agricultural insects/pests comprising applying said phytochemical composition to the plant or to the affected parts of the plants in suitable amount thereof.

In an embodiment, the phytochemicals of the present invention are safe, non-toxic to humans and environment while being highly potent towards the larvae and the insects at large.

In another embodiment, the phytochemical composition of the present invention is applied to the plants/crops at all developmental stages in suitable dosages.

The following example, which includes preferred embodiments, will serve to illustrate the practice of this invention, it being understood that the particulars shown are by way of example and for purpose of illustrative discussion of preferred embodiments of the invention.

### EXPERIMENTAL

### Example 1: Botanical Based Bio-Insecticide—Embodiment 1

TABLE 1

| Sr | | Actual | Percent |
|---|---|---|---|
| No. | Ingredient | Percent | Range |
| 1. | Eugenol | 8.0% | 0.001 to 10% |
| 2. | Thymol | 12.5% | 0.001 to 13% |
| 3. | Clove oil | 5.0% | 0.1 to 15% |
| 5. | Poly sorbate 80 | 7.0% | 0.1 to 13% |
| 6. | Sodium oleoyl amino fatty acid | 8.0% | 0.1 to 15% |
| | (Surfactant) | | |
| 7. | Dimethyl sulfoxide (DMSO) | 22.3% | 10.0 to 45% |
| 8. | Benzyl acetate | 33.2% | 15.0 to 55% |

### Preparation of Botanical Based Bio-Insecticide—Embodiment 1:

Wherein the process for preparing the said product comprises the steps of:
1. The emulsifier and surfactant were dissolved in dimethyl sulfoxide and benzyl acetate to make inert mixture and agitated with homogenizer until the uniform blend was formed.
2. Active ingredients, eugenol, thymol and clove oil in given quantity were added to the blend form in step 1 and homogenized completely to make emulsion concentration.
3. The emulsion concentrate prepared in step no.2 was stirred at 300 to 800 rpm at 25 to 55 degrees Celsius in close mixing vessel made up of stainless steel 316 grade with outer jacket for maintaining temperature, mixing vessel was connected with stirrer (blade stirrer, propeller stirrer, turbine stirrer, anchor stirrer, universal stirrer) for continues stirring. Towards the bottom of vessel homogenizer with the speed of 3700˜27000 rpm was attached to reduce the particle size under very high pressures, sheer, turbulence, acceleration and impact, to make them more stable and effective.
4. Blend prepare in step no 3 was passed through in line shear pump with 1800 RPM to 5800 RPM to reduce particle size in nano, so as to achieve nano emulsion with particle size ranging from 10 to 900 nano meter.
5. Further to obtain nano particles base formulation the blend formed in step no 4 was further passed-through High-pressure homogenization (homogenization at speed of 4000 rpm to 10000 rpm and pressure max up to 4,200 bar (60,000 psi)) to reduce the particle size below 100 nano meters.
6. After passing through high pressure homogenizer the material was passed through sparkler filter having seven layers of membrane filters with pore size less than 1-2 micron to achieve proper filtration.
7. Product recovered from step 6 was further quantified for the active phyto constituent by using various instruments but not limited to liquid chromatography-mass spectrometry, gas chromatography-mass spectrometry, High pressure liquid chromatograph, gas chromatography, spectroscopy compounds etc.
8. The product obtained in step 7 was also tested for bio-efficacy against pests on different crops in vitro and in vivo, and compared to other chemically synthesised pesticides.

### Example 2: Botanical Based Bio-Insecticide—Embodiment 2

TABLE 2

| Sr | | Actual | Percent |
|---|---|---|---|
| No. | Ingredient | Percent | Range |
| 1. | Piperine | 7.4% | 0.001 to 10% |
| 2. | Thymol | 10.3% | 0.001 to 13% |
| 3. | Black pepper oil | 6.0% | 0.1 to 15% |
| 4. | Span 80 | 6.8% | 0.1 to 13% |
| 5. | Sodium oleoyl amino fatty acid | 7.4% | 0.1 to 15% |
| | (Surfactant) | | |
| 6. | N-methyl pyrrolidinone | 27.2% | 10.0 to 45% |
| 7. | Benzyl acetate | 34.9% | 15.0 to 55% |

### Preparation of Botanical Based Bio-Insecticide—Embodiment 2:

Wherein the process for preparing the said product comprises the steps of:
1. The emulsifier and surfactant were dissolved in N-methyl pyrrolidinone and benzyl acetate to make inert mixture and agitated with homogenizer until the uniform blend was formed.
2. Active ingredients, Piperine, thymol and black pepper oil in given quantity were added to the blend formed in step 1 and homogenized completely to make emulsion concentration.
3. The emulsion concentrate prepared in step no.2 was stirred at 300 to 800 rpm at 25 to 55 degrees Celsius in closed mixing vessel made up of stainless steel 316 grade with outer jacket for maintaining temperature, mixing vessel is connected with stirrer (blade stirrer, propeller stirrer, turbine stirrer, anchor stirrer, universal stirrer) for continues stirring. Towards the bottom of vessel homogenizer with the speed of 3700˜27000 rpm was attached to reduce the particle size under very high pressures, sheer, turbulence, acceleration and impact, to make them more stable and effective.
4. Blend prepared in step no 3 was passed through in line shear pump with 1800 RPM to 5800 RPM to reduce particle size in nano, so as to achieve nano emulsion with particle size ranging from 10 to 900 nano meter.
5. Further to obtain nano particles base formulation the blend formed in step no 4 was further passed-through High-pressure homogenization (homogenization at speed of 4000 rpm to 10000 rpm and pressure max up to 4,200 bar (60,000 psi)) to reduce the particle size below 100 nano meters.
6. After passing through high pressure homogenizer the material was passed through sparkler filter having seven layers of membrane filters with pore size less than 1-2 micron to achieve proper filtration.
7. Product recovered from step 6 was further quantified for the active phyto constituent by using various instruments but not limited to liquid chromatography-mass spectrometry, gas chromatography-mass spectrometry, High pressure liquid chromatograph, gas chromatography, spectroscopy compounds etc.
8. The product obtained in step 7 was also tested for bio-efficacy against pests on different crops in vitro and in vivo, and compared to other chemically synthesised pesticides.

### Example 3: Botanical Based Bio-Insecticide—Embodiment 3

TABLE 3

| Sr | | Actual | Percent |
|---|---|---|---|
| No. | Ingredient | Percent | Range |
| 1. | Citral | 12.5% | 0.001 to 10% |
| 2. | Thymol | 9.3% | 0.001 to 13% |
| 3. | Thyme oil | 3.5% | 0.001 to 13% |
| 4. | Span 80 (emulsifier) | 7.3% | 0.1 to 13% |
| 5. | Sodium oleoyl amino fatty acid | 8.5% | 0.1 to 15% |
| | (Surfactant) | | |
| 6. | N-methyl pyrrolidinone | 26.85% | 10.0 to 45% |
| 7. | Diacetone alcohol | 32.05% | 15.0 to 55% |

### Preparation of Botanical Based Bio-Insecticide—Embodiment 3:

Wherein the process for preparing the said product comprises the steps of:
1. The emulsifier and surfactant were dissolved in N-methyl pyrrolidinone and Diacetone alcohol to make inert mixture and agitated with homogenizer until the uniform blend was formed.
2. The active ingredients, citral, thymol and thyme oil in given quantity were added to the blend formed in step 1 and homogenized completely to make emulsion concentration.
3. The emulsion concentrate prepared in step no. 2 was stirred at 300 to 800 rpm at 25 to 55 degrees Celsius in close mixing vessel made up of stainless steel 316 grade with outer jacket for maintaining temperature, mixing vessel was connected with stirrer (blade stirrer, propeller stirrer, turbine stirrer, anchor stirrer, universal stirrer) for continues stirring. Towards the bottom of vessel homogenizer with the speed of 3700˜27000 rpm is attached to reduce the particle size under very high pressures, sheer, turbulence, acceleration and impact, to make them more stable and effective.
4. Blend prepared in step no 3 was passed through in line shear pump with 1800 RPM to 5800 RPM to reduce particle size in nano, so as to achieve nano emulsion with particle size ranging from 10 to 900 nano meter.
5. Further to obtain nano particles based formulation the blend formed in step no 4 was further passed-through High-pressure homogenization (homogenization at speed of 4000 rpm to 10000 rpm and pressure max up to 4,200 bar (60,000 psi)) to reduce the particle size below 100 nano meters.
6. After passing through high pressure homogenizer the material was passed through sparkler filter having seven layers of membrane filters with pore size less than 1-2 micron to achieve proper filtration.
7. Product recovered from step 6 was further quantified for the active phytoconstituent by using various instruments but not limited to liquid chromatography-mass spectrometry, gas chromatography-mass spectrometry, High pressure liquid chromatograph, gas chromatography, spectroscopy compounds etc.
8. The product obtained in step 7 was also tested for bio-efficacy against pests on different crops in vitro and in vivo, and compared to other chemically synthesised pesticides.

### Example 4: Botanical Based Bio-Insecticide—Embodiment 4

TABLE 4

| Sr | | Actual | Percent |
|---|---|---|---|
| No. | Ingredient | Percent | Range |
| 1. | Citral | 12.5% | 0.001 to 10% |
| 2. | Eugenol | 8.5% | 0.001 to 13% |
| 3. | Basil oil | 4.5% | 0.1 to 15% |
| 4. | Polysorbate 80 (emulsifier) | 7.8% | 0.1 to 13% |
| 5. | Sodium oleoyl amino fatty acid | 8.0% | 0.1 to 15% |
| | (Surfactant) | | |
| 6. | N-methyl pyrrolidinone | 32.8% | 10.0 to 45% |
| 7. | Diacetone alcohol | 30.4% | 15.0 to 55% |

### Preparation of Botanical Based Bio-Insecticide—Embodiment 4:

Wherein the process for preparing the said product comprises the steps of:
1. The emulsifier and surfactant were dissolved in N-methyl pyrrolidinone and Diacetone alcohol to make inert mixture and agitated with homogenizer until the uniform blend was formed.
2. The active ingredients, citral, eugenol and basil oil in given quantity were added to the blend form in step 1 and homogenized completely to make emulsion concentration.
3. The emulsion concentrate prepared in step no.2 was stirred at 300 to 800 rpm at 25 to 55 degrees Celsius in close mixing vessel made up of stainless steel 316 grade with outer jacket for maintaining temperature, mixing vessel was connected with stirrer (blade stirrer, propeller stirrer, turbine stirrer, anchor stirrer, universal stirrer) for continues stirring. Towards the bottom of vessel homogenizer with the speed of 3700˜27000 rpm was attached to reduce the particle size under very high pressures, sheer, turbulence, acceleration and impact, to make them more stable and effective.
4. Blend prepared in step no 3 was passed through in line shear pump with 1800 RPM to 5800 RPM to reduce particle size in nano, so as to achieve nano emulsion with particle size ranging from 10 to 900 nano meter.
5. Further to obtain nano particles base formulation the blend formed in step no 4 was further passed-through High-pressure homogenization (homogenization at speed of 4000 rpm to 10000 rpm and pressure max up to 4,200 bar (60,000 psi)) to reduce the particle size below 100 nano meters.
6. After passing through high pressure homogenizer the material was passed through sparkler filter having seven layers of membrane filters with pore size less than 1-2 micron to achieve proper filtration.
7. Product recovered from step 6 was further quantified for the active phytoconstituent by using various instruments but not limited to liquid chromatography-mass spectrometry, gas chromatography-mass spectrometry, High pressure liquid chromatograph, gas chromatography, spectroscopy compounds etc.
8. The product obtained in step 7 was also tested for bio-efficacy against pests on different crops in vitro and in vivo, and compared to other chemically synthesised pesticides.

### Example 5: Botanical Based Bio-Insecticide—Embodiment 5

TABLE 5

| Sr | | Actual | Percent |
|---|---|---|---|
| No. | Ingredient | Percent | Range |
| 1. | Camphor | 10.5% | 0.001 to 10% |
| 2. | Thymol | 14.5% | 0.001 to 13% |
| 3. | Camphor oil | 5.0% | 0.1 to 15% |
| 4. | Polysorbate 60 (emulsifier) | 7.8% | 0.1 to 13% |
| 5. | Sodium oleoyl amino fatty acid | 8.0% | 0.1 to 15% |
| | (Surfactant) | | |
| 6. | N-methyl pyrrolidinone | 32.8% | 10.0 to 45% |
| 7. | Diacetone alcohol | 30.4% | 15.0 to 55% |

### Preparation of Botanical Based Bio-Insecticide—Embodiment 5:

Wherein the process for preparing the said product comprises the steps of,
1. The emulsifier and surfactant were dissolved in N-methyl pyrrolidinone and Diacetone alcohol to make inert mixture and agitated with homogenizer until the uniform blend was formed.
2. The active ingredients, citral, thymol and camphor oil in given quantity were added to the blend formed in step 1 and homogenized completely to make emulsion concentration.
3. The emulsion concentrate prepared in step no.2 was stirred at 300 to 800 rpm at 25 to 55 degrees Celsius in close mixing vessel made up of stainless steel 316 grade with outer jacket for maintaining temperature, mixing vessel was connected with stirrer (blade stirrer, propeller stirrer, turbine stirrer, anchor stirrer, universal stirrer) for continues stirring. Towards the bottom of vessel homogenizer with the speed of 3700˜27000 rpm was attached to reduce the particle size under very high pressures, sheer, turbulence, acceleration and impact, to make them more stable and effective.
4. Blend prepared in step no 3 was passed through in line shear pump with 1800 RPM to 5800 RPM to reduce particle size in nano, so as to achieve nano emulsion with particle size ranging from 10 to 900 nano meter.
5. Further to obtain nano particles base formulation the blend formed in step no 4 was further passed-through High-pressure homogenization (homogenization at speed of 4000 rpm to 10000 rpm and pressure max up to 4,200 bar (60,000 psi)) to reduce the particle size below 100 nano meters.
6. After passing through high pressure homogenizer the material was passed through sparkler filter having seven layers of membrane filters with pore size less than 1-2 micron to achieve proper filtration.
7. Product recovered from step 6 was further quantified for the active phyto constituent by using various instruments but not limited to liquid chromatography-mass spectrometry, gas chromatography-mass spectrometry, High pressure liquid chromatograph, gas chromatography, spectroscopy compounds etc.
8. The product obtained in step 7 was also tested for bio-efficacy against pests on different crops in vitro and in vivo, and compared to other chemically synthesised pesticides.

### Example 6: Botanical Based Bio-Insecticide—Embodiment 6

TABLE 6

| Sr | | Actual | |
|---|---|---|---|
| No. | Ingredient | Percent | Percent Range |
| 1. | Camphor | 3.5% | 0.00 1 to 7% |
| 2. | Eugenol | 3.3% | 0.001 to 10% |
| 3. | Thymol | 4.5% | 0.001 to 13% |
| 4. | Piperine | 3.8% | 0.001 to 8% |
| 5. | Methyl chavicol | 5.0% | 0.001 to 9% |
| 6. | Citral | 8.0% | 0.001 to 15% |
| 7. | D-limonene | 2.7% | 0.001 to 8% |
| 8. | Thymoquinone | 1.0% | 0.001 to 8% |
| 9. | Capsaicin | 2.2% | 0.001 to 8% |
| 10. | Palmitic acid | 1.2% | 0.001 to 8% |
| 11. | Essential oil of Ferula asafoetida | 4.0% | 0.001 to 8% |
| 12. | Orange oil | 3.5% | 0.1 to 15% |
| 13. | Gaur gum (Emulsifier) | 4.2% | 0.001 to 7.5% |
| 14. | Ethoxylated castor oil (Emulsifier) | 5.8% | 0.001 to 10% |
| 15. | Sodium oleoyl amino fatty acid | 8.0% | 0.1 to 15% |
| | (Surfactant) | | |
| 16. | Dimethyl sulfoxide (DMSO) | 22.5% | 10.0 to 35% |
| 17. | Benzyl acetate | 24.7% | 10.0 to 35% |

### Preparation of Botanical Based Bio-Insecticide—Embodiment 6:

Wherein the process for preparing the said product comprises the steps of:
1. The emulsifier and surfactant were dissolved in dimethyl sulfoxide and benzyl acetate to make inert mixture and agitated with homogenizer until the uniform blend was formed.
2. The active ingredients, camphor, eugenol, thymol, piperine, methyl chavicol, citral, D-limonene, thymoquinone, capsaicin, Palmitic acid orange oil and essential oil of Ferula asafoetida in given quantity were added to the blend formed in step 1 and homogenized completely to make emulsion concentration.
3. The emulsion concentrate prepared in step no.2 was stirred at 300 to 800 rpm at 25 to 55 degrees Celsius in close mixing vessel made up of stainless steel 316 grade with outer jacket for maintaining temperature, mixing vessel is connected with stirrer (blade stirrer, propeller stirrer, turbine stirrer, anchor stirrer, universal stirrer) for continues stirring. Towards the bottom of vessel homogenizer with the speed of 3700˜27000 rpm was attached to reduce the particle size under very high pressures, sheer, turbulence, acceleration and impact, to make them more stable and effective.
4. Blend prepared in step no 3 was passed through in line shear pump with 1800 RPM to 5800 RPM to reduce particle size in nano, so as to achieve nano emulsion with particle size ranging from 10 to 900 nano meter.
5. Further to obtain nano particles base formulation the blend formed in step no 4 was further passed-through High-pressure homogenization (homogenization at speed of 4000 rpm to 10000 rpm and pressure max up to 4,200 bar (60,000 psi)) to reduce the particle size below 100 nano meters.
6. After passing through high pressure homogenizer the material was passed through sparkler filter having seven layers of membrane filters with pore size less than 1-2 micron to achieve proper filtration.
7. Product recovered from step 6 was further quantified for the active phyto constituent by using various instruments but not limited to liquid chromatography-mass spectrometry, gas chromatography-mass spectrometry, High pressure liquid chromatograph, gas chromatography, spectroscopy compounds etc.
8. The product obtained in step 7 was also tested for bio-efficacy against pests on different crops in vitro and in vivo, and compared to other chemically synthesised pesticides.

### Example 7: Botanical Based Bio-Insecticide—Embodiment 7

TABLE 7

| Sr | | Actual | |
|---|---|---|---|
| No. | Ingredient | Percent | Percent Range |
| 1. | Camphor | 3.5% | 0.00 1 to 7% |
| 2. | Eugenol | 3.3% | 0.001 to 10% |
| 3. | Thymol | 4.5% | 0.001 to 13% |
| 4. | Piperine | 3.8% | 0.001 to 8% |
| 5. | Methyl chavicol | 5.0% | 0.001 to 9% |
| 6. | Citral | 8.0% | 0.001 to 15% |
| 7. | D-limonene | 2.7% | 0.001 to 8% |
| 8. | Thymoquinone | 1.0% | 0.001 to 8% |
| 9. | Capsaicin | 2.2% | 0.001 to 8% |
| 10. | Palmitic acid | 1.2% | 0.001 to 8% |
| 11. | Essential oil of Ferula asafoetida | 4.0% | 0.001 to 8% |
| 12. | Gaur gum (Emulsifier) | 4.2% | 0.001 to 7.5% |
| 13. | ethoxylated castor oil (Emulsifier) | 5.8% | 0.001 to 10% |
| 14. | Sodium oleoyl amino fatty acid | 8.0% | 0.1 to 15% |
| | (Surfactant) | | |
| 15. | Dimethyl sulfoxide (DMSO) | 22.5% | 10.0 to 35% |
| 16. | Benzyl acetate | 24.7% | 10.0 to 35% |

### Preparation of Botanical Based Bio-Insecticide—Embodiment 7:

Wherein the process for preparing the said product comprises the steps of:
1. The emulsifier and surfactant were dissolved in dimethyl sulfoxide and benzyl acetate to make inert mixture and agitated with homogenizer until the uniform blend was formed.
2. The active ingredients, camphor, eugenol, thymol, piperine, methyl chavicol, citral, D-limonene, thymoquinone, capsaicin, Palmitic acid and essential oil of Ferula asafoetida in given quantity were added to the blend form in step 1, and homogenized completely to make emulsion concentration.
3. The emulsion concentrate prepared in step no.2 was stirred at 300 to 800 rpm at 25 to 55 degrees Celsius in close mixing vessel made up of stainless steel 316 grade with outer jacket for maintaining temperature, mixing vessel is connected with stirrer (blade stirrer, propeller stirrer, turbine stirrer, anchor stirrer, universal stirrer) for continues stirring. Towards the bottom of vessel homogenizer with the speed of 3700˜27000 rpm is attached to reduce the particle size under very high pressures, sheer, turbulence, acceleration and impact, to make them more stable and effective.
4. Blend prepare in step no 3 was passed through in line shear pump with 1800 RPM to 5800 RPM to reduce particle size in nano, so as to achieve nano emulsion with particle size ranging from 10 to 900 nano meter.
5. Further to obtain nano particles base formulation the blend formed in step no 4 was further passed-through High-pressure homogenization (homogenization at speed of 4000 rpm to 10000 rpm and pressure max up to 4,200 bar (60,000 psi)) to reduce the particle size below 100 nano meters.
6. After passing through high pressure homogenizer the material was passed through sparkler filter having seven layers of membrane filters with pore size less than 1-2 micron to achieve proper filtration.
7. Product recovered from step 6 was further quantified for the active phyto constituent by using various instruments but not limited to liquid chromatography-mass spectrometry, gas chromatography-mass spectrometry, High pressure liquid chromatograph, gas chromatography, spectroscopy compounds etc.
8. The product obtained in step 7 was also tested for bio-efficacy against pests on different crops in vitro and in vivo, and compared to other chemically synthesised pesticides.

### Example 8: Botanical Based Bio-Insecticide—Embodiment 8

TABLE 8

| Sr | | Actual | |
|---|---|---|---|
| No. | Ingredient | Percent | Percent Range |
| 1. | Parthenin | 3.6% | 0.00 1 to 7% |
| 2. | Carvacrol | 7.3% | 0.001 to 10% |
| 3. | thymol | 6.5% | 0.001 to 13% |
| 4. | Gingerol | 6.8% | 0.001 to 8% |
| 5. | Menthol | 5.3% | 0.001 to 9% |
| 6. | P-Cymene | 2.8% | 0.001 to 15% |
| 7. | 2-Undecanone | 2.4% | 0.001 to 8% |
| 8. | citral | 4.5% | 0.001 to 15% |
| 9. | Ellagic acid | 1.6% | 0.001 to 8% |
| 10. | Swainsonine (Alkaloid) | 3.0% | 0.001 to 8% |
| 11. | Polysorbate 80 (Emulsifier) | 4.2% | 0.001 to 7.5% |
| 12. | ethoxylated castor oil (Emulsifier) | 5.8% | 0.001 to 10% |
| 13. | Sodium dodecyl sulfate (Surfactant) | 8.0% | 0.1 to 15% |
| 14. | Dimethyl sulfoxide (DMSO) | 19.5% | 10.0 to 35% |
| 15. | N-methyl pyrrolidinone | 20.3% | 10.0 to 35% |

### Preparation of Botanical Based Bio-Insecticide—Embodiment 8:

Wherein the process for preparing the said product comprises the steps of:
1. The emulsifier and surfactant were dissolved in dimethyl sulfoxide and N-methyl pyrrolidinone to make inert mixture and agitatedwith homogenizer until the uniform blend was formed.
2. The active ingredients, Parthenin, carvacrol, thymol, gingerol, Menthol, P-cymene, 2-undecanone, citral, Ellagic acid and swainsonine (Alkaloid) in given quantity were added to the blend form in step 1 and homogenized completely to make emulsion concentration.
3. The emulsion concentrate prepared in step no.2 was stirred at 300 to 800 rpm at 25 to 55 degrees Celsius in closed mixing vessel made up of stainless steel 316 grade with outer jacket for maintaining temperature, mixing vessel was connected with stirrer (blade stirrer, propeller stirrer, turbine stirrer, anchor stirrer, universal stirrer) for continues stirring. Towards the bottom of vessel homogenizer with the speed of 3700˜27000 rpm was attached to reduce the particle size under very high pressures, sheer, turbulence, acceleration and impact, to make them more stable and effective.
4. Blend prepare in step no 3 was passed through in line shear pump with 1800 RPM to 5800 RPM to reduce particle size in nano, so as to achieve nano emulsion with particle size ranging from 10 to 900 nano meter.
5. Further to obtain nano particles base formulation the blend formed in step no 4 was further passed-through High-pressure homogenization (homogenization at speed of 4000 rpm to 10000 rpm and pressure max up to 4,200 bar (60,000 psi)) to reduce the particle size below 100 nano meters.
6. After passing through high pressure homogenizer the material was passed through sparkler filter having seven layers of membrane filters with pore size less than 1-2 micron to achieve proper filtration.
7. Product recovered from step 6 was further quantified for the active phytoconstituent by using various instruments but not limited to liquid chromatography-mass spectrometry, gas chromatography-mass spectrometry, High pressure liquid chromatograph, gas chromatography, spectroscopy compounds etc.
8. The product obtained in step 7 was also tested for bio-efficacy against pests on different crops in vitro and in vivo, and compared to other chemically synthesised pesticides.

### Example 9: Botanical Based Bio-Insecticide—Embodiment 9

TABLE 9

| Sr | | Actual | |
|---|---|---|---|
| No. | Ingredient | Percent | Percent Range |
| 1. | 1,8 cineole | 2.8% | 0.00 1 to 7% |
| 2. | eugenol | 1.5% | 0.001 to 10% |
| 3. | Alpha-pine | 3.0% | 0.001 to 13% |
| 4. | berberine | 1.2% | 0.001 to 8% |
| 5. | Isoquinoline (Alkaloid) | 2.0% | 0.001 to 9% |
| 6. | camphor | 5.0% | 0.001 to 15% |
| 7. | β-asarone | 3.0% | 0.001 to 9% |
| 8. | Cuminaldehyde | 3.3% | 0.00 1 to 10% |
| 9. | ar-Turmerone | 3.7% | 0.001 to 8% |
| 10. | Chavibetol | 1.0% | 0.00 1 to 7% |
| 11. | Camphene | 1.2% | 0.00 1 to 7% |
| 12. | Gaur gum (Emulsifier) | 6.2% | 0.001 to 7.5% |
| 13. | ethoxylated castor oil (Emulsifier) | 7.4% | 0.001 to 10% |
| 14. | Sodium oleoyl amino fatty acid | 7.8% | 0.1 to 15% |
| | (Surfactant) | | |
| 15. | Dimethyl sulfoxide (DMSO) | 23.5% | 10.0 to 35% |
| 16. | Benzyl acetate | 27.4% | 10.0 to 35% |

### Preparation of Botanical Based Bio-Insecticide—Embodiment 9:

Wherein the process for preparing the said product comprises the steps of, 1. The emulsifier and surfactant were dissolved in dimethyl sulfoxide and benzyl acetate to make inert mixture and agitated with homogenizer until the uniform blend was formed.
2. The active ingredients, 1,8 cineole, eugenol, alpha pine, berberine, isoquinoline, camphor, β-asarone, Cuminaldehyde, ar-Turmerone, chavibetol, camphene in given quantity were added to the blend formed in step 1 and homogenized completely to make emulsion concentration.
3. The emulsion concentrate prepared in step no.2 was stirred at 300 to 800 rpm at 25 to 55 degrees Celsius in close mixing vessel made up of stainless steel 316 grade with outer jacket for maintaining temperature, mixing vessel is connected with stirrer (blade stirrer, propeller stirrer, turbine stirrer, anchor stirrer, universal stirrer) for continues stirring. Towards the bottom of vessel homogenizer with the speed of 3700˜27000 rpm was attached to reduce the particle size under very high pressures, sheer, turbulence, acceleration and impact, to make them more stable and effective.
4. Blend prepared in step no 3 was passed through in line shear pump with 1800 RPM to 5800 RPM to reduce particle size in nano, so as to achieve nano emulsion with particle size ranging from 10 to 900 nano meter.
5. Further to obtain nano particles base formulation the blend formed in step no 4 was further passed-through High-pressure homogenization (homogenization at speed of 4000 rpm to 10000 rpm and pressure max up to 4,200 bar (60,000 psi)) to reduce the particle size below 100 nano meters.
6. After passing through high pressure homogenizer the material was passed through sparkler filter having seven layers of membrane filters with pore size less than 1-2 micron to achieve proper filtration.
7. Product recovered from step 6 was further quantified for the active phytoconstituent by using various instruments but not limited to liquid chromatography-mass spectrometry, gas chromatography-mass spectrometry, High pressure liquid chromatograph, gas chromatography, spectroscopy compounds etc.
8. The product obtained in step 7 was also tested for bio-efficacy against pests on different crops in vitro and in vivo, and compared to other chemically synthesised pesticides.

### Example 10: Botanical Based Bio-Insecticide—Embodiment 10

TABLE 10

| Sr | | Actual | |
|---|---|---|---|
| No. | Ingredient | Percent | Percent Range |
| 1. | Camphor | 3.5% | 0.00 1 to 7% |
| 2. | eugenol | 3.3% | 0.001 to 10% |
| 3. | thymol | 4.5% | 0.001 to 13% |
| 4. | piperine | 3.8% | 0.001 to 8% |
| 5. | Methyl chavicol | 5.0% | 0.001 to 9% |
| 6. | Citral | 8.0% | 0.001 to 15% |
| 7. | D-limonene | 2.7% | 0.001 to 8% |
| 8. | thymoquinone | 1.0% | 0.001 to 8% |
| 9. | capsaicin | 2.2% | 0.001 to 8% |
| 10. | Palmitic acid | 1.2% | 0.001 to 8% |
| 11. | Essential oil of Ferula asafoetida | 4.0% | 0.001 to 8% |
| 12. | Span 80 (Emulsifier) | 4.2% | 0.001 to 7.5% |
| 13. | Polyoxyl 35 hydrogenated castor oil | 3.6% | 0.001 to 10% |
| | (Surfactant) | | |
| 15. | ethoxylated castor oil (Emulsifier) | 4.8% | 0.001 to 10% |
| 15. | Sodium oleoyl amino fatty acid | 8.0% | 0.1 to 15% |
| | (Surfactant) | | |
| 16. | Dimethyl sulfoxide (DMSO) | 4.5% | 10.0 to 35% |
| 17. | Benzyl acetate | 4.7% | 10.0 to 35% |
| 18. | water | 40.0% | 10.0 to 75% |

### Preparation of Botanical Based Bio-Insecticide—Embodiment 10:

Wherein the process for preparing the said product comprises the steps of:
1. The emulsifier and surfactant were dissolved in dimethyl sulfoxide and benzyl acetate to make inert mixture and agitated with homogenizer until the uniform blend was formed.
2. The active ingredients, camphor, eugenol, thymol, piperine, methyl chavicol, citral, D-limonene, thymoquinone, capsaicin, Palmitic acid and essential oil of Ferula asafoetida in given quantity were added to the blend formed in step 1 and homogenized completely to make emulsion concentration.
3. The emulsion concentrate prepared in step no.2 was stirred at 300 to 800 rpm at 25 to 55 degrees Celsius in closed mixing vessel made up of stainless steel 316 grade with outer jacket for maintaining temperature, mixing vessel was connected with stirrer (blade stirrer, propeller stirrer, turbine stirrer, anchor stirrer, universal stirrer) for continues stirring. Towards the bottom of vessel homogenizer with the speed of 3700˜27000 rpm was attached to reduce the particle size under very high pressures, sheer, turbulence, acceleration and impact, to make them more stable and effective.
4. Blend prepare in step no 3 was passed through in line shear pump with 1800 RPM to 5800 RPM to reduce particle size in nano, so as to achieve nano emulsion with particle size ranging from 10 to 900 nano meter.
5. Further to obtain nano particles base formulation the blend formed in step no 4 was further passed-through High-pressure homogenization (homogenization at speed of 4000 rpm to 10000 rpm and pressure max up to 4,200 bar (60,000 psi)) to reduce the particle size below 100 nano meters.
6. After passing through high pressure homogenizer the material was passed through sparkler filter having seven layers of membrane filters with pore size less than 1-2 micron to achieve proper filtration.
7. Product recovered from step 6 was further quantified for the active phyto constituent by using various instruments but not limited to liquid chromatography-mass spectrometry, gas chromatography-mass spectrometry, High pressure liquid chromatograph, gas chromatography, spectroscopy compounds etc.
8. The product obtained in step 7 was also tested for bio-efficacy against pests on different crops in vitro and in vivo, and compared to other chemically synthesised pesticides.

### Example 11: Botanical Based Bio-Insecticide—Embodiment 11

TABLE 11

| Sr | | Actual | |
|---|---|---|---|
| No. | Ingredient | Percent | Percent Range |
| 1. | Camphor | 1.0% | 0.00 1 to 7% |
| 2. | eugenol | 1.5% | 0.001 to 10% |
| 3. | thymol | 3.0% | 0.001 to 13% |
| 4. | piperine | 2.1% | 0.001 to 8% |
| 5. | Methyl chavicol | 1.2% | 0.001 to 9% |
| 6. | Citral | 3.1% | 0.001 to 15% |
| 7. | Essential oil of Ferula asafoetida | 2.0% | 0.001 to 8% |
| 8. | Orange oil | 8.5% | 0.1 to 15% |
| 9. | Gaur gum (Emulsifier) | 4.2% | 0.001 to 7.5% |
| 10. | ethoxylated castor oil (Emulsifier) | 5.8% | 0.001 to 10% |
| 11. | Sodium oleoyl amino fatty acid | 8.0% | 0.1 to 15% |
| | (Surfactant) | | |
| 12. | Dimethyl sulfoxide (DMSO) | 22.5% | 10.0 to 35% |
| 13. | N-Ethyl-2 pyrrolidone (NEP) | 37.1% | 10.0 to 35% |

### Preparation of Botanical Based Bio-Insecticide—Embodiment 11:

Wherein the process for preparing the said product comprises the steps of,
1. The emulsifier and surfactant were dissolved in dimethyl sulfoxide and N-Ethyl-2 pyrrolidone to make inert mixture and agitated with homogenizer until the uniform blend was formed.
2. The active ingredients, camphor, eugenol, thymol, piperine, methyl chavicol, citral, orange oil and essential oil of Ferula asafoetida in given quantity were added to the blend formed in step 1 and homogenized completely to make emulsion concentration.
3. The emulsion concentrate prepared in step no.2 was stirred at 300 to 800 rpm at 25 to 55 degrees Celsius in close mixing vessel made up of stainless steel 316 grade with outer jacket for maintaining temperature, mixing vessel was connected with stirrer (blade stirrer, propeller stirrer, turbine stirrer, anchor stirrer, universal stirrer) for continues stirring. Towards the bottom of vessel homogenizer with the speed of 3700˜27000 rpm was attached to reduce the particle size under very high pressures, sheer, turbulence, acceleration and impact, to make them more stable and effective.
4. Blend prepared in step no 3 was passed through in line shear pump with 1800 RPM to 5800 RPM to reduce particle size in nano, so as to achieve nano emulsion with particle size ranging from 10 to 900 nano meter.
5. Further to obtain nano particles base formulation the blend formed in step no 4 was further passed-through High-pressure homogenization (homogenization at speed of 4000 rpm to 10000 rpm and pressure max up to 4,200 bar (60,000 psi)) to reduce the particle size below 100 nano meters.
6. After passing through high pressure homogenizer the material was passed through sparkler filter having seven layers of membrane filters with pore size less than 1-2 micron to achieve proper filtration.
7. Product recovered from step 6 was further quantified for the active phyto constituent by using various instruments but not limited to liquid chromatography-mass spectrometry, gas chromatography-mass spectrometry, High pressure liquid chromatograph, gas chromatography, spectroscopy compounds etc.
8. The product obtained in step 7 was also tested for bio-efficacy against pests on different crops in vitro and in vivo, and compared to other chemically synthesised pesticides.

### Example 12: Botanical Based Bio-Insecticide—Embodiment 12

TABLE 12

| Sr | | Actual | |
|---|---|---|---|
| No. | Ingredient | Percent | Percent Range |
| 1. | Camphor | 1.5% | 0.00 1 to 7% |
| 2. | eugenol | 2.3% | 0.001 to 10% |
| 3. | thymol | 2.0% | 0.001 to 15% |
| 4. | piperine | 1.4% | 0.001 to 12% |
| 5. | Methyl chavicol | 2.8% | 0.001 to 10% |
| 6. | Citral | 2.4% | 0.001 to 15% |
| 7. | D-limonene | 0.7% | 0.001 to 10% |
| 8. | Fumed silica | 0.9% | 0.001 to 5.0% |
| 9. | Sodium N methyl N-Oleyl taurate | 0.85% | 0.001 to 6.0% |
| 10. | Polyorganosiloxane | 0.1% | 0.001 to 7.0% |
| 11. | Sodium alkyl naphthalene sulfonate | 4.5% | 0.001 to 15% |
| 12. | starch | 8.5% | 0.01 to 25% |
| 13. | Anhydrous lactose | 72.05% | 65.0 to 75.0% |

### Preparation of Botanical Based Bio-Insecticide—Embodiment 12:

1. The soluble granule formulation was made on a greater scale.
2. The active ingredient camphor, eugenol, thymol, piperine, methyl chavicol, citral, and D-limonene were blended with the excipients in a 500 litre blender for 5-10 minutes until a uniform mixture was formed, followed by the addition of approximately 10 kg of water (10-12.5%) to the blender.
3. The water was added as a single spray and blending was continued for 1 minute after addition.
4. It was determined that in large scale formulation, less water was required.
5. The wet mass was transferred to a basket extruder, which extruded it to a 0.8 mm screen before drying in a fluid bed.
6. Each batch was divided into two sub-batches and dried in a single cycle, with no extra stirring required.
7. The extrudate was dried on a fluidized bed drier for 12-20 minutes at 60° C. inlet temperature and 1 m3/min air flow rate.
8. Granules were vacuum-transferred to vibrating sieving apparatus, which separated particles beyond the desired range of 4 to 50 mesh.
9. The total yield was around 90%, however there were some yield losses due to product segregation outside the specified particle size.
10. The recovered product from step 9 was measured for active phyto constituents using various equipment such as liquid chromatography-mass spectrometry, gas chromatography-mass spectrometry, high pressure liquid chromatograph, gas chromatography, and spectroscopic compounds.
11. The product obtained in step 9 was also tested for bio-efficacy against pests on different crops in vitro and in vivo, and it is compared to other chemically synthesised pesticides.

All the above Embodiments-1 to 12 were effective against broad group of pests within 48-72 hrs of application with low risk of resistance development and most importantly safe for environment and mammalian.

Furthermore, Embodiments-1 to 12 have number of plant based Phyto ingredient which significantly boost the plant growth with respect of height, growth, chlorophyll content, increase in flower and fruit number and subsequently the yield and most importantly being originated from plants they are easily taken up by plants.

### Example 13: Phytochemicals and its Activity

TABLE 13

| Sr. | Phyto | Botanical | Pesticidal | | Phytotonic |
|---|---|---|---|---|---|
| No. | ingredient | Source | Properties | Mode of action | Effect |
| 1. | Camphor | Cinnamomum | Insecticidal | Strong contact toxicity | Strong |
| | | camphora | Activities | against sucking pests, | abilities in |
| | | | | Effective against larvae, | lowering |
| | | | | Antifeedant activity, | ROS and |
| | | | | Oviposition deterrence | maintaining |
| | | | Antioxidant | Free radical scavenging | photosynthesis |
| | | | Activity | activity | |
| | | | Acaricidal | Deteriorating respiratory | |
| | | | Activity | system | |
| | | | Bactericidal | Inhibit microbial growth, | |
| | | | Activity | Disrupts cell wall & | |
| | | | | membrane integrity | |
| | | | Nematicidal | Strong activity against | |
| | | | Activity | plant-parasitic nematodes | |
| | | | Antifungal | Repel fungal infections | |
| | | | Activity | | |
| | | | Virucidal | Control the spread of viral | |
| | | | Activity | infections | |
| 2. | Eugenol | Syzygium | Insecticidal | Growth inhibitory, | Regulating |
| | | aromaticum | Activities | antifeedant activities, | plant |
| | | | | Contact toxicity | resistant |
| | | | Antioxidant | Scavenge free radicals, | physiology, |
| | | | Activity | inhibit the generation of | root |
| | | | | reactive oxygen species | development |
| | | | Acaricidal | Inhibitory effects against | |
| | | | Activity | the mitochondrial | |
| | | | | membrane potential | |
| | | | Bactericidal | Alters membrane permeability | |
| | | | Activity | resulting in leakage of | |
| | | | | intracellular contents | |
| | | | Nematicidal | Inhibited egg differentiation | |
| | | | Activity | | |
| | | | Antifungal | Inhibition of myceial growth | |
| | | | Activity | | |
| | | | Virucidal | Inactivated the cell-free | |
| | | | Activity | virions, inhibited the viral | |
| | | | | autophagy, reduced the | |
| | | | | expression of autophagic genes | |
| 3. | Citral | Ociumum | Insecticidal | Repellent and Antifeedant | Trigger |
| | | gratissimum | Activities | action | chlorophyll |
| | | | Antioxidant | Induced the overexpression | synthesis |
| | | | Activity | of defence enzymes, | |
| | | | | induce systemic acquired | |
| | | | | resistance | |
| | | | Acaricidal | Repelling and killing | |
| | | | Activity | activity | |
| | | | Bactericidal | High mortality against | |
| | | | Activity | bacterial infections | |
| | | | Nematicidal | Strong Nematicidal activity | |
| | | | Activity | | |
| | | | Antifungal | Inhibited the mycelial | |
| | | | Activity | growth and morphology, | |
| | | | | zoospore germination, and | |
| | | | | cell membrane permeability | |
| | | | Virucidal | Increases plant disease | |
| | | | Activity | resistance activity | |
| 4. | Thymol | Thymus | Insecticidal | Inhibited the growth, | Improves |
| | | vulgaris | Activities | particularly in younger | salinity |
| | | | | larvae | tolerance |
| | | | Antioxidant | Antioxidant and food | |
| | | | Activity | additive to maintain the | |
| | | | | quality of fresh food | |
| | | | Acaricidal | Reduce the frequency of | |
| | | | Activity | mite resistance phenomena | |
| | | | Bactericidal | Growth inhibition | |
| | | | Activity | | |
| | | | Nematicidal | Inhibited the hatching of | |
| | | | Activity | the root-knot nematode | |
| | | | Antifungal | Disrupts cell wall or | |
| | | | Activity | membrane integrity | |
| | | | Virucidal | Inhibit virus replication | |
| | | | Activity | with a significant reduction | |
| 5. | Piperine | Piper | Insecticidal | Lowering hatching of | Boost plant |
| | | longum | Activities | larvae | defence |
| | | | Antioxidant | Increased activities of the | mechanism |
| | | | Activity | resistance-related enzymes; | and promote |
| | | | | peroxidase (POX), | white root |
| | | | | polyphenol oxidase (PPO) | formation. |
| | | | | and phenylalanine | |
| | | | | ammonia lyase (PAL) | |
| | | | Acaricidal | Cause dehydration of mites | |
| | | | Activity | | |
| | | | Nematicidal | Nemato-toxic effects | |
| | | | Activity | through inactivation of | |
| | | | | growth and eradication | |
| | | | Antifungal | Inhibition of the fungal | |
| | | | Activity | population | |
| 6. | Cuminal | Cuminum | Insecticidal | Acute Toxicity Effects | Boost plant |
| | dehyde | cyminum | Activities | | growth |
| | | | Antioxidant | Increase in reactive oxygen | |
| | | | Activity | species (ROS) production, | |
| | | | | programmed cell death | |
| | | | | (PCD), and loss of | |
| | | | | membrane integrity, in a | |
| | | | | concentration-dependent | |
| | | | | manner | |
| | | | Bactericidal | Great antimicrobial effects | |
| | | | Activity | against both gram positive | |
| | | | | and negative bacteria | |
| | | | Nematicidal | Efficient hatching inhibitor | |
| | | | Activity | | |
| | | | Antifungal | Mycelial growth inhibition | |
| | | | Activity | | |
| 7. | Methyl | Ocimum | Insecticidal | Larvicidal effect shown | Trigger the |
| | chavicol | sanctum | Activities | | synthesis |
| | | | Antioxidant | Exhibits antioxidant | of auxin in |
| | | | Activity | activities | plants |
| | | | Acaricidal | Shows acaricidal activities | |
| | | | Activity | | |
| | | | Bactericidal | Helpful in controlling | |
| | | | Activity | Angular Leaf Spot | |
| | | | Nematicidal | Shows Nematicidal | |
| | | | Activity | activities | |
| | | | Antifungal | Shows antifungal activities | |
| | | | Activity | | |
| 8. | Total | Ipomoea | Insecticidal | Anti-feedings | Trigger |
| | Alkaloid | carnea | Activities | | growth of |
| | including | | Antioxidant | Scavenging ability of the | plants and |
| | swainsonine | | Activity | free radicals | germination |
| | | | Acaricidal | Superiority in repellence | |
| | | | Activity | | |
| | | | Bactericidal | Strong inhibition against | |
| | | | Activity | gram positive & negative | |
| | | | | bacteria | |
| 9. | Mixture of | Ferula | Insecticidal | Moderate antifeedant, | Increase |
| | Essential | asafoetida | Activities | insect repellents | tolerance |
| | oils and | | Antioxidant | Improve antioxidant | to biotic |
| | oleoresin | | Activity | activity | and abiotic |
| | | | Bactericidal | Anti-bacterial activity | stress |
| | | | Activity | | |
| | | | Nematicidal | Reducing population of | |
| | | | Activity | root knot nematodes | |
| | | | Antifungal | Inhibited growth of fungi | |
| | | | Activity | | |
| 10. | Parthenin | Parthenium | Insecticidal | Antifeedant activity against | Boost the |
| | | hysterophorus | Activities | Spodoptera litura. | seedling |
| | | | | Repellent activity against | growth. |
| | | | | Plutella xylostella larvae. | |
| | | | | Insecticidal activity against | |
| | | | | Aphis craccivora. | |
| | | | Antioxidant | Possesses antioxidant | |
| | | | Activity | properties | |
| | | | Nematicidal | Nematicidal activity | |
| | | | Activity | against the juvenile stage-II | |
| | | | | (J2) of the root knot | |
| | | | | nematode Meloidogyne | |
| | | | | incognita. | |
| 11. | Essential | Curcuma | Insecticidal | Repellent, Contact poison, | Trigger |
| | oils and | longa | Activities | antifeedant, oviposition | defence |
| | Total | | | deterrent | mechanism |
| | turmerones | | Antioxidant | Anti-oxidant activities on | of plants |
| | | | Activity | F. verticillioides. | |
| | | | Acaricidal | Deterrence of Oviposition | |
| | | | Activity | | |
| | | | Bactericidal | Protective function against | |
| | | | Activity | bacteria | |
| | | | Nematicidal | | |
| | | | Activity | | |
| | | | Antifungal | Growth inhibition & | |
| | | | Activity | Damaging action on the | |
| | | | | cell walls of F. | |
| | | | | verticillioides. | |
| 12. | Carvacrol | Origanum | Insecticidal | Insecticidal toxicities | increased the |
| | | vulgare | Activities | exhibition | number |
| | | | Antioxidant | Antioxidant activities | and size of |
| | | | Activity | expressed | chloroplasts, |
| | | | Acaricidal | Has acaricidal activities | the development |
| | | | Activity | | of chloroplast |
| | | | Bactericidal | Exhibits antibacterial | grana, and |
| | | | Activity | activities | the concentration |
| | | | Nematicidal | Effective against plant | of chlorophyll |
| | | | Activity | parasitic nematodes | |
| | | | Antifungal | Antifungal activities | |
| | | | Activity | expressed | |
| 13. | D-limonene | Citrus | Insecticidal | Destroy the wax layer of | Exhibits plant |
| | | sinensis | Activities | the insect respiratory | growth regulator |
| | | | | system so that once applied | activities |
| | | | | directly, the insects will | |
| | | | | suffocate. | |
| | | | Antioxidant | Possesses antioxidant | |
| | | | Activity | activities | |
| | | | Acaricidal | Ovicidal, repellent activity | |
| | | | Activity | against mites | |
| | | | Bactericidal | Inhibits the growth of | |
| | | | Activity | bacterial diseases | |
| | | | Nematicidal | Nematicide effect by | |
| | | | Activity | destroying the waterproof | |
| | | | | protective layer on the | |
| | | | | surface of the worm. | |
| | | | Antifungal | Inhibits the growth of | |
| | | | Activity | fungal diseases | |
| | | | Virucidal | Exhibits viricidal activities | |
| | | | Activity | | |
| 14. | Gingerol | Zingiber | Insecticidal | Exhibit repellent activity | Enhanced plant |
| | | officinale | Activities | | height, branch |
| | | | Antioxidant | High antioxidant activity | number, flower |
| | | | Activity | | and yield |
| | | | Acaricidal | Cause dehydration and | |
| | | | Activity | paralysis | |
| | | | Bactericidal | Antibacterial activity | |
| | | | Activity | | |
| | | | Nematicidal | Suppressed root knot egg | |
| | | | Activity | hatching and caused | |
| | | | | juveniles mortality | |
| | | | Antifungal | More effective in restricting | |
| | | | Activity | the pathogen growth | |
| | | | Virucidal | Inhibit viral nucleic | |
| | | | Activity | material replication | |
| 15. | β-Asarone | Acorus | Insecticidal | Reductions in oviposition | increased the |
| | | calamus | Activities | duration, fecundity, and | concentration of |
| | | | | hatchability | chlorophyll |
| | | | Bactericidal | Inhibit protein synthesis in | |
| | | | Activity | microbes | |
| | | | Nematicidal | Act as potent nematicide | |
| | | | Activity | | |
| | | | Antifungal | Completely inhibited | |
| | | | Activity | mycelial growth of plant | |
| | | | | pathogenic fungi | |
| 16. | Menthol | Mentha | Insecticidal | Insecticidal activities on | Trigger in |
| | | piperita | Activities | Aphids | production |
| | | | Antioxidant | Possesses antioxidant | of growth |
| | | | Activity | properties | regulating |
| | | | Acaricidal | Causes mortality & reduction | hormones. |
| | | | Activity | in fertility of mites | |
| | | | Bactericidal | Menthol showed | |
| | | | Activity | antibacterial activities | |
| | | | Antifungal | Inhibits fungal growth | |
| | | | Activity | | |
| | | | Insecticidal | Lower larval weight, reduced | |
| | | | Activities | pupation, and lower adult | |
| | | | | emergence rates | |
| 17. | Capsaicin | Capsicum | Antioxidant | Showed antioxidant | Increase |
| | | frutescens | Activity | activity | tolerance |
| | | | Acaricidal | Acts as a mite feeding | to stress |
| | | | Activity | depressant and repellent | |
| | | | Bactericidal | Inhibition of bacterial | |
| | | | Activity | growth | |
| | | | Nematicidal | Nematicidal activity | |
| | | | Activity | | |
| | | | Antifungal | Inhibits the hyphae | |
| | | | Activity | formation, | |
| | | | Virucidal | Inhibited viral replication | |
| | | | Activity | | |
| | | | Insecticidal | Fumigant and larvicidal | |
| | | | Activities | activity | |
| 18. | p-Cymene | Trachyspermumammi | Antioxidant | Enhanced generation of | Trigger plant |
| | | | Activity | reactive oxygen species (ROS) | Growth |
| | | | Acaricidal | Showed mortality against | |
| | | | Activity | spider mites | |
| | | | Bactericidal | Strong anti-bacterial | |
| | | | Activity | activity | |
| | | | Nematicidal | Effective in reducing | |
| | | | Activity | nematode hatching | |
| | | | Antifungal | Slightly reduced growth of | |
| | | | Activity | fungal infestation | |
| | | | Insecticidal | High mortality against | |
| | | | Activities | insects | |
| 19. | Palmitic | Cassia | Acaricidal | Exhibited potent acaricidal | Optimize soil |
| | acid | tora | Activity | activity | health and |
| | | | Bactericidal | Destroyed or disintegrated | facilitate |
| | | | Activity | some microbial plasma | plant growth |
| | | | | membranes and tissues | |
| | | | Nematicidal | Repelling nematodes | |
| | | | Activity | | |
| | | | Antifungal | Strongest antifungal | |
| | | | Activity | ability, and the inhibition | |
| | | | | of mycelial growth and | |
| | | | | spore production | |
| | | | Insecticidal | Effect on mortality of | |
| | | | Activities | Spodoptera litura | |
| 20. | Ellagic | Punica | Antioxidant | Exhibit antioxidant | Reduces plant |
| | acid | granatum | Activity | activities | stress under |
| | | | Acaricidal | Shows acaricidal activities | saline conditions |
| | | | Activity | | |
| | | | Bactericidal | Exhibits bactericidal | |
| | | | Activity | activities | |
| | | | Antifungal | Fungicidal activities | |
| | | | Activity | against Pythium, | |
| | | | | Colletriticum | |
| | | | Insecticidal | Inhibit the growth, food | |
| | | | Activities | intake and oviposition | |
| 21. | 2-undecanone | Zanthoxylum | Acaricidal | Least sensitive to mites but | Increasing root |
| | | armatum | Activity | shows results | growth and shoot |
| | | | Bactericidal | Moderate anti-bacterial | growth |
| | | | Activity | activity | |
| | | | Nematicidal | Disturbing the growth of | |
| | | | Activity | juvenile forms, development, | |
| | | | | and oviposition of nematodes | |
| | | | Antifungal | Antifungal and repellent | |
| | | | Activity | activities | |
| | | | Insecticidal | Insecticidal action, | |
| | | | Activities | repellence, feeding, and | |
| | | | | oviposition deterrence and | |
| | | | | development inhibition. | |
| 22. | Chavibetol | Piperbetle | Antioxidant | Increasing Antioxidative | trigger seed |
| | | | Activity | Activities | germination and |
| | | | Bactericidal | Inhibit the reproduction | growth |
| | | | Activity | and growth | |
| | | | Insecticidal | Repellent | |
| | | | Activities | | |
| 23. | Thymoquinone | Nigella | Antioxidant | Reducing Oxidative Stress | increase in |
| | | sativa | Activity | and Increasing | shoot and root |
| | | | | Antioxidative Activities | length, fresh and |
| | | | Acaricidal | Contact acaricidal activity | dry weight, and |
| | | | Activity | | chlorophyll |
| | | | Bactericidal | Inhibitory effect on spore | content |
| | | | Activity | germination | |
| | | | Antifungal | Antifungal Activity | |
| | | | Activity | | |
| | | | Insecticidal | Decreased larval survival | |
| | | | Activities | | |
| 24. | Berberine | Berberis | Antioxidant | Reducing Oxidative Stress | Boost |
| | | aristata | Activity | and Increasing | physiological |
| | | | | Antioxidative Activities | processes in plants |
| | | | Bactericidal | Resulting in DNA damage, | |
| | | | Activity | cytoplasm leakage, and | |
| | | | | membrane permeability changes | |
| | | | Nematicidal | Effective against root knot | |
| | | | Activity | nematodes | |
| | | | Antifungal | Inhibit multipath mechanisms, | |
| | | | Activity | including destruction on | |
| | | | | cells, interference of | |
| | | | | mitochondrial functions, | |
| | | | | and repression of DNA | |
| | | | | replication and gene | |
| | | | | expression. | |
| | | | Virucidal | Through activation of | |
| | | | Activity | secondary metabolites | |
| | | | Insecticidal | Disturbed moulting, larval- | |
| | | | Activities | pupal intermediates and | |
| | | | | malformed moth emergence/ | |
| | | | | dead pupae | |
| 25. | Quaternary | Argemone | Antioxidant | Activating the antioxidant | trigger plant |
| | isoquinoline | mexican | Activity | system | growth and all |
| | alkaloids | | Acaricidal | Repellent, oviposition | the physiological |
| | | | Activity | deterrence and ovicidal | processes. |
| | | | | properties | |
| | | | Nematicidal | Toxic to the juvenile stages | |
| | | | Activity | | |
| | | a | Antifungal | Inhibition in the growth of | |
| | | | Activity | phytopathogen, | |
| | | | Larvicidal | Trigger plant defence | |
| | | | activity | mechanism | |

| | | | | |
|---|---|---|---|---|
| 26. | Alpha- | Rosmarinus | Contact toxicity, fumigant toxicity | Trigger plant |
| | pinene | officinalis | and repellent activity. | defence mechanism |
| | | | repellent activity | Boost chlorophyll |
| | | | Larvicidal and oviposition- | production |
| | | | altering activity | |
| | | | Contact toxicity, fumigant toxicity | |
| | | | and repellent activity. | |
| 27. | 1,8 | Rosmarinus | Repellent activity | Boost chlorophyll |
| | cineole | officinalis | Larvicidal and oviposition-altering | production |
| | | | activity | Trigger the nutrition |
| | | | Larvicidal activity | absorption ablity of |
| | | | | plant |
| 28. | Camphene | Rosmarinus | Repellent activity | Trigger the nutrition |
| | | officinalis | Larvicidal and oviposition-altering | absorption ablity of |
| | | | activity | plant |

### Example 14: In Vitro Bio-Efficacy of Plant Extracted Phytochemicals and its Combinations Against Aphids

### Material and Methodology:

Insect Studied: Aphid (Collected culture from insectary section)
Host plant leaves: Cotton leaves (For Aphid feeding)
No. of Treatments: 41
Replications: 4
No. of Insects Taken: 10/treatments
Solution for spray: 1 lit. spray solution of respective bio-pesticides was prepared.
Micropipette: Require for taking accurate volume of bio-pesticide as per recommendations.
Microscope: Zoom stereo trinocular microscope for insect observation.
Observation Recorded: After 48 hrs. of application
Statistical Design Used: Completely Randomized Design

$$Calculations : \% Corrected Mortality = \frac{( \% Treated Mortality - \% Control Mortality )}{100 - \% Control Mortality} \times 100$$

### Results:

TABLE 14
In vitro bio-efficacy of plant extracted phytochemicals
and its combinations against aphids.

| | | | | Total No. | % | % |
|---|---|---|---|---|---|---|
| | | | Dose | of dead | Mortality | Corrected |
| Tr. | | Concentration | (ml/gm/ | insect at | at 48 | Mortality |
| No. | Treatments | Range | lit.) | 48 Hrs. | Hrs. | at 48 Hrs. |
| 1 | Camphor | 0.001 to 7% | 1 | 5.75 | 57.50 | 51.43 |
| 2 | Eugenol | 0.001 to 10% | 1 | 6.00 | 60.00 | 54.29 |
| 3 | Citral | 0.001 to 15% | 1 | 6.50 | 65.00 | 60.00 |
| 4 | Thymol | 0.001 to 13% | 1 | 6.25 | 62.50 | 57.14 |
| 5 | Piperine | 0.001 to 8% | 1 | 7.00 | 70.00 | 65.71 |
| 6 | Cuminaldehyde | 0.001 to 10% | 1 | 5.25 | 52.50 | 45.71 |
| 7 | Methyl chavicol | 0.001 to 9% | 1 | 6.50 | 65.00 | 60.00 |
| 8 | Total Alkaloid | 0.001 to 8% | 1 | 5.50 | 55.00 | 48.57 |
| | including | | | | | |
| | swainsonine | | | | | |
| 9 | Mixture of | 0.001 to 8% | 1 | 5.75 | 57.50 | 51.43 |
| | Essential oils | | | | | |
| | and oleoresin | | | | | |
| 10 | Parthenin | 0.001 to 7% | 1 | 6.00 | 60.00 | 54.29 |
| 11 | Essential oils | 0.001 to 8% | 1 | 6.50 | 65.00 | 60.00 |
| | and Total | | | | | |
| | turmerones | | | | | |
| 12 | Carvacrol | 0.001 to 10% | 1 | 7.00 | 70.00 | 65.71 |
| 13 | D-limonene | 0.001 to 8% | 1 | 6.25 | 62.50 | 57.14 |
| 14 | Gingerol | 0.001 to 8% | 1 | 6.25 | 62.50 | 57.14 |
| 15 | β-Asarone | 0.001 to 9% | 1 | 7.25 | 72.50 | 68.57 |
| 16 | Menthol | 0.001 to 9% | 1 | 7.00 | 70.00 | 65.71 |
| 17 | Capsaicin | 0.001 to 8% | 1 | 6.25 | 62.50 | 57.14 |
| 18 | p-Cymene | 0.001 to 15% | 1 | 6.00 | 60.00 | 54.29 |
| 19 | Palmitic acid | 0.001 to 8% | 1 | 6.00 | 60.00 | 54.29 |
| 20 | Ellagic acid | 0.001 to 8% | 1 | 7.25 | 72.50 | 68.57 |
| 21 | 2-undecanone | 0.001 to 8% | 1 | 6.75 | 67.50 | 62.86 |
| 22 | Chavibetol | 0.001 to 7% | 1 | 5.50 | 55.00 | 48.57 |
| 23 | Thymoquinone | 0.001 to 8% | 1 | 4.75 | 47.50 | 40.00 |
| 24 | Berberine | 0.001 to 8% | 1 | 5.25 | 52.50 | 45.71 |
| 25 | Quaternary | 0.001 to 9% | 1 | 6.25 | 62.50 | 57.14 |
| | isoquinoline | | | | | |
| | alkaloids | | | | | |
| 26 | Alpha-pinene | 0.001 to 13% | 1 | 5.75 | 57.50 | 51.43 |
| 27 | 1,8 cineole | 0.001 to 7% | 1 | 6.50 | 65.00 | 60.00 |
| 28 | Camphene | 0.001 to 7% | 1 | 5.25 | 52.50 | 45.71 |
| 29 | Embodiment 1 | Combination of | 1 | 9.00 | 90.00 | 88.57 |
| | | Phytochemicals | | | | |
| 30 | Embodiment 2 | Combination of | 1 | 9.25 | 92.50 | 91.43 |
| | | Phytochemicals | | | | |
| 31 | Embodiment 3 | Combination of | 1 | 9.25 | 92.50 | 91.43 |
| | | Phytochemicals | | | | |
| 32 | Embodiment 4 | Combination of | 1 | 9.50 | 95.00 | 94.29 |
| | | Phytochemicals | | | | |
| 33 | Embodiment 5 | Combination of | 1 | 9.50 | 95.00 | 94.29 |
| | | Phytochemicals | | | | |
| 34 | Embodiment 6 | Combination of | 1 | 9.00 | 90.00 | 88.57 |
| | | Phytochemicals | | | | |
| 35 | Embodiment 7 | Combination of | 1 | 8.75 | 87.50 | 85.71 |
| | | Phytochemicals | | | | |
| 36 | Embodiment 8 | Combination of | 1 | 8.50 | 85.00 | 82.86 |
| | | Phytochemicals | | | | |
| 38 | Embodiment 9 | Combination of | 1 | 8.75 | 87.50 | 85.71 |
| | | Phytochemicals | | | | |
| 38 | Embodiment | Combination of | 1 | 8.00 | 80.00 | 77.14 |
| | 10 | Phytochemicals | | | | |
| 39 | Embodiment | Combination of | 1 | 9.00 | 90.00 | 88.57 |
| | 11 | Phytochemicals | | | | |
| 40 | Embodiment | Combination of | 1 | 8.75 | 87.50 | 85.71 |
| | 12 | Phytochemicals | | | | |
| 41 | Water Control | 100% | | 1.25 | 12.50 | 0.00 |

### Conclusion:

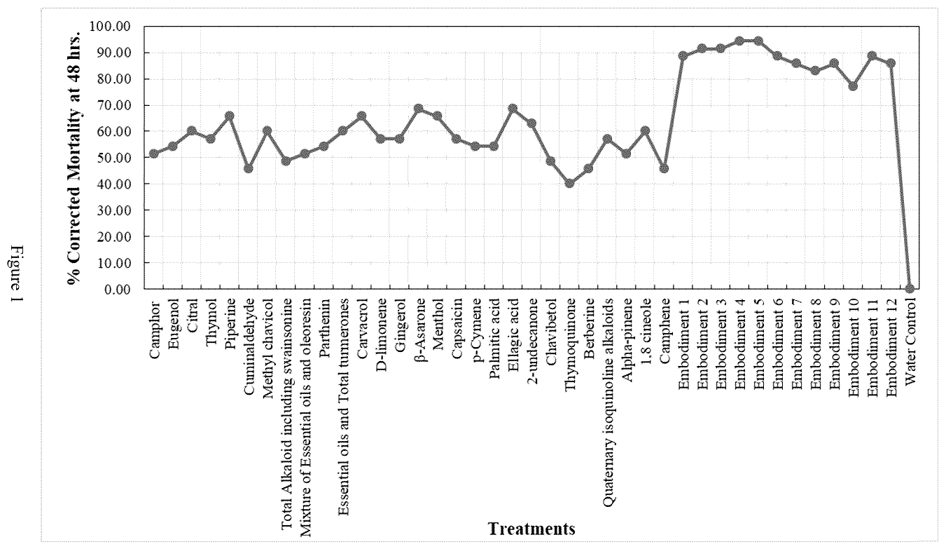

In vitro bio-efficacy study revealed that Embodiment 4@1.0 ml/lit & Embodiment 5@1.0 ml/lit showed highest corrected mortality 94.29% at 48 hours followed by Embodiment 2@1.0 ml/lit. & Embodiment 3@1.0 ml/lit. showed 91.43% corrected mortality against aphid. All the Embodiment (Combinations of phytochemicals) reported maximum aphid mortality than the individual phytochemicals (depicted in FIG. 1).

### Example 15: In Vitro Bio-Efficacy of Plant Extracted Phytochemicals and its Combinations Against Mite

### Material and Methodology:

Insect Studied: Mite (Collected culture from insectary section)
Host plant leaves: Okra leaves (For mite feeding)
No. of Treatments: 41

### Replications: 4

No. of Insects Taken: 10/treatments
Solution for spray: 1 lit. spray solution of respective bio-acaricide was prepared.
   Micropipette: Require for taking accurate volume of bio-acaricide as per recommendations.
Microscope: Zoom stereo trinocular microscope for insect observation.
Observation Recorded: After 48 hrs. of application
Statistical Design Used: Completely Randomized Design

### Calculations:

$$\% Corrected Mortality = \frac{( \% Treated Mortality - \% Control Mortality )}{100 - \% Control Mortality} \times 100$$

### Results:

TABLE 15
In vitro bio-efficacy of plant extracted phytochemicals
and its combinations against mite.

| | | | | Total No. | % | % |
|---|---|---|---|---|---|---|
| | | | Dose | of dead | Mortality | Corrected |
| Tr. | | Concentration | (ml/gm/ | insect at | at 48 | Mortality |
| No. | Treatments | Range | lit.) | 48 Hrs. | Hrs. | at 48 Hrs. |
| 1 | Camphor | 0.001 to 7% | 1 | 6.75 | 67.50 | 64.86 |
| 2 | Eugenol | 0.001 to 10% | 1 | 5.25 | 52.50 | 48.65 |
| 3 | Citral | 0.001 to 15% | 1 | 5.50 | 55.00 | 51.35 |
| 4 | Thymol | 0.001 to 13% | 1 | 6.00 | 60.00 | 56.76 |
| 5 | Piperine | 0.001 to 8% | 1 | 6.25 | 62.50 | 59.46 |
| 6 | Cuminaldehyde | 0.001 to 10% | 1 | 3.75 | 37.50 | 32.43 |
| 7 | Methyl chavicol | 0.001 to 9% | 1 | 4.50 | 45.00 | 40.54 |
| 8 | Total Alkaloid | 0.001 to 8% | 1 | 3.00 | 30.00 | 24.32 |
| | including | | | | | |
| | swainsonine | | | | | |
| 9 | Mixture of | 0.001 to 8% | 1 | 2.25 | 22.50 | 16.22 |
| | Essential oils | | | | | |
| | and oleoresin | | | | | |
| 10 | Parthenin | 0.001 to 7% | 1 | 3.25 | 32.50 | 27.03 |
| 11 | Essential oils | 0.001 to 8% | 1 | 3.00 | 30.00 | 24.32 |
| | and Total | | | | | |
| | turmerones | | | | | |
| 12 | Carvacrol | 0.001 to 10% | 1 | 4.25 | 42.50 | 37.84 |
| 13 | D-limonene | 0.001 to 8% | 1 | 5.00 | 50.00 | 45.95 |
| 14 | Gingerol | 0.001 to 8% | 1 | 3.50 | 35.00 | 29.73 |
| 15 | β-Asarone | 0.001 to 9% | 1 | 2.50 | 25.00 | 18.92 |
| 16 | Menthol | 0.001 to 9% | 1 | 4.50 | 45.00 | 40.54 |
| 17 | Capsaicin | 0.001 to 8% | 1 | 5.25 | 52.50 | 48.65 |
| 18 | p-Cymene | 0.001 to 15% | 1 | 6.00 | 60.00 | 56.76 |
| 19 | Palmitic acid | 0.001 to 8% | 1 | 4.25 | 42.50 | 37.84 |
| 20 | Ellagic acid | 0.001 to 8% | 1 | 5.00 | 50.00 | 45.95 |
| 21 | 2-undecanone | 0.001 to 8% | 1 | 3.00 | 30.00 | 24.32 |
| 22 | Chavibetol | 0.001 to 7% | 1 | 2.50 | 25.00 | 18.92 |
| 23 | Thymoquinone | 0.001 to 8% | 1 | 3.25 | 32.50 | 27.03 |
| 24 | Berberine | 0.001 to 8% | 1 | 4.75 | 47.50 | 43.24 |
| 25 | Quaternary | 0.001 to 9% | 1 | 5.00 | 50.00 | 45.95 |
| | isoquinoline | | | | | |
| | alkaloids | | | | | |
| 26 | Alpha-pinene | 0.001 to 13% | 1 | 4.00 | 40.00 | 35.14 |
| 27 | 1,8 cineole | 0.001 to 7% | 1 | 2.50 | 25.00 | 18.92 |
| 28 | Camphene | 0.001 to 7% | 1 | 4.00 | 40.00 | 35.14 |
| 29 | Embodiment 1 | Combination of | 1 | 9.00 | 90.00 | 89.19 |
| | | Phytochemicals | | | | |
| 30 | Embodiment 2 | Combination of | 1 | 9.50 | 95.00 | 94.59 |
| | | Phytochemicals | | | | |
| 31 | Embodiment 3 | Combination of | 1 | 9.75 | 97.50 | 97.30 |
| | | Phytochemicals | | | | |
| 32 | Embodiment 4 | Combination of | 1 | 8.00 | 80.00 | 78.38 |
| | | Phytochemicals | | | | |
| 33 | Embodiment 5 | Combination of | 1 | 8.25 | 82.50 | 81.08 |
| | | Phytochemicals | | | | |
| 34 | Embodiment 6 | Combination of | 1 | 9.75 | 97.50 | 97.30 |
| | | Phytochemicals | | | | |
| 35 | Embodiment 7 | Combination of | 1 | 8.50 | 85.00 | 83.78 |
| | | Phytochemicals | | | | |
| 36 | Embodiment 8 | Combination of | 1 | 8.75 | 87.50 | 86.49 |
| | | Phytochemicals | | | | |
| 38 | Embodiment 9 | Combination of | 1 | 8.00 | 80.00 | 78.38 |
| | | Phytochemicals | | | | |
| 38 | Embodiment 10 | Combination of | 1 | 8.50 | 85.00 | 83.78 |
| | | Phytochemicals | | | | |
| 39 | Embodiment 11 | Combination of | 1 | 9.25 | 92.50 | 91.89 |
| | | Phytochemicals | | | | |
| 40 | Embodiment 12 | Combination of | 1 | 8.75 | 87.50 | 86.49 |
| | | Phytochemicals | | | | |
| 41 | Water Control | 100% | | 0.75 | 7.50 | 0.00 |

### Conclusion:

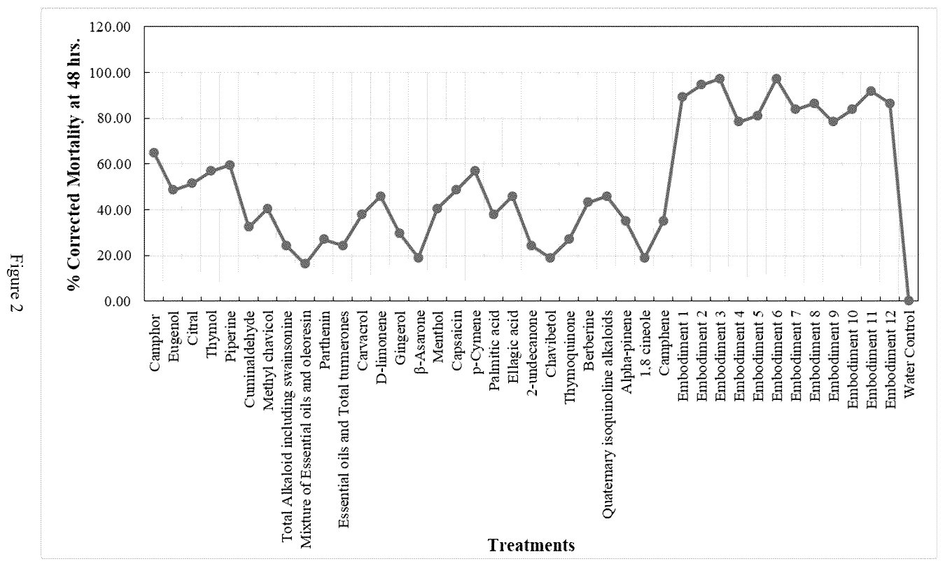

In vitro bio-efficacy study revealed that Embodiment 3@1.0 ml/lit & Embodiment 6@1.0 ml/lit. showed highest corrected mortality 97.30% at 48 hours followed by Embodiment 2@1.0 ml/lit. showed 94.59% corrected mortality against mite, respectively. All the Embodiment (Combinations of phytochemicals) reported maximum mite mortality than the individual phytochemicals (depicted in FIG. 2).

### Example 16: In vitro Bio-Efficacy of Plant Extracted Phytochemicals and its Combinations Against Mealy Bug

### Material and Methodology:

Insect Studied: Mealy Bug (Collected culture from insectary section)
Host plant leaves: Cotton leaves (For Mealy Bug feeding)
No. of Treatments: 41
Replications: 4
No. of Insects Taken: 10/treatments
Solution for spray: 1 lit. spray solution of respective bio-pesticides was prepared.
Micropipette: Require for taking accurate volume of bio-pesticide as per recommendations.
Microscope: Zoom stereo trinocular microscope for insect observation.
Observation Recorded: After 48 hrs. of application
Statistical Design Used: Completely Randomized Design

$$Calculations : \% Corrected Mortality = \frac{( \% Treated Mortality - \% Control Mortality )}{100 - \% Control Mortality} \times 100$$

### Results:

TABLE 16
In vitro bio-efficacy of plant extracted phytochemicals
and its combinations against mealy bugs.

| | | | | Total No. | % | % |
|---|---|---|---|---|---|---|
| | | | Dose | of dead | Mortality | Corrected |
| Tr. | | Concentration | (ml/gm/ | insect at | at 48 | Mortality |
| No. | Treatments | Range | lit.) | 48 Hrs. | Hrs. | at 48 Hrs. |
| 1 | Camphor | 0.001 to 7% | 1 | 5.25 | 52.50 | 50.00 |
| 2 | Eugenol | 0.001 to 10% | 1 | 6.50 | 65.00 | 63.16 |
| 3 | Citral | 0.001 to 15% | 1 | 2.50 | 25.00 | 21.05 |
| 4 | Thymol | 0.001 to 13% | 1 | 5.50 | 55.00 | 52.63 |
| 5 | Piperine | 0.001 to 8% | 1 | 5.25 | 52.50 | 50.00 |
| 6 | Cuminaldehyde | 0.001 to 10% | 1 | 5.25 | 52.50 | 50.00 |
| 7 | Methyl chavicol | 0.001 to 9% | 1 | 6.25 | 62.50 | 60.53 |
| 8 | Total Alkaloid | 0.001 to 8% | 1 | 6.50 | 65.00 | 63.16 |
| | including | | | | | |
| | swainsonine | | | | | |
| 9 | Mixture of | 0.001 to 8% | 1 | 4.25 | 42.50 | 39.47 |
| | Essential oils | | | | | |
| | and oleoresin | | | | | |
| 10 | Parthenin | 0.001 to 7% | 1 | 4.75 | 47.50 | 44.74 |
| 11 | Essential oils | 0.001 to 8% | 1 | 5.50 | 55.00 | 52.63 |
| | and Total | | | | | |
| | turmerones | | | | | |
| 12 | Carvacrol | 0.001 to 10% | 1 | 6.75 | 67.50 | 65.79 |
| 13 | D-limonene | 0.001 to 8% | 1 | 4.25 | 42.50 | 39.47 |
| 14 | Gingerol | 0.001 to 8% | 1 | 2.75 | 27.50 | 23.68 |
| 15 | β-Asarone | 0.001 to 9% | 1 | 3.00 | 30.00 | 26.32 |
| 16 | Menthol | 0.001 to 9% | 1 | 6.50 | 65.00 | 63.16 |
| 17 | Capsaicin | 0.001 to 8% | 1 | 7.00 | 70.00 | 68.42 |
| 18 | p-Cymene | 0.001 to 15% | 1 | 4.00 | 40.00 | 36.84 |
| 19 | Palmitic acid | 0.001 to 8% | 1 | 6.50 | 65.00 | 63.16 |
| 20 | Ellagic acid | 0.001 to 8% | 1 | 6.00 | 60.00 | 57.89 |
| 21 | 2-undecanone | 0.001 to 8% | 1 | 5.50 | 55.00 | 52.63 |
| 22 | Chavibetol | 0.001 to 7% | 1 | 4.00 | 40.00 | 36.84 |
| 23 | Thymoquinone | 0.001 to 8% | 1 | 5.25 | 52.50 | 50.00 |
| 24 | Berberine | 0.001 to 8% | 1 | 7.50 | 75.00 | 73.68 |
| 25 | Quaternary | 0.001 to 9% | 1 | 6.25 | 62.50 | 60.53 |
| | isoquinoline | | | | | |
| | alkaloids | | | | | |
| 26 | Alpha-pinene | 0.001 to 13% | 1 | 5.25 | 52.50 | 50.00 |
| 27 | 1,8 cineole | 0.001 to 7% | 1 | 5.50 | 55.00 | 52.63 |
| 28 | Camphene | 0.001 to 7% | 1 | 4.50 | 45.00 | 42.11 |
| 29 | Embodiment 1 | Combination of | 1 | 9.25 | 92.50 | 92.11 |
| | | Phytochemicals | | | | |
| 30 | Embodiment 2 | Combination of | 1 | 9.50 | 95.00 | 94.74 |
| | | Phytochemicals | | | | |
| 31 | Embodiment 3 | Combination of | 1 | 9.75 | 97.50 | 97.37 |
| | | Phytochemicals | | | | |
| 32 | Embodiment 4 | Combination of | 1 | 9.00 | 90.00 | 89.47 |
| | | Phytochemicals | | | | |
| 33 | Embodiment 5 | Combination of | 1 | 8.75 | 87.50 | 86.84 |
| | | Phytochemicals | | | | |
| 34 | Embodiment 6 | Combination of | 1 | 9.25 | 92.50 | 92.11 |
| | | Phytochemicals | | | | |
| 35 | Embodiment 7 | Combination of | 1 | 9.00 | 90.00 | 89.47 |
| | | Phytochemicals | | | | |
| 36 | Embodiment 8 | Combination of | 1 | 8.50 | 85.00 | 84.21 |
| | | Phytochemicals | | | | |
| 38 | Embodiment 9 | Combination of | 1 | 9.00 | 90.00 | 89.47 |
| | | Phytochemicals | | | | |
| 38 | Embodiment 10 | Combination of | 1 | 8.50 | 85.00 | 84.21 |
| | | Phytochemicals | | | | |
| 39 | Embodiment 11 | Combination of | 1 | 8.75 | 87.50 | 86.84 |
| | | Phytochemicals | | | | |
| 40 | Embodiment 12 | Combination of | 1 | 8.50 | 85.00 | 84.21 |
| | | Phytochemicals | | | | |
| 41 | Water Control | 100% | | 0.50 | 5.00 | 0.00 |

### Conclusion:

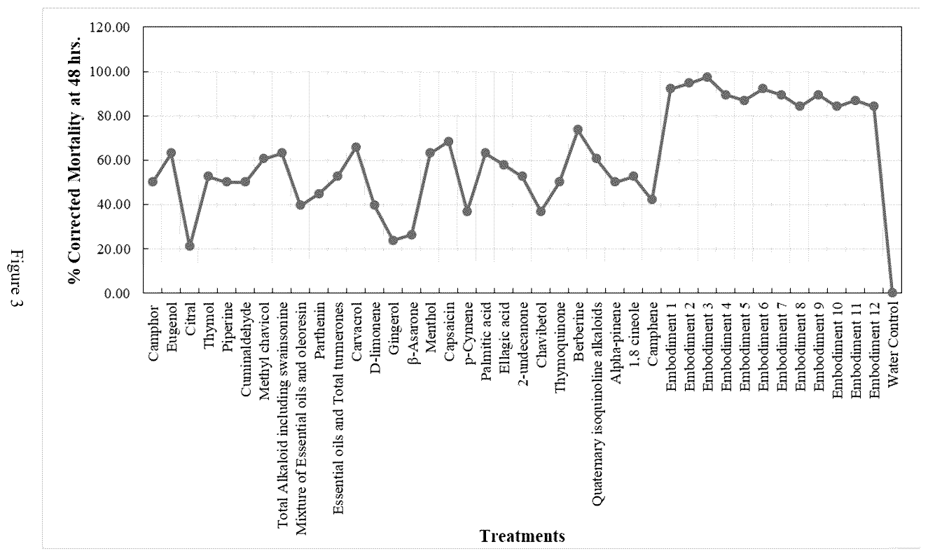

In vitro bio-efficacy study revealed that Embodiment 3@1.0 ml/lit showed highest corrected mortality 97.37% at 48 hours followed by Embodiment 2@1.0 ml/lit. showed 94.74% corrected mortality against mealy bug, respectively. All the Embodiment (Combinations of phytochemicals) reported maximum mealy bug mortality than the individual phytochemicals (depicted in FIG. 3).

### Example 17: In Vitro Bio-Efficacy of Plant Extracted Phytochemicals and its Combinations Against Helicoverpa armigera

### Material and Methodology:

Insect Studied: Helicoverpa armigera (Collected culture from insectary section)
Host plant fruits: Okra Fruits (For Helicoverpa armigera feeding)
No. of Treatments: 41
Replications: 4
No. of Insects Taken: 10/treatments
Solution for spray: 1 lit. spray solution of respective bio-pesticides was prepared.
Micropipette: Require for taking accurate volume of bio-pesticide as per recommendations
Microscope: Zoom stereo trinocular microscope for insect observation.
Observation Recorded: After 72 hrs. of application
Statistical Design Used: Completely Randomized Design

$$Calculations : \% Corrected Mortality = \frac{( \% Treated Mortality - \% Control Mortality )}{100 - \% Control Mortality} \times 100$$

### Results:

TABLE 17
In vitro bio-efficacy of plant extracted phytochemicals
and its combinations against Helicoverpa armigera

| | | | | Total No. | % | % |
|---|---|---|---|---|---|---|
| | | | Dose | of dead | Mortality | Corrected |
| Tr. | | Concentration | (ml/gm/ | insect at | at 72 | Mortality |
| No. | Treatments | Range | lit.) | 72 Hrs. | Hrs. | at 72 Hrs. |
| 1 | Camphor | 0.001 to 7% | 1 | 6.00 | 60.00 | 60.00 |
| 2 | Eugenol | 0.001 to 10% | 1 | 4.75 | 47.50 | 47.50 |
| 3 | Citral | 0.001 to 15% | 1 | 3.00 | 30.00 | 30.00 |
| 4 | Thymol | 0.001 to 13% | 1 | 6.50 | 65.00 | 65.00 |
| 5 | Piperine | 0.001 to 8% | 1 | 7.00 | 70.00 | 70.00 |
| 6 | Cuminaldehyde | 0.001 to 10% | 1 | 3.75 | 37.50 | 37.50 |
| 7 | Methyl chavicol | 0.001 to 9% | 1 | 6.25 | 62.50 | 62.50 |
| 8 | Total Alkaloid | 0.001 to 8% | 1 | 4.25 | 42.50 | 42.50 |
| | including | | | | | |
| | swainsonine | | | | | |
| 9 | Mixture of | 0.001 to 8% | 1 | 2.25 | 22.50 | 22.50 |
| | Essential oils | | | | | |
| | and oleoresin | | | | | |
| 10 | Parthenin | 0.001 to 7% | 1 | 3.25 | 32.50 | 32.50 |
| 11 | Essential oils | 0.001 to 8% | 1 | 4.50 | 45.00 | 45.00 |
| | and Total | | | | | |
| | turmerones | | | | | |
| 12 | Carvacrol | 0.001 to 10% | 1 | 5.50 | 55.00 | 55.00 |
| 13 | D-limonene | 0.001 to 8% | 1 | 3.25 | 32.50 | 32.50 |
| 14 | Gingerol | 0.001 to 8% | 1 | 5.25 | 52.50 | 52.50 |
| 15 | β-Asarone | 0.001 to 9% | 1 | 5.00 | 50.00 | 50.00 |
| 16 | Menthol | 0.001 to 9% | 1 | 6.00 | 60.00 | 60.00 |
| 17 | Capsaicin | 0.001 to 8% | 1 | 4.50 | 45.00 | 45.00 |
| 18 | p-Cymene | 0.001 to 15% | 1 | 6.50 | 65.00 | 65.00 |
| 19 | Palmitic acid | 0.001 to 8% | 1 | 4.50 | 45.00 | 45.00 |
| 20 | Ellagic acid | 0.001 to 8% | 1 | 7.25 | 72.50 | 72.50 |
| 21 | 2-undecanone | 0.001 to 8% | 1 | 5.50 | 55.00 | 55.00 |
| 22 | Chavibetol | 0.001 to 7% | 1 | 4.25 | 42.50 | 42.50 |
| 23 | Thymoquinone | 0.001 to 8% | 1 | 4.25 | 42.50 | 42.50 |
| 24 | Berberine | 0.001 to 8% | 1 | 6.50 | 65.00 | 65.00 |
| 25 | Quaternary | 0.001 to 9% | 1 | 5.75 | 57.50 | 57.50 |
| | isoquinoline | | | | | |
| | alkaloids | | | | | |
| 26 | Alpha-pinene | 0.001 to 13% | 1 | 7.00 | 70.00 | 70.00 |
| 27 | 1,8 cineole | 0.001 to 7% | 1 | 5.50 | 55.00 | 55.00 |
| 28 | Camphene | 0.001 to 7% | 1 | 6.25 | 62.50 | 62.50 |
| 29 | Embodiment 1 | Combination of | 1 | 8.00 | 80.00 | 80.00 |
| | | Phytochemicals | | | | |
| 30 | Embodiment 2 | Combination of | 1 | 8.75 | 87.50 | 87.50 |
| | | Phytochemicals | | | | |
| 31 | Embodiment 3 | Combination of | 1 | 8.25 | 82.50 | 82.50 |
| | | Phytochemicals | | | | |
| 32 | Embodiment 4 | Combination of | 1 | 9.75 | 97.50 | 97.50 |
| | | Phytochemicals | | | | |
| 33 | Embodiment 5 | Combination of | 1 | 9.50 | 95.00 | 95.00 |
| | | Phytochemicals | | | | |
| 34 | Embodiment 6 | Combination of | 1 | 9.25 | 92.50 | 92.50 |
| | | Phytochemicals | | | | |
| 35 | Embodiment 7 | Combination of | 1 | 8.25 | 82.50 | 82.50 |
| | | Phytochemicals | | | | |
| 36 | Embodiment 8 | Combination of | 1 | 8.50 | 85.00 | 85.00 |
| | | Phytochemicals | | | | |
| 38 | Embodiment 9 | Combination of | 1 | 8.00 | 80.00 | 80.00 |
| | | Phytochemicals | | | | |
| 38 | Embodiment | Combination of | 1 | 9.25 | 92.50 | 92.50 |
| | 10 | Phytochemicals | | | | |
| 39 | Embodiment | Combination of | 1 | 8.00 | 80.00 | 80.00 |
| | 11 | Phytochemicals | | | | |
| 40 | Embodiment | Combination of | 1 | 8.75 | 87.50 | 87.50 |
| | 12 | Phytochemicals | | | | |
| 41 | Water Control | 100% | | 0.00 | 0.00 | 0.00 |

### Conclusion:

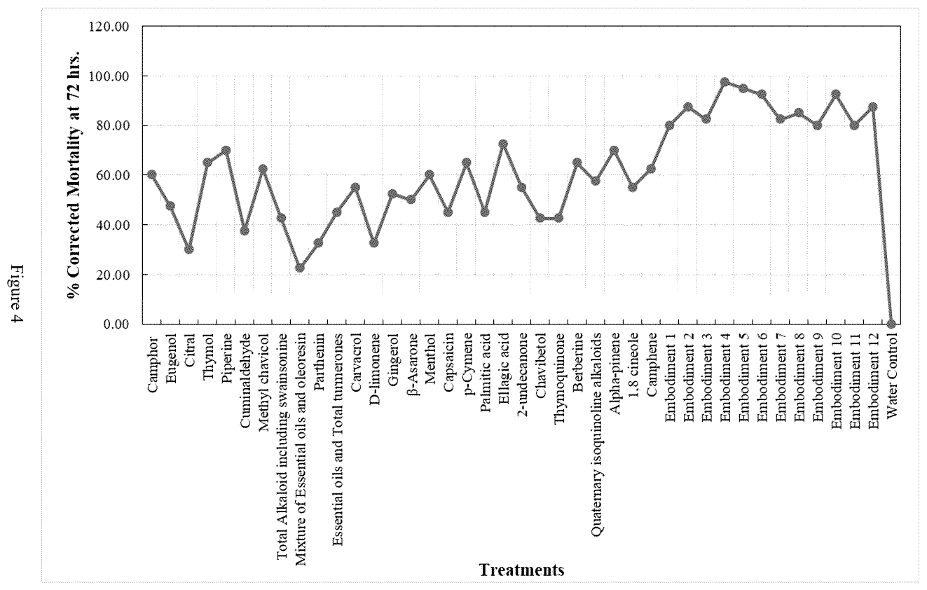

In vitro bio-efficacy study revealed that Embodiment 4@1.0 ml/lit showed highest corrected mortality 97.50% at 72 hours followed by Embodiment 5@1.0 ml/lit. showed 95.00% corrected mortality against Helicoverpa armigera. All the Embodiment (Combinations of phytochemicals) reported maximum Helicoverpa armigera mortality than the individual phytochemicals (depicted in FIG. 4).

### Example 18: In Vitro Bio-Efficacy of Plant Extracted Phytochemicals and its Combinations Against Spodoptera litura

### Material and Methodology:

Insect Studied: Spodoptera litura (Collected culture from insectary section)
Host plant leaves: Castor leaves (For Spodoptera litura feeding)
No. of Treatments: 41
Replications: 4
No. of Insects Taken: 10/treatments
Solution for spray: 1 lit. spray solution of respective bio-pesticides was prepared.
Micropipette: Require for taking accurate volume of bio-pesticide as per recommendations.
Microscope: Zoom stereo trinocular microscope for insect observation.
Observation Recorded: After 72 hrs. of application
Statistical Design Used: Completely Randomized Design

$$Calculations : \% Corrected Mortality = \frac{( \% Treated Mortality - \% Control Mortality )}{100 - \% Control Mortality} \times 100$$

### Results:

TABLE 18
In vitro bio-efficacy of plant extracted phytochemicals
and its combinations against Spodoptera litura

| | | | | Total No. | % | % |
|---|---|---|---|---|---|---|
| | | | Dose | of dead | Mortality | Corrected |
| Tr. | | Concentration | (ml/gm/ | insect at | at 72 | Mortality |
| No. | Treatments | Range | lit.) | 72 Hrs. | Hrs. | at 72 Hrs. |
| 1 | Camphor | 0.001 to 7% | 1 | 4.25 | 42.50 | 39.47 |
| 2 | Eugenol | 0.001 to 10% | 1 | 6.00 | 60.00 | 57.89 |
| 3 | Citral | 0.001 to 15% | 1 | 5.50 | 55.00 | 52.63 |
| 4 | Thymol | 0.001 to 13% | 1 | 6.75 | 67.50 | 65.79 |
| 5 | Piperine | 0.001 to 8% | 1 | 7.25 | 72.50 | 71.05 |
| 6 | Cuminaldehyde | 0.001 to 10% | 1 | 5.25 | 52.50 | 50.00 |
| 7 | Methyl chavicol | 0.001 to 9% | 1 | 6.50 | 65.00 | 63.16 |
| 8 | Total Alkaloid | 0.001 to 8% | 1 | 4.50 | 45.00 | 42.11 |
| | including | | | | | |
| | swainsonine | | | | | |
| 9 | Mixture of | 0.001 to 8% | 1 | 4.00 | 40.00 | 36.84 |
| | Essential oils | | | | | |
| | and oleoresin | | | | | |
| 10 | Parthenin | 0.001 to 7% | 1 | 2.75 | 27.50 | 23.68 |
| 11 | Essential oils | 0.001 to 8% | 1 | 5.50 | 55.00 | 52.63 |
| | and Total | | | | | |
| | turmerones | | | | | |
| 12 | Carvacrol | 0.001 to 10% | 1 | 4.50 | 45.00 | 42.11 |
| 13 | D-limonene | 0.001 to 8% | 1 | 2.50 | 25.00 | 21.05 |
| 14 | Gingerol | 0.001 to 8% | 1 | 4.00 | 40.00 | 36.84 |
| 15 | β-Asarone | 0.001 to 9% | 1 | 6.00 | 60.00 | 57.89 |
| 16 | Menthol | 0.001 to 9% | 1 | 2.75 | 27.50 | 23.68 |
| 17 | Capsaicin | 0.001 to 8% | 1 | 4.25 | 42.50 | 39.47 |
| 18 | p-Cymene | 0.001 to 15% | 1 | 7.25 | 72.50 | 71.05 |
| 19 | Palmitic acid | 0.001 to 8% | 1 | 2.50 | 25.00 | 21.05 |
| 20 | Ellagic acid | 0.001 to 8% | 1 | 6.00 | 60.00 | 57.89 |
| 21 | 2-undecanone | 0.001 to 8% | 1 | 4.00 | 40.00 | 36.84 |
| 22 | Chavibetol | 0.001 to 7% | 1 | 4.25 | 42.50 | 39.47 |
| 23 | Thymoquinone | 0.001 to 8% | 1 | 4.25 | 42.50 | 39.47 |
| 24 | Berberine | 0.001 to 8% | 1 | 7.00 | 70.00 | 68.42 |
| 25 | Quaternary | 0.001 to 9% | 1 | 4.25 | 42.50 | 39.47 |
| | isoquinoline | | | | | |
| | alkaloids | | | | | |
| 26 | Alpha-pinene | 0.001 to 13% | 1 | 5.00 | 50.00 | 47.37 |
| 27 | 1,8 cineole | 0.001 to 7% | 1 | 6.00 | 60.00 | 57.89 |
| 28 | Camphene | 0.001 to 7% | 1 | 6.75 | 67.50 | 65.79 |
| 29 | Embodiment 1 | Combination of | 1 | 9.25 | 89.75 | 89.21 |
| | | Phytochemicals | | | | |
| 30 | Embodiment 2 | Combination of | 1 | 8.50 | 85.00 | 84.21 |
| | | Phytochemicals | | | | |
| 31 | Embodiment 3 | Combination of | 1 | 8.75 | 87.50 | 86.84 |
| | | Phytochemicals | | | | |
| 32 | Embodiment 4 | Combination of | 1 | 9.75 | 97.50 | 97.37 |
| | | Phytochemicals | | | | |
| 33 | Embodiment 5 | Combination of | 1 | 9.50 | 95.00 | 94.74 |
| | | Phytochemicals | | | | |
| 34 | Embodiment 6 | Combination of | 1 | 9.25 | 92.50 | 92.11 |
| | | Phytochemicals | | | | |
| 35 | Embodiment 7 | Combination of | 1 | 8.50 | 85.00 | 84.21 |
| | | Phytochemicals | | | | |
| 36 | Embodiment 8 | Combination of | 1 | 8.75 | 87.50 | 86.84 |
| | | Phytochemicals | | | | |
| 38 | Embodiment 9 | Combination of | 1 | 8.25 | 82.50 | 81.58 |
| | | Phytochemicals | | | | |
| 38 | Embodiment | Combination of | 1 | 9.75 | 97.50 | 97.37 |
| | 10 | Phytochemicals | | | | |
| 39 | Embodiment | Combination of | 1 | 9.00 | 90.00 | 89.47 |
| | 11 | Phytochemicals | | | | |
| 40 | Embodiment | Combination of | 1 | 8.75 | 87.50 | 86.84 |
| | 12 | Phytochemicals | | | | |
| 41 | Water Control | 100% | | 0.50 | 5.00 | 0.00 |

### Conclusion:

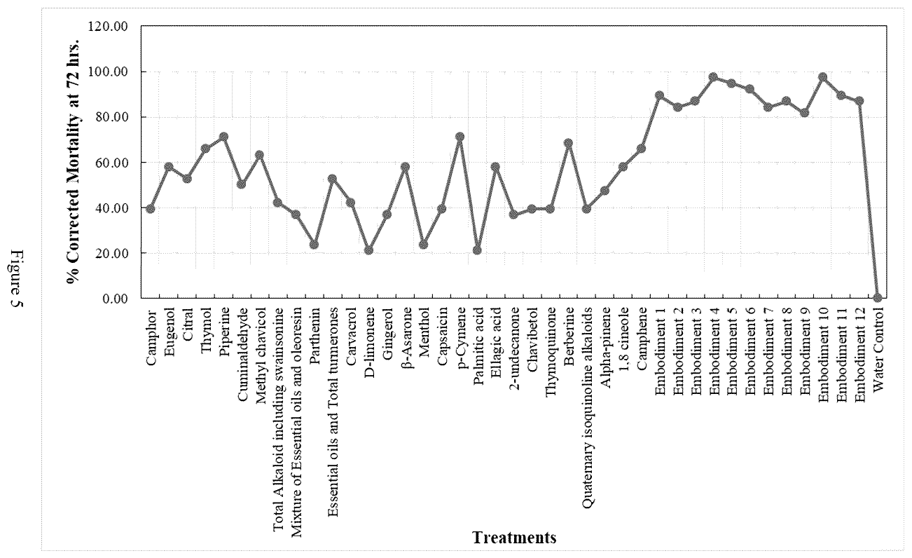

In vitro bio-efficacy study revealed that Embodiment 4@1.0 ml/lit & Embodiment 10@1.0 ml/lit showed highest corrected mortality 97.37% at 72 hours followed by Embodiment 5@1.0 ml/lit. showed 94.74% corrected mortality against Spodoptera litura. All the Embodiment (Combinations of phytochemicals) reported maximum Spodoptera litura mortality than the individual phytochemicals (depicted in FIG. 5).

### Example 19: In Vitro Bio-Efficacy of Plant Extracted Phytochemicals and its Combinations Against Thrips

### Material and Methodology:

Insect Studied: Thrips (Collected culture from insectary section)
Host plant leaves: Cotton leaves (For thrips feeding)
No. of Treatments: 41
Replications: 4
No. of Insects Taken: 10/treatments
Solution for spray: 1 lit. spray solution of respective bio-pesticides was prepared.
Micropipette: Require for taking accurate volume of bio-pesticide as per recommendations.
Microscope: Zoom stereo trinocular microscope for insect observation.
Observation Recorded: After 48 hrs. of application
Statistical Design Used: Completely Randomized Design

### Calculations:

$$\% Corrected Mortality = \frac{( \% Treated Mortality - \% Control Mortality )}{100 - \% Control Mortality} \times 100$$

### Results:

TABLE 19
In vitro bio-efficacy of plant extracted phytochemicals
and its combinations against thrips.

| | | | | Total No. | | % |
|---|---|---|---|---|---|---|
| | | | | of dead | % | Corrected |
| Tr. | | Concentration | Dose | insect at | Mortality | Mortality |
| No. | Treatments | Range | (ml/gm/lit.) | 48 Hrs. | at 48 Hrs. | at 48 Hrs. |
| 1 | Camphor | 0.001 to 7% | 1 | 4.50 | 45.00 | 37.14 |
| 2 | Eugenol | 0.001 to 10% | 1 | 2.50 | 25.00 | 14.29 |
| 3 | Citral | 0.001 to 15% | 1 | 5.75 | 57.50 | 51.43 |
| 4 | Thymol | 0.001 to 13% | 1 | 3.25 | 32.50 | 22.86 |
| 5 | Piperine | 0.001 to 8% | 1 | 4.00 | 40.00 | 31.43 |
| 6 | Cuminaldehyde | 0.001 to 10% | 1 | 4.25 | 42.50 | 34.29 |
| 7 | Methyl | 0.001 to 9% | 1 | 5.50 | 55.00 | 48.57 |
| | chavicol | | | | | |
| 8 | Total Alkaloid | 0.001 to 8% | 1 | 6.50 | 65.00 | 60.00 |
| | including | | | | | |
| | swainsonine | | | | | |
| 9 | Mixture of | 0.001 to 8% | 1 | 6.75 | 67.50 | 62.86 |
| | Essential oils | | | | | |
| | and oleoresin | | | | | |
| 10 | Parthenin | 0.001 to 7% | 1 | 4.75 | 47.50 | 40.00 |
| 11 | Essential oils | 0.001 to 8% | 1 | 5.00 | 50.00 | 42.86 |
| | and Total | | | | | |
| | turmerones | | | | | |
| 12 | Carvacrol | 0.001 to 10% | 1 | 3.50 | 35.00 | 25.71 |
| 13 | D-limonene | 0.001 to 8% | 1 | 3.75 | 37.50 | 28.57 |
| 14 | Gingerol | 0.001 to 8% | 1 | 3.75 | 37.50 | 28.57 |
| 15 | β-Asarone | 0.001 to 9% | 1 | 6.75 | 67.50 | 62.86 |
| 16 | Menthol | 0.001 to 9% | 1 | 7.50 | 75.00 | 71.43 |
| 17 | Capsaicin | 0.001 to 8% | 1 | 6.25 | 62.50 | 57.14 |
| 18 | p-Cymene | 0.001 to 15% | 1 | 6.00 | 60.00 | 54.29 |
| 19 | Palmitic acid | 0.001 to 8% | 1 | 4.25 | 42.50 | 34.29 |
| 20 | Ellagic acid | 0.001 to 8% | 1 | 3.50 | 35.00 | 25.71 |
| 21 | 2-undecanone | 0.001 to 8% | 1 | 5.00 | 50.00 | 42.86 |
| 22 | Chavibetol | 0.001 to 7% | 1 | 5.25 | 52.50 | 45.71 |
| 23 | Thymoquinone | 0.001 to 8% | 1 | 2.25 | 22.50 | 11.43 |
| 24 | Berberine | 0.001 to 8% | 1 | 6.50 | 65.00 | 60.00 |
| 25 | Quaternary | 0.001 to 9% | 1 | 3.50 | 35.00 | 25.71 |
| | isoquinoline | | | | | |
| | alkaloids | | | | | |
| 26 | Alpha-pinene | 0.001 to 13% | 1 | 4.25 | 42.50 | 34.29 |
| 27 | 1,8 cineole | 0.001 to 7% | 1 | 7.00 | 70.00 | 65.71 |
| 28 | Camphene | 0.001 to 7% | 1 | 5.25 | 52.50 | 45.71 |
| 29 | Embodiment 1 | Combination of | 1 | 8.50 | 85.00 | 82.86 |
| | | Phytochemicals | | | | |
| 30 | Embodiment 2 | Combination of | 1 | 8.75 | 87.50 | 85.71 |
| | | Phytochemicals | | | | |
| 31 | Embodiment 3 | Combination of | 1 | 8.25 | 82.50 | 80.00 |
| | | Phytochemicals | | | | |
| 32 | Embodiment 4 | Combination of | 1 | 9.50 | 95.00 | 94.29 |
| | | Phytochemicals | | | | |
| 33 | Embodiment 5 | Combination of | 1 | 9.25 | 92.50 | 91.43 |
| | | Phytochemicals | | | | |
| 34 | Embodiment 6 | Combination of | 1 | 9.75 | 97.50 | 97.14 |
| | | Phytochemicals | | | | |
| 35 | Embodiment 7 | Combination of | 1 | 8.50 | 85.00 | 82.86 |
| | | Phytochemicals | | | | |
| 36 | Embodiment 8 | Combination of | 1 | 8.75 | 87.50 | 85.71 |
| | | Phytochemicals | | | | |
| 38 | Embodiment 9 | Combination of | 1 | 9.25 | 92.50 | 91.43 |
| | | Phytochemicals | | | | |
| 38 | Embodiment 10 | Combination of | 1 | 9.50 | 95.00 | 94.29 |
| | | Phytochemicals | | | | |
| 39 | Embodiment 11 | Combination of | 1 | 9.25 | 92.50 | 91.43 |
| | | Phytochemicals | | | | |
| 40 | Embodiment 12 | Combination of | 1 | 8.50 | 85.00 | 82.86 |
| | | Phytochemicals | | | | |
| 41 | Water Control | 100% | | 1.25 | 12.50 | 0.00 |

### Conclusion:

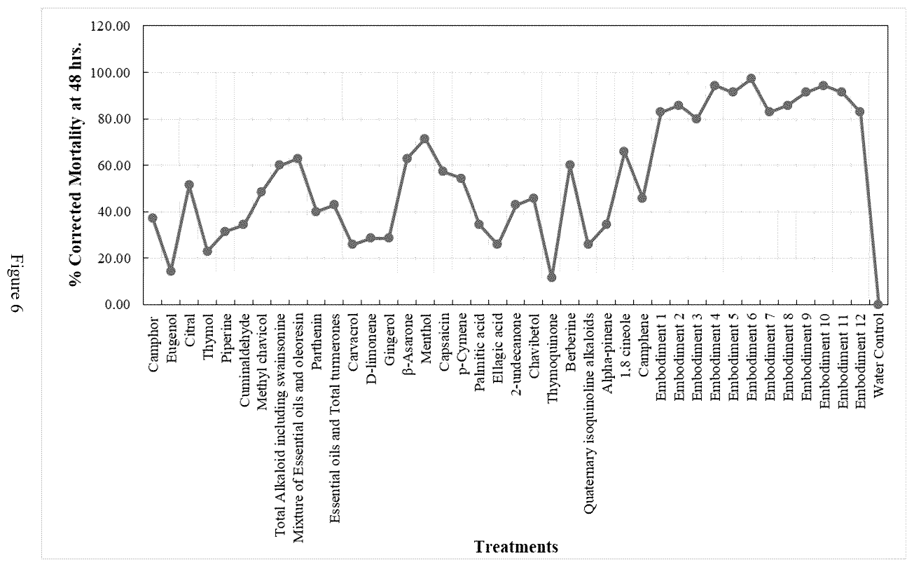

In vitro bio-efficacy study revealed that Embodiment 6@1.0 ml/lit showed highest corrected mortality 97.14% at 48 hours followed by Embodiment 4@1.0 ml/lit. & Embodiment 10@1.0 ml/lit. showed 94.29% corrected mortality against thrips. All the Embodiment (Combinations of phytochemicals) reported maximum thrips mortality than the individual phytochemicals (depicted in FIG. 6).

### Example 20: In Vitro Bio-Efficacy of Plant Extracted Phytochemicals and its Combinations Against Fungus

### Material and Methodology:

Pathogen Studied: Alternaria alternata (Sample collected from Plant Pathology section)
Technique Used: Poisoned Food Technique
Media used: Potato Dextrose Agar medium (For fungus growing)
No. of Treatments: 41
Replications: 4
Micropipette: Require for taking accurate volume of bio-fungicides as per recommendations.
Weighing Balance: Require for taking accurate quantity of bio-fungicides as per recommendations
Zone Scale: Require for measuring growth of fungi
Observation Recorded: After Seven Days Application
Statistical Design Used: Completely Randomized Design

$$Calculations : Percent Growth Inhibition = \frac{( C - T )}{C} \times 100$$

Where,
   C=Growth (mm) of test fungus in untreated control plate
   T=Growth (mm) of test fungus in treated plates

### Results:

TABLE 20
In vitro bio-efficacy of plant extracted phytochemicals
and its combinations against Alternaria alternata.

| | | | Dose | Mean colony | % |
|---|---|---|---|---|---|
| Tr. | | Concentration | (ml/gm/ | Diameter | Inhibition |
| No. | Treatments | Range | lit.) | (mm) | of growth |
| 1 | Camphor | 0.001 to 7% | 1 | 60.00 | 31.82 |
| 2 | Eugenol | 0.001 to 10% | 1 | 50.50 | 42.61 |
| 3 | Citral | 0.001 to 15% | 1 | 45.50 | 48.30 |
| 4 | Thymol | 0.001 to 13% | 1 | 51.50 | 41.48 |
| 5 | Piperine | 0.001 to 8% | 1 | 52.00 | 40.91 |
| 6 | Cuminaldehyde | 0.001 to 10% | 1 | 51.50 | 41.48 |
| 7 | Methyl chavicol | 0.001 to 9% | 1 | 54.00 | 38.64 |
| 8 | Total Alkaloid | 0.001 to 8% | 1 | 78.50 | 10.80 |
| | including swainsonine | | | | |
| 9 | Mixture of Essential | 0.001 to 8% | 1 | 55.00 | 37.50 |
| | oils and oleoresin | | | | |
| 10 | Parthenin | 0.001 to 7% | 1 | 78.00 | 11.36 |
| 11 | Essential oils and | 0.001 to 8% | 1 | 48.50 | 44.89 |
| | Total turmerones | | | | |
| 12 | Carvacrol | 0.001 to 10% | 1 | 52.50 | 40.34 |
| 13 | D-limonene | 0.001 to 8% | 1 | 47.00 | 46.59 |
| 14 | Gingerol | 0.001 to 8% | 1 | 42.50 | 51.70 |
| 15 | β-Asarone | 0.001 to 9% | 1 | 40.50 | 53.98 |
| 16 | Menthol | 0.001 to 9% | 1 | 52.00 | 40.91 |
| 17 | Capsaicin | 0.001 to 8% | 1 | 50.50 | 42.61 |
| 18 | p-Cymene | 0.001 to 15% | 1 | 58.00 | 34.09 |
| 19 | Palmitic acid | 0.001 to 8% | 1 | 58.00 | 34.09 |
| 20 | Ellagic acid | 0.001 to 8% | 1 | 44.00 | 50.00 |
| 21 | 2-undecanone | 0.001 to 8% | 1 | 52.00 | 40.91 |
| 22 | Chavibetol | 0.001 to 7% | 1 | 55.50 | 36.93 |
| 23 | Thymoquinone | 0.001 to 8% | 1 | 54.00 | 38.64 |
| 24 | Berberine | 0.001 to 8% | 1 | 45.50 | 48.30 |
| 25 | Quaternary | 0.001 to 9% | 1 | 48.50 | 44.89 |
| | isoquinoline alkaloids | | | | |
| 26 | Alpha-pinene | 0.001 to 13% | 1 | 71.50 | 18.75 |
| 27 | 1,8 cineole | 0.001 to 7% | 1 | 72.00 | 18.18 |
| 28 | Camphene | 0.001 to 7% | 1 | 71.50 | 18.75 |
| 29 | Embodiment 1 | Combination of | 1 | 9.00 | 89.77 |
| | | Phytochemicals | | | |
| 30 | Embodiment 2 | Combination of | 1 | 6.00 | 93.18 |
| | | Phytochemicals | | | |
| 31 | Embodiment 3 | Combination of | 1 | 7.00 | 92.05 |
| | | Phytochemicals | | | |
| 32 | Embodiment 4 | Combination of | 1 | 6.50 | 92.61 |
| | | Phytochemicals | | | |
| 33 | Embodiment 5 | Combination of | 1 | 7.50 | 91.48 |
| | | Phytochemicals | | | |
| 34 | Embodiment 6 | Combination of | 1 | 6.50 | 92.61 |
| | | Phytochemicals | | | |
| 35 | Embodiment 7 | Combination of | 1 | 6.00 | 93.18 |
| | | Phytochemicals | | | |
| 36 | Embodiment 8 | Combination of | 1 | 0.00 | 100.00 |
| | | Phytochemicals | | | |
| 38 | Embodiment 9 | Combination of | 1 | 7.50 | 91.48 |
| | | Phytochemicals | | | |
| 38 | Embodiment 10 | Combination of | 1 | 6.50 | 92.61 |
| | | Phytochemicals | | | |
| 39 | Embodiment 11 | Combination of | 1 | 7.50 | 91.48 |
| | | Phytochemicals | | | |
| 40 | Embodiment 12 | Combination of | 1 | 0.00 | 100.00 |
| | | Phytochemicals | | | |
| 41 | Water Control | 100% | | 88.00 | 0.00 |

### Conclusion:

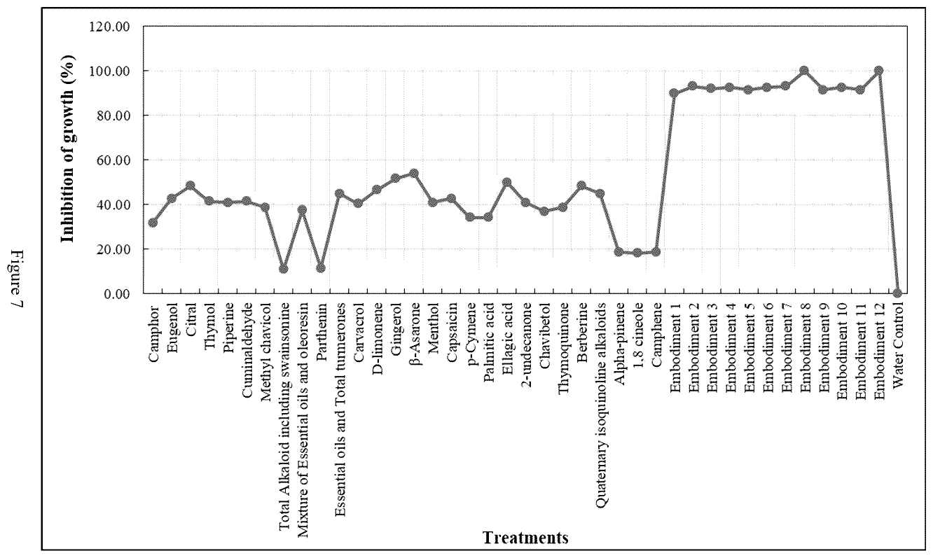

In vitro bio-efficacy study revealed that Embodiment 8 & 12@1.0 ml/lit showed 100% inhibition of growth after 7 days followed by Embodiment 7 & 2@1.0 ml/lit. showed 93.18% inhibition of growth against Alternaria alternata. All the Embodiment (Combinations of phytochemicals) reported maximum percent inhibition of growth than the individual phytochemicals (depicted in FIG. 7).

### Example 21: In Vitro Bio-Efficacy of Plant Extracted Phytochemicals and its Combinations Against Xanthomonas Axanopodis Pv. Punicae

### Material and Methodology:

Pathogen Studied: Xanthomonas axanopodis pv. punicae (Sample collected from Plant Pathology section)
Technique Used: Well diffusion technique
Media used: Nutrient Agar medium (For bacteria growing)
No. of Treatments: 41
Replications: 4
Micropipette: Require for taking accurate volume of bio-bactericides as per recommendations.
Weighing Balance: Require for taking accurate volume of bio-bactericides as per recommendations
Antibiotic Zone Scale: Require for measuring accurate zone
Observation Recorded: After three Days Application
Statistical Design Used: Completely Randomized Design
Calculations: Zone of inhibition (mm)

### Results:

TABLE 21
In vitro bio-efficacy of plant extracted phytochemicals and its
combinations against Xanthomonas axanopodis pv. punicae.

| | | | Dose | Zone of |
|---|---|---|---|---|
| Tr. | | | (ml/gm/ | Inhibition |
| No. | Treatments | Concentration Range | lit.) | (mm) |
| 1 | Camphor | 0.001 to 7% | 1 | 10.00 |
| 2 | Eugenol | 0.001 to 10% | 1 | 11.00 |
| 3 | Citral | 0.001 to 15% | 1 | 12.50 |
| 4 | Thymol | 0.001 to 13% | 1 | 10.75 |
| 5 | Piperine | 0.001 to 8% | 1 | 7.00 |
| 6 | Cuminaldehyde | 0.001 to 10% | 1 | 13.75 |
| 7 | Methyl chavicol | 0.001 to 9% | 1 | 11.25 |
| 8 | Total Alkaloid | 0.001 to 8% | 1 | 12.75 |
| | including swainsonine | | | |
| 9 | Mixture of Essential | 0.001 to 8% | 1 | 11.25 |
| | oils and oleoresin | | | |
| 10 | Parthenin | 0.001 to 7% | 1 | 7.00 |
| 11 | Essential oils | 0.001 to 8% | 1 | 13.25 |
| | and Total | | | |
| | turmerones | | | |
| 12 | Carvacrol | 0.001 to 10% | 1 | 12.25 |
| 13 | D-limonene | 0.001 to 8% | 1 | 11.75 |
| 14 | Gingerol | 0.001 to 8% | 1 | 9.75 |
| 15 | B-Asarone | 0.001 to 9% | 1 | 7.50 |
| 16 | Menthol | 0.001 to 9% | 1 | 12.00 |
| 17 | Capsaicin | 0.001 to 8% | 1 | 12.25 |
| 18 | p-Cymene | 0.001 to 15% | 1 | 11.50 |
| 19 | Palmitic acid | 0.001 to 8% | 1 | 11.50 |
| 20 | Ellagic acid | 0.001 to 8% | 1 | 10.25 |
| 21 | 2-undecanone | 0.001 to 8% | 1 | 14.57 |
| 22 | Chavibetol | 0.001 to 7% | 1 | 13.25 |
| 23 | Thymoquinone | 0.001 to 8% | 1 | 12.75 |
| 24 | Berberine | 0.001 to 8% | 1 | 10.50 |
| 25 | Quaternary | 0.001 to 9% | 1 | 7.75 |
| | isoquinoline | | | |
| | alkaloids | | | |
| 26 | Alpha-pinene | 0.001 to 13% | 1 | 7.50 |
| 27 | 1,8 cineole | 0.001 to 7% | 1 | 8.25 |
| 28 | Camphene | 0.001 to 7% | 1 | 9.00 |
| 29 | Embodiment 1 | Combination of | 1 | 30.25 |
| | | Phytochemicals | | |
| 30 | Embodiment 2 | Combination of | 1 | 31.75 |
| | | Phytochemicals | | |
| 31 | Embodiment 3 | Combination of | 1 | 33.25 |
| | | Phytochemicals | | |
| 32 | Embodiment 4 | Combination of | 1 | 32.50 |
| | | Phytochemicals | | |
| 33 | Embodiment 5 | Combination of | 1 | 34.75 |
| | | Phytochemicals | | |
| 34 | Embodiment 6 | Combination of | 1 | 32.50 |
| | | Phytochemicals | | |
| 35 | Embodiment 7 | Combination of | 1 | 39.75 |
| | | Phytochemicals | | |
| 36 | Embodiment 8 | Combination of | 1 | 35.50 |
| | | Phytochemicals | | |
| 38 | Embodiment 9 | Combination of | 1 | 35.00 |
| | | Phytochemicals | | |
| 38 | Embodiment 10 | Combination of | 1 | 34.25 |
| | | Phytochemicals | | |
| 39 | Embodiment 11 | Combination of | 1 | 33.75 |
| | | Phytochemicals | | |
| 40 | Embodiment 12 | Combination of | 1 | 38.50 |
| | | Phytochemicals | | |
| 41 | Water Control | 100% | | 0.00 |

### Conclusion:

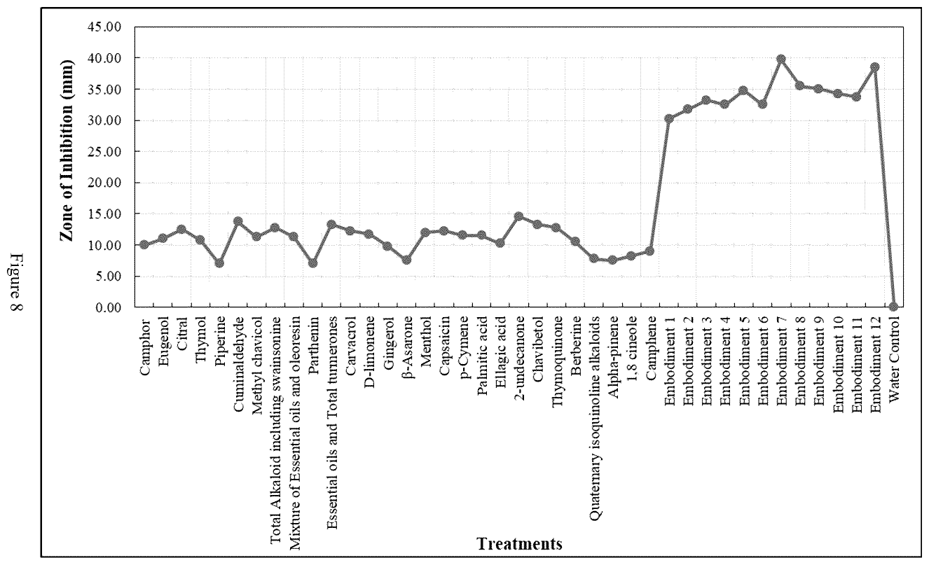

In vitro bio-efficacy study revealed that Embodiment 7@1.0 ml/lit showed 39.75 mm zone of inhibition after 3 days followed by Embodiment 12@1.0 ml/lit. & Embodiment 8@1.0 ml/lit. showed 38.50% & 35.50% zone of inhibition against Xanthomonas axanopodis pv. punicae, respectively. All the Embodiment (Combinations of phytochemicals) reported maximum zone of inhibition than the individual phytochemicals (depicted in FIG. 8).

### Example 22: The Effect of Plant Extracted Phytochemicals and its Combinations on Aphids in Green House Condition

### Material and Methodology:

Insect Studied: Aphid (Collected culture from insectary section)
Insect Stage: Early nymphal stage
Host plant selected: Cotton plants having five leaf stage (For Aphid feeding)
No. of Treatments: 41
Replications: 4
No. of Insects/plants: 10 (placed on 3 to 4 leaves)
No. of plants/treatment: 10 plants
Insect acclimatization period: 24 hrs.
Solution for spray: 2 lit. spray solution of respective bio-pesticides was prepared.
Cage Size: 150×120×100 cm
Green House Temp.: 26±2° C.
Humidity: 75±5%
Observation Recorded: After 48 hrs. of application
Statistical Design Used: Completely Randomized Design

$$Calculations : \% Corrected Mortality = \frac{( \% Treated Mortality - \% Control Mortality )}{100 - \% Control Mortality} \times 100$$

### Results:

TABLE 22
Effect of plant extracted phytochemicals and its combinations against aphids.

| | | | | Total No. | | % |
|---|---|---|---|---|---|---|
| | | | | of dead | % | Corrected |
| Tr. | | Concentration | Dose | insect at | Mortality | Mortality |
| No. | Treatments | Range | (ml/gm/lit.) | 48 Hrs. | at 48 Hrs. | at 48 Hrs. |
| 1 | Camphor | 0.001 to 7% | 1 | 60.00 | 60.00 | 52.94 |
| 2 | Eugenol | 0.001 to 10% | 1 | 65.00 | 65.00 | 58.82 |
| 3 | Citral | 0.001 to 15% | 1 | 70.00 | 70.00 | 64.71 |
| 4 | Thymol | 0.001 to 13% | 1 | 62.50 | 62.50 | 55.88 |
| 5 | Piperine | 0.001 to 8% | 1 | 70.00 | 70.00 | 64.71 |
| 6 | Cuminaldehyde | 0.001 to 10% | 1 | 55.00 | 55.00 | 47.06 |
| 7 | Methyl | 0.001 to 9% | 1 | 67.50 | 67.50 | 61.76 |
| | chavicol | | | | | |
| 8 | Total Alkaloid | 0.001 to 8% | 1 | 65.00 | 65.00 | 58.82 |
| | including | | | | | |
| | swainsonine | | | | | |
| 9 | Mixture of | 0.001 to 8% | 1 | 55.00 | 55.00 | 47.06 |
| | Essential oils | | | | | |
| | and oleoresin | | | | | |
| 10 | Parthenin | 0.001 to 7% | 1 | 57.50 | 57.50 | 50.00 |
| 11 | Essential oils | 0.001 to 8% | 1 | 60.00 | 60.00 | 52.94 |
| | and Total | | | | | |
| | turmerones | | | | | |
| 12 | Carvacrol | 0.001 to 10% | 1 | 72.50 | 72.50 | 67.65 |
| 13 | D-limonene | 0.001 to 8% | 1 | 62.50 | 62.50 | 55.88 |
| 14 | Gingerol | 0.001 to 8% | 1 | 65.00 | 65.00 | 58.82 |
| 15 | β-Asarone | 0.001 to 9% | 1 | 70.00 | 70.00 | 64.71 |
| 16 | Menthol | 0.001 to 9% | 1 | 75.00 | 75.00 | 70.59 |
| 17 | Capsaicin | 0.001 to 8% | 1 | 62.50 | 62.50 | 55.88 |
| 18 | p-Cymene | 0.001 to 15% | 1 | 60.00 | 60.00 | 52.94 |
| 19 | Palmitic acid | 0.001 to 8% | 1 | 70.00 | 70.00 | 64.71 |
| 20 | Ellagic acid | 0.001 to 8% | 1 | 75.00 | 75.00 | 70.59 |
| 21 | 2-undecanone | 0.001 to 8% | 1 | 67.50 | 67.50 | 61.76 |
| 22 | Chavibetol | 0.001 to 7% | 1 | 55.00 | 55.00 | 47.06 |
| 23 | Thymoquinone | 0.001 to 8% | 1 | 47.50 | 47.50 | 38.24 |
| 24 | Berberine | 0.001 to 8% | 1 | 55.00 | 55.00 | 47.06 |
| 25 | Quaternary | 0.001 to 9% | 1 | 67.50 | 67.50 | 61.76 |
| | isoquinoline | | | | | |
| | alkaloids | | | | | |
| 26 | Alpha-pinene | 0.001 to 13% | 1 | 60.00 | 60.00 | 52.94 |
| 27 | 1,8 cineole | 0.001 to 7% | 1 | 62.50 | 62.50 | 55.88 |
| 28 | Camphene | 0.001 to 7% | 1 | 50.00 | 50.00 | 41.18 |
| 29 | Embodiment 1 | Combination of | 1 | 90.00 | 90.00 | 88.24 |
| | | Phytochemicals | | | | |
| 30 | Embodiment 2 | Combination of | 1 | 90.00 | 90.00 | 88.24 |
| | | Phytochemicals | | | | |
| 31 | Embodiment 3 | Combination of | 1 | 92.50 | 92.50 | 91.18 |
| | | Phytochemicals | | | | |
| 32 | Embodiment 4 | Combination of | 1 | 95.00 | 95.00 | 94.12 |
| | | Phytochemicals | | | | |
| 33 | Embodiment 5 | Combination of | 1 | 92.50 | 92.50 | 91.18 |
| | | Phytochemicals | | | | |
| 34 | Embodiment 6 | Combination of | 1 | 90.00 | 90.00 | 88.24 |
| | | Phytochemicals | | | | |
| 35 | Embodiment 7 | Combination of | 1 | 87.50 | 87.50 | 85.29 |
| | | Phytochemicals | | | | |
| 36 | Embodiment 8 | Combination of | 1 | 85.00 | 85.00 | 82.35 |
| | | Phytochemicals | | | | |
| 38 | Embodiment 9 | Combination of | 1 | 85.00 | 85.00 | 82.35 |
| | | Phytochemicals | | | | |
| 38 | Embodiment 10 | Combination of | 1 | 80.00 | 80.00 | 76.47 |
| | | Phytochemicals | | | | |
| 39 | Embodiment 11 | Combination of | 1 | 90.00 | 90.00 | 88.24 |
| | | Phytochemicals | | | | |
| 40 | Embodiment 12 | Combination of | 1 | 82.50 | 82.50 | 79.41 |
| | | Phytochemicals | | | | |
| 41 | Water Control | 100% | | 15.00 | 15.00 | 0.00 |

### Conclusion

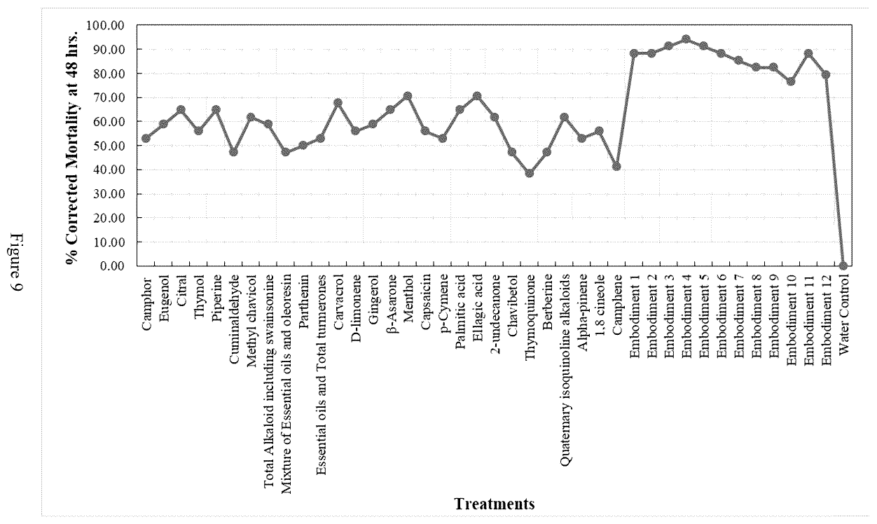

The bio-efficacy study revealed that Embodiment 4@1.0 ml/lit showed highest corrected mortality 94.12% at 48 hours followed by Embodiment 3@1.0 ml/lit. & Embodiment 5@ 1.0 ml/lit. showed 91.18% corrected mortality against aphid. All the Embodiment (Combinations of phytochemicals) reported maximum aphid mortality than the individual phytochemicals (depicted as FIG. 9).

### Example 23: The Effect of Plant Extracted Phytochemicals and its Combinations Against Mite in Green House Conditions

### Material and Methodology:

Insect Studied: Mite (Collected culture from insectary section)
Insect Stage: Nymphal and adult stage
Host plant selected: Okra plants having five leaf stage (For Mites feeding)
No. of Treatments: 41
Replications: 4
No. of Insects/plants: 10 (placed on 2 to 3 leaves)
No. of plants/treatment: 10 plants
Insect acclimatization period: 24 hrs.
Solution for spray: 2 lit. spray solution of respective bio-pesticides was prepared.
Cage Size: 150×120×100 cm
Green House Temp.: 26±2° C.
Humidity: 75±5%
Observation Recorded: After 48 hrs. of application
Statistical Design Used: Completely Randomized Design

$$Calculations : \% Corrected Mortality = \frac{( \% Treated Mortality - \% Control Mortality )}{100 - \% Control Mortality} \times 100$$

### Results:

TABLE 23
The effect of plant extracted phytochemicals and its combinations against mite.

| | | | | Total | | % |
|---|---|---|---|---|---|---|
| | | | | No. of | % | Corrected |
| Tr. | | Concentration | Dose | dead insect | Mortality | Mortality |
| No. | Treatments | Range | (ml/gm/lit.) | at 48 Hrs. | at 48 Hrs. | at 48 Hrs. |
| 1 | Camphor | 0.001 to 7% | 1 | 65.00 | 65.00 | 63.16 |
| 2 | Eugenol | 0.001 to 10% | 1 | 52.50 | 52.50 | 50.00 |
| 3 | Citral | 0.001 to 15% | 1 | 55.00 | 55.00 | 52.63 |
| 4 | Thymol | 0.001 to 13% | 1 | 62.50 | 62.50 | 60.53 |
| 5 | Piperine | 0.001 to 8% | 1 | 60.00 | 60.00 | 57.89 |
| 6 | Cuminaldehyde | 0.001 to 10% | 1 | 35.00 | 35.00 | 31.58 |
| 7 | Methyl | 0.001 to 9% | 1 | 42.50 | 42.50 | 39.47 |
| | chavicol | | | | | |
| 8 | Total Alkaloid | 0.001 to 8% | 1 | 25.00 | 25.00 | 21.05 |
| | including | | | | | |
| | swainsonine | | | | | |
| 9 | Mixture of | 0.001 to 8% | 1 | 30.00 | 30.00 | 26.32 |
| | Essential oils | | | | | |
| | and oleoresin | | | | | |
| 10 | Parthenin | 0.001 to 7% | 1 | 22.50 | 22.50 | 18.42 |
| 11 | Essential oils | 0.001 to 8% | 1 | 32.50 | 32.50 | 28.95 |
| | and Total | | | | | |
| | turmerones | | | | | |
| 12 | Carvacrol | 0.001 to 10% | 1 | 47.50 | 47.50 | 44.74 |
| 13 | D-limonene | 0.001 to 8% | 1 | 52.50 | 52.50 | 50.00 |
| 14 | Gingerol | 0.001 to 8% | 1 | 30.00 | 30.00 | 26.32 |
| 15 | β-Asarone | 0.001 to 9% | 1 | 22.50 | 22.50 | 18.42 |
| 16 | Menthol | 0.001 to 9% | 1 | 42.50 | 42.50 | 39.47 |
| 17 | Capsaicin | 0.001 to 8% | 1 | 52.40 | 52.40 | 49.89 |
| 18 | p-Cymene | 0.001 to 15% | 1 | 67.50 | 67.50 | 65.79 |
| 19 | Palmitic acid | 0.001 to 8% | 1 | 45.00 | 45.00 | 42.11 |
| 20 | Ellagic acid | 0.001 to 8% | 1 | 52.50 | 52.50 | 50.00 |
| 21 | 2-undecanone | 0.001 to 8% | 1 | 27.50 | 27.50 | 23.68 |
| 22 | Chavibetol | 0.001 to 7% | 1 | 22.50 | 22.50 | 18.42 |
| 23 | Thymoquinone | 0.001 to 8% | 1 | 30.00 | 30.00 | 26.32 |
| 24 | Berberine | 0.001 to 8% | 1 | 45.00 | 45.00 | 42.11 |
| 25 | Quaternary | 0.001 to 9% | 1 | 47.50 | 47.50 | 44.74 |
| | isoquinoline | | | | | |
| | alkaloids | | | | | |
| 26 | Alpha-pinene | 0.001 to 13% | 1 | 32.50 | 32.50 | 28.95 |
| 27 | 1,8 cineole | 0.001 to 7% | 1 | 22.50 | 22.50 | 18.42 |
| 28 | Camphene | 0.001 to 7% | 1 | 40.00 | 40.00 | 36.84 |
| 29 | Embodiment 1 | Combination of | 1 | 87.50 | 87.50 | 86.84 |
| | | Phytochemicals | | | | |
| 30 | Embodiment 2 | Combination of | 1 | 92.50 | 92.50 | 92.11 |
| | | Phytochemicals | | | | |
| 31 | Embodiment 3 | Combination of | 1 | 97.50 | 97.50 | 97.37 |
| | | Phytochemicals | | | | |
| 32 | Embodiment 4 | Combination of | 1 | 82.50 | 82.50 | 81.58 |
| | | Phytochemicals | | | | |
| 33 | Embodiment 5 | Combination of | 1 | 80.00 | 80.00 | 78.95 |
| | | Phytochemicals | | | | |
| 34 | Embodiment 6 | Combination of | 1 | 95.00 | 95.00 | 94.74 |
| | | Phytochemicals | | | | |
| 35 | Embodiment 7 | Combination of | 1 | 82.50 | 82.50 | 81.58 |
| | | Phytochemicals | | | | |
| 36 | Embodiment 8 | Combination of | 1 | 87.50 | 87.50 | 86.84 |
| | | Phytochemicals | | | | |
| 38 | Embodiment 9 | Combination of | 1 | 82.50 | 82.50 | 81.58 |
| | | Phytochemicals | | | | |
| 38 | Embodiment 10 | Combination of | 1 | 85.00 | 85.00 | 84.21 |
| | | Phytochemicals | | | | |
| 39 | Embodiment 11 | Combination of | 1 | 90.00 | 90.00 | 89.47 |
| | | Phytochemicals | | | | |
| 40 | Embodiment 12 | Combination of | 1 | 87.50 | 87.50 | 86.84 |
| | | Phytochemicals | | | | |
| 41 | Water Control | 100% | | 5.00 | 5.00 | 0.00 |

### Conclusion:

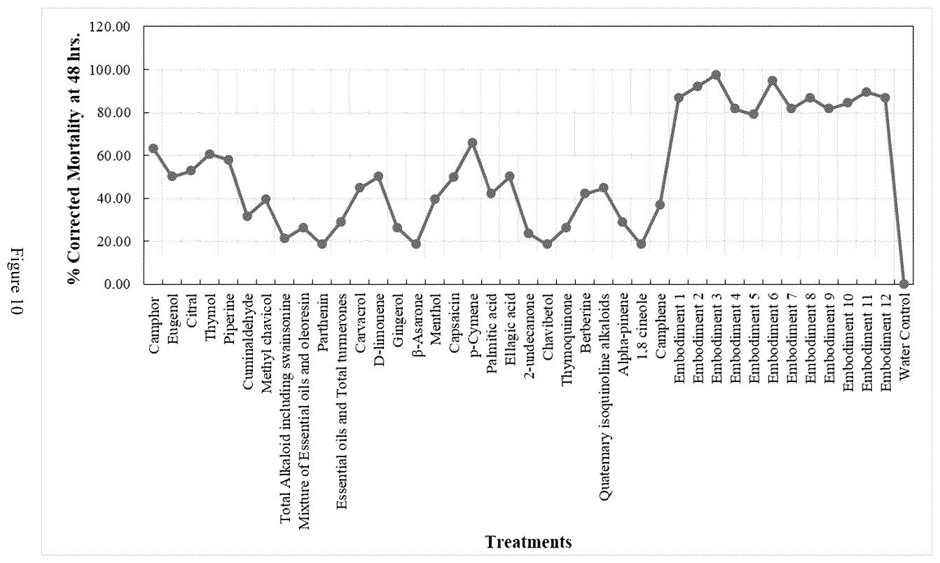

The bio-efficacy study revealed that Embodiment 3@1.0 ml/lit showed highest corrected mortality 97.37% at 48 hours followed by Embodiment 6@1.0 ml/lit. & Embodiment 2@1.0 ml/lit. showed 94.74% & 92.11% corrected mortality against mite, respectively. All the Embodiment (Combinations of phytochemicals) reported maximum mite mortality than the individual phytochemicals (depicted in FIG. 10).

### Example 24: The Effect of Plant Extracted Phytochemicals and its Combinations on Mealy Bugs in Green House Condition

### Material and Methodology:

Insect Studied: Mealy Bug (Collected culture from insectary section)
Insect Stage: Early nymphal stage
Host plant selected: Cotton plants having five leaf stage (For Mealy bugs feeding)
No. of Treatments: 41
Replications: 4
No. of Insects/plants: 10 (placed on 3 to 4 leaves)
No. of plants/treatment: 10 plants
Insect acclimatization period: 48 hrs.
Solution for spray: 2 lit. spray solution of respective bio-pesticides was prepared.
Cage Size: 150×120×100 cm
Green House Temp.: 26±2° C.
Humidity: 75±5%
Observation Recorded: After 48 hrs. of application
Statistical Design Used: Completely Randomized Design

$$Calculations : \% Corrected Mortality = \frac{( \% Treated Mortality - \% Control Mortality )}{100 - \% Control Mortality} \times 100$$

### Results:

TABLE 24
Effect of plant extracted phytochemicals and its combinations against mealy bugs.

| | | | | Total | | % |
|---|---|---|---|---|---|---|
| | | | | No. of dead | % | Corrected |
| Tr. | | Concentration | Dose | insect at | Mortality | Mortality |
| No. | Treatments | Range | (ml/gm/lit.) | 48 Hrs. | at 48 Hrs. | at 48 Hrs. |
| 1 | Camphor | 0.001 to 7% | 1 | 67.50 | 67.50 | 63.89 |
| 2 | Eugenol | 0.001 to 10% | 1 | 75.00 | 75.00 | 72.22 |
| 3 | Citral | 0.001 to 15% | 1 | 30.00 | 30.00 | 22.22 |
| 4 | Thymol | 0.001 to 13% | 1 | 55.00 | 55.00 | 50.00 |
| 5 | Piperine | 0.001 to 8% | 1 | 57.50 | 57.50 | 52.78 |
| 6 | Cuminaldehyde | 0.001 to 10% | 1 | 55.00 | 55.00 | 50.00 |
| 7 | Methyl | 0.001 to 9% | 1 | 60.00 | 60.00 | 55.56 |
| | chavicol | | | | | |
| 8 | Total Alkaloid | 0.001 to 8% | 1 | 62.50 | 62.50 | 58.33 |
| | including | | | | | |
| | swainsonine | | | | | |
| 9 | Mixture of | 0.001 to 8% | 1 | 45.00 | 45.00 | 38.89 |
| | Essential oils | | | | | |
| | and oleoresin | | | | | |
| 10 | Parthenin | 0.001 to 7% | 1 | 50.00 | 50.00 | 44.44 |
| 11 | Essential oils | 0.001 to 8% | 1 | 55.00 | 55.00 | 50.00 |
| | and Total | | | | | |
| | turmerones | | | | | |
| 12 | Carvacrol | 0.001 to 10% | 1 | 65.00 | 65.00 | 61.11 |
| 13 | D-limonene | 0.001 to 8% | 1 | 45.00 | 45.00 | 38.89 |
| 14 | Gingerol | 0.001 to 8% | 1 | 37.50 | 37.50 | 30.56 |
| 15 | β-Asarone | 0.001 to 9% | 1 | 35.00 | 35.00 | 27.78 |
| 16 | Menthol | 0.001 to 9% | 1 | 67.50 | 67.50 | 63.89 |
| 17 | Capsaicin | 0.001 to 8% | 1 | 77.50 | 77.50 | 75.00 |
| 18 | p-Cymene | 0.001 to 15% | 1 | 42.50 | 42.50 | 36.11 |
| 19 | Palmitic acid | 0.001 to 8% | 1 | 55.00 | 55.00 | 50.00 |
| 20 | Ellagic acid | 0.001 to 8% | 1 | 57.50 | 57.50 | 52.78 |
| 21 | 2-undecanone | 0.001 to 8% | 1 | 57.50 | 57.50 | 52.78 |
| 22 | Chavibetol | 0.001 to 7% | 1 | 45.00 | 45.00 | 38.89 |
| 23 | Thymoquinone | 0.001 to 8% | 1 | 50.00 | 50.00 | 44.44 |
| 24 | Berberine | 0.001 to 8% | 1 | 70.00 | 70.00 | 66.67 |
| 25 | Quaternary | 0.001 to 9% | 1 | 65.00 | 65.00 | 61.11 |
| | isoquinoline | | | | | |
| | alkaloids | | | | | |
| 26 | Alpha-pinene | 0.001 to 13% | 1 | 60.00 | 60.00 | 55.56 |
| 27 | 1,8 cineole | 0.001 to 7% | 1 | 45.00 | 45.00 | 38.89 |
| 28 | Camphene | 0.001 to 7% | 1 | 52.50 | 52.50 | 47.22 |
| 29 | Embodiment 1 | Combination of | 1 | 90.00 | 90.00 | 88.89 |
| | | Phytochemicals | | | | |
| 30 | Embodiment 2 | Combination of | 1 | 92.50 | 92.50 | 91.67 |
| | | Phytochemicals | | | | |
| 31 | Embodiment 3 | Combination of | 1 | 97.50 | 97.50 | 97.22 |
| | | Phytochemicals | | | | |
| 32 | Embodiment 4 | Combination of | 1 | 87.50 | 87.50 | 86.11 |
| | | Phytochemicals | | | | |
| 33 | Embodiment 5 | Combination of | 1 | 87.50 | 87.50 | 86.11 |
| | | Phytochemicals | | | | |
| 34 | Embodiment 6 | Combination of | 1 | 95.00 | 95.00 | 94.44 |
| | | Phytochemicals | | | | |
| 35 | Embodiment 7 | Combination of | 1 | 90.00 | 90.00 | 88.89 |
| | | Phytochemicals | | | | |
| 36 | Embodiment 8 | Combination of | 1 | 80.00 | 80.00 | 77.78 |
| | | Phytochemicals | | | | |
| 38 | Embodiment 9 | Combination of | 1 | 85.00 | 85.00 | 83.33 |
| | | Phytochemicals | | | | |
| 38 | Embodiment 10 | Combination of | 1 | 82.50 | 82.50 | 80.56 |
| | | Phytochemicals | | | | |
| 39 | Embodiment 11 | Combination of | 1 | 90.00 | 90.00 | 88.89 |
| | | Phytochemicals | | | | |
| 40 | Embodiment 12 | Combination of | 1 | 87.50 | 87.50 | 86.11 |
| | | Phytochemicals | | | | |
| 41 | Water Control | 100% | | 10.00 | 10.00 | 0.00 |

### Conclusion:

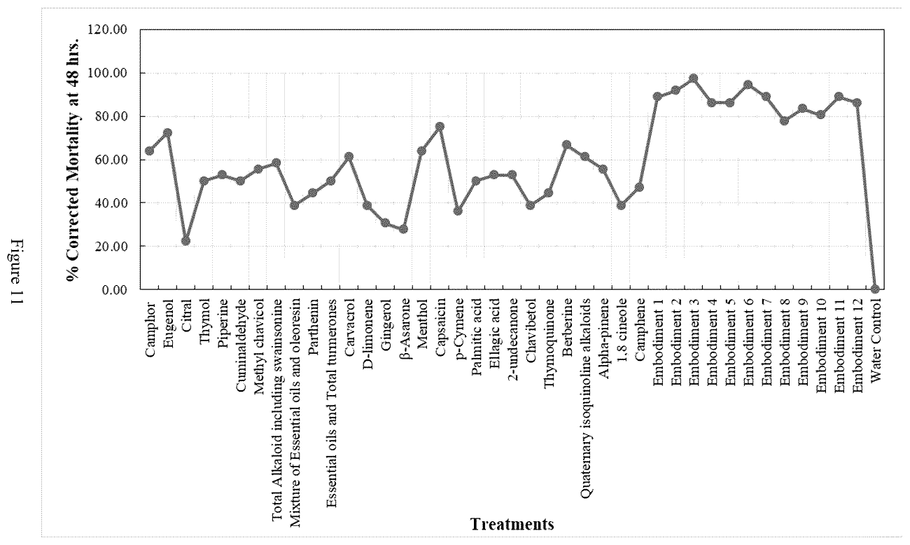

The bio-efficacy study revealed that Embodiment 3@1.0 ml/lit showed highest corrected mortality 97.22% at 48 hours followed by Embodiment 6@1.0 ml/lit. & Embodiment 2@1.0 ml/lit. showed 94.44% & 91.67% corrected mortality against mealy bug, respectively. All the Embodiment (Combinations of phytochemicals) reported maximum mealy bug mortality than the individual phytochemicals (depicted in FIG. 11).

### Example 25: The Effect of Plant Extracted Phytochemicals and its Combinations Against Helicoverpa armigera in Controlled Conditions

### Material and Methodology:

Insect Studied: Helicoverpa armigera (Collected culture from insectary section)
Insect Stage: 3^{rd} instar
Host plant selected: Chickpea plants of 30 days age (For Helicoverpa feeding)
No. of Treatments: 41
Replications: 4
No. of Insects/plants: Two
No. of plants/treatment: 10 plants
Insect acclimatization period: 24 hrs.
Solution for spray: 2 lit. spray solution of respective bio-pesticides was prepared.
Cage Size: 150×120×100 cm
Green House Temp.: 26±2° C.
Humidity: 75±5%
Observation Recorded: After 72 hrs. of application
Statistical Design Used: Completely Randomized Design
Calculations:

$$\% Corrected Mortality = \frac{( \% Treated Mortality - \% Control Mortality )}{100 - \% Control Mortality} \times 100$$

### Results:

TABLE 25
The effect of plant extracted phytochemicals and
its combinations agains Helicoverpa armigera

| | | | | Total | | % |
|---|---|---|---|---|---|---|
| | | | | No. of dead | % | Corrected |
| Tr. | | Concentration | Dose | insect at | Mortality | Mortality |
| No. | Treatments | Range | (ml/gm/lit.) | 72 Hrs. | at 72 Hrs. | at 72 Hrs. |
| 1 | Camphor | 0.001 to 7% | 1 | 55.00 | 55.00 | 55.00 |
| 2 | Eugenol | 0.001 to 10% | 1 | 42.50 | 42.50 | 42.50 |
| 3 | Citral | 0.001 to 15% | 1 | 32.50 | 32.50 | 32.50 |
| 4 | Thymol | 0.001 to 13% | 1 | 62.50 | 62.50 | 62.50 |
| 5 | Piperine | 0.001 to 8% | 1 | 67.50 | 67.50 | 67.50 |
| 6 | Cuminaldehyde | 0.001 to 10% | 1 | 35.00 | 35.00 | 35.00 |
| 7 | Methyl | 0.001 to 9% | 1 | 67.50 | 67.50 | 67.50 |
| | chavicol | | | | | |
| 8 | Total Alkaloid | 0.001 to 8% | 1 | 45.00 | 45.00 | 45.00 |
| | including | | | | | |
| | swainsonine | | | | | |
| 9 | Mixture of | 0.001 to 8% | 1 | 25.00 | 25.00 | 25.00 |
| | Essential oils | | | | | |
| | and oleoresin | | | | | |
| 10 | Parthenin | 0.001 to 7% | 1 | 35.00 | 35.00 | 35.00 |
| 11 | Essential oils | 0.001 to 8% | 1 | 45.00 | 45.00 | 45.00 |
| | and Total | | | | | |
| | turmerones | | | | | |
| 12 | Carvacrol | 0.001 to 10% | 1 | 52.50 | 52.50 | 52.50 |
| 13 | D-limonene | 0.001 to 8% | 1 | 32.50 | 32.50 | 32.50 |
| 14 | Gingerol | 0.001 to 8% | 1 | 50.00 | 50.00 | 50.00 |
| 15 | β-Asarone | 0.001 to 9% | 1 | 52.50 | 52.50 | 52.50 |
| 16 | Menthol | 0.001 to 9% | 1 | 55.00 | 55.00 | 55.00 |
| 17 | Capsaicin | 0.001 to 8% | 1 | 42.50 | 42.50 | 42.50 |
| 18 | p-Cymene | 0.001 to 15% | 1 | 65.00 | 65.00 | 65.00 |
| 19 | Palmitic acid | 0.001 to 8% | 1 | 40.00 | 40.00 | 40.00 |
| 20 | Ellagic acid | 0.001 to 8% | 1 | 70.00 | 70.00 | 70.00 |
| 21 | 2-undecanone | 0.001 to 8% | 1 | 52.50 | 52.50 | 52.50 |
| 22 | Chavibetol | 0.001 to 7% | 1 | 47.50 | 47.50 | 47.50 |
| 23 | Thymoquinone | 0.001 to 8% | 1 | 45.00 | 45.00 | 45.00 |
| 24 | Berberine | 0.001 to 8% | 1 | 62.50 | 62.50 | 62.50 |
| 25 | Quaternary | 0.001 to 9% | 1 | 52.50 | 52.50 | 52.50 |
| | isoquinoline | | | | | |
| | alkaloids | | | | | |
| 26 | Alpha-pinene | 0.001 to 13% | 1 | 67.50 | 67.50 | 67.50 |
| 27 | 1,8 cineole | 0.001 to 7% | 1 | 52.50 | 52.50 | 52.50 |
| 28 | Camphene | 0.001 to 7% | 1 | 60.00 | 60.00 | 60.00 |
| 29 | Embodiment 1 | Combination of | 1 | 77.50 | 77.50 | 77.50 |
| | | Phytochemicals | | | | |
| 30 | Embodiment 2 | Combination of | 1 | 87.50 | 87.50 | 87.50 |
| | | Phytochemicals | | | | |
| 31 | Embodiment 3 | Combination of | 1 | 80.00 | 80.00 | 80.00 |
| | | Phytochemicals | | | | |
| 32 | Embodiment 4 | Combination of | 1 | 95.00 | 95.00 | 95.00 |
| | | Phytochemicals | | | | |
| 33 | Embodiment 5 | Combination of | 1 | 90.00 | 90.00 | 90.00 |
| | | Phytochemicals | | | | |
| 34 | Embodiment 6 | Combination of | 1 | 92.50 | 92.50 | 92.50 |
| | | Phytochemicals | | | | |
| 35 | Embodiment 7 | Combination of | 1 | 80.00 | 80.00 | 80.00 |
| | | Phytochemicals | | | | |
| 36 | Embodiment 8 | Combination of | 1 | 85.00 | 85.00 | 85.00 |
| | | Phytochemicals | | | | |
| 38 | Embodiment 9 | Combination of | 1 | 75.00 | 75.00 | 75.00 |
| | | Phytochemicals | | | | |
| 38 | Embodiment 10 | Combination of | 1 | 92.50 | 92.50 | 92.50 |
| | | Phytochemicals | | | | |
| 39 | Embodiment 11 | Combination of | 1 | 82.50 | 82.50 | 82.50 |
| | | Phytochemicals | | | | |
| 40 | Embodiment 12 | Combination of | 1 | 85.00 | 85.00 | 85.00 |
| | | Phytochemicals | | | | |
| 41 | Water Control | 100% | | 0.00 | 0.00 | 0.00 |

### Conclusion:

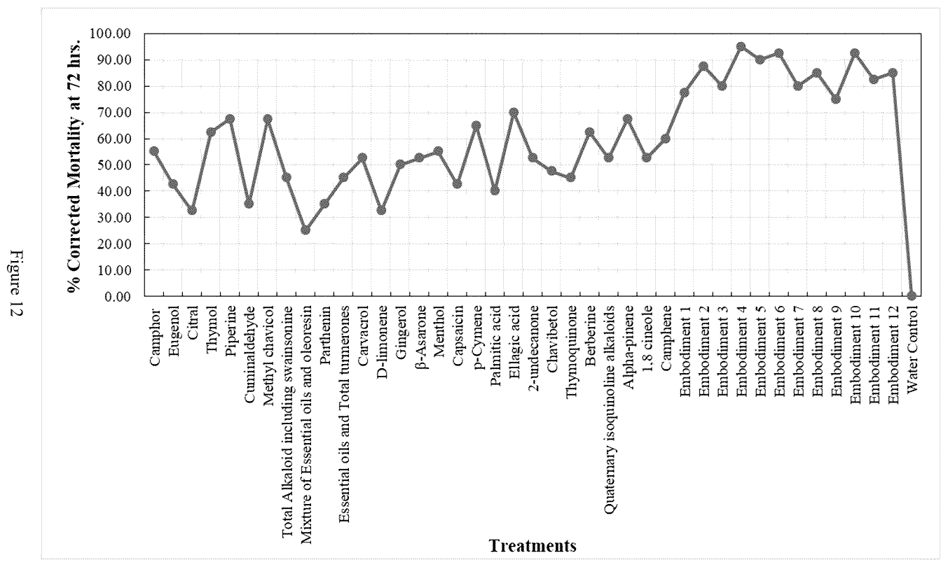

The bio-efficacy study revealed that Embodiment 4@1.0 ml/lit showed highest corrected mortality 95.00% at 72 hours followed by Embodiment 6@1.0 ml/lit. & Embodiment 10@1.0 ml/lit. showed 92.50% corrected mortality against Helicoverpa armigera. All the Embodiment (Combinations of phytochemicals) reported maximum Helicoverpa armigera mortality than the individual phytochemicals (depicted in FIG. 12).

### Example 26: The Effect of Plant Extracted Phytochemicals and its Combinations Against Spodoptera litura Under Controlled Environmental Condition

### Material and Methodology:

Insect Studied: Spodoptera litura (Collected culture from insectary section)
Insect Stage: 3^{rd} instar
Host plant selected: Cabbage plants having five leaf stage (For Spodoptera feeding)
No. of Treatments: 41
Replications: 4
No. of Insects/plants: 2 (placed on 3^{rd} & 4th leaf)
No. of plants/treatment: 10 plants
Insect acclimatization period: 24 hrs.
Solution for spray: 2 lit. spray solution of respective bio-pesticides was prepared.
Cage Size: 150×120×100 cm
Green House Temp.: 26±2° C.
Humidity: 75±5%
Observation Recorded: After 72 hrs. of application
Statistical Design Used: Completely Randomized Design Calculations:

$$\% Corrected Mortality = \frac{( \% Treated Mortality - \% Control Mortality )}{100 - \% Control Mortality} \times 100$$

### Results:

TABLE 26
The effect of plant extracted phytochemicals and
its combinations against Spodoptera litura.

| | | | | Total | | % |
|---|---|---|---|---|---|---|
| | | | | No. of dead | % | Corrected |
| Tr. | | Concentration | Dose | insect at | Mortality | Mortality |
| No. | Treatments | Range | (ml/gm/lit.) | 72 Hrs. | at 72 Hrs. | at 72 Hrs. |
| 1 | Camphor | 0.001 to 7% | 1 | 45.00 | 45.00 | 42.11 |
| 2 | Eugenol | 0.001 to 10% | 1 | 62.50 | 62.50 | 60.53 |
| 3 | Citral | 0.001 to 15% | 1 | 52.50 | 52.50 | 50.00 |
| 4 | Thymol | 0.001 to 13% | 1 | 65.00 | 65.00 | 63.16 |
| 5 | Piperine | 0.001 to 8% | 1 | 70.00 | 70.00 | 68.42 |
| 6 | Cuminaldehyde | 0.001 to 10% | 1 | 55.00 | 55.00 | 52.63 |
| 7 | Methyl chavicol | 0.001 to 9% | 1 | 62.50 | 62.50 | 60.53 |
| 8 | Total Alkaloid | 0.001 to 8% | 1 | 42.50 | 42.50 | 39.47 |
| | including | | | | | |
| | swainsonine | | | | | |
| 9 | Mixture of | 0.001 to 8% | 1 | 35.00 | 35.00 | 31.58 |
| | Essential oils and | | | | | |
| | oleoresin | | | | | |
| 10 | Parthenin | 0.001 to 7% | 1 | 27.50 | 27.50 | 23.68 |
| 11 | Essential oils and | 0.001 to 8% | 1 | 52.50 | 52.50 | 50.00 |
| | Total turmerones | | | | | |
| 12 | Carvacrol | 0.001 to 10% | 1 | 47.50 | 47.50 | 44.74 |
| 13 | D-limonene | 0.001 to 8% | 1 | 27.50 | 27.50 | 23.68 |
| 14 | Gingerol | 0.001 to 8% | 1 | 37.50 | 37.50 | 34.21 |
| 15 | β-Asarone | 0.001 to 9% | 1 | 55.00 | 55.00 | 52.63 |
| 16 | Menthol | 0.001 to 9% | 1 | 27.50 | 27.50 | 23.68 |
| 17 | Capsaicin | 0.001 to 8% | 1 | 47.50 | 47.50 | 44.74 |
| 18 | p-Cymene | 0.001 to 15% | 1 | 70.00 | 70.00 | 68.42 |
| 19 | Palmitic acid | 0.001 to 8% | 1 | 27.50 | 27.50 | 23.68 |
| 20 | Ellagic acid | 0.001 to 8% | 1 | 55.00 | 55.00 | 52.63 |
| 21 | 2-undecanone | 0.001 to 8% | 1 | 42.50 | 42.50 | 39.47 |
| 22 | Chavibetol | 0.001 to 7% | 1 | 44.00 | 44.00 | 41.05 |
| 23 | Thymoquinone | 0.001 to 8% | 1 | 42.50 | 42.50 | 39.47 |
| 24 | Berberine | 0.001 to 8% | 1 | 67.50 | 67.50 | 65.79 |
| 25 | Quaternary | 0.001 to 9% | 1 | 42.50 | 42.50 | 39.47 |
| | isoquinoline | | | | | |
| | alkaloids | | | | | |
| 26 | Alpha-pinene | 0.001 to 13% | 1 | 55.00 | 55.00 | 52.63 |
| 27 | 1,8 cineole | 0.001 to 7% | 1 | 70.00 | 70.00 | 68.42 |
| 28 | Camphene | 0.001 to 7% | 1 | 65.00 | 65.00 | 63.16 |
| 29 | Embodiment 1 | Combination of | 1 | 94.75 | 94.75 | 94.47 |
| | | Phytochemicals | | | | |
| 30 | Embodiment 2 | Combination of | 1 | 87.50 | 87.50 | 86.84 |
| | | Phytochemicals | | | | |
| 31 | Embodiment 3 | Combination of | 1 | 87.50 | 87.50 | 86.84 |
| | | Phytochemicals | | | | |
| 32 | Embodiment 4 | Combination of | 1 | 95.00 | 95.00 | 94.74 |
| | | Phytochemicals | | | | |
| 33 | Embodiment 5 | Combination of | 1 | 92.50 | 92.50 | 92.11 |
| | | Phytochemicals | | | | |
| 34 | Embodiment 6 | Combination of | 1 | 97.50 | 97.50 | 97.37 |
| | | Phytochemicals | | | | |
| 35 | Embodiment 7 | Combination of | 1 | 85.00 | 85.00 | 84.21 |
| | | Phytochemicals | | | | |
| 36 | Embodiment 8 | Combination of | 1 | 82.50 | 82.50 | 81.58 |
| | | Phytochemicals | | | | |
| 38 | Embodiment 9 | Combination of | 1 | 85.00 | 85.00 | 84.21 |
| | | Phytochemicals | | | | |
| 38 | Embodiment 10 | Combination of | 1 | 95.00 | 95.00 | 94.74 |
| | | Phytochemicals | | | | |
| 39 | Embodiment 11 | Combination of | 1 | 90.00 | 90.00 | 89.47 |
| | | Phytochemicals | | | | |
| 40 | Embodiment 12 | Combination of | 1 | 78.50 | 78.50 | 77.37 |
| | | Phytochemicals | | | | |
| 41 | Water Control | 100% | | 5.00 | 5.00 | 0.00 |

### Conclusion:

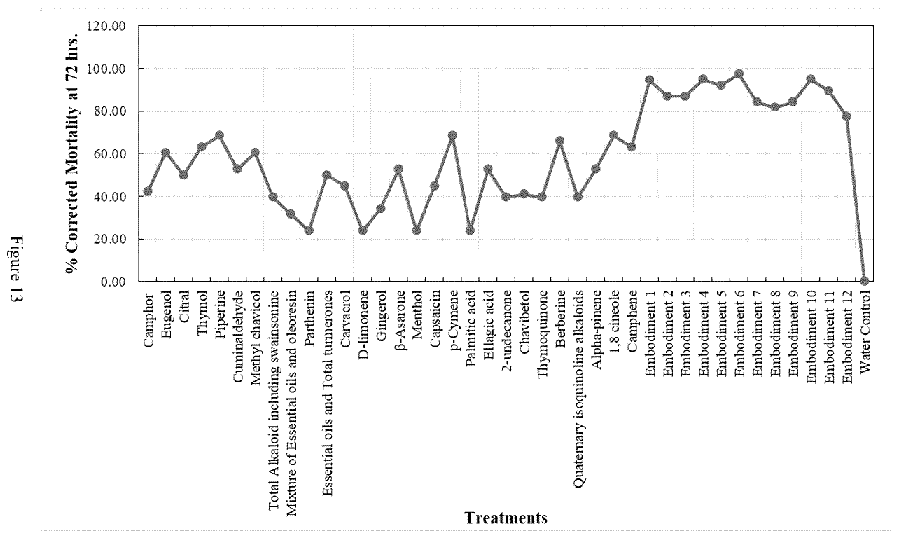

The bio-efficacy study revealed that Embodiment 6@1.0 ml/lit showed highest corrected mortality 97.37% at 72 hours followed by Embodiment 4@1.0 ml/lit. & Embodiment 10@1.0 ml/lit. showed 94.74% corrected mortality against Spodoptera litura. All the Embodiment (Combinations of phytochemicals) reported maximum Spodoptera litura mortality than the individual phytochemicals (depicted in FIG. 13).

### Example 27: The Effect of Plant Extracted Phytochemicals and its Combinations Against Thrips Under Greenhouse Condition

### Material and Methodology:

Insect Studied: Thrips (Collected culture from insectary section)
Insect Stage: Early nymphal stage
Host plant selected: Cotton plants having five leaf stage (For Thrips feeding)
No. of Treatments: 41
Replications: 4
No. of Insects/plants: 10 (placed on 3 to 4 leaves)
No. of plants/treatment: 10 plants
Insect acclimatization period: 24 hrs.
Solution for spray: 2 lit. spray solution of respective bio-pesticides was prepared.
Cage Size: 150×120×100 cm
Green House Temp.: 26±2° C.
Humidity: 75±5%
Observation Recorded: After 48 hrs. of application
Statistical Design Used: Completely Randomized Design
Calculations:

$$\% Corrected Mortality = \frac{( \% Treated Mortality - \% Control Mortality )}{100 - \% Control Mortality} \times 100$$

### Results:

TABLE 27
The effect of plant extracted phytochemicals and its combinations against thrips.

| | | | | Total | | % |
|---|---|---|---|---|---|---|
| | | | | No. of dead | % | Corrected |
| Tr. | | Concentration | Dose | insect at | Mortality | Mortality |
| No. | Treatments | Range | (ml/gm/lit.) | 48 Hrs. | at 48 Hrs. | at 48 Hrs. |
| 1 | Camphor | 0.001 to 7% | 1 | 42.50 | 42.50 | 36.11 |
| 2 | Eugenol | 0.001 to 10% | 1 | 27.50 | 27.50 | 19.44 |
| 3 | Citral | 0.001 to 15% | 1 | 57.50 | 57.50 | 52.78 |
| 4 | Thymol | 0.001 to 13% | 1 | 35.00 | 35.00 | 27.78 |
| 5 | Piperine | 0.001 to 8% | 1 | 32.50 | 32.50 | 25.00 |
| 6 | Cuminaldehyde | 0.001 to 10% | 1 | 40.00 | 40.00 | 33.33 |
| 7 | Methyl chavicol | 0.001 to 9% | 1 | 57.50 | 57.50 | 52.78 |
| 8 | Total Alkaloid | 0.001 to 8% | 1 | 67.50 | 67.50 | 63.89 |
| | including | | | | | |
| | swainsonine | | | | | |
| 9 | Mixture of | 0.001 to 8% | 1 | 62.50 | 62.50 | 58.33 |
| | Essential oils and | | | | | |
| | oleoresin | | | | | |
| 10 | Parthenin | 0.001 to 7% | 1 | 45.00 | 45.00 | 38.89 |
| 11 | Essential oils and | 0.001 to 8% | 1 | 47.50 | 47.50 | 41.67 |
| | Total turmerones | | | | | |
| 12 | Carvacrol | 0.001 to 10% | 1 | 32.50 | 32.50 | 25.00 |
| 13 | D-limonene | 0.001 to 8% | 1 | 37.50 | 37.50 | 30.56 |
| 14 | Gingerol | 0.001 to 8% | 1 | 30.00 | 30.00 | 22.22 |
| 15 | β-Asarone | 0.001 to 9% | 1 | 65.00 | 65.00 | 61.11 |
| 16 | Menthol | 0.001 to 9% | 1 | 72.50 | 72.50 | 69.44 |
| 17 | Capsaicin | 0.001 to 8% | 1 | 60.00 | 60.00 | 55.56 |
| 18 | p-Cymene | 0.001 to 15% | 1 | 57.50 | 57.50 | 52.78 |
| 19 | Palmitic acid | 0.001 to 8% | 1 | 40.00 | 40.00 | 33.33 |
| 20 | Ellagic acid | 0.001 to 8% | 1 | 32.50 | 32.50 | 25.00 |
| 21 | 2-undecanone | 0.001 to 8% | 1 | 47.50 | 47.50 | 41.67 |
| 22 | Chavibetol | 0.001 to 7% | 1 | 52.50 | 52.50 | 47.22 |
| 23 | Thymoquinone | 0.001 to 8% | 1 | 20.00 | 20.00 | 11.11 |
| 24 | Berberine | 0.001 to 8% | 1 | 67.50 | 67.50 | 63.89 |
| 25 | Quaternary | 0.001 to 9% | 1 | 35.00 | 35.00 | 27.78 |
| | isoquinoline | | | | | |
| | alkaloids | | | | | |
| 26 | Alpha-pinene | 0.001 to 13% | 1 | 42.50 | 42.50 | 36.11 |
| 27 | 1,8 cineole | 0.001 to 7% | 1 | 67.50 | 67.50 | 63.89 |
| 28 | Camphene | 0.001 to 7% | 1 | 50.00 | 50.00 | 44.44 |
| 29 | Embodiment 1 | Combination of | 1 | 82.50 | 82.50 | 80.56 |
| | | Phytochemicals | | | | |
| 30 | Embodiment 2 | Combination of | 1 | 85.00 | 85.00 | 83.33 |
| | | Phytochemicals | | | | |
| 31 | Embodiment 3 | Combination of | 1 | 82.50 | 82.50 | 80.56 |
| | | Phytochemicals | | | | |
| 32 | Embodiment 4 | Combination of | 1 | 92.50 | 92.50 | 91.67 |
| | | Phytochemicals | | | | |
| 33 | Embodiment 5 | Combination of | 1 | 97.50 | 97.50 | 97.22 |
| | | Phytochemicals | | | | |
| 34 | Embodiment 6 | Combination of | 1 | 90.00 | 90.00 | 88.89 |
| | | Phytochemicals | | | | |
| 35 | Embodiment 7 | Combination of | 1 | 82.50 | 82.50 | 80.56 |
| | | Phytochemicals | | | | |
| 36 | Embodiment 8 | Combination of | 1 | 82.50 | 82.50 | 80.56 |
| | | Phytochemicals | | | | |
| 38 | Embodiment 9 | Combination of | 1 | 95.00 | 95.00 | 94.44 |
| | | Phytochemicals | | | | |
| 38 | Embodiment 10 | Combination of | 1 | 92.50 | 92.50 | 91.67 |
| | | Phytochemicals | | | | |
| 39 | Embodiment 11 | Combination of | 1 | 90.00 | 90.00 | 88.89 |
| | | Phytochemicals | | | | |
| 40 | Embodiment 12 | Combination of | 1 | 87.50 | 87.50 | 86.11 |
| | | Phytochemicals | | | | |
| 41 | Water Control | 100% | | 10.00 | 10.00 | 0.00 |

### Conclusion:

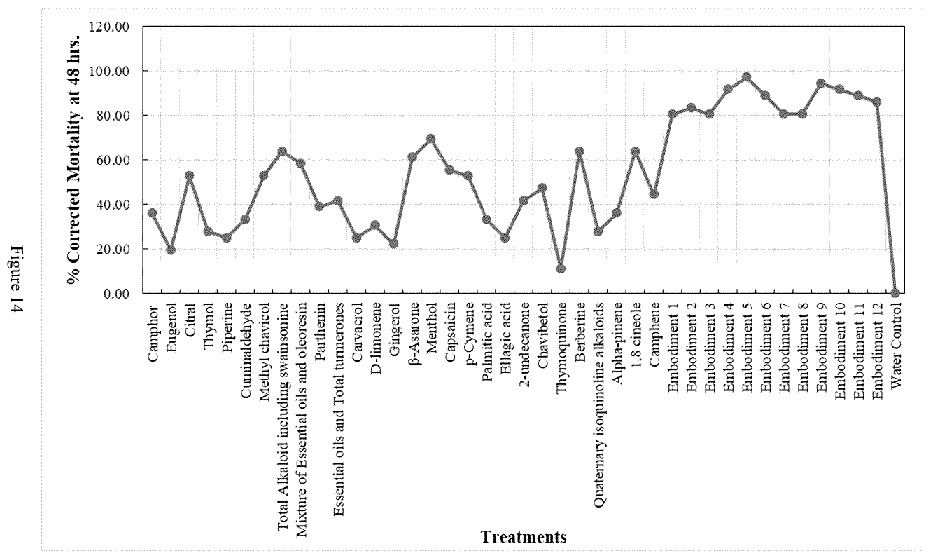

The bio-efficacy study revealed that Embodiment 5@1.0 ml/lit showed highest corrected mortality 97.22% at 48 hours followed by Embodiment 9@1.0 ml/lit. showed 94.44% corrected mortality against thrips. All the Embodiment (Combinations of phytochemicals) reported maximum thrips mortality than the individual phytochemicals (depicted in FIG. 14).

### Example 28: Effect of Plant Extracted Phytochemicals and its Combinations Against Alternaria Leaf Spot/Blight Under Controlled Environmental Conditions

### Material and Methodology:

Pathogen Studied: Alternaria alternata (Sample collected from Plant Pathology section)
Technique Used: Inoculation technique (Spray of spore suspensions)
Culture grows on: Potato dextrose broth (for Alternaria alternata growing)
Plant used: Tomato
Plant Age: 35 days after transplanting
Spray taken during: 7 days after spore inoculation (After proper symptoms development)
No. of Treatments: 41
Replications: 4
No. of Plants/treatments: 10
Green House Temp.: 26±2° C.
Humidity: 80±5%
Observation Recorded: After 5th and 7th Days of Application
Statistical Design Used: Completely Randomized Design
Calculations:

$$Disease Reduction over control ( \% ) = \frac{\begin{matrix}\% disease Intensity of Control Plot - \\ \% disease Intensity of Treated\end{matrix}}{\% disease Intensity of Control Plot}$$

### Results:

TABLE 28
The effect of plant extracted phytochemicals and its combinations against Alternaria alternata.

| | | | | | 5^{th} day | 7^{th} day | % Disease |
|---|---|---|---|---|---|---|---|
| Tr. | | Concentration | Dose | Pre | after | after | reduction |
| No. | Treatments | Range | (ml/gm/lit.) | Spraying | spray | spray | over Control |
| 1 | Camphor | 0.001 to 7% | 1 | 18.00 | 17.25 | 16.25 | 46.28 |
| 2 | Eugenol | 0.001 to 10% | 1 | 19.25 | 17.25 | 15.50 | 48.76 |
| 3 | Citral | 0.001 to 15% | 1 | 19.75 | 14.75 | 12.00 | 60.33 |
| 4 | Thymol | 0.001 to 13% | 1 | 20.00 | 15.75 | 11.75 | 61.16 |
| 5 | Piperine | 0.001 to 8% | 1 | 17.25 | 16.00 | 14.00 | 53.72 |
| 6 | Cuminaldehyde | 0.001 to 10% | 1 | 19.50 | 16.50 | 14.25 | 52.89 |
| 7 | Methyl | 0.001 to 9% | 1 | 18.25 | 17.00 | 15.50 | 48.76 |
| | chavicol | | | | | | |
| 8 | Total | 0.001 to 8% | 1 | 18.00 | 17.75 | 17.25 | 42.98 |
| | Alkaloid | | | | | | |
| | including | | | | | | |
| | swainsonine | | | | | | |
| 9 | Mixture of | 0.001 to 8% | 1 | 19.00 | 18.00 | 16.25 | 46.28 |
| | Essential oils | | | | | | |
| | and oleoresin | | | | | | |
| 10 | Parthenin | 0.001 to 7% | 1 | 18.00 | 17.50 | 17.00 | 43.80 |
| 11 | Essential oils | 0.001 to 8% | 1 | 18.75 | 17.25 | 16.50 | 45.45 |
| | and Total | | | | | | |
| | turmerones | | | | | | |
| 12 | Carvacrol | 0.001 to 10% | 1 | 20.25 | 17.00 | 15.75 | 47.93 |
| 13 | D-limonene | 0.001 to 8% | 1 | 17.75 | 17.25 | 15.00 | 50.41 |
| 14 | Gingerol | 0.001 to 8% | 1 | 19.25 | 15.50 | 11.50 | 61.98 |
| 15 | β-Asarone | 0.001 to 9% | 1 | 18.50 | 14.75 | 10.75 | 64.46 |
| 16 | Menthol | 0.001 to 9% | 1 | 20.25 | 15.50 | 13.25 | 56.20 |
| 17 | Capsaicin | 0.001 to 8% | 1 | 17.50 | 15.75 | 14.75 | 51.24 |
| 18 | p-Cymene | 0.001 to 15% | 1 | 17.25 | 16.25 | 15.75 | 47.93 |
| 19 | Palmitic acid | 0.001 to 8% | 1 | 20.50 | 19.25 | 15.00 | 50.41 |
| 20 | Ellagic acid | 0.001 to 8% | 1 | 20.75 | 15.75 | 10.25 | 66.12 |
| 21 | 2-undecanone | 0.001 to 8% | 1 | 18.50 | 16.00 | 12.50 | 58.68 |
| 22 | Chavibetol | 0.001 to 7% | 1 | 19.75 | 17.50 | 16.00 | 47.11 |
| 23 | Thymoquinone | 0.001 to 8% | 1 | 19.25 | 18.50 | 16.75 | 44.63 |
| 24 | Berberine | 0.001 to 8% | 1 | 18.25 | 16.00 | 14.25 | 52.89 |
| 25 | Quaternary | 0.001 to 9% | 1 | 19.00 | 14.75 | 13.75 | 54.55 |
| | isoquinoline | | | | | | |
| | alkaloids | | | | | | |
| 26 | Alpha-pinene | 0.001 to 13% | 1 | 18.50 | 16.75 | 17.50 | 42.15 |
| 27 | 1,8 cineole | 0.001 to 7% | 1 | 17.00 | 16.75 | 16.25 | 46.28 |
| 28 | Camphene | 0.001 to 7% | 1 | 20.00 | 18.75 | 17.50 | 42.15 |
| 29 | Embodiment 1 | Combination of | 1 | 18.00 | 10.25 | 5.25 | 82.64 |
| | | Phytochemicals | | | | | |
| 30 | Embodiment 2 | Combination of | 1 | 18.75 | 12.25 | 8.50 | 71.90 |
| | | Phytochemicals | | | | | |
| 31 | Embodiment 3 | Combination of | 1 | 19.25 | 10.50 | 6.25 | 79.34 |
| | | Phytochemicals | | | | | |
| 32 | Embodiment 4 | Combination of | 1 | 20.00 | 10.25 | 6.00 | 80.17 |
| | | Phytochemicals | | | | | |
| 33 | Embodiment 5 | Combination of | 1 | 20.25 | 11.75 | 6.50 | 78.51 |
| | | Phytochemicals | | | | | |
| 34 | Embodiment 6 | Combination of | 1 | 17.50 | 13.25 | 4.75 | 84.30 |
| | | Phytochemicals | | | | | |
| 35 | Embodiment 7 | Combination of | 1 | 17.00 | 12.00 | 7.25 | 76.03 |
| | | Phytochemicals | | | | | |
| 36 | Embodiment 8 | Combination of | 1 | 18.75 | 9.25 | 4.00 | 86.78 |
| | | Phytochemicals | | | | | |
| 38 | Embodiment 9 | Combination of | 1 | 19.25 | 10.75 | 7.00 | 76.86 |
| | | Phytochemicals | | | | | |
| 38 | Embodiment 10 | Combination of | 1 | 18.75 | 10.25 | 6.25 | 79.34 |
| | | Phytochemicals | | | | | |
| 39 | Embodiment 11 | Combination of | 1 | 20.25 | 10.00 | 7.75 | 74.38 |
| | | Phytochemicals | | | | | |
| 40 | Embodiment 12 | Combination of | 1 | 20.25 | 8.25 | 4.25 | 85.95 |
| | | Phytochemicals | | | | | |
| 41 | Water Control | 100% | | 17.25 | 21.50 | 30.25 | 0.00 |

### Conclusion:

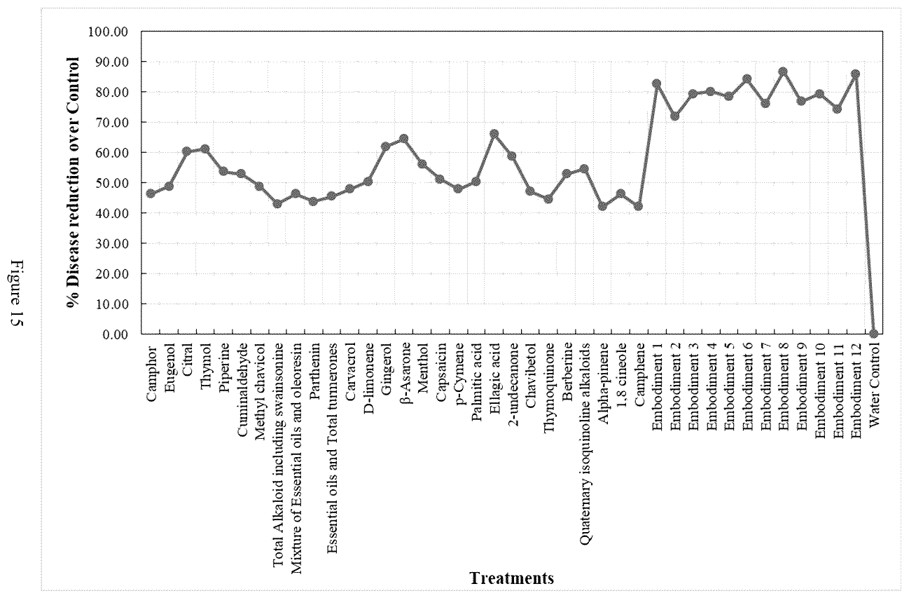

The bio-efficacy study revealed that Embodiment 8@1.0 ml/lit showed 86.78% disease reduction over control after 7 days followed by Embodiment 12@1.0 ml/lit. & Embodiment 6@1.0 ml/lit showed 85.95% & 84.30% disease reduction over control against Alternaria alternata, respectively. All the Embodiment (Combinations of phytochemicals) reported maximum percent inhibition of growth than the individual phytochemicals (depicted in FIG. 15).

### Example 29: Effect of Plant Extracted Phytochemicals and its Combinations Against Xanthomonas axanopodis pv. punicae

### Material and Methodology:

Pathogen Studied: Xanthomonas axanopodis pv. punicae
Technique Used: Inoculation technique (Spray of bacterial suspensions)
Culture grows on: Nutrient broth (for Xanthomonas axanopodis pv. punicae growing)
Plant used: Pomegranate
Plant Age: 1 year
Spray taken during: 30 days after bacterial inoculation (After proper symptoms development)
No. of Treatments: 41
Replications: 4
No. of Plants/treatments: 10
Green House Temp.: 28±2° C.
Humidity: 90±5%
Observation Recorded: After 5th and 7th Days of Application
Statistical Design Used: Completely Randomized Design
Calculations:

$$Disease Reduction over control ( \% ) = \frac{\begin{matrix}\% disease Intensity of Control Plot - \\ \% disease Intensity of Treated\end{matrix}}{\% disease Intensity of Control Plot}$$

### Results:

TABLE 29
The effect of plant extracted phytochemicals and its combinations
against Xanthomonas axanopodis pv. punicae

| | | | | | 5^{th} day | 7^{th} day | % Disease |
|---|---|---|---|---|---|---|---|
| Tr. | | Concentration | Dose | Pre | after | after | reduction |
| No. | Treatments | Range | (ml/gm/lit.) | Spraying | spray | spray | over Control |
| 1 | Camphor | 0.001 to 7% | 1 | 15.75 | 12.50 | 11.25 | 60.87 |
| 2 | Eugenol | 0.001 to 10% | 1 | 16.25 | 13.50 | 11.00 | 61.74 |
| 3 | Citral | 0.001 to 15% | 1 | 14.75 | 11.75 | 10.50 | 63.48 |
| 4 | Thymol | 0.001 to 13% | 1 | 14.25 | 12.25 | 10.25 | 64.35 |
| 5 | Piperine | 0.001 to 8% | 1 | 14.00 | 13.75 | 13.00 | 54.78 |
| 6 | Cuminaldehyde | 0.001 to 10% | 1 | 15.75 | 12.25 | 10.00 | 65.22 |
| 7 | Methyl | 0.001 to 9% | 1 | 16.00 | 13.75 | 10.25 | 64.35 |
| | chavicol | | | | | | |
| 8 | Total Alkaloid | 0.001 to 8% | 1 | 16.00 | 11.25 | 9.75 | 66.09 |
| | including | | | | | | |
| | swainsonine | | | | | | |
| 9 | Mixture of | 0.001 to 8% | 1 | 14.75 | 13.25 | 10.25 | 64.35 |
| | Essential oils | | | | | | |
| | and oleoresin | | | | | | |
| 10 | Parthenin | 0.001 to 7% | 1 | 15.25 | 14.25 | 12.75 | 55.65 |
| 11 | Essential oils | 0.001 to 8% | 1 | 16.00 | 13.50 | 10.00 | 65.22 |
| | and Total | | | | | | |
| | turmerones | | | | | | |
| 12 | Carvacrol | 0.001 to 10% | 1 | 16.75 | 12.25 | 11.50 | 60.00 |
| 13 | D-limonene | 0.001 to 8% | 1 | 16.50 | 13.75 | 10.75 | 62.61 |
| 14 | Gingerol | 0.001 to 8% | 1 | 14.50 | 12.50 | 10.50 | 63.48 |
| 15 | β-Asarone | 0.001 to 9% | 1 | 14.00 | 12.50 | 11.75 | 59.13 |
| 16 | Menthol | 0.001 to 9% | 1 | 16.75 | 12.00 | 7.00 | 75.65 |
| 17 | Capsaicin | 0.001 to 8% | 1 | 16.00 | 11.75 | 7.50 | 73.91 |
| 18 | p-Cymene | 0.001 to 15% | 1 | 14.50 | 10.75 | 7.25 | 74.78 |
| 19 | Palmitic acid | 0.001 to 8% | 1 | 16.25 | 11.75 | 8.75 | 69.57 |
| 20 | Ellagic acid | 0.001 to 8% | 1 | 15.50 | 12.75 | 12.00 | 58.26 |
| 21 | 2-undecanone | 0.001 to 8% | 1 | 15.00 | 12.50 | 8.75 | 69.57 |
| 22 | Chavibetol | 0.001 to 7% | 1 | 15.25 | 11.00 | 8.25 | 71.30 |
| 23 | Thymoquinone | 0.001 to 8% | 1 | 15.75 | 11.25 | 9.25 | 67.83 |
| 24 | Berberine | 0.001 to 8% | 1 | 16.00 | 12.25 | 9.50 | 66.96 |
| 25 | Quaternary | 0.001 to 9% | 1 | 16.25 | 15.25 | 14.00 | 51.30 |
| | isoquinoline | | | | | | |
| | alkaloids | | | | | | |
| 26 | Alpha-pinene | 0.001 to 13% | 1 | 15.00 | 15.00 | 14.25 | 50.43 |
| 27 | 1,8 cineole | 0.001 to 7% | 1 | 14.75 | 13.75 | 13.25 | 53.91 |
| 28 | Camphene | 0.001 to 7% | 1 | 16.25 | 14.25 | 13.50 | 53.04 |
| 29 | Embodiment 1 | Combination of | 1 | 16.25 | 11.50 | 6.25 | 78.26 |
| | | Phytochemicals | | | | | |
| 30 | Embodiment 2 | Combination of | 1 | 16.00 | 10.50 | 5.00 | 82.61 |
| | | Phytochemicals | | | | | |
| 31 | Embodiment 3 | Combination of | 1 | 16.00 | 9.00 | 4.25 | 85.22 |
| | | Phytochemicals | | | | | |
| 32 | Embodiment 4 | Combination of | 1 | 15.50 | 10.25 | 5.75 | 80.00 |
| | | Phytochemicals | | | | | |
| 33 | Embodiment 5 | Combination of | 1 | 16.00 | 8.75 | 4.00 | 86.09 |
| | | Phytochemicals | | | | | |
| 34 | Embodiment 6 | Combination of | 1 | 16.25 | 9.50 | 4.25 | 85.22 |
| | | Phytochemicals | | | | | |
| 35 | Embodiment 7 | Combination of | 1 | 14.25 | 10.75 | 3.75 | 86.96 |
| | | Phytochemicals | | | | | |
| 36 | Embodiment 8 | Combination of | 1 | 14.50 | 8.50 | 5.50 | 80.87 |
| | | Phytochemicals | | | | | |
| 38 | Embodiment 9 | Combination of | 1 | 15.50 | 8.75 | 5.00 | 82.61 |
| | | Phytochemicals | | | | | |
| 38 | Embodiment 10 | Combination of | 1 | 15.25 | 9.00 | 4.25 | 85.22 |
| | | Phytochemicals | | | | | |
| 39 | Embodiment 11 | Combination of | 1 | 15.75 | 9.50 | 5.75 | 80.00 |
| | | Phytochemicals | | | | | |
| 40 | Embodiment 12 | Combination of | 1 | 14.25 | 10.25 | 3.50 | 87.83 |
| | | Phytochemicals | | | | | |
| 41 | Water Control | 100% | | 15.00 | 21.75 | 28.75 | 0.00 |

### Conclusion:

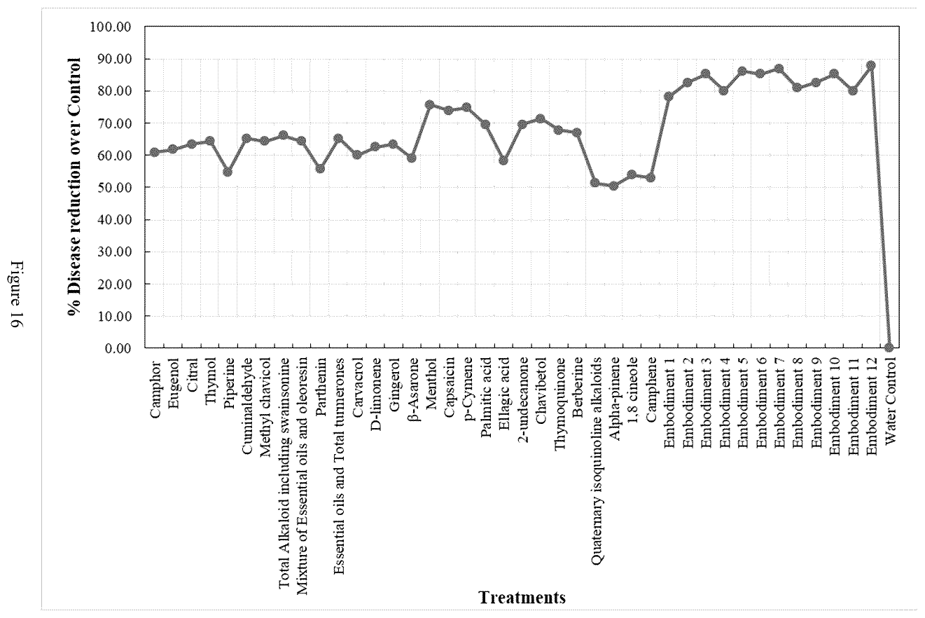

The bio-efficacy study revealed that Embodiment 12@1.0 ml/lit showed 87.83% disease reduction over control after 7 days followed by Embodiment 7@1.0 ml/lit. & Embodiment 5 @1.0 ml/lit showed 86.96% & 86.09% disease reduction over control against Xanthomonas axanopodis pv. punicae, respectively. All the Embodiment (Combinations of phytochemicals) reported maximum percent disease reduction than the individual phytochemicals (depicted in FIG. 16).

### Example 30: Response of Tomato Plants Against Plant Extracted Phytochemicals and its Combinations Under Greenhouse Condition

### Material and Methodology:

Plant Studied: Tomato
Selected plant age: 22 days after sowing
No. of Treatments: 41
Replications: 3
No. of sprays taken: One (2 days after seedling transplanting)
Water used for spray: 2 lit.
No. of Plants in each Treatment: 20
Material Used: Measuring Scale. Vernier Calliper & Apogee CCI meter
Observations Recorded on: 5th day & 10th day after application
Observations Recorded: Plant Height (cm). Stem Girth (mm), CCI (Chlorophyll Concentration Index) & Root Length (cm)
Calculations:

$$\% Increase over pre = ( ( Post / Pre ) \times 100 ) - 100$$

$$\% Increase over control = ( ( Post / Control ) \times 100 ) - 100$$

### Results:

TABLE 30
Effect of plant extracted phytochemicals and its combinations on morphology of tomato seedlings.

| | | | | Plant Height | | | | Stem Girth | | | |
|---|---|---|---|---|---|---|---|---|---|---|---|
| | | | | (cm) | | | % Increase | (mm) | | | % Increase |
| Sr. | | Concentration | Dose | | 5^{th} | 10^{th} | over pre | | 5^{th} | 10^{th} | over pre |
| No. | Treatments | Range | (ml/gm/lit.) | Pre | Day | Day | on 10^{th} Day | Pre | Day | Day | on 10^{th} Day |
| 1 | Camphor | 0.001 to 7% | 1 | 5.44 | 6.34 | 6.96 | 27.94 | 1.34 | 1.90 | 2.06 | 53.50 |
| 2 | Eugenol | 0.001 to 10% | 1 | 5.65 | 6.66 | 7.56 | 33.81 | 1.34 | 1.70 | 2.31 | 72.90 |
| 3 | Citral | 0.001 to 15% | 1 | 6.11 | 7.15 | 7.85 | 28.48 | 1.35 | 1.46 | 2.12 | 56.50 |
| 4 | Thymol | 0.001 to 13% | 1 | 5.84 | 6.81 | 7.62 | 30.48 | 1.57 | 1.90 | 2.53 | 61.42 |
| 5 | Piperine | 0.001 to 8% | 1 | 5.38 | 6.41 | 7.02 | 30.48 | 1.42 | 1.80 | 2.24 | 57.52 |
| 6 | Cuminaldehyde | 0.001 to 10% | 1 | 5.58 | 6.62 | 7.33 | 31.36 | 1.27 | 1.77 | 2.08 | 64.12 |
| 7 | Methyl | 0.001 to 9% | 1 | 6.12 | 7.16 | 7.86 | 28.43 | 1.35 | 1.50 | 2.10 | 55.56 |
| | chavicol | | | | | | | | | | |
| 8 | Total | 0.001 to 8% | 1 | 6.09 | 7.08 | 7.83 | 28.57 | 1.31 | 1.59 | 2.03 | 54.80 |
| | Alkaloid | | | | | | | | | | |
| | including | | | | | | | | | | |
| | swainsonine | | | | | | | | | | |
| 9 | Mixture of | 0.001 to 8% | 1 | 5.55 | 6.64 | 7.41 | 33.51 | 1.34 | 1.48 | 2.15 | 59.89 |
| | Essential | | | | | | | | | | |
| | oils and | | | | | | | | | | |
| | oleoresin | | | | | | | | | | |
| 10 | Parthenin | 0.001 to 7% | 1 | 5.61 | 6.64 | 7.29 | 29.95 | 1.43 | 1.66 | 2.22 | 55.53 |
| 11 | Essential | 0.001 to 8% | 1 | 5.82 | 6.91 | 7.42 | 27.49 | 1.31 | 1.99 | 2.08 | 58.94 |
| | oils and | | | | | | | | | | |
| | Total | | | | | | | | | | |
| | turmerones | | | | | | | | | | |
| 12 | Carvacrol | 0.001 to 10% | 1 | 5.45 | 6.38 | 7.23 | 32.66 | 1.44 | 2.05 | 2.35 | 63.42 |
| 13 | D-limonene | 0.001 to 8% | 1 | 5.52 | 6.44 | 7.56 | 36.96 | 1.30 | 1.98 | 2.21 | 69.48 |
| 14 | Gingerol | 0.001 to 8% | 1 | 5.62 | 6.45 | 7.59 | 35.05 | 1.35 | 1.92 | 2.31 | 70.52 |
| 15 | β-Asarone | 0.001 to 9% | 1 | 5.67 | 6.72 | 7.24 | 27.69 | 1.57 | 1.72 | 2.45 | 56.32 |
| 16 | Menthol | 0.001 to 9% | 1 | 5.64 | 6.78 | 7.18 | 27.30 | 1.42 | 1.48 | 2.19 | 54.01 |
| 17 | Capsaicin | 0.001 to 8% | 1 | 6.08 | 7.11 | 7.86 | 29.28 | 1.27 | 1.92 | 2.01 | 58.60 |
| 18 | p-Cymene | 0.001 to 15% | 1 | 6.12 | 7.24 | 7.84 | 28.10 | 1.35 | 1.82 | 2.06 | 52.59 |
| 19 | Palmitic acid | 0.001 to 8% | 1 | 6.05 | 7.14 | 8.54 | 41.16 | 1.31 | 1.79 | 2.32 | 76.92 |
| 20 | Ellagic acid | 0.001 to 8% | 1 | 6.01 | 7.09 | 8.18 | 36.11 | 1.34 | 1.54 | 2.19 | 62.87 |
| 21 | 2-undecanone | 0.001 to 8% | 1 | 5.38 | 6.48 | 7.56 | 40.52 | 1.43 | 1.61 | 2.40 | 68.29 |
| 22 | Chavibetol | 0.001 to 7% | 1 | 6.11 | 7.26 | 8.34 | 36.50 | 1.40 | 1.49 | 2.25 | 60.71 |
| 23 | Thymoquinone | 0.001 to 8% | 1 | 5.44 | 6.58 | 7.69 | 41.36 | 1.32 | 1.68 | 2.30 | 74.24 |
| 24 | Berberine | 0.001 to 8% | 1 | 5.65 | 6.78 | 7.34 | 29.91 | 1.46 | 2.01 | 2.25 | 54.11 |
| 25 | Quaternary | 0.001 to 9% | 1 | 5.64 | 6.75 | 7.92 | 40.43 | 1.58 | 2.07 | 2.63 | 66.46 |
| | isoquinoline | | | | | | | | | | |
| | alkaloids | | | | | | | | | | |
| 26 | Alpha- | 0.001 to 13% | 1 | 6.12 | 7.24 | 7.74 | 26.47 | 1.43 | 2.01 | 2.22 | 55.24 |
| | pinene | | | | | | | | | | |
| 27 | 1,8 cineole | 0.001 to 7% | 1 | 5.81 | 6.84 | 7.53 | 29.60 | 1.36 | 1.74 | 2.16 | 58.82 |
| 28 | Camphene | 0.001 to 7% | 1 | 5.75 | 6.82 | 7.34 | 27.65 | 1.29 | 1.49 | 2.07 | 60.47 |
| 29 | Embodiment 1 | Combination of | 1 | 5.65 | 7.78 | 9.68 | 71.33 | 1.24 | 1.73 | 2.36 | 90.32 |
| | | Phytochemicals | | | | | | | | | |
| 30 | Embodiment 2 | Combination of | 1 | 6.08 | 8.18 | 10.9 | 79.28 | 1.42 | 1.68 | 2.74 | 92.96 |
| | | Phytochemicals | | | | | | | | | |
| 31 | Embodiment 3 | Combination of | 1 | 5.81 | 7.86 | 9.91 | 70.57 | 1.45 | 1.48 | 2.72 | 87.59 |
| | | Phytochemicals | | | | | | | | | |
| 32 | Embodiment 4 | Combination of | 1 | 5.62 | 7.72 | 9.71 | 72.78 | 1.32 | 1.52 | 2.61 | 97.73 |
| | | Phytochemicals | | | | | | | | | |
| 33 | Embodiment 5 | Combination of | 1 | 5.43 | 7.56 | 9.91 | 82.50 | 1.28 | 1.65 | 2.54 | 98.44 |
| | | Phytochemicals | | | | | | | | | |
| 34 | Embodiment 6 | Combination of | 1 | 5.39 | 7.61 | 9.72 | 80.33 | 1.41 | 1.75 | 2.64 | 87.23 |
| | | Phytochemicals | | | | | | | | | |
| 35 | Embodiment 7 | Combination of | 1 | 5.66 | 7.75 | 9.85 | 74.03 | 1.38 | 1.64 | 2.52 | 82.61 |
| | | Phytochemicals | | | | | | | | | |
| 36 | Embodiment 8 | Combination of | 1 | 6.02 | 7.14 | 9.24 | 53.49 | 1.43 | 1.56 | 2.61 | 82.52 |
| | | Phytochemicals | | | | | | | | | |
| 38 | Embodiment 9 | Combination of | 1 | 5.81 | 7.92 | 9.98 | 71.77 | 1.37 | 1.58 | 2.64 | 92.70 |
| | | Phytochemicals | | | | | | | | | |
| 38 | Embodiment 10 | Combination of | 1 | 6.04 | 8.12 | 10.24 | 69.54 | 1.31 | 1.44 | 2.53 | 93.13 |
| | | Phytochemicals | | | | | | | | | |
| 39 | Embodiment 11 | Combination of | 1 | 6.11 | 8.24 | 10.54 | 72.50 | 1.33 | 1.48 | 2.51 | 88.72 |
| | | Phytochemicals | | | | | | | | | |
| 40 | Embodiment 12 | Combination of | 1 | 5.92 | 7.98 | 9.95 | 68.07 | 1.46 | 1.5 | 2.76 | 89.04 |
| | | Phytochemicals | | | | | | | | | |
| 41 | Water Control | 100% | | 5.67 | 6.11 | 7.04 | 24.16 | 1.3 | 1.42 | 1.89 | 45.38 |

TABLE 31
Effect of plant extracted phytochemicals and its combinations
on chlorophyll index and root length of tomato seedlings.

| | | | | | | | | Root | |
|---|---|---|---|---|---|---|---|---|---|
| | | | | CCI | | | % Increase | Length | % Increase |
| Sr. | | Concentration | Dose | | 5^{th} | 10^{th} | over pre | (cm) | over |
| No. | Treatments | Range | (ml/gm/lit.) | Pre | Day | Day | on 10^{th} Day | 10^{th} Day | control |
| 1 | Camphor | 0.001 to 7% | 1 | 11.70 | 13.64 | 14.82 | 26.67 | 3.58 | 7.76 |
| 2 | Eugenol | 0.001 to 10% | 1 | 11.50 | 13.74 | 15.48 | 34.61 | 4.37 | 31.25 |
| 3 | Citral | 0.001 to 15% | 1 | 11.20 | 13.34 | 14.25 | 27.23 | 4.16 | 25.08 |
| 4 | Thymol | 0.001 to 13% | 1 | 12.55 | 14.12 | 15.42 | 22.87 | 4.82 | 44.89 |
| 5 | Piperine | 0.001 to 8% | 1 | 12.12 | 13.89 | 14.63 | 20.71 | 3.93 | 18.18 |
| 6 | Cuminaldehyde | 0.001 to 10% | 1 | 12.54 | 13.64 | 14.65 | 16.83 | 3.81 | 14.59 |
| 7 | Methyl | 0.001 to 9% | 1 | 12.37 | 14.23 | 15.23 | 23.12 | 4.13 | 24.05 |
| | chavicol | | | | | | | | |
| 8 | Total | 0.001 to 8% | 1 | 11.10 | 13.52 | 14.52 | 30.81 | 3.97 | 19.46 |
| | Alkaloid | | | | | | | | |
| | including | | | | | | | | |
| | swainsonine | | | | | | | | |
| 9 | Mixture of | 0.001 to 8% | 1 | 11.14 | 13.64 | 14.98 | 34.47 | 3.98 | 19.74 |
| | Essential | | | | | | | | |
| | oils and | | | | | | | | |
| | oleoresin | | | | | | | | |
| 10 | Parthenin | 0.001 to 7% | 1 | 12.32 | 13.95 | 14.87 | 20.70 | 4.05 | 21.63 |
| 11 | Essential | 0.001 to 8% | 1 | 12.52 | 14.25 | 15.47 | 23.56 | 3.86 | 15.99 |
| | oils and | | | | | | | | |
| | Total | | | | | | | | |
| | turmerones | | | | | | | | |
| 12 | Carvacrol | 0.001 to 10% | 1 | 11.87 | 13.62 | 15.87 | 33.70 | 4.25 | 27.69 |
| 13 | D-limonene | 0.001 to 8% | 1 | 11.59 | 13.66 | 15.54 | 34.08 | 4.18 | 25.57 |
| 14 | Gingerol | 0.001 to 8% | 1 | 12.65 | 14.63 | 16.87 | 33.36 | 4.38 | 31.77 |
| 15 | β-Asarone | 0.001 to 9% | 1 | 11.28 | 13.45 | 14.56 | 29.08 | 4.43 | 33.31 |
| 16 | Menthol | 0.001 to 9% | 1 | 11.26 | 13.48 | 14.35 | 27.44 | 3.93 | 18.18 |
| 17 | Capsaicin | 0.001 to 8% | 1 | 12.64 | 14.66 | 15.42 | 21.99 | 3.95 | 18.74 |
| 18 | p-Cymene | 0.001 to 15% | 1 | 12.58 | 14.52 | 15.68 | 24.64 | 4.04 | 21.38 |
| 19 | Palmitic acid | 0.001 to 8% | 1 | 11.16 | 13.26 | 14.89 | 33.42 | 4.95 | 48.91 |
| 20 | Ellagic acid | 0.001 to 8% | 1 | 11.29 | 13.39 | 14.56 | 28.96 | 4.48 | 34.64 |
| 21 | 2-undecanone | 0.001 to 8% | 1 | 11.63 | 13.42 | 15.23 | 30.95 | 4.54 | 36.48 |
| 22 | Chavibetol | 0.001 to 7% | 1 | 12.54 | 14.68 | 16.58 | 32.22 | 4.69 | 41.03 |
| 23 | Thymoquinone | 0.001 to 8% | 1 | 12.4 | 14.21 | 16.21 | 30.73 | 4.42 | 32.93 |
| 24 | Berberine | 0.001 to 8% | 1 | 12.55 | 14.53 | 15.67 | 24.86 | 4.13 | 24.12 |
| 25 | Quaternary | 0.001 to 9% | 1 | 12.57 | 14.95 | 15.62 | 24.26 | 5.21 | 56.55 |
| | isoquinoline | | | | | | | | |
| | alkaloids | | | | | | | | |
| 26 | Alpha- | 0.001 to 13% | 1 | 11.44 | 13.65 | 14.32 | 25.17 | 4.30 | 29.14 |
| | pinene | | | | | | | | |
| 27 | 1,8 cineole | 0.001 to 7% | 1 | 11.54 | 13.55 | 14.55 | 26.08 | 4.07 | 22.24 |
| 28 | Camphene | 0.001 to 7% | 1 | 11.85 | 13.99 | 14.95 | 26.16 | 3.80 | 14.19 |
| 29 | Embodiment 1 | Combination of | 1 | 11.82 | 14.14 | 17.24 | 45.85 | 5.71 | 71.69 |
| | | Phytochemicals | | | | | | | |
| 30 | Embodiment 2 | Combination of | 1 | 11.76 | 14.23 | 17.85 | 51.79 | 7.47 | 124.46 |
| | | Phytochemicals | | | | | | | |
| 31 | Embodiment 3 | Combination of | 1 | 11.63 | 14.55 | 17.55 | 50.90 | 6.74 | 102.59 |
| | | Phytochemicals | | | | | | | |
| 32 | Embodiment 4 | Combination of | 1 | 12.24 | 15.86 | 17.89 | 46.16 | 6.34 | 90.47 |
| | | Phytochemicals | | | | | | | |
| 33 | Embodiment 5 | Combination of | 1 | 12.54 | 15.42 | 17.45 | 39.15 | 6.29 | 89.18 |
| | | Phytochemicals | | | | | | | |
| 34 | Embodiment 6 | Combination of | 1 | 11.73 | 14.88 | 17.21 | 46.72 | 6.42 | 92.86 |
| | | Phytochemicals | | | | | | | |
| 35 | Embodiment 7 | Combination of | 1 | 11.44 | 14.87 | 17.25 | 50.79 | 6.21 | 86.55 |
| | | Phytochemicals | | | | | | | |
| 36 | Embodiment 8 | Combination of | 1 | 12.25 | 15.98 | 17.88 | 45.96 | 6.03 | 81.25 |
| | | Phytochemicals | | | | | | | |
| 38 | Embodiment 9 | Combination of | 1 | 12.58 | 15.63 | 17.98 | 42.93 | 6.59 | 98.02 |
| | | Phytochemicals | | | | | | | |
| 38 | Embodiment 10 | Combination of | 1 | 12.45 | 15.66 | 17.86 | 43.45 | 6.48 | 94.71 |
| | | Phytochemicals | | | | | | | |
| 39 | Embodiment 11 | Combination of | 1 | 11.89 | 14.67 | 17.24 | 45.00 | 6.61 | 98.83 |
| | | Phytochemicals | | | | | | | |
| 40 | Embodiment 12 | Combination of | 1 | 12.25 | 14.95 | 18.56 | 51.51 | 6.87 | 106.39 |
| | | Phytochemicals | | | | | | | |
| 41 | Water Control | 100% | | 12.39 | 13.26 | 14.88 | 20.10 | 3.33 | 0.00 |

### Conclusion:

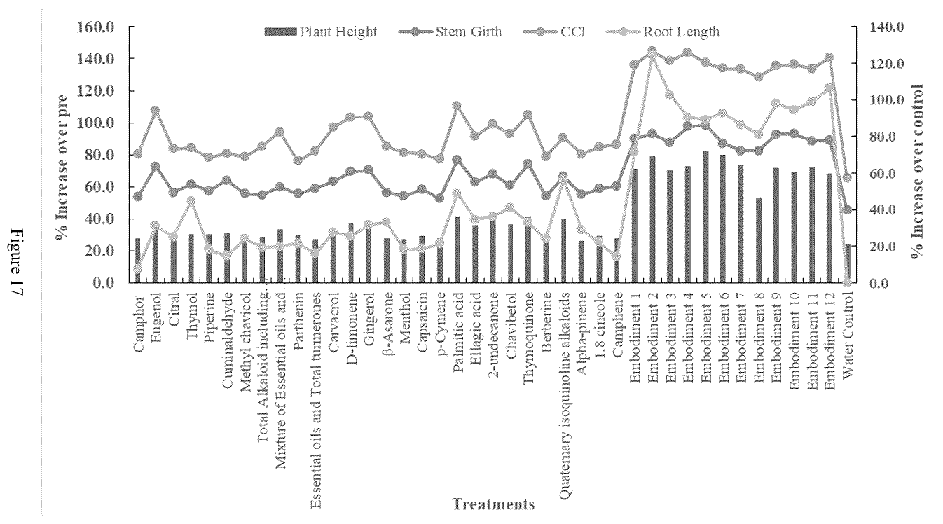

1. The data on tomato plant height reported that the Embodiment 5@1.0 ml/lit. dose showed 82.50% plant height improvement followed by Embodiment 6@1.0 ml/lit. 80.33% & Embodiment 2@1.0 ml/lit. 79.82%.
2. The data on tomato stem girth reported that the Embodiment 5@1.0 ml/lit. dose showed 98.44% stem girth improvement followed by Embodiment 4@1.0 ml/lit. 97.73% & Embodiment 10 @ 1.0 ml/lit. 93.13%.
3. Among the data of root length, the Embodiment 2@1.0 ml/lit. dose showed 124.98% root length improvement followed by Embodiment 12@1.0 ml/lit. 106.39% & Embodiment 3 @ 1.0 ml/lit. 102.59%.
4. The chlorophyll concentration index (CCI) also changes as per the treatments exposed, the Embodiment 2@1.0 ml/lit. dose showed 51.79% chlorophyll index improvement followed by Embodiment 12 @ 1.0 ml/lit. 51.51% & Embodiment 3@1.0 ml/lit. 50.90%.
5. All the Embodiment (Combinations of phytochemicals) reported maximum morphology improvement than the individual phytochemicals (as depicted in FIG. 17).

### Example 31: Response of Chili Plants Against Plant Extracted Phytochemicals and its Combinations Under Greenhouse Condition

### Material and Methodology:

Plant Studied: Chili
Selected plant age: 25 days after sowing
No. of Treatments: 41
Replications: 3
No. of sprays taken: One (2 days after seedling transplanting)
Water used for spray: 2 lit.
No. of Plants in each Treatment: 20
Material Used: Measuring Scale, Vernier Calliper & Apogee CCI meter
Observations Recorded on: 5th day & 10th day after application
Observations Recorded: Plant Height (cm), Stem Girth (mm), CCI (Chlorophyll Concentration Index) & Root Length (cm)
Calculations:

$$\% Increase over pre = ( ( Post / Pre ) \times 100 ) - 100$$

$$\% Increase over control = ( ( Post / Control \times 100 ) - 100$$

### Results:

TABLE 32
Effect of plant extracted phytochemicals and its combinations on morphology of chili seedlings.

| | | | | Plant Height | | | | Stem Girth | | | |
|---|---|---|---|---|---|---|---|---|---|---|---|
| | | | | (cm) | | | % Increase | (mm) | | | % Increase |
| Sr. | | Concentration | Dose | | 5^{th} | 10^{th} | over pre | 5^{th} | 10^{th} | | over pre |
| No. | Treatments | Range | (ml/gm/lit.) | Pre | Day | Day | on 10^{th} Day | Day | Day | 10^{th} | on 10^{th} Day |
| 1 | Camphor | 0.001 to 7% | 1 | 4.03 | 5.70 | 6.30 | 56.20 | 1.23 | 1.66 | 1.78 | 44.32 |
| 2 | Eugenol | 0.001 to 10% | 1 | 4.57 | 6.53 | 7.59 | 66.08 | 1.35 | 1.84 | 2.09 | 54.59 |
| 3 | Citral | 0.001 to 15% | 1 | 4.47 | 6.30 | 6.79 | 52.01 | 1.37 | 1.78 | 1.90 | 38.62 |
| 4 | Thymol | 0.001 to 13% | 1 | 4.60 | 6.13 | 7.27 | 58.04 | 1.25 | 1.87 | 1.89 | 51.36 |
| 5 | Piperine | 0.001 to 8% | 1 | 4.60 | 6.30 | 7.12 | 54.78 | 1.16 | 1.82 | 1.62 | 39.49 |
| 6 | Cuminaldehyde | 0.001 to 10% | 1 | 4.27 | 5.77 | 6.40 | 50.00 | 1.30 | 1.74 | 1.82 | 40.41 |
| 7 | Methyl | 0.001 to 9% | 1 | 4.30 | 5.97 | 6.21 | 44.42 | 1.25 | 1.65 | 1.82 | 45.91 |
| | chavicol | | | | | | | | | | |
| 8 | Total | 0.001 to 8% | 1 | 3.67 | 5.07 | 5.47 | 49.18 | 1.21 | 1.73 | 1.68 | 38.84 |
| | Alkaloid | | | | | | | | | | |
| | including | | | | | | | | | | |
| | swainsonine | | | | | | | | | | |
| 9 | Mixture of | 0.001 to 8% | 1 | 3.90 | 5.77 | 6.25 | 60.26 | 1.28 | 1.76 | 1.81 | 40.80 |
| | Essential | | | | | | | | | | |
| | oils and | | | | | | | | | | |
| | oleoresin | | | | | | | | | | |
| 10 | Parthenin | 0.001 to 7% | 1 | 4.37 | 6.13 | 6.65 | 52.29 | 1.35 | 1.76 | 1.87 | 38.18 |
| 11 | Essential | 0.001 to 8% | 1 | 5.20 | 7.03 | 7.54 | 45.00 | 1.41 | 1.70 | 1.99 | 41.13 |
| | oils and | | | | | | | | | | |
| | Total | | | | | | | | | | |
| | turmerones | | | | | | | | | | |
| 12 | Carvacrol | 0.001 to 10% | 1 | 4.57 | 6.33 | 7.57 | 65.77 | 1.33 | 1.64 | 1.98 | 49.25 |
| 13 | D-limonene | 0.001 to 8% | 1 | 4.90 | 6.97 | 8.24 | 68.16 | 1.25 | 1.63 | 2.00 | 60.00 |
| 14 | Gingerol | 0.001 to 8% | 1 | 4.05 | 5.95 | 6.65 | 64.20 | 1.20 | 1.68 | 1.74 | 45.00 |
| 15 | β-Asarone | 0.001 to 9% | 1 | 5.02 | 5.70 | 7.61 | 51.59 | 1.31 | 1.82 | 1.84 | 40.46 |
| 16 | Menthol | 0.001 to 9% | 1 | 4.49 | 6.48 | 6.52 | 45.21 | 1.18 | 1.76 | 1.68 | 42.37 |
| 17 | Capsaicin | 0.001 to 8% | 1 | 4.6 | 6.30 | 6.59 | 43.26 | 1.27 | 1.85 | 1.82 | 43.31 |
| 18 | p-Cymene | 0.001 to 15% | 1 | 4.29 | 6.13 | 6.48 | 51.05 | 1.39 | 1.72 | 1.95 | 40.29 |
| 19 | Palmitic acid | 0.001 to 8% | 1 | 4.32 | 6.30 | 7.3 | 68.98 | 1.31 | 1.67 | 2.08 | 58.78 |
| 20 | Ellagic acid | 0.001 to 8% | 1 | 3.69 | 5.77 | 6 | 62.60 | 1.25 | 1.71 | 1.89 | 51.20 |
| 21 | 2-undecanone | 0.001 to 8% | 1 | 3.92 | 5.97 | 6.59 | 68.11 | 1.32 | 1.74 | 2.12 | 60.61 |
| 22 | Chavibetol | 0.001 to 7% | 1 | 4.39 | 5.07 | 6.98 | 59.00 | 1.32 | 1.71 | 1.92 | 45.45 |
| 23 | Thymoquinone | 0.001 to 8% | 1 | 4.22 | 5.77 | 6.89 | 63.27 | 1.27 | 1.62 | 2.00 | 57.48 |
| 24 | Berberine | 0.001 to 8% | 1 | 4.59 | 6.15 | 6.89 | 50.11 | 1.32 | 1.65 | 1.85 | 40.15 |
| 25 | Quaternary | 0.001 to 9% | 1 | 4.62 | 7.05 | 7.59 | 64.29 | 1.29 | 1.64 | 1.91 | 48.06 |
| | isoquinoline | | | | | | | | | | |
| | alkaloids | | | | | | | | | | |
| 26 | Alpha- | 0.001 to 13% | 1 | 4.31 | 6.35 | 6.54 | 51.74 | 1.22 | 1.61 | 1.73 | 41.80 |
| | pinene | | | | | | | | | | |
| 27 | 1,8 cineole | 0.001 to 7% | 1 | 5.04 | 6.99 | 7.54 | 49.60 | 1.27 | 1.74 | 1.84 | 44.88 |
| 28 | Camphene | 0.001 to 7% | 1 | 3.94 | 5.97 | 6.21 | 57.61 | 1.21 | 1.71 | 1.74 | 43.80 |
| 29 | Embodiment 1 | Combination of | 1 | 4.34 | 5.72 | 7.89 | 81.80 | 1.22 | 1.72 | 2.02 | 65.57 |
| | | Phytochemicals | | | | | | | | | |
| 30 | Embodiment 2 | Combination of | 1 | 4.45 | 6.55 | 7.82 | 75.73 | 1.35 | 1.66 | 2.24 | 65.93 |
| | | Phytochemicals | | | | | | | | | |
| 31 | Embodiment 3 | Combination of | 1 | 3.79 | 6.32 | 7.21 | 90.24 | 1.33 | 1.78 | 2.29 | 72.18 |
| | | Phytochemicals | | | | | | | | | |
| 32 | Embodiment 4 | Combination of | 1 | 3.72 | 6.15 | 7.11 | 91.13 | 1.42 | 1.67 | 2.41 | 69.72 |
| | | Phytochemicals | | | | | | | | | |
| 33 | Embodiment 5 | Combination of | 1 | 4.05 | 6.32 | 7.86 | 94.07 | 1.41 | 1.66 | 2.34 | 65.96 |
| | | Phytochemicals | | | | | | | | | |
| 34 | Embodiment 6 | Combination of | 1 | 4.11 | 5.79 | 7.83 | 90.51 | 1.35 | 1.78 | 2.45 | 81.48 |
| | | Phytochemicals | | | | | | | | | |
| 35 | Embodiment 7 | Combination of | 1 | 4.28 | 6.01 | 7.79 | 82.01 | 1.38 | 1.84 | 2.41 | 74.64 |
| | | Phytochemicals | | | | | | | | | |
| 36 | Embodiment 8 | Combination of | 1 | 3.88 | 5.09 | 7.48 | 92.78 | 1.41 | 1.87 | 2.35 | 66.67 |
| | | Phytochemicals | | | | | | | | | |
| 38 | Embodiment 9 | Combination of | 1 | 3.59 | 5.79 | 6.95 | 93.59 | 1.42 | 1.66 | 2.38 | 67.61 |
| | | Phytochemicals | | | | | | | | | |
| 38 | Embodiment 10 | Combination of | 1 | 3.62 | 6.15 | 7.02 | 93.92 | 1.31 | 1.62 | 2.48 | 89.31 |
| | | Phytochemicals | | | | | | | | | |
| 39 | Embodiment 11 | Combination of | 1 | 3.45 | 5.85 | 6.45 | 86.96 | 1.33 | 1.64 | 2.45 | 84.21 |
| | | Phytochemicals | | | | | | | | | |
| 40 | Embodiment 12 | Combination of | 1 | 3.68 | 5.87 | 6.64 | 80.43 | 1.35 | 1.69 | 2.65 | 96.30 |
| | | Phytochemicals | | | | | | | | | |
| 41 | Water Control | 100% | | 4.02 | 5.12 | 5.71 | 42.04 | 1.34 | 1.68 | 1.84 | 37.31 |

TABLE 33
Effect of plant extracted phytochemicals and its combinations
on chlorophyll index and root length of chili seedlings.

| | | | | | | | | Root | |
|---|---|---|---|---|---|---|---|---|---|
| | | | | CCI | | | % Increase | Lenght | % Increase |
| Sr. | | Concentration | Dose | | 5^{th} | 10^{th} | over pre | (cm) | over |
| No. | Treatments | Range | (ml/gm/lit.) | Pre | Day | Day | on 10^{th} Day | 10^{th} Day | control |
| 1 | Camphor | 0.001 to 7% | 1 | 10.50 | 11.80 | 13.21 | 25.81 | 3.47 | 26.68 |
| 2 | Eugenol | 0.001 to 10% | 1 | 10.10 | 13.40 | 15.48 | 53.27 | 4.16 | 52.07 |
| 3 | Citral | 0.001 to 15% | 1 | 8.60 | 11.02 | 12.02 | 39.77 | 3.13 | 14.22 |
| 4 | Thymol | 0.001 to 13% | 1 | 8.45 | 13.80 | 14.85 | 75.74 | 3.77 | 37.87 |
| 5 | Piperine | 0.001 to 8% | 1 | 10.24 | 13.30 | 14.2 | 38.67 | 3.25 | 18.81 |
| 6 | Cuminaldehyde | 0.001 to 10% | 1 | 10.29 | 12.10 | 13.9 | 35.08 | 3.12 | 13.94 |
| 7 | Methyl | 0.001 to 9% | 1 | 10.90 | 12.70 | 15.1 | 38.53 | 3.11 | 13.83 |
| | chavicol | | | | | | | | |
| 8 | Total | 0.001 to 8% | 1 | 8.90 | 13.20 | 13.87 | 55.84 | 3.04 | 10.93 |
| | Alkaloid | | | | | | | | |
| | including | | | | | | | | |
| | swainsonine | | | | | | | | |
| 9 | Mixture of | 0.001 to 8% | 1 | 9.60 | 15.10 | 16 | 66.67 | 3.48 | 27.35 |
| | Essential | | | | | | | | |
| | oils and | | | | | | | | |
| | oleoresin | | | | | | | | |
| 10 | Parthenin | 0.001 to 7% | 1 | 9.10 | 14.50 | 15.87 | 74.40 | 3.12 | 14.01 |
| 11 | Essential | 0.001 to 8% | 1 | 9.50 | 15.90 | 18 | 89.47 | 2.97 | 8.55 |
| | oils and | | | | | | | | |
| | Total | | | | | | | | |
| | turmerones | | | | | | | | |
| 12 | Carvacrol | 0.001 to 10% | 1 | 9.10 | 14.95 | 15 | 64.84 | 3.97 | 44.94 |
| 13 | D-limonene | 0.001 to 8% | 1 | 10.30 | 13.60 | 17.4 | 68.93 | 4.42 | 61.51 |
| 14 | Gingerol | 0.001 to 8% | 1 | 9.40 | 13.02 | 16 | 70.21 | 3.77 | 37.61 |
| 15 | β-Asarone | 0.001 to 9% | 1 | 8.92 | 9.58 | 12.49 | 40.02 | 3.17 | 16.00 |
| 16 | Menthol | 0.001 to 9% | 1 | 9.58 | 10.24 | 13.87 | 44.78 | 3.02 | 10.37 |
| 17 | Capsaicin | 0.001 to 8% | 1 | 9.20 | 12.21 | 13.52 | 46.96 | 2.99 | 9.09 |
| 18 | p-Cymene | 0.001 to 15% | 1 | 9.30 | 11.47 | 13.48 | 44.95 | 3.15 | 15.10 |
| 19 | Palmitic acid | 0.001 to 8% | 1 | 10.20 | 13.04 | 15.95 | 56.37 | 4.41 | 61.00 |
| 20 | Ellagic acid | 0.001 to 8% | 1 | 10.12 | 16.35 | 16.95 | 67.49 | 3.92 | 43.41 |
| 21 | 2-undecanone | 0.001 to 8% | 1 | 8.89 | 13.57 | 15.15 | 70.42 | 4.44 | 62.21 |
| 22 | Chavibetol | 0.001 to 7% | 1 | 9.82 | 14.58 | 14.98 | 52.55 | 3.60 | 31.63 |
| 23 | Thymoquinone | 0.001 to 8% | 1 | 8.85 | 13.76 | 14 | 58.19 | 4.16 | 52.17 |
| 24 | Berberine | 0.001 to 8% | 1 | 10.25 | 13.04 | 14.04 | 36.98 | 3.11 | 13.75 |
| 25 | Quaternary | 0.001 to 9% | 1 | 9.55 | 12.39 | 15.3 | 60.21 | 3.87 | 41.58 |
| | isoquinoline | | | | | | | | |
| | alkaloids | | | | | | | | |
| 26 | Alpha- | 0.001 to 13% | 1 | 9.21 | 11.40 | 12.58 | 36.59 | 3.23 | 17.88 |
| | pinene | | | | | | | | |
| 27 | 1,8 cineole | 0.001 to 7% | 1 | 8.82 | 9.69 | 12.58 | 42.63 | 3.26 | 19.07 |
| 28 | Camphene | 0.001 to 7% | 1 | 9.35 | 10.40 | 12.02 | 28.56 | 3.50 | 27.80 |
| 29 | Embodiment 1 | Combination of | 1 | 9.47 | 16.75 | 18.47 | 95.04 | 5.08 | 85.72 |
| | | Phytochemicals | | | | | | | |
| 30 | Embodiment 2 | Combination of | 1 | 9.24 | 18.74 | 20.04 | 116.88 | 4.88 | 78.51 |
| | | Phytochemicals | | | | | | | |
| 31 | Embodiment 3 | Combination of | 1 | 8.86 | 18.91 | 19.97 | 125.40 | 5.60 | 104.68 |
| | | Phytochemicals | | | | | | | |
| 32 | Embodiment 4 | Combination of | 1 | 10.26 | 17.08 | 21.96 | 114.04 | 5.55 | 102.70 |
| | | Phytochemicals | | | | | | | |
| 33 | Embodiment 5 | Combination of | 1 | 10.44 | 17.89 | 21.95 | 110.25 | 5.52 | 101.67 |
| | | Phytochemicals | | | | | | | |
| 34 | Embodiment 6 | Combination of | 1 | 9.45 | 19.20 | 21.06 | 122.86 | 5.93 | 116.74 |
| | | Phytochemicals | | | | | | | |
| 35 | Embodiment 7 | Combination of | 1 | 9.98 | 18.00 | 21.1 | 111.42 | 5.40 | 97.40 |
| | | Phytochemicals | | | | | | | |
| 36 | Embodiment 8 | Combination of | 1 | 9.46 | 17.42 | 21.4 | 126.22 | 5.50 | 100.94 |
| | | Phytochemicals | | | | | | | |
| 38 | Embodiment 9 | Combination of | 1 | 9.25 | 17.02 | 20.06 | 116.86 | 5.56 | 103.14 |
| | | Phytochemicals | | | | | | | |
| 38 | Embodiment 10 | Combination of | 1 | 8.95 | 16.47 | 19.57 | 118.66 | 6.32 | 130.91 |
| | | Phytochemicals | | | | | | | |
| 39 | Embodiment 11 | Combination of | 1 | 8.82 | 15.45 | 19.98 | 126.53 | 5.90 | 115.70 |
| | | Phytochemicals | | | | | | | |
| 40 | Embodiment 12 | Combination of | 1 | 9.25 | 15.74 | 17.89 | 93.41 | 6.09 | 122.71 |
| | | Phytochemicals | | | | | | | |
| 41 | Water Control | 100% | | 9.78 | 10.70 | 11.02 | 12.68 | 2.74 | 0.00 |

### Conclusion:

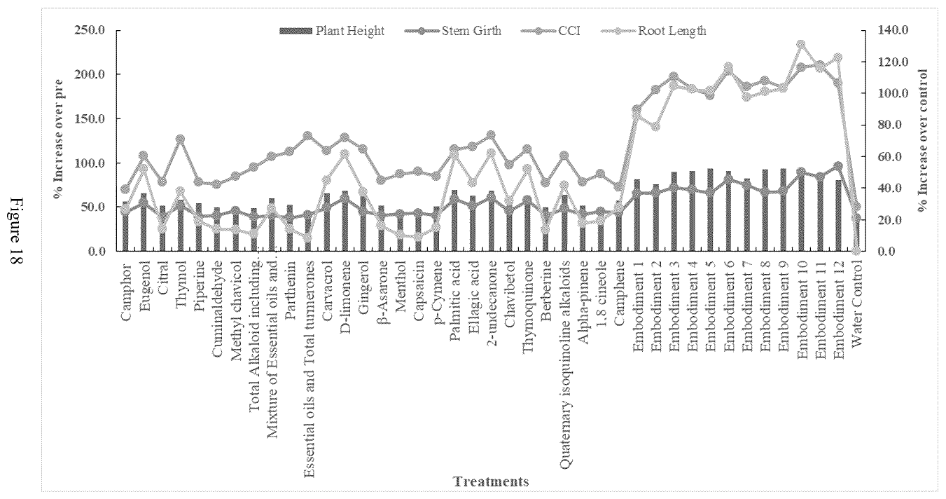

1. The data on chili plant height reported that the Embodiment 5@1.0 ml/lit. dose showed 94.07% plant height improvement followed by Embodiment 10@1.0 ml/lit. 93.92% & Embodiment 9@1.0 ml/lit. 93.59%.
2. The data on chili stem girth reported that the Embodiment 12@1.0 ml/lit. dose showed 96.30% stem girth improvement followed by Embodiment 10@1.0 ml/lit. 89.31% & Embodiment 11@1.0 ml/lit. 84.21%.
3. Among the data of root length, the Embodiment 10@1.0 ml/lit. dose showed 130.91% root length improvement followed by Embodiment 12@1.0 ml/lit. 122.71% & Embodiment 6@1.0 ml/lit. 116.74%.
4. The chlorophyll concentration index (CCI) also changes as per the treatments exposed, the Embodiment 11@1.0 ml/lit. dose showed 126.53% chlorophyll index improvement followed by Embodiment 8@1.0 ml/lit. 126.22% & Embodiment 3@1.0 ml/lit. 125.40%.
5. All the Embodiment (Combinations of phytochemicals) reported maximum morphology improvement than the individual phytochemicals (as depicted in FIG. 18).

### the Material and Methodology for the Following Example 32 to 43 Comprised of the Following:

Replications: 4
No. of Insects Taken: 10/treatments
Solution for spray: 1 lit spray solution of respective pesticides was prepared
Micropipette: Require for taking accurate volume of pesticide as per recommendations
Microscope: Zoom stereo trinocular microscope for insect observation
Statistical Design Used: Completely Randomized Design
Calculations:

$$\% Corrected Mortality = \frac{( \% Test Mortality - \% Control Mortality )}{100 - \% Control Mortality} \times 100$$

### Example 32: In Vitro Bio-Efficacy of Bio-Insecticides (Embodiment) and Synthetic Insecticides Against Cotton Aphids

### Material and Methodology:

Insect Studied: Cotton Aphids (Collected culture from insectary section)
Host plant leaves: Cotton leaves (For Aphid feeding)
Observation Recorded: After 48 Hrs. application

### Results:

TABLE 34
In vitro Bio-efficacy of Bio-Insecticides (Embodiment)
and Synthetic Insecticides against Cotton Aphids

| | | | | Total no | | % |
|---|---|---|---|---|---|---|
| | | Dose | | of dead | % | Corrected |
| Tr. | | ml or | | insects | Mortality | Mortality |
| No. | Treatments | gm/lit | | at 48 hrs. | at 48 hrs. | at 48 hrs. |
| T1 | Embodiment 1 | 0.5 | ml | 35.0 | 87.5 | 87.07 |
| T2 | Embodiment 1 | 1.0 | ml | 38.0 | 95.0 | 94.83 |
| T3 | Embodiment 3 | 0.5 | ml | 32.0 | 80.0 | 79.31 |
| T4 | Embodiment 3 | 1.0 | ml | 37.0 | 92.5 | 92.24 |
| T5 | Embodiment 4 | 0.5 | ml | 30.0 | 75.0 | 74.14 |
| T6 | Embodiment 4 | 1.0 | ml | 36.0 | 90.0 | 89.66 |
| T7 | Acetamiprid 20% SP | 2.0 | g | 30.0 | 75.0 | 74.14 |
| T8 | Buprofezin 25% SC | 1.0 | g | 28.0 | 70.0 | 68.97 |
| T9 | Diafenthiuron 47.8% SC | 1.0 | g | 31.0 | 77.5 | 76.72 |
| T10 | Dimethoate 30% EC | 2.0 | ml | 25.0 | 62.5 | 61.21 |

| | | | | | |
|---|---|---|---|---|---|
| T11 | Control | — | 2.0 | 3.3 | 0.00 |

| | |
|---|---|
| CD (0.01%) | 0.47 |

Conclusion: In vitro bio-efficacy study revealed that Embodiment 1@1.0 ml/lit showed highest mortality percentage 94.83% at 48 hours followed by Embodiment 3@1.0 ml/lit showed 92.24% against Cotton Aphid.

### Example 33: In Vitro Bio-Efficacy of Bio-Insecticides (Embodiment) and Synthetic Insecticides Against Rice Hopper

### Material and Methodology:

Insect Studied: Rice Hopper (Collected culture from insectary section)
Host plant leaves: Rice stalk (For Hopper feeding)
No. of Treatments: 11
Observation Recorded: After 48 Hrs. application

### Results:

TABLE 35
In vitro Bio-efficacy of Bio-Insecticides (Embodiment)
and Synthetic Insecticides against Rice Hopper

| | | | | Total no | | % |
|---|---|---|---|---|---|---|
| | | Dose | | of dead | % | Corrected |
| Tr. | | ml or | | insects | Mortality | Mortality |
| No. | Treatments | gm/lit | | at 48 hrs. | at 48 hrs. | at 48 hrs. |
| T1 | Embodiment 1 | 0.5 | ml | 33.0 | 82.5 | 81.08 |
| T2 | Embodiment 1 | 1.0 | ml | 35.0 | 87.5 | 86.49 |
| T3 | Embodiment 3 | 0.5 | ml | 31.0 | 77.5 | 75.68 |
| T4 | Embodiment 3 | 1.0 | ml | 39.0 | 97.5 | 97.30 |
| T5 | Embodiment 4 | 0.5 | ml | 30.0 | 75.0 | 72.97 |
| T6 | Embodiment 4 | 1.0 | ml | 36.0 | 90.0 | 89.19 |
| T7 | Buprofezin 25% SC | 1.0 | gm | 28.0 | 70.0 | 67.57 |
| T8 | Buprofezin 20% + | 0.4 | gm | 30.0 | 75.0 | 72.97 |
| | Acephate 50% WP | | | | | |
| T9 | Acephate 95% SG | 2.5 | ml | 29.0 | 72.5 | 70.27 |
| T10 | Acetamiprid 20% SP | 2.0 | gm | 24.0 | 60.0 | 56.76 |

| | | | | | |
|---|---|---|---|---|---|
| T11 | Control | — | 3.0 | 7.5 | 0.00 |

| | |
|---|---|
| CD (0.01%) | 0.57 |

Conclusion: In vitro bio-efficacy study revealed that Embodiment 3@1.0 ml/lit showed highest mortality percentage 97.30% at 48 hrs followed by Embodiment 4@1.0 ml/lit showed 89.19% against Rice Hopper.

### Example 34: In Vitro Bio-Efficacy of Bio-Insecticides (Embodiment) and Synthetic Insecticides Against Tomato White Fly

### Material and Methodology:

Insect Studied: Tomato White fly (Collected culture from insectary section)
Host plant leaves: Tomato leaves (For White fly feeding)
No. of Treatments: 11
Observation Recorded: After 72 Hrs. application

### Results:

TABLE 36
In vitro Bio-efficacy of Bio-Insecticides (Embodiment) and Synthetic
Insecticides against Tomato White fly is depicted in Table 15.

| | | | | Total no | | % |
|---|---|---|---|---|---|---|
| | | Dose | | of dead | % | Corrected |
| Tr. | | ml or | | insects | Mortality | Mortality |
| No. | Treatments | gm/lit | | at 72 hrs. | at 72 hrs. | at 72 hrs. |
| T1 | Embodiment 1 | 0.5 | ml | 28.0 | 70.0 | 68.42 |
| T2 | Embodiment 1 | 1.0 | ml | 30.0 | 75.0 | 73.68 |
| T3 | Embodiment 3 | 0.5 | ml | 29.0 | 72.5 | 71.05 |
| T4 | Embodiment 3 | 1.0 | ml | 31.0 | 77.5 | 76.32 |
| T5 | Embodiment 4 | 0.5 | ml | 26.0 | 65.0 | 63.16 |
| T6 | Embodiment 4 | 1.0 | ml | 38.0 | 95.0 | 94.74 |
| T7 | Difennthiuron 50% WP | 1.0 | gm | 25.0 | 62.5 | 60.53 |
| T8 | Acetamapride 20% SP | 0.5 | gm | 28.0 | 70.0 | 68.42 |
| T9 | Flonicamide 50% WG | 0.5 | gm | 24.0 | 60.0 | 57.89 |
| T10 | Spiromesifen 22.90% SC | 1.0 | ml | 27.0 | 67.5 | 65.79 |
| T11 | Control | | | 2.0 | 5.0 | |

| | |
|---|---|
| CD (0.01%) | 0.62 |

Conclusion: In vitro bio-efficacy study revealed that Embodiment 4@1.0 ml/lit showed highest mortality percentage 94.74% at 72 hrs followed by Embodiment 3@1.0 ml/lit showed 76.32% against Tomato White fly.

### Example 35: In Vitro Bio-Efficacy of Bio-Insecticides (Embodiment) and Synthetic Insecticides Against Citrus Red Mite

### Material and Methodology:

Insect Studied: Citrus Red mite (Collected culture from insectary section)
Host plant leaves: Citrus leaves (For Red mite feeding)
No. of Treatments: 11
Observation Recorded: After 48 Hrs. application

### Results:

TABLE 37
In vitro Bio-efficacy of Bio-Insecticides (Embodiment)
and Synthetic Insecticides against Citrus Red mite

| | | | Total no | | % |
|---|---|---|---|---|---|
| | | Dose | of dead | % | Corrected |
| Tr. | | ml or | insects | Mortality | Mortality |
| No. | Treatments | gm/lit | at 48 hrs. | at 48 hrs. | at 48 hrs. |
| T1 | Embodiment 2 | 0.5 ml | 32.0 | 80.0 | 78.95 |
| T2 | Embodiment 2 | 1.0 ml | 38.0 | 95.0 | 94.74 |
| T3 | Embodiment 3 | 0.5 ml | 30.0 | 75.0 | 73.68 |
| T4 | Embodiment 3 | 1.0 ml | 35.0 | 87.5 | 86.84 |
| T5 | Embodiment 6 | 0.5 ml | 28.0 | 70.0 | 68.42 |
| T6 | Embodiment 6 | 1.0 ml | 37.0 | 92.5 | 92.11 |
| T7 | Fluxametamide 10% EC | 0.8 ml | 31.0 | 77.5 | 76.32 |
| T8 | Spiromesifen 22.90% SC | 1.0 ml | 27.0 | 67.5 | 65.79 |
| T9 | Propargite 57% EC | 1.0 ml | 28.0 | 70.0 | 68.42 |
| T10 | Fenpropathrin 30% EC | 0.5 ml | 22.0 | 55.0 | 52.63 |
| T11 | Control | | 2.0 | 5.0 | 0.00 |

| | |
|---|---|
| CD (0.01%) | 0.63 |

Conclusion: In vitro bio-efficacy study revealed that Embodiment 2@1.0 ml/lit showed highest mortality percentage 94.74% at 48 hrs. followed by Embodiment 6@1.0 ml/lit showed 92.11% against Citrus Red mite.

### Example 36: In Vitro Bio-Efficacy of Bio-Insecticides (Embodiment) and Synthetic Insecticides Against Grapes Mealy Bug

### Material and Methodology:

Insect Studied: Grapes Mealy Bug (Collected culture from insectary section)
Host plant leaves: Grapes leaves (For Mealy Bug feeding)
No. of Treatments: 11
Observation Recorded: After 48 Hrs. application

### Results:

TABLE 38
In vitro Bio-efficacy of Bio-Insecticides (Embodiment)
and Synthetic Insecticides against Grapes Mealy Bug

| | | | | Total no | | % |
|---|---|---|---|---|---|---|
| | | Dose | | of dead | % | Corrected |
| Tr. | | ml or | | insects | Mortality | Mortality |
| No. | Treatments | gm/lit | | at 48 hrs. | at 48hrs. | at 48 hrs. |
| T1 | Embodiment 2 | 0.5 | ml | 29.0 | 73.0 | 71.79 |
| T2 | Embodiment 2 | 1.0 | ml | 33.0 | 83.0 | 82.05 |
| T3 | Embodiment 3 | 0.5 | ml | 32.0 | 80.0 | 79.49 |
| T4 | Embodiment 3 | 1.0 | ml | 39.0 | 98.0 | 97.44 |
| T5 | Embodiment 6 | 0.5 | ml | 30.0 | 75.0 | 74.36 |
| T6 | Embodiment 6 | 1.0 | ml | 35.0 | 88.0 | 87.18 |
| T7 | Buprofezin 25% SC | 1.5 | ml | 28.0 | 70.0 | 69.23 |
| T8 | Spirotetramat 15.31% OD | 1.0 | ml | 25.0 | 63.0 | 61.54 |
| T9 | Spirotetramat 11.01% + | 1.0 | ml | 20.0 | 50.0 | 48.72 |
| | Imidacloprid 11.01% SC | | | | | |
| T10 | Fipronil 15% + | 0.8 | gm | 22.0 | 55.0 | 53.85 |
| | Flonicamide 15% WDG | | | | | |
| T11 | Control | | | 1.0 | 3.0 | 0.00 |

| | |
|---|---|
| CD (0.01%) | 0.5 |

Conclusion: In vitro bio-efficacy study revealed that Embodiment 3@1.0 ml/lit showed highest mortality percentage 97.44% at 48 hrs. followed by Embodiment 6@1.0 ml/lit showed 87.18% against Grapes Mealy Bug.

### Example 37: In vitro Bio-Efficacy of Bio-Insecticides (Embodiment) and Synthetic Insecticides Against Chilli Yellow Mite

### Material and Methodology:

Insect Studied: Chilli Yellow mite (Collected culture from insectary section)
Host plant leaves: Chilli leaves (For Yellow mite feeding)
No. of Treatments: 11
Observation Recorded: After 48 Hrs. application

### Results:

TABLE 39
In vitro Bio-efficacy of Bio-Insecticides (Embodiment)
and Synthetic Insecticides against Chilli Yellow mite

| | | | Total no | | % |
|---|---|---|---|---|---|
| | | Dose | of dead | % | Corrected |
| Tr. | | ml or | insects | Mortality | Mortality |
| No. | Treatments | gm/lit | at 48 hrs. | at 48 hrs. | at 48 hrs. |
| T1 | Embodiment 2 | 0.5 ml | 29.0 | 72.5 | 71.05 |
| T2 | Embodiment 2 | 1.0 ml | 37.0 | 92.5 | 92.11 |
| T3 | Embodiment 3 | 0.5 ml | 26.0 | 65.0 | 63.16 |
| T4 | Embodiment 3 | 1.0 ml | 38.0 | 95.0 | 94.74 |
| T5 | Embodiment 6 | 0.5 ml | 27.0 | 67.5 | 65.79 |
| T6 | Embodiment 6 | 1.0 ml | 34.0 | 85.0 | 84.21 |
| T7 | Propargite 57% EC | 1.0 ml | 25.0 | 62.5 | 60.53 |
| T8 | Cyenopyrafen 30% SC | 0.6 ml | 22.0 | 55.0 | 52.63 |
| T9 | Fenpropathrin 30% EC | 0.5 ml | 28.0 | 70.0 | 68.42 |
| T10 | Hexathiazox 5.45% EC | 1.0 ml | 27.0 | 67.5 | 65.79 |
| T11 | Control | | 2.0 | 5.0 | 0.00 |

| | |
|---|---|
| CD (0.01%) | 0.58 |

Conclusion: In vitro bio-efficacy study revealed that Embodiment 3@1.0 ml/lit showed highest mortality percentage 94.74% at 48 hours followed by Embodiment 2@1.0 ml/lit showed 92.11% against Citrus Yellow mite.

### Example 38: In Vitro Bio-Efficacy of Bio-Insecticides (Embodiment) and Synthetic Insecticides Against Spodoptera litura on Cotton

### Material and Methodology:

Insect Studied: Spodoptera litura on Cotton (Collected culture from insectary section)
Host plant leaves: Cotton balls (For Spodoptera litura feeding)
No. of Treatments: 13
Observation Recorded: After 72 Hrs. application

### Results:

TABLE 40
In vitro Bio-efficacy of Bio-Insecticides (Embodiment) and Synthetic
Insecticides against Spodoptera litura on Cotton

| | | | | Total no | | % |
|---|---|---|---|---|---|---|
| | | Dose | | of dead | % | Corrected |
| Tr. | | ml or | | insects | Mortality | Mortality |
| No. | Treatments | gm/lit | | at 72 hrs. | at 72 hrs. | at 72 hrs. |
| T1 | Embodiment 4 | 1.0 | ml | 25.0 | 62.5 | 60.53 |
| T2 | Embodiment 4 | 1.5 | ml | 33.0 | 82.5 | 81.58 |
| T3 | Embodiment 5 | 1.0 | ml | 20.0 | 50.0 | 47.37 |
| T4 | Embodiment 5 | 1.5 | ml | 30.0 | 75.0 | 73.68 |
| T5 | Embodiment 6 | 1.0 | ml | 18.0 | 45.0 | 42.11 |
| T6 | Embodiment 6 | 1.5 | ml | 32.0 | 80.0 | 78.95 |
| T7 | Embodiment 10 | 1.0 | ml | 22.0 | 55.0 | 52.63 |
| T8 | Embodiment 10 | 1.5 | ml | 34.0 | 85.0 | 84.21 |
| T9 | Chlorantraniliprole 18.5% SC | 0.3 | ml | 21.0 | 52.5 | 50.00 |
| T10 | Emamectin Benzonate 5% SG | 0.4 | gm | 25.0 | 62.5 | 60.53 |
| T11 | Deltamethrin 2.8 EC (2.8% w/w) | 1.5 | ml | 23.0 | 57.5 | 55.26 |
| T12 | Thiodicarb 75% WP | 2.0 | gm | 24.0 | 60.0 | 57.89 |
| T13 | Control | | | 2.0 | 5.0 | |

| | |
|---|---|
| CD (0.01%) | 0.81 |

Conclusion: In vitro bio-efficacy study revealed that Embodiment 10@1.5 ml/lit showed highest mortality percentage 84.21% at 72 hours followed by Embodiment 4@1.5 ml/lit showed 81.58% against Cotton Spodoptera litura.

### Example 39: In Vitro Bio-Efficacy of Bio-Insecticides (Embodiment) and Synthetic Insecticides Against Helicoverpa armigera on Cotton

### Material and Methodology:

Insect Studied: Helicoverpa armigera Cotton (Collected culture from insectary section)
Host plant leaves: Cotton balls (For Helicoverpa armigera feeding)
No. of Treatments: 13
Observation Recorded: After 72 Hrs. application

### Results:

TABLE 41
In vitro Bio-efficacy of Bio-Insecticides (Embodiment) and Synthetic
Insecticides against Helicoverpa armigera on Cotton

| | | | Total no | | % |
|---|---|---|---|---|---|
| | | Dose | of dead | % | Corrected |
| Tr. | | ml or | insects | Mortality | Mortality |
| No. | Treatments | gm/lit | at 72 hrs. | at 72 hrs. | at 72 hrs. |
| T1 | Embodiment 4 | 1.0 ml | 22.0 | 55.0 | 53.85 |
| T2 | Embodiment 4 | 1.5 ml | 28.0 | 70.0 | 69.23 |
| T3 | Embodiment 5 | 1.0 ml | 25.0 | 62.5 | 61.54 |
| T4 | Embodiment 5 | 1.5 ml | 34.0 | 85.0 | 84.62 |
| T5 | Embodiment 6 | 1.0 ml | 24.0 | 60.0 | 58.97 |
| T6 | Embodiment 6 | 1.5 ml | 36.0 | 90.0 | 89.74 |
| T7 | Embodiment 10 | 1.0 ml | 20.0 | 50.0 | 48.72 |
| T8 | Embodiment 10 | 1.5 ml | 27.0 | 67.5 | 66.67 |
| T9 | Spinetoram 11.7% SC | 0.9 ml | 22.0 | 55.0 | 53.85 |
| T10 | Chlorpyriphos 50% EC | 2.0 ml | 21.0 | 52.5 | 51.28 |
| T11 | Chloropyriphos 50% + | 1.0 ml | 25.0 | 62.5 | 61.54 |
| | Cypermethrin 5% EC | | | | |
| T12 | Cypermethrin 25% EC | 1.0 ml | 23.0 | 57.5 | 56.41 |
| T13 | Control | — | 1.0 | 2.5 | |

| | |
|---|---|
| CD (0.01%) | 0.49 |

Conclusion: In vitro bio-efficacy study revealed that Embodiment 6@1.5 ml/lit showed highest mortality percentage 89.74% at 72 hours followed by Embodiment 5@1.5 ml/lit showed 84.62% against Helicoverpa armigera on Cotton.

### Example 40: In Vitro Bio-Efficacy of Bio-Insecticides (Embodiment) and Synthetic Insecticides Against Diamondback Moth (Plutella xylostella) on Cabbage

### Material and Methodology:

Insect Studied: Diamondback moth on Cabbage (Collected culture from insectary section)
Host plant leaves: Cabbage Leaves (For Diamondback moth feeding)
No. of Treatments: 13
Observation Recorded: After 72 Hrs. application

### Results:

TABLE 42
In vitro Bio-efficacy of Bio-Insecticides (Embodiment) and Synthetic Insecticide
against Diamondback moth (Plutella xylostella) on Cabbage

| | | | | Total no | | % |
|---|---|---|---|---|---|---|
| | | Dose | | of dead | % | Corrected |
| Tr. | | ml or | | insects | Mortality | Mortality |
| No. | Treatments | gm/lit | | at 72 hrs. | at 72 hrs. | at 72 hrs. |
| T1 | Embodiment 4 | 0.5 | ml | 33.0 | 82.5 | 81.58 |
| T2 | Embodiment 4 | 1.0 | ml | 38.0 | 95.0 | 94.74 |
| T3 | Embodiment 5 | 0.5 | ml | 30.0 | 75.0 | 73.68 |
| T4 | Embodiment 5 | 1.0 | ml | 39.0 | 97.5 | 97.37 |
| T5 | Embodiment 6 | 0.5 | ml | 29.0 | 72.5 | 71.05 |
| T6 | Embodiment 6 | 1.0 | ml | 36.0 | 90.0 | 89.47 |
| T7 | Embodiment 10 | 0.5 | ml | 28.0 | 70.0 | 68.42 |
| T8 | Embodiment 10 | 1.0 | ml | 35.0 | 87.5 | 86.84 |
| T9 | Deltamethrin 2.8 EC (2.8% w/w) | 1.5 | ml | 34.0 | 85.0 | 84.21 |
| T10 | Thiodicarb 75% WP | 2.0 | gm | 31.0 | 77.5 | 76.32 |
| T11 | Spinosad 480 SC (45% w/w) | 0.5 | ml | 32.0 | 80.0 | 78.95 |
| T12 | Chlorantraniliprole 18.5% SC | 0.3 | ml | 27.0 | 67.5 | 65.79 |
| T13 | Control | | | 2.0 | 5.0 | 0.00 |

| | |
|---|---|
| CD (0.01%) | 0.58 |

Conclusion: In vitro bio-efficacy study revealed that Embodiment 5@1.0 ml/lit showed highest mortality percentage 97.37% at 72 hrs followed by Embodiment 4@1.0 ml/lit showed 94.74% against Diamondback moth on Cabbage.

### Example 41: In Vitro Bio-Efficacy of Bio-Insecticides (Embodiment) and Synthetic Insecticides Against Earias vittella on Cotton

### Material and Methodology:

Insect Studied: Earias vittella on Cotton (Collected culture from insectary section)
Host plant leaves: Cotton balls (For Earias vittella feeding)
No. of Treatments: 13
Observation Recorded: After 72 Hrs. application

### Results:

TABLE 43
In vitro Bio-efficacy of Bio-Insecticides (Embodiment) and
Synthetic Insecticides against Earias vittella on Cotton

| | | | | Total no | | % |
|---|---|---|---|---|---|---|
| | | Dose | | of dead | % | Corrected |
| Tr. | | ml or | | insects | Mortality | Mortality |
| No. | Treatments | gm/lit | | at 72 hrs. | at 72 hrs. | at 72 hrs. |
| T1 | Embodiment 4 | 1.0 | ml | 22.0 | 55.0 | 52.63 |
| T2 | Embodiment 4 | 1.5 | ml | 28.0 | 70.0 | 68.42 |
| T3 | Embodiment 5 | 1.0 | ml | 20.0 | 50.0 | 47.37 |
| T4 | Embodiment 5 | 1.5 | ml | 29.0 | 72.5 | 71.05 |
| T5 | Embodiment 6 | 1.0 | ml | 25.0 | 62.5 | 60.53 |
| T6 | Embodiment 6 | 1.5 | ml | 34.0 | 85.0 | 84.21 |
| T7 | Embodiment 10 | 1.0 | ml | 21.0 | 52.5 | 50.00 |
| T8 | Embodiment 10 | 1.5 | ml | 31.0 | 77.5 | 76.32 |
| T9 | Spinetoram 11.7% SC | 0.9 | ml | 24.0 | 60.0 | 57.89 |
| T10 | EmamectinBenzonate 5% SG | 0.4 | gm | 28.0 | 70.0 | 68.42 |
| T11 | Chlorantraniliprole (10%) + | 0.5 | ml | 22.0 | 55.0 | 52.63 |
| | Lambda cyhalothrin (5%) ZC | | | | | |
| T12 | Cypermethrin 25% EC | 1.0 | ml | 26.0 | 65.0 | 63.16 |
| T13 | Control | | | 2.0 | 5.0 | 0.00 |

| | |
|---|---|
| CD (0.01%) | 0.53 |

Conclusion: In vitro bio-efficacy study revealed that Embodiment 6@1.5 ml/lit showed highest mortality percentage 84.21% at 72 hrs. followed by Embodiment 10@1.5 ml/lit showed 76.32% against Earias vittella on Cotton.

### Example 42: In Vitro Bio-Efficacy of Bio-Insecticides (Embodiment) and Synthetic Insecticides Against Potato Whitefly

### Material and Methodology:

Insect Studied: Potato Whitefly (Collected culture from insectary section)
Host plant leaves: Potato leaves (For Whitefly feeding)
No. of Treatments: 13
Observation Recorded: After 72 Hrs. application

### Results:

TABLE 44
In vitro Bio-efficacy of Bio-Insecticides (Embodiment)
and Synthetic Insecticides against Potato Whitefly

| | | | | Total no | | % |
|---|---|---|---|---|---|---|
| | | Dose | | of dead | % | Corrected |
| Tr. | | ml or | | insects | Mortality | Mortality |
| No. | Treatments | gm/lit | | at 72 hrs. | at 72 hrs. | at 72 hrs. |
| T1 | Embodiment 4 | 0.5 | ml | 25.0 | 62.5 | 61.54 |
| T2 | Embodiment 4 | 1.0 | ml | 30.0 | 75.0 | 74.36 |
| T3 | Embodiment 5 | 0.5 | ml | 28.0 | 70.0 | 69.23 |
| T4 | Embodiment 5 | 1.0 | ml | 32.0 | 80.0 | 79.49 |
| T5 | Embodiment 6 | 0.5 | ml | 25.0 | 62.5 | 61.54 |
| T6 | Embodiment 6 | 1.0 | ml | 34.0 | 85.0 | 84.62 |
| T7 | Embodiment 10 | 0.5 | ml | 23.0 | 57.5 | 56.41 |
| T8 | Embodiment 10 | 1.0 | ml | 36.0 | 90.0 | 89.74 |
| T9 | Cyantraniliprole 10.26% OD | 1.0 | ml | 25.0 | 62.5 | 61.54 |
| T10 | Emamectin benzoate 5% SG | 0.5 | gm | 24.0 | 60.0 | 58.97 |
| T11 | Dimethoate 30% EC | 1.0 | ml | 20.0 | 50.0 | 48.72 |
| T12 | Imidachlopride 17.8% SL | 0.5 | ml | 21.0 | 52.5 | 51.28 |
| T13 | Control | | | 1.0 | 2.5 | 0.00 |

| | |
|---|---|
| CD (0.01%) | 0.71 |

Conclusion: In vitro bio-efficacy study revealed that Embodiment 10@1.0 ml/l showed highest mortality percentage 89.74% at 72 hours followed by Embodiment 6@1 ml/l showed 84.62% against Potato Whitefly.

### Example 43: In Vitro Bio-Efficacy of Bio-Insecticides (Embodiment) and Synthetic Insecticides Against Chilli Thrips

### Material and Methodology:

Insect Studied: Chilli Thrips (Collected culture from insectary section)
Host plant leaves: Chilli leaves (For Thrips feeding)
No. of Treatments: 13
Observation Recorded: After 48 Hrs. application

### Results:

TABLE 45
In vitro Bio-efficacy of Bio-Insecticides (Embodiment)
and Synthetic Insecticides against Chilli Thrips

| | | | | Total no | | % |
|---|---|---|---|---|---|---|
| | | Dose | | of dead | % | Corrected |
| Tr. | | ml or | | insects | Mortality | Mortality |
| No. | Treatments | gm/lit | | at 48 hrs. | at 48 hrs. | at 48 hrs. |
| T1 | Embodiment 4 | 0.5 | ml | 20.0 | 50.0 | 47.37 |
| T2 | Embodiment 4 | 1.0 | ml | 30.0 | 75.0 | 73.68 |
| T3 | Embodiment 5 | 0.5 | ml | 22.0 | 55.0 | 52.63 |
| T4 | Embodiment 5 | 1.0 | ml | 35.0 | 87.5 | 86.84 |
| T5 | Embodiment 6 | 0.5 | ml | 30.0 | 75.0 | 73.68 |
| T6 | Embodiment 6 | 1.0 | ml | 38.0 | 95.0 | 94.74 |
| T7 | Embodiment 10 | 0.5 | ml | 25.0 | 62.5 | 60.53 |
| T8 | Embodiment 10 | 1.0 | ml | 36.0 | 90.0 | 89.47 |
| T9 | Fipronil 80% WG 0.2 g | 1.0 | ml | 22.0 | 55.0 | 52.63 |
| T10 | Difenthiuron 50% WP 1 g | 0.5 | gm | 25.0 | 62.5 | 60.53 |
| T11 | Imidachlopride 17.8% SL | 1.0 | ml | 26.0 | 65.0 | 63.16 |
| T12 | Spinetoram 11.7% SC 0.9 ml | 0.5 | ml | 24.0 | 60.0 | 57.89 |
| T13 | Control | | | 2.0 | 5.0 | 0.00 |

| | |
|---|---|
| CD (0.01%) | 0.53 |

Conclusion: In vitro bio-efficacy study revealed that Embodiment 6@1.0 ml/lit showed highest mortality percentage 94.74% at 48 hrs. followed by Embodiment 10@1.0 ml/lit showed 89.47% against Chilli Thrips.

### the Material and Methodology for the Following Example 44 to 48 Comprised of the Following:

Technique Used: Paper Disc Technique
Media used: Nutrient Agar medium (For Bacteria growing)
No. of Treatments: 8
Replications: 3
Micropipette: Required for taking accurate volume of bactericides as per recommendations
Weighing Balance: Required for taking accurate volume of bactericides as per recommendations
Antibiotic Zone Scale: Required for measuring accurate zone
Observation Recorded: After three days application
Statistical Design Used: Completely Randomized Design
Calculations: Zone of inhibition (mm)

### Example 44: In Vitro Bio-Efficacy of Bio-Bactericides (Embodiment) and Synthetic Bactericides Against Bacterial Blight (Xanthomonas oryzae pv. Oryzae) of Paddy

### Material and Methodology:

Pathogen Studied: Xanthomonas oryzae pv. oryzae (Collected culture from Plant Pathology section)

### Results:—

TABLE 46
In vitro effect of bactericides on growth and inhibition
of Xanthomonas oryzae pv. oryzae

| | | Dose | | Zone of |
|---|---|---|---|---|
| Sr. | | ml or | | Inhibition |
| No. | Treatments | gm/ml | | (mm) |
| T1 | Embodiment 7 | 0.5 | ml | 34.33 |
| T2 | Embodiment 7 | 1.0 | ml | 36.66 |
| T3 | Embodiment 7 | 2.0 | ml | 42.33 |
| T4 | Streptocycline Sulphate: 90% w/w + | 0.5 | gm | 26.66 |
| | Tetracycline Hydrochloride: 10% w/w | | | |
| T5 | Copper Oxychloride 45% WP | 1.0 | gm | 25.33 |
| T6 | Kasugamycin 5% + Copper Oxychloride 45% WP | 1.5 | gm | 28.66 |
| T7 | Validamycin 3% L | 2.5 | gm | 21.33 |

| | | | |
|---|---|---|---|
| T8 | Control | — | 0 |

| | |
|---|---|
| F test | Sig. |
| SE(M)± | 0.57 |
| CD (P = 0.01) | 2.29 |

### Conclusions:

1. All tested bactericides significantly superior over control.
2. In vitro bio-efficacy study revealed that Embodiment 7@2.0 ml/lit showed Maximum Zone of inhibition 42.33 (mm) followed by Embodiment 7@1.0 ml/lit and Embodiment 7@0.5 ml/lit against Xanthomonas oryzae pv. oryzae.

### Example 45: In Vitro Bio-Efficacy of Bio-Bactericides (Embodiment) and Synthetic Bactericides Against Moko/Bacterial Wilt (Ralstonia solanacearum Race 2) of Banana

### Material and Methodology:

Pathogen Studied: Ralstonia solanacearum race 2. (Collected culture from Plant Pathology section)

### Results:—

TABLE 47
In vitro effect of bactericides on growth and
inhibition of Ralstonia solanacearum race 2.

| | | Dose | | Zone of |
|---|---|---|---|---|
| Sr. | | ml or | | Inhibition |
| No. | Treatments | gm/lit | | (mm) |
| T1 | Embodiment 7 | 0.5 | ml | 36.66 |
| T2 | Embodiment 7 | 1.0 | ml | 39.66 |
| T3 | Embodiment 7 | 2.0 | ml | 44.33 |
| T4 | Streptocycline Sulphate: 90% w/w + | 0.5 | gm | 28.66 |
| | Tetracycline Hydrochloride: 10% w/w | | | |
| T5 | Copper Oxychloride 45% WP | 1.0 | gm | 27.33 |
| T6 | Kasugamycin 5% + | 1.5 | gm | 29.66 |
| | Copper Oxychloride 45% WP | | | |
| T7 | Validamycin 3% L | 2.5 | gm | 25.33 |

| | | | |
|---|---|---|---|
| T8 | Control | — | 0 |

| | |
|---|---|
| F test | Sig. |
| SE(M)± | 0.93 |
| CD (P = 0.01) | 2.49 |

### Conclusions:

1. All tested bactericides significantly superior over control.
2. In vitro bio-efficacy study revealed that Embodiment 7@2.0 ml/lit showed Maximum Zone of inhibition 44.33 (mm) followed by Embodiment 7@1.0 and 0.5 ml/lit against Ralstonia solanacearum race 2.

### Example 46: In Vitro Bio-Efficacy of Bio-Bactericides (Embodiment) and Synthetic Bactericides Against Bacterial Blight (Xanthomonas axanopodis pv. Punicae) of Pomegranate

### Material and Methodology:

Pathogen Studied: Xanthomonas axanopodis pv. punicae (Collected culture from Plant Pathology section)

### Results:—

TABLE 48
In vitro effect of bactericides on growth and inhibition
of Xanthomonas axanopodis pv. punicae

| | | Dose | | Zone of |
|---|---|---|---|---|
| Sr. | | ml or | | Inhibition |
| No. | Treatments | gm/lit | | (mm) |
| T1 | Embodiment 7 | 0.5 | ml | 31.33 |
| T2 | Embodiment 7 | 1.0 | ml | 35.66 |
| T3 | Embodiment 7 | 2.0 | ml | 39.33 |
| T4 | Streptocycline Sulphate: 90% w/w + | 0.5 | gm | 24.66 |
| | Tetracycline Hydrochloride: 10% w/w | | | |
| T5 | Copper Oxychloride 45% WP | 1.0 | gm | 23.33 |
| T6 | Kasugamycin 5% + | 1.5 | gm | 25.66 |
| | Copper Oxychloride 45% WP | | | |
| T7 | Validamycin 3% L | 2.5 | gm | 19.33 |

| | | | |
|---|---|---|---|
| T8 | Control | — | 0 |

| | |
|---|---|
| F test | Sig. |
| SE(M)± | 0.95 |
| CD (P = 0.01) | 2.89 |

### Conclusions:

1. All tested bactericides significantly superior over control.
2. In vitro bio-efficacy study revealed that Embodiment 7@2.0 ml/lit showed Maximum Zone of inhibition 39.33 (mm) followed by Embodiment 7@1.0, 0.5 ml/lit Zone of inhibition against Xanthomonas axanopodis pv. punicae.

### Example 47: In Vitro Bio-Efficacy of Bio-Bactericides (Embodiment) and Synthetic Bactericides Against Bacterial Leaf Spot (Xanthomonas campestris pv. vesicatoria) of Tomato

### Material and Methodology:

Pathogen Studied: Xanthomonas campestris pv. vesicatoria (Collected culture from Plant Pathology section)

### Results:—

TABLE 49
In vitro effect of Bactericides on growth and inhibition
of Xanthomonas campestris pv. vesicatoria

| | | Dose | Zone of |
|---|---|---|---|
| Sr. | | ml or | Inhibition |
| No. | Treatments | gm /lit | (mm) |
| T1 | Embodiment 12 | 0.5 gm | 34.66 |
| T2 | Embodiment 12 | 1.0 gm | 37.33 |
| T3 | Embodiment 12 | 2.0 gm | 41.33 |
| T4 | Streptocycline Sulphate: 90% w/w + | 0.5 gm | 26.66 |
| | Tetracycline Hydrochloride: 10% w/w | | |
| T5 | Copper Oxychloride 45% WP | 1.0 gm | 26.33 |
| T6 | Kasugamycin 5% + | 1.5 gm | 28.66 |
| | Copper Oxychloride 45% WP | | |
| T7 | Validamycin 3% L | 2.5 gm | 23.33 |
| T8 | Control | — | 0 |

| | |
|---|---|
| F test | Sig. |
| SE(M)± | 0.93 |
| CD (P = 0.01) | 2.87 |

### Conclusions:

1. All tested bactericides significantly superior over control.
2. In vitro bio-efficacy study revealed that Embodiment 12@2.0 gm/lit showed Maximum Zone of inhibition 41.33 (mm) followed by Embodiment 12@1.0, 0.5 gm//lit Zone of inhibition against Xanthomonas campestris pv. Vesicatoria.

### Example 48: In Vitro Bio-Efficacy of Bio-Bactericides (Embodiment) and Synthetic Bactericides Against Bacterial Wilt (Ralstonia solanacearum) of Capsicum

### Material and Methodology:

Pathogen Studied: Ralstonia solanacearum (Collected culture from Plant Pathology section)

### Results:

TABLE 50
In vitro effect of bactericides on growth
and inhibition of Ralstonia solanacearum

| | | Dose | Zone of |
|---|---|---|---|
| Sr. | | ml or | Inhibition |
| No. | Treatments | gm/lit | (mm) |
| T1 | Embodiment 12 | 0.5 gm | 34.66 |
| T2 | Embodiment 12 | 1.0 gm | 36.33 |
| T3 | Embodiment 12 | 2.0 gm | 39.66 |
| T4 | Streptocycline Sulphate: 90% w/w + | 0.5 gm | 24.66 |
| | Tetracycline Hydrochloride: 10% w/w | | |
| T5 | Copper Oxychloride 45% WP | 1.0 gm | 25.33 |
| T6 | Kasugamycin 5% + | 1.5 gm | 26.66 |
| | Copper Oxychloride 45% WP | | |
| T7 | Validamycin 3% L | 2.5 gm | 22.33 |
| T8 | Control | — | 0 |

| | |
|---|---|
| F test | Sig. |
| SE(M)± | 0.98 |
| CD (P = 0.01) | 3.15 |

### Conclusions:

1. All tested bactericides significantly superior over control.
2. In vitro bio-efficacy study revealed that Embodiment 12@2.0 gm/lit showed Maximum Zone of inhibition 39.66 (mm) followed by Embodiment 12@1.0 and 0.5 gm/lit Zone of inhibition against Ralstonia solanacearum.

The Material and Methodology for the following Example 49 to 53 comprised of the following:

### Material and Methodology:

Technique Used: Poisoned Food Technique
Media used: Potato Dextrose Agar medium (For fungus growing)
No. of Treatments: 8
Replications: 3
Micropipette: Required for taking accurate volume of fungicides as per recommendations.
Weighing Balance: Required for taking accurate quantity of fungicides as per recommendations
Zone Scale: Required for measuring growth of fungi
Observation Recorded: After Seven Days Application
Statistical Design Used: Completely Randomized Design
Calculations:

$$Percent Growth Inhibition = \frac{( C - T )}{C} \times 100$$

where, C=Growth (mm) of test fungus in untreated control plate
   T=Growth (mm) of test fungus in treated plates

### Example 49: In Vitro Bio-Efficacy of Bio-Fungicides (Embodiment) and Synthetic Fungicides Against Wilt (Fusarium oxysporum f. Sp. vasinfectum) of Cotton

### Material and Methodology:

Pathogen Studied: Fusarium oxysporum f. sp. vasinfectum (Collected culture from Plant Pathology section)

### Results:—

TABLE 51
In vitro effect of fungicides on growth and inhibition
of Fusarium oxysporum f. sp. vasinfectum

| | | | | Mean | Percent |
|---|---|---|---|---|---|
| | | Dose | | colony | Inhibition |
| Sr. | | ml or | | Diameter | of growth |
| No. | Treatments | gm/lit | | (mm) | (%) |
| T1 | Embodiment 8 | 0.5 | ml | 0.00 | 100.00 |
| T2 | Embodiment 8 | 1.0 | ml | 0.00 | 100.00 |
| T3 | Embodiment 8 | 2.0 | ml | 0.00 | 100.00 |
| T4 | Thiophanate Methyl 70% | 1.0 | gm | 26.00 | 69.00 |
| T5 | Thiophanate Methyl 45% + | 0.5 | gm | 20.00 | 76.65 |
| | Pyraclostrobin 5% | | | | |
| T6 | Mancozeb 63% + | 1.0 | gm | 09.00 | 89.49 |
| | Carbendazim 12% | | | | |
| T7 | Carboxin 37.5% + | 1.0 | gm | 23.00 | 73.14 |
| | Thiram 37.5% | | | | |

| | | | | |
|---|---|---|---|---|
| T8 | Control | — | 85.66 | 00.00 |

| | |
|---|---|
| F test | Sig |
| SE(M)± | 0.41 |
| CD (P = 0.01) | 1.27 |

### Conclusions:

1. All tested fungicides significantly superior over control.
2. In vitro bio-efficacy study revealed that Embodiment 8@0.5 ml/lit showed maximum mycelial growth inhibition 100% followed by Embodiment 8@1.0 and Embodiment 8@2.0 ml/lit against Fusarium oxysporum f. sp. vasinfectum.

### Example 50: In Vitro Bio-Efficacy of Bio-Fungicides (Embodiment) and Synthetic Fungicides Against Sheath Blight (Rhizoctonia solani) of Rice

### Material and Methodology:

Pathogen Studied: Rhizoctonia solani (Collected culture from Plant Pathology section)

### Results:—

TABLE 52
In vitro effect of fungicides on growth
and inhibition of Rhizoctonia solani

| | | | Mean | Percent |
|---|---|---|---|---|
| | | | colony | Inhibition |
| Sr. | | Dose ml | Diameter | of growth |
| No. | Treatments | or gm /lit | (mm) | (%) |
| T1 | Embodiment 8 | 0.5 ml | 0.00 | 100.00 |
| T2 | Embodiment 8 | 1.0 ml | 0.00 | 100.00 |
| T3 | Embodiment 8 | 2.0 ml | 0.00 | 100.00 |
| T4 | Kresoxim-methyl 44.3% SC | 1.5 ml | 17.00 | 81.11 |
| T5 | Azoxystrobin 18.2% + | 1.0 ml | 15.00 | 83.33 |
| | Difenoconazole 11.4% w/w | | | |
| | SC | | | |
| T6 | Propiconazole 25% EC | 1.0 ml | 19.00 | 78.88 |
| T7 | Tebuconazole 25.9% EC | 1.0 ml | 11.00 | 87.77 |
| T8 | Control | — | 90.00 | 00.00 |

| | |
|---|---|
| F test | Sig |
| SE(M)± | 0.43 |
| CD (P = 0.01) | 1.37 |

### Conclusions:

1. All tested fungicides significantly superior over control.
2. In vitro bio-efficacy study revealed that Embodiment 8@0.5 ml/lit showed maximum mycelial growth inhibition 100% followed by Embodiment 8@1.0 ml/lit and Embodiment 8@2 ml/lit against Rhizoctonia solani.

### Example 51: In Vitro Bio-Efficacy of Bio-Fungicides (Embodiment) and Synthetic Fungicides Against Wilt (Fusarium oxysporum f. Sp. Lycopersici) of Tomato

### Material and Methodology:

Pathogen Studied: Fusarium oxysporum f. sp. lycopersici (Collected culture from Plant Pathology section)

### Results:—

TABLE 53
In vitro effect of fungicides on growth and inhibition
of Fusarium oxysporum f. sp. lycopersici

| | | | | Mean | Percent |
|---|---|---|---|---|---|
| | | Dose | | colony | Inhibition |
| Sr. | | ml or | | Diameter | of growth |
| No. | Treatments | gm/lit | | (mm) | (%) |
| T1 | Embodiment 8 | 0.5 | ml | 0.00 | 100.00 |
| T2 | Embodiment 8 | 1.0 | ml | 0.00 | 100.00 |
| T3 | Embodiment 8 | 2.0 | ml | 0.00 | 100.00 |
| T4 | Thiophanate Methyl 70% | 1.0 | gm | 30.00 | 65.51 |
| T5 | Thiophanate Methyl 45% + | 0.5 | gm | 26.00 | 70.11 |
| | Pyraclostrobin 5% | | | | |
| T6 | Mancozeb 63% + | 1.0 | gm | 10.00 | 88.50 |
| | Carbendazim 12% | | | | |
| T7 | Carboxin 37.5% + | 1.0 | gm | 14.00 | 83.90 |
| | Thiram 37.5% | | | | |

| | | | | |
|---|---|---|---|---|
| T8 | Control | — | 87.00 | 00.00 |

| | |
|---|---|
| F test | Sig. |
| SE(M)± | 0.45 |
| CD (P = 0.01) | 1.39 |

### Conclusions:

1. All tested fungicides significantly superior over control.
2. In vitro bio-efficacy study revealed that Embodiment 8@0.5 ml/lit showed maximum mycelial growth inhibiton 100% followed by Embodiment 8@1.0 ml/lit and Embodiment 8@2.0 ml/lit against Fusarium oxysporum f. sp. lycopersici.

### Example 52: In Vitro Bio-Efficacy of Bio-Fungicides (Embodiment) and Synthetic Fungicides Against Blast (Pyricularia Oryzae) of Paddy

### Material and Methodology:

Pathogen Studied: Pyricularia oryzae (Collected culture from Plant Pathology section)

### Results:

TABLE 54
In vitro effect of fungicides on growth
and inhibition of Pyricularia oryzae

| | | | | Mean | Percent |
|---|---|---|---|---|---|
| | | Dose | | colony | Inhibition |
| Sr. | | ml or | | Diameter | of growth |
| No. | Treatments | gm/lit | | (mm) | (%) |
| T1 | Embodiment 12 | 0.5 | gm | 0.00 | 100.00 |
| T2 | Embodiment 12 | 1.0 | gm | 0.00 | 100.00 |
| T3 | Embodiment 12 | 2.0 | gm | 0.00 | 100.00 |
| T4 | Isoprothiolane 40% EC | 1.0 | ml | 11.00 | 85.89 |
| T5 | Azoxystrobin 18.2% + | 1.0 | gm | 08.00 | 89.74 |
| | Difenoconazole 11.4% SC | | | | |
| T6 | Kresoxim- methyl 44.3% EC | 1.5 | gm | 17.00 | 78.20 |
| T7 | Carpropamid 27.8% SC | 2.0 | ml | 22.00 | 71.79 |

| | | | | |
|---|---|---|---|---|
| T8 | Control | — | 78.00 | 00.00 |

| | |
|---|---|
| F test | Sign. |
| SE(M)± | 0.37 |
| CD (P = 0.01) | 1.23 |

### Conclusions:

1. All tested fungicides significantly superior over control.
2. In vitro bio-efficacy study revealed that Embodiment 12@0.5 gm/lit showed maximum mycelial growth inhibition 100% followed by Embodiment 12@1.0 gm/lit and Embodiment 12@2.0 ml/lit against Pyricularia oryzae.

### Example 53: In Vitro Bio-Efficacy of Bio-Fungicides (Embodiment) and Synthetic Fungicides Against Early Blight (Alternaria solani) of Potato

### Material and Methodology:

Pathogen Studied: Alternaria solani (Collected culture from Plant Pathology section)

### Results:—

TABLE 55
In vitro effect of fungicides on growth
and inhibition of Alternaria solani

| | | | | Mean | Percent |
|---|---|---|---|---|---|
| | | Dose | | colony | Inhibition |
| Sr. | | ml or | | Diameter | of growth |
| No. | Treatments | gm/lit | | (mm) | (%) |
| T1 | Embodiment 12 | 0.5 | gm | 0.00 | 100.00 |
| T2 | Embodiment 12 | 1.0 | gm | 0.00 | 100.00 |
| T3 | Embodiment 12 | 2.0 | gm | 0.00 | 100.00 |
| T4 | Azoxystrobin 11% + | 1.0 | ml | 13.00 | 84.33 |
| | Tebuconazole 18.3% SC | | | | |
| T5 | Tebuconazole 50% + | 0.75 | gm | 14.00 | 83.13 |
| | Trifloxystrobin 25% WG | | | | |
| T6 | Metiram 55% + | 2.25 | gm | 19.00 | 77.10 |
| | pyraclostrobin 5% SC | | | | |
| T7 | Kresoxim methyl 44.3% EC | 1.5 | ml | 21.00 | 74.69 |

| | | | | |
|---|---|---|---|---|
| T8 | Control | — | 83.00 | 00.00 |

| | |
|---|---|
| F test | Sign. |
| SE(M)± | 0.33 |
| CD (P = 0.01) | 1.37 |

### Conclusions:

1. All tested fungicides significantly superior over control.
2. In vitro bio-efficacy study revealed that Embodiment 12@0.5 gm/lit showed maximum mycelial growth inhibition 100% followed by Embodiment 12@1.0 gm/lit and Embodiment 12@2.0 gm/lit against Alternaria solani.

The Material and Methodology for the following Example 54 to 59 comprised of the following:

### Material and Methodology:

Replications: 4
No. of Insects Taken: 10/treatments
Solution for spray: 1 lit solution of respective pesticides was prepared.
Micropipette: Require for taking accurate volume of pesticide as per recommendations.
Microscope: Zoom stereo trinocular microscope for insect observation.
Observation Recorded After 72 Hrs.
Statistical Design Used: Completely Randomized Design
Calculations

$$\% Corrected Mortality = \frac{( \% Test Mortality - \% Control Mortality )}{100 - \% Control Mortality} \times 100$$

### Example 54: In Vitro Bio-Efficacy of Bio-Insecticides (Embodiment) and Synthetic Insecticides Against Wheat Gall Nematode (Anguina tritici)

### Material and Methodology:

Insect Studied: Wheat Gall Nematode (Anguina tritici) (Collected culture from insectary section)
Medium to survive: Water (As a Nematode Survive medium)
No. of Treatments: 5

### Results:

TABLE 56
In vitro Bio-efficacy of Bio-Insecticides (Embodiment)
and Synthetic Insecticides against Wheat Gall Nematode

| | | | Total no | | % |
|---|---|---|---|---|---|
| | | Dose | of dead | % | Corrected |
| Tr. | | ml or | insects | Mortality | Mortality |
| No. | Treatments | gm/ lit | at 48 hrs | at 48 hrs. | at 48 hrs. |
| T1 | Embodiment 8 | 1.0 ml | 30.0 | 75.0 | 74.36 |
| T2 | Embodiment 8 | 2.0 ml | 37.0 | 92.5 | 92.31 |
| T3 | Fluopyrum | 1.25 ml | 28.0 | 70.0 | 69.23 |
| | 34.48% SC | | | | |
| T4 | No Nots | 2.0 ml | 25.0 | 62.5 | 61.54 |
| T5 | Control | | 1.0 | 2.5 | 0.00 |

| | |
|---|---|
| CD (0.01%) | 0.54 |

Conclusion: In vitro bio-efficacy study revealed that Embodiment 8@2.0 ml/lit showed highest mortality percentage 92.31% followed by Embodiment 8@1.0 ml/lit showed highest mortality percentage 74.36% at 72 hrs. against Wheat Gall Nematode.

### Example 55: In Vitro Bio-Efficacy of Bio-Insecticides (Embodiment) and Synthetic Insecticides Against Potato Cyst Nematode (Globodera rostochiensis)

### Material and Methodology:

Insect Studied: Potato cyst Nematode (Globodera rostochiensis) (Collected culture from insectary section)
Medium to survive: Water (As a Nematode Survive medium)
No. of Treatments: 5

### Results:

TABLE 57
In vitro Bio-efficacy of Bio-Insecticides (Embodiment)
and Synthetic Insecticides against Potato cyst
Nematode (Globodera rostochiensis)

| | | | Total no | | % |
|---|---|---|---|---|---|
| | | Dose | of dead | % | Corrected |
| Tr. | | ml or | insects | Mortality | Mortality |
| No. | Treatments | gm/lit | at 48 hrs. | at 48 hrs. | at 48 hrs. |
| T1 | Embodiment 8 | 1.0 ml | 29.0 | 72.5 | 71.79 |
| T2 | Embodiment 8 | 2.0 ml | 36.0 | 90.0 | 89.74 |
| T3 | Fluopyrum | 1.25 ml | 28.0 | 70.0 | 69.23 |
| | 34.48% SC | | | | |
| T4 | No Nots | 2.0 ml | 25.0 | 62.5 | 61.54 |
| T5 | Control | | 1.0 | 2.5 | 0.00 |

| | |
|---|---|
| CD (0.01%) | 4.45 |

Conclusion: In vitro bio-efficacy study revealed that Embodiment 8@2.0 ml/lit showed highest mortality percentage 89.74% followed by Embodiment 8@1.0 ml/lit showed highest mortality percentage 71.79% at 72 hrs. against Potato Cyst Nematode.

### Example 56: In Vitro Bio-Efficacy of Bio-Insecticides (Embodiment) and Synthetic Insecticides Against Cucumber Whitefly

### Material and Methodology:

Insect Studied: Cucumber Whitefly (Collected culture from insectary section)
Host plant leaves: Cucumber leaves (For Whitefly feeding)
No. of Treatments: 13

### Results

TABLE 58
In vitro Bio-efficacy of Bio-Insecticides (Embodiment)
and Synthetic Insecticides against Cucumber Whitefly

| | | | | Total no | | % |
|---|---|---|---|---|---|---|
| | | Dose | | of dead | % | Corrected |
| Tr. | | ml or | | insects | Mortality | Mortality |
| No. | Treatments | gm/lit | | at 72 hrs. | at 72 hrs. | at 72 hrs. |
| T1 | Embodiment 9 | 0.5 | ml | 28.0 | 70.0 | 69.23 |
| T2 | Embodiment 9 | 1.0 | ml | 36.0 | 90.0 | 89.74 |
| T3 | Difennthiuron | 1.0 | gm | 24.0 | 60.0 | 58.97 |
| | 50% WP - | | | | | |
| T4 | Acetamapride | 0.5 | gm | 27.0 | 67.5 | 66.67 |
| | 20% SP - | | | | | |
| T5 | Flonicamide | 0.5 | gm | 24.0 | 60.0 | 58.97 |
| | 50% WG - | | | | | |
| T6 | Spiromesifen | 1.0 | ml | 26.0 | 65.0 | 64.10 |
| | 22.90% SC - | | | | | |
| T7 | Control | | | 1.0 | 2.5 | 0.00 |

| | |
|---|---|
| CD (0.01%) | 0.59 |

Conclusion: In vitro bio-efficacy study revealed that Embodiment 9@1.0 ml/lit showed highest mortality percentage 89.74% at 72 hours followed by Embodiment 9@0.5 ml/l showed 69.23% against Potato Whitefly.

### Example 57: In Vitro Bio-Efficacy of Bio-Insecticides (Embodiment) and Synthetic Insecticides Against Tomato Thrips

### Material and Methodology:

Insect Studied: Tomato thrips (Collected culture from insectary section)
Host plant leaves: Tomato leaves (For Thrips feeding)
No. of Treatments: 17

### Results:

TABLE 59
In vitro Bio-efficacy of Bio-Insecticides (Embodiment)
and Synthetic Insecticides against Tomato Thrips

| | | | Total no | | % |
|---|---|---|---|---|---|
| | | Dose | of dead | % | Corrected |
| Tr. | | ml or | insects | Mortality | Mortality |
| No. | Treatments | gm/lit | at 72 hrs. | at 72 hrs. | at 72 hrs. |
| T1 | Embodiment 9 | 0.5 ml | 26.0 | 65.0 | 63.16 |
| T2 | Embodiment 9 | 1.0 ml | 36.0 | 90.0 | 89.47 |
| T3 | Fluxametamide | 0.8 ml | 24.0 | 60.0 | 57.89 |
| T4 | Brofranilide | 0.17 ml | 20.0 | 50.0 | 47.37 |
| T5 | Imidachlopride | 0.5 ml | 25.0 | 62.5 | 60.53 |
| | 17.8% SL | | | | |
| T6 | Spinetoram | 0.9 ml | 24.0 | 60.0 | 57.89 |
| | 11.7% SC | | | | |
| T7 | Control | | 2.0 | 5.0 | 0.00 |

| | |
|---|---|
| CD (0.01%) | 0.42 |

Conclusion: In vitro bio-efficacy study revealed that Embodiment 9@1.0 ml/lit showed highest mortality percentage 89.47% followed by Embodiment 9@0.5 ml/lit showed highest mortality percentage 63.16% at 72 hrs against Tomato Thrips.

### Example 58: In Vitro Bio-Efficacy of Bio-Insecticides (Embodiment) and Synthetic Insecticides Against Rice Root Knot Nematode (Meloidogyne graminicola)

### Material and Methodology:

Insect Studied: Rice Root Knot Nematode (Meloidogyne graminicola) (Collected culture from insectary section)
Medium to survive: Water (As a Nematode Survive medium)
No. of Treatments: 5

### Results:

TABLE 60
In vitro Bio-efficacy of Bio-Insecticides (Embodiment) and
Synthetic Insecticides against Rice Root Knot Nematode

| | | | | Total no | | % |
|---|---|---|---|---|---|---|
| | | Dose | | of dead | % | Corrected |
| Tr. | | ml or | | insects | Mortality | Mortality |
| No. | Treatments | gm/lit | | at 48 hrs. | at 48 hrs. | at 48 hrs |
| T1 | Embodiment 12 | 1.0 | ml | 30.0 | 75.0 | 74.36 |
| T2 | Embodiment 12 | 2.0 | ml | 38.0 | 95.0 | 94.87 |
| T3 | Fluopyrum | 1.25 | ml | 28.0 | 70.0 | 69.23 |
| | 34.48% SC | | | | | |
| T4 | Nemastin | 5.0 | gm | 27.0 | 67.5 | 66.67 |
| T5 | Control | | | 1.0 | 2.5 | 0.00 |

| | |
|---|---|
| CD (0.01%) | 0.43 |

Conclusion: In vitro bio-efficacy study revealed that Embodiment 12@2.0 ml/lit showed highest mortality percentage 94.87% at 48 hrs. followed by Embodiment 12@1.0 ml/lit showed mortality percentage 74.36% against Rice Root Knot Nematode.

### Example 59: In Vitro Bio-Efficacy of Bio-Insecticides (Embodiment) and Synthetic Insecticides Against Tomato Root Knot Nematode (Meloidogyne incognita)

Insect Studied: Tomato Root Knot Nematode (Meloidogyne incognita) (Collected culture from insectary section)
Medium to survive: Water (As a Nematode survive medium)
No. of Treatments: 5

### Results:

TABLE 61
In vitro Bio-efficacy of Bio-Insecticides (Embodiment) and
Synthetic Insecticides against Tomato Root Knot Nematode.

| | | | | Total no | | % |
|---|---|---|---|---|---|---|
| | | Dose | | of dead | % | Corrected |
| Tr. | | ml or | | insects | Mortality | Mortality |
| No. | Treatments | gm/lit | | at 48 hrs. | at 48 hrs. | at 48 hrs. |
| T1 | Embodiment 12 | 1.0 | ml | 26.0 | 65.0 | 64.10 |
| T2 | Embodiment 12 | 2.0 | ml | 35.0 | 87.5 | 87.18 |
| T3 | Fluopyrum | 1.25 | ml | 25.0 | 62.5 | 61.54 |
| | 34.48% SC | | | | | |
| T4 | Nemastin | 5.0 | gm | 22.0 | 55.0 | 53.85 |
| T5 | Control | | | 1.0 | 2.5 | 0.00 |

| | |
|---|---|
| CD (0.01%) | 0.56 |

Conclusion: In vitro bio-efficacy study revealed that Embodiment 12@2.0 ml/lit showed highest mortality percentage 87.18% at 48 hrs. followed by Embodiment 12@1.0 ml/lit recorded mortality percentage 64.10% against Rice Root Knot Nematode.

### Example 60: Bio-Efficacy of Bio-Insecticides (Embodiment) and Synthetic Insecticides Against Cotton Aphid (Aphis gossypii)

Methodology: The field experimental trial was conducted to study the bio-efficacy of different bio-insecticide and synthetic insecticides against Cotton aphid during kharif season 2022-2023 at Kay Bee Research and Development Farm, Maharashtra, India. The experiment was laid out by using randomized block design with three replication and fourteen treatments following spacings of 120 cm and 60 cm between rows and plants respectively. Each treatment consisted of an area of 5×4 m. Recommended agronomic practices were followed raise the Cotton crop. Observations on aphid population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 62
Effect of Bio-Insecticide and Synthetic Insecticides on Aphid
Population, % Population Reduction & yield of cotton.

| | | | | | 1^{st} spray | | 2^{nd} spray | | | |
|---|---|---|---|---|---|---|---|---|---|---|
| | | | | | | % | | % | | % |
| | | | | No. of | No. of | Reduction | No. of | Reduction | | Increase |
| | | Dose | | Aphid | Aphid | in Aphids | Aphid | in Aphids | | in Yield |
| Tr. | | ml or | | before | after | Population | after | Population | Yield | over |
| No. | Treatments | gm/L | | spray | 1st spray | over control | 2nd spray | over control | (qtl/ha) | control |
| T1 | Embodiment 1 | 0.5 | ml | 22.18 | 5.01 | 82.11 | 3.39 | 89.10 | 22.91 | 23.92 |
| T2 | Embodiment 1 | 1 | ml | 23.76 | 4.31 | 84.61 | 2.93 | 90.58 | 24.11 | 27.71 |
| T3 | Embodiment 1 | 2 | ml | 21.55 | 3.12 | 88.86 | 2.1 | 93.25 | 26.73 | 34.79 |
| T4 | Embodiment 3 | 0.5 | ml | 24.67 | 4.61 | 83.54 | 3.13 | 89.94 | 22.82 | 23.62 |
| T5 | Embodiment 3 | 1 | ml | 26.77 | 4.39 | 84.32 | 2.96 | 90.48 | 23.78 | 26.70 |
| T6 | Embodiment 3 | 2 | ml | 25.76 | 3.98 | 85.79 | 2.7 | 91.32 | 25.46 | 31.54 |
| T7 | Embodiment 4 | 0.5 | ml | 22.78 | 4.9 | 82.50 | 3.35 | 89.23 | 22.92 | 23.95 |
| T8 | Embodiment 4 | 1 | ml | 25.45 | 4.48 | 84.00 | 3.03 | 90.26 | 23.58 | 26.08 |
| T9 | Embodiment 4 | 2 | ml | 23.67 | 4.12 | 85.29 | 2.77 | 91.09 | 24.46 | 28.74 |
| T10 | Beta- | 1 | ml | 24.76 | 4.9 | 82.50 | 3.32 | 89.32 | 22.89 | 23.85 |
| | Cyfluthrin + | | | | | | | | | |
| | Imidacloprid | | | | | | | | | |
| | 300 OD (8.49 + | | | | | | | | | |
| | 19.81% w/w) | | | | | | | | | |
| T11 | Lambda- | 2.5 | ml | 26.78 | 4.68 | 83.29 | 3.17 | 89.81 | 22.81 | 23.59 |
| | CYHALOTHRIN | | | | | | | | | |
| | 5% EC | | | | | | | | | |
| T12 | Thiamethoxam | 0.4 | gm | 24.67 | 4.51 | 83.89 | 3.05 | 90.19 | 22.99 | 24.18 |
| | 25% WG | | | | | | | | | |
| T13 | Acetamiprid | 0.5 | gm | 22.18 | 4.53 | 83.82 | 3.07 | 90.13 | 22.82 | 23.62 |
| | 20% SP | | | | | | | | | |

| | | | | | | | | | |
|---|---|---|---|---|---|---|---|---|---|
| T14 | Control | — | 24.00 | 28.00 | 0.00 | 31.1 | 0.00 | 17.43 | 0.00 |

| | | | | |
|---|---|---|---|---|
| SE± | 0.71 | 1.20 | 2.10 | 2.55 |
| C.D. (0.05) | NS | 3.58 | 6.30 | 7.51 |

1. The results of the trial revealed that an application of Embodiment 1@2 ml/l recorded the maximum % reduction in aphids population of 88.86% and 93.25% in 1st and 2nd spray over the control, respectively.
2. The Embodiment 1 exhibited the highest 34.79% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 61: Bio-Efficacy of Bio-Insecticides (Embodiment) and Synthetic Insecticides Against Tomato Aphid (Myzus persicae)

Methodology: The field experimental trial was conducted to study the bio-efficacy of different bio-insecticide and synthetic insecticides against Tomato aphid during kharif season 2022-2023 at Kay Bee Research and Development Farm, Maharashtra, India. The experiment was laid out by using randomized block design with three replication and fourteen treatments following spacings of 90 cm and 30 cm between rows and plants respectively. Each treatment consisted of an area of 5×4 m. Recommended agronomic practices were followed raise the Tomato crop. Observations on aphid population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 63
Effect of Bio-Insecticide and Synthetic Insecticides on Aphid
Population, % Population Reduction & Yield of Tomato.

| | | | | | 1^{st} spray | | 2^{nd} spray | | | |
|---|---|---|---|---|---|---|---|---|---|---|
| | | | | | | % | | % | | % |
| | | | | No. of | No. of | Reduction | No. of | Reduction | | Increase |
| | | Dose | | Aphid | Aphid | in Aphids | Aphid | in Aphids | | in Yield |
| Tr. | | ml or | | before | after | Population | after | Population | Yield | over |
| No. | Treatments | gm/L | | spray | 1st spray | over control | 2nd spray | over control | (qtl/ha) | control |
| T1 | Embodiment 1 | 0.5 | ml | 12.22 | 5.01 | 73.63 | 3.58 | 84.02 | 33.11 | 14.56 |
| T2 | Embodiment 1 | 1 | ml | 13.80 | 4.6 | 75.79 | 3.29 | 85.31 | 34.08 | 16.99 |
| T3 | Embodiment 1 | 2 | ml | 11.60 | 3.9 | 79.47 | 2.7 | 87.95 | 37.64 | 24.84 |
| T4 | Embodiment 3 | 0.5 | ml | 14.67 | 4.95 | 73.95 | 3.54 | 84.20 | 32.98 | 14.22 |
| T5 | Embodiment 3 | 1 | ml | 15.80 | 4.39 | 76.89 | 3.14 | 85.98 | 34.36 | 17.67 |
| T6 | Embodiment 3 | 2 | ml | 16.45 | 4.13 | 78.26 | 2.9 | 87.05 | 36.80 | 23.13 |
| T7 | Embodiment 4 | 0.5 | ml | 12.98 | 4.9 | 74.21 | 3.5 | 84.38 | 33.13 | 14.61 |
| T8 | Embodiment 4 | 1 | ml | 15.70 | 4.35 | 77.11 | 3.11 | 86.12 | 34.86 | 18.85 |
| T9 | Embodiment 4 | 2 | ml | 13.87 | 3.12 | 83.58 | 2.23 | 90.04 | 38.36 | 26.25 |
| T10 | Beta- | 1 | ml | 14.72 | 4.9 | 74.21 | 3.52 | 84.29 | 33.09 | 14.51 |
| | Cyfluthrin + | | | | | | | | | |
| | Imidacloprid | | | | | | | | | |
| | 300 OD (8.49 + | | | | | | | | | |
| | 19.81% w/w) | | | | | | | | | |
| T11 | Lambda- | 2.5 | ml | 16.88 | 4.68 | 75.37 | 3.35 | 85.04 | 32.97 | 14.19 |
| | cyhalothrin | | | | | | | | | |
| | 5% EC | | | | | | | | | |
| T12 | Thiamethoxam | 0.4 | gm | 14.55 | 4.77 | 74.89 | 3.41 | 84.78 | 33.24 | 14.89 |
| | 25% WG | | | | | | | | | |
| T13 | Acetamiprid | 0.5 | gm | 12.57 | 4.66 | 75.47 | 3.33 | 85.13 | 33.55 | 15.68 |
| | 20% SP | | | | | | | | | |

| | | | | | | | | | |
|---|---|---|---|---|---|---|---|---|---|
| T14 | Control | — | 14.00 | 19.00 | 0.00 | 22.4 | 0.00 | 28.29 | 0.00 |

| | | | | |
|---|---|---|---|---|
| SE± | 0.78 | 1.10 | 2.16 | 2.60 |
| C.D. (0.05) | NS | 3.30 | 6.47 | 7.80 |

### Conclusion:

1. The results of the trial revealed that an application of Embodiment 4@2 ml/l recorded the maximum % reduction in aphids' population of 83.58% and 90.04% in 1st and 2nd spray over the control, respectively.
2. The Embodiment 4 exhibited the highest 26.25% increase in yield over the control. All the Embodiments reported phyto-tonic effects on plants.
3. All the Embodiments having dose of 2 ml and 1 ml recorded maximum reduction in % insect population with increases in yield followed by rest of the treatments.

### Example 62: Bio-Efficacy of Bio-Insecticides (Embodiment) and Synthetic Insecticides Against Wheat Aphid (Sitobion avenae)

Methodology: The field experimental trial was conducted to study the bio-efficacy of different bio-insecticide and synthetic insecticides against Wheat aphid during rabi season 2022-2023 at Kay Bee Research and Development Farm, Maharashtra, India. The experiment was laid out by using randomized block design with three replication and fourteen treatments following spacings of 22.5 cm between row to row. Each treatment consisted of an area of 5×4 m. Recommended agronomic practices were followed raise the Wheat crop. Observations on aphid population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 64
Effect of Bio-Insecticide and Synthetic Insecticides on
Aphid Population, % Population Reduction& yield of wheat.

| | | | | | 1^{st} spray | | 2^{nd} spray | | | |
|---|---|---|---|---|---|---|---|---|---|---|
| | | | | | | % | | % | | % |
| | | | | | No. of | Reduction | No. of | Reduction | | Increase |
| | | Dose | | No. of | Aphid | in Aphids | Aphid | in Aphids | | in Yield |
| Tr. | | ml or | | Aphid | after | Population | after | Population | Yield | over |
| No. | Treatments | gm/L | | before | 1st spray | over control | 2nd spray | over control | (qtl/ha) | control |
| T1 | Embodiment 1 | 0.5 | ml | 7.57 | 3.61 | 55.81 | 2.07 | 93.34 | 30.10 | 19.57 |
| T2 | Embodiment 1 | 1 | ml | 7.67 | 2.40 | 70.62 | 1.77 | 94.31 | 31.68 | 23.58 |
| T3 | Embodiment 1 | 2 | ml | 8.33 | 1.72 | 78.95 | 1.37 | 95.59 | 35.12 | 31.06 |
| T4 | Embodiment 3 | 0.5 | ml | 7.67 | 3.41 | 58.26 | 2.47 | 92.06 | 29.98 | 19.25 |
| T5 | Embodiment 3 | 1 | ml | 8.00 | 2.51 | 69.28 | 1.50 | 95.18 | 31.24 | 22.50 |
| T6 | Embodiment 3 | 2 | ml | 7.87 | 1.75 | 78.58 | 1.47 | 95.27 | 33.45 | 27.62 |
| T7 | Embodiment 4 | 0.5 | ml | 8.67 | 3.5 | 57.16 | 2.17 | 93.02 | 30.12 | 19.62 |
| T8 | Embodiment 4 | 1 | ml | 8.23 | 2.7 | 66.95 | 1.57 | 94.95 | 30.98 | 21.85 |
| T9 | Embodiment 4 | 2 | ml | 7.67 | 2.01 | 75.40 | 1.47 | 95.27 | 32.14 | 24.67 |
| T10 | Beta- | 1 | ml | 8.33 | 3.50 | 57.16 | 1.77 | 94.31 | 30.08 | 19.51 |
| | Cyfluthrin + | | | | | | | | | |
| | Imidacloprid | | | | | | | | | |
| | 300 OD (8.49 + | | | | | | | | | |
| | 19.81% w/w) | | | | | | | | | |
| T11 | Lambda- | 2.5 | ml | 7.67 | 3.28 | 59.85 | 2.37 | 92.38 | 29.97 | 19.22 |
| | cyhalothrin | | | | | | | | | |
| | 5% EC | | | | | | | | | |
| T12 | Thiamethoxam | 0.4 | gm | 8.00 | 3.11 | 61.93 | 2.07 | 93.34 | 30.20 | 19.83 |
| | 25% WG | | | | | | | | | |
| T13 | Acetamiprid | 0.5 | gm | 7.47 | 3.13 | 61.69 | 2.53 | 91.86 | 29.98 | 19.25 |
| | 20% SP | | | | | | | | | |

| | | | | | | | | | |
|---|---|---|---|---|---|---|---|---|---|
| T14 | Control | — | 7.67 | 8.17 | 0.00 | 31.1 | 0.00 | 24.21 | 0.00 |

| | | | | |
|---|---|---|---|---|
| SE± | 0.72 | 1.15 | 2.06 | 2.57 |
| C.D. (0.05) | NS | 3.45 | 6.09 | 7.73 |

### Conclusion:

1. The results of the trial revealed that an application of Embodiment 1@2 ml/l recorded the maximum % reduction in aphids population of 78.95% and 95.59% in 1st and 2nd spray over the control, respectively.
2. The Embodiment 1 exhibited the highest 31.06% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 63: Bio-Efficacy of Bio-Insecticides (Embodiment) and Synthetic Insecticides Against Cotton Hopper (Amrasca Biguttula Biguttula)

Methodology: The field experimental trial was conducted to study the bio-efficacy of different bio-insecticide and synthetic insecticides against Cotton hopper during kharif season 2022-2023 at Kay Bee Research and Development Farm, Maharashtra, India. The experiment was laid out by using randomized block design with three replication and fourteen treatments following spacings of 120 cm and 60 cm between rows and plants respectively. Each treatment consisted of an area of 5×4 m. Recommended agronomic practices were followed raise the Cotton crop. Observations on hopper population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 65
Effect of Bio-Insecticide and Synthetic Insecticides on Hopper
Population, % Population Reduction & Yield of Cotton.

| | | | | | 1^{st} spray | | 2^{nd} spray | | | |
|---|---|---|---|---|---|---|---|---|---|---|
| | | | | | | % | | % | | % |
| | | | | No. of | No. of | Reduction | No. of | Reduction | | Increase |
| | | Dose | | Hopper | Hopper | in Hopper | Hopper | in Hopper | | in Yield |
| Tr. | | ml or | | before | after | Population | after | Population | Yield | over |
| No. | Treatments | gm/L | | spray | 1st spray | over control | 2nd spray | over control | (qtl/ha) | control |
| T1 | Embodiment 1 | 0.5 | ml | 12.34 | 4.24 | 72.52 | 2.84 | 83.59 | 19.05 | 15.33 |
| T2 | Embodiment 1 | 1 | ml | 11.71 | 3.71 | 75.96 | 2.54 | 85.33 | 20.75 | 22.27 |
| T3 | Embodiment 1 | 2 | ml | 11.76 | 3.23 | 79.07 | 2.23 | 87.12 | 21.97 | 26.58 |
| T4 | Embodiment 3 | 0.5 | ml | 13.72 | 4.11 | 73.36 | 2.8 | 83.82 | 18.87 | 14.52 |
| T5 | Embodiment 3 | 1 | ml | 12.57 | 3.78 | 75.50 | 2.7 | 84.40 | 20.52 | 21.39 |
| T6 | Embodiment 3 | 2 | ml | 11.02 | 2.28 | 85.22 | 1.82 | 89.49 | 23.13 | 30.26 |
| T7 | Embodiment 4 | 0.5 | ml | 9.96 | 4.35 | 71.81 | 2.98 | 82.78 | 19.14 | 15.73 |
| T8 | Embodiment 4 | 1 | ml | 10.35 | 3.59 | 76.73 | 2.44 | 85.90 | 19.43 | 16.98 |
| T9 | Embodiment 4 | 2 | ml | 11.58 | 2.89 | 81.27 | 1.91 | 88.97 | 20.48 | 21.24 |
| T10 | Beta- | 1 | ml | 9.88 | 4.22 | 72.65 | 2.83 | 83.65 | 19.18 | 15.90 |
| | Cyfluthrin + | | | | | | | | | |
| | Imidacloprid | | | | | | | | | |
| | 300 OD (8.49 + | | | | | | | | | |
| | 19.81% w/w) | | | | | | | | | |
| T11 | Lambda- | 2.5 | ml | 10.94 | 4.25 | 72.46 | 2.99 | 82.73 | 18.98 | 15.02 |
| | cyhalothrin | | | | | | | | | |
| | 5% EC | | | | | | | | | |
| T12 | Thiamethoxam | 0.4 | gm | 11.18 | 4.48 | 70.97 | 3.00 | 82.67 | 18.83 | 14.34 |
| | 25% WG | | | | | | | | | |
| T13 | Acetamiprid | 0.5 | gm | 12.88 | 4.53 | 70.64 | 2.85 | 83.54 | 18.78 | 14.11 |
| | 20% SP | | | | | | | | | |

| | | | | | | | | | |
|---|---|---|---|---|---|---|---|---|---|
| T14 | Control | — | 11.25 | 15.43 | 0.00 | 17.31 | 0.00 | 16.13 | 0.00 |

| | | | | |
|---|---|---|---|---|
| SE± | 0.68 | 1.22 | 2.13 | 2.53 |
| C.D. (0.05) | NS | 3.64 | 6.39 | 7.52 |

### Conclusion:

1. The results of the trial revealed that an application of Embodiment 3@2 ml/l recorded the maximum % reduction in Hopper population of 85.22% and 89.49% in 1st and 2nd spray over the control, respectively.
2. The Embodiment 3 exhibited the highest 30.26% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 64: Bio-Efficacy of Bio-Insecticides (Embodiment) and Synthetic Insecticides Against Potato Hopper (Amarasca devastance)

Methodology: The field experimental trial was conducted to study the bio-efficacy of different bio-insecticide and synthetic insecticides against Potato hopper during rabi season 2022-2023 at Kay Bee Research and Development Farm, Maharashtra, India. The experiment was laid out by using randomized block design with three replication and fourteen treatments following spacings of 60 cm and 20 cm between rows and plants respectively. Each treatment consisted of an area of 5×4 m. Recommended agronomic practices were followed raise the potato crop. Observations on hopper population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} \times 100$$

### Results:

TABLE 66
Effect of Bio-Insecticide and Synthetic Insecticides on Hopper
Population, % Population Reduction & yield of potato.

| | | | | | 1^{st} spray | | 2^{nd} spray | | | |
|---|---|---|---|---|---|---|---|---|---|---|
| | | | | | | % | | % | | % |
| | | | | No. of | No. of | Reduction | No. of | Reduction | | Increase |
| | | Dose | | Hopper | Hopper | in Hopper | Hopper | in Hopper | | in Yield |
| Tr. | | ml or | | before | after | Population | after | Population | Yield | over |
| No. | Treatments | gm/L | | spray | 1st spray | over control | 2nd spray | over control | (qtl/ha) | control |
| T1 | Embodiment 1 | 0.5 | ml | 10.46 | 3.38 | 80.11 | 2.73 | 85.52 | 23.88 | 14.28 |
| T2 | Embodiment 1 | 1 | ml | 11.18 | 2.83 | 83.34 | 2.31 | 87.75 | 24.74 | 17.26 |
| T3 | Embodiment 1 | 2 | ml | 10.4 | 2.21 | 86.99 | 1.68 | 91.09 | 26.25 | 22.02 |
| T4 | Embodiment 3 | 0.5 | ml | 12.4 | 3.64 | 78.58 | 2.71 | 85.62 | 24.01 | 14.74 |
| T5 | Embodiment 3 | 1 | ml | 12.01 | 2.94 | 82.70 | 2.33 | 87.64 | 24.2 | 15.41 |
| T6 | Embodiment 3 | 2 | ml | 11.76 | 2.53 | 85.11 | 1.84 | 90.24 | 25.89 | 20.93 |
| T7 | Embodiment 4 | 0.5 | ml | 10.61 | 3.77 | 77.81 | 2.97 | 84.24 | 23.78 | 13.92 |
| T8 | Embodiment 4 | 1 | ml | 11.8 | 3.02 | 82.22 | 2.50 | 86.74 | 24.17 | 15.31 |
| T9 | Embodiment 4 | 2 | ml | 11.28 | 2.57 | 84.87 | 2.04 | 89.18 | 25.77 | 20.57 |
| T10 | Beta- | 1 | ml | 13.15 | 3.13 | 81.58 | 2.65 | 85.94 | 23.9 | 14.35 |
| | Cyfluthrin + | | | | | | | | | |
| | Imidacloprid | | | | | | | | | |
| | 300 OD (8.49 + | | | | | | | | | |
| | 19.81% w/w) | | | | | | | | | |
| T11 | Lambda- | 2.5 | ml | 10.85 | 2.91 | 82.87 | 2.48 | 86.84 | 23.94 | 14.49 |
| | cyhalothrin | | | | | | | | | |
| | 5% EC | | | | | | | | | |
| T12 | Thiamethoxam | 0.4 | gm | 11.73 | 3.54 | 79.16 | 2.88 | 84.72 | 23.58 | 13.19 |
| | 25% WG | | | | | | | | | |
| T13 | Acetamiprid | 0.5 | gm | 10.42 | 3.04 | 82.11 | 2.57 | 86.37 | 23.81 | 14.03 |
| | 20% SP | | | | | | | | | |

| | | | | | | | | | |
|---|---|---|---|---|---|---|---|---|---|
| T14 | Control | — | 12.85 | 16.99 | 0.00 | 18.85 | 0.00 | 20.47 | 0.00 |

| | | | | |
|---|---|---|---|---|
| SE± | 0.80 | 1.25 | 2.11 | 2.48 |
| C.D. (0.05) | NS | 3.76 | 6.34 | 7.49 |

### Conclusion:

1. The results of the trial revealed that an application of Embodiment 1@2 ml/l recorded the maximum % reduction in hopper population of 86.99% and 91.09% in 1st and 2nd spray over the control, respectively.
2. The Embodiment 1 exhibited the highest 22.02% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 65: Bio-Efficacy of Bio-Insecticides (Embodiment) and Synthetic Insecticides Against Rice Hopper (Nilaparvata lugens)

Methodology: The field experimental trial was conducted to study the bio-efficacy of different bio-insecticide and synthetic insecticides against Rice hopper during kharif season 2022-2023 at Kay Bee Research and Development Farm, Maharashtra, India. The experiment was laid out by using randomized block design with three replication and fourteen treatments following spacings of 30 cm and 10 cm between rows and plants respectively. Each treatment consisted of an area of 5×4 m. Recommended agronomic practices were followed raise the Rice crop. Observations on hopper population were taken on randomly selected five rice hills. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} \times 100$$

### Results:

TABLE 67
Effect of Bio-Insecticide and Synthetic Insecticides on Hopper
Population, % Population Reduction & Yield of rice.

| | | | | | 1^{st} spray | | 2^{nd} spray | | | |
|---|---|---|---|---|---|---|---|---|---|---|
| | | | | | | % | | % | | % |
| | | | | No. of | No. of | Reduction | No. of | Reduction | | Increase |
| | | Dose | | Hopper | Hopper | in Hopper | Hopper | in Hopper | | in Yield |
| Tr. | | ml or | | before | after | Population | after | Population | Yield | over |
| No. | Treatments | gm/L | | spray | 1st spray | over control | 2nd spray | over control | (qtl/ha) | control |
| T1 | Embodiment 1 | 0.5 | ml | 9.77 | 4.57 | 72.22 | 3.98 | 80.24 | 37.14 | 12.74 |
| T2 | Embodiment 1 | 1 | ml | 11.04 | 4.22 | 74.35 | 3.18 | 84.21 | 39.74 | 18.44 |
| T3 | Embodiment 1 | 2 | ml | 9.28 | 3.58 | 78.24 | 2.51 | 87.54 | 43.74 | 25.90 |
| T4 | Embodiment 3 | 0.5 | ml | 11.73 | 4.52 | 72.52 | 3.46 | 82.82 | 38.07 | 14.87 |
| T5 | Embodiment 3 | 1 | ml | 12.64 | 4.12 | 74.95 | 2.80 | 86.10 | 40.65 | 20.27 |
| T6 | Embodiment 3 | 2 | ml | 13.16 | 2.77 | 83.16 | 1.90 | 90.57 | 45.12 | 28.17 |
| T7 | Embodiment 4 | 0.5 | ml | 10.38 | 4.47 | 72.83 | 3.78 | 81.23 | 37.77 | 14.19 |
| T8 | Embodiment 4 | 1 | ml | 12.56 | 3.9 | 76.29 | 2.86 | 85.80 | 40.21 | 19.40 |
| T9 | Embodiment 4 | 2 | ml | 11.09 | 2.85 | 82.67 | 2.17 | 89.23 | 44.43 | 27.05 |
| T10 | Beta- | 1 | ml | 11.77 | 4.5 | 72.64 | 3.44 | 82.92 | 38.45 | 15.71 |
| | Cyfluthrin + | | | | | | | | | |
| | Imidacloprid | | | | | | | | | |
| | 300 OD (8.49 + | | | | | | | | | |
| | 19.81% w/w) | | | | | | | | | |
| T11 | Lambda- | 2.5 | ml | 13.50 | 4.35 | 73.56 | 3.86 | 80.83 | 37.47 | 13.50 |
| | cyhalothrin | | | | | | | | | |
| | 5% EC | | | | | | | | | |
| T12 | Thiamethoxam | 0.4 | gm | 11.64 | 4.45 | 72.95 | 3.71 | 81.58 | 38.11 | 14.96 |
| | 25% WG | | | | | | | | | |
| T13 | Acetamiprid | 0.5 | gm | 10.05 | 4.55 | 72.34 | 3.89 | 80.69 | 37 | 12.41 |

| | | | | | | | | | |
|---|---|---|---|---|---|---|---|---|---|
| | 20% SP | | | | | | | | |
| T14 | Control | — | 11.2 | 16.45 | 0.00 | 20.14 | 0.00 | 32.41 | 0.00 |

| | | | | |
|---|---|---|---|---|
| SE± | 0.77 | 1.27 | 2.19 | 2.59 |
| C.D. (0.05) | NS | 3.81 | 6.54 | 7.79 |

### Conclusion:

1. The results of the trial revealed that an application of Embodiment 3@2 ml/l recorded the maximum % reduction in Hopper population of 83.16% and 90.57% in 1st and 2nd spray over the control, respectively.
2. The Embodiment 3 exhibited the highest 28.17% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 66: Bio-Efficacy of Bio-Insecticides (Embodiment) and Synthetic Insecticides Against Cotton Whiteflies (Bemisia tabaci)

Methodology: The field experimental trial was conducted to study the bio-efficacy of different bio-insecticide and synthetic insecticides against cotton whiteflies during kharif season 2022-2023 at Kay Bee Research and Development Farm, Maharashtra, India. The experiment was laid out by using randomized block design with three replication and fourteen treatments following spacings of 120 cm and 60 cm between rows and plants respectively. Each treatment consisted of an area of 5×4 m. Recommended agronomic practices were followed raise the Cotton crop. Observations on whiteflies population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 68
Effect of Bio-Insecticide and Synthetic Insecticides on Whiteflies Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction in | | Reduction in | | Increase |
| | | Dose | | whiteflies | | Whiteflies | | Whiteflies | | in Yield |
| Tr. | | ml or | | before | No. of | Population | No. of | Population | Yield | over |
| No. | Treatments | gm/L | | spray | whiteflies | over control | whiteflies | over control | (qtl/ha) | control |
| T1 | Embodiment 1 | 0.5 | ml | 14.74 | 4.85 | 71.69 | 3.72 | 79.69 | 13.36 | 15.27 |
| T2 | Embodiment 1 | 1.0 | ml | 15.22 | 4.03 | 76.47 | 3.02 | 83.52 | 14.00 | 19.14 |
| T3 | Embodiment 1 | 2.0 | ml | 15.28 | 3.25 | 81.03 | 2.66 | 85.48 | 14.73 | 23.15 |
| T4 | Embodiment 3 | 0.5 | ml | 17.82 | 4.32 | 74.78 | 3.79 | 79.31 | 13.32 | 15.02 |
| T5 | Embodiment 3 | 1.0 | ml | 16.33 | 4.24 | 75.25 | 3.12 | 82.97 | 14.16 | 20.06 |
| T6 | Embodiment 3 | 2.0 | ml | 14.32 | 3.17 | 81.49 | 2.45 | 86.63 | 14.94 | 24.23 |
| T7 | Embodiment 4 | 0.5 | ml | 12.94 | 5.03 | 70.64 | 3.92 | 78.60 | 13.49 | 16.09 |
| T8 | Embodiment 4 | 1.0 | ml | 13.45 | 4.28 | 75.01 | 3.15 | 82.81 | 13.82 | 18.09 |
| T9 | Embodiment 4 | 2.0 | ml | 15.05 | 3.30 | 80.74 | 2.52 | 86.24 | 14.22 | 20.39 |
| T10 | Acephate 50% + | 2.0 | g | 12.84 | 4.56 | 73.38 | 3.77 | 79.42 | 13.48 | 16.02 |
| | Imidacloprid | | | | | | | | | |
| | 1.8% SP | | | | | | | | | |
| T11 | Pyriproxyfen | 1.5 | ml | 14.22 | 4.76 | 72.21 | 3.92 | 78.60 | 13.37 | 15.33 |
| | 05.00% + | | | | | | | | | |
| | Fenpropathrin | | | | | | | | | |
| | 15.00% EC | | | | | | | | | |
| T12 | Beta- | 1.0 | ml | 14.52 | 4.56 | 73.38 | 3.84 | 79.04 | 13.70 | 17.37 |
| | Cyfluthrin + | | | | | | | | | |
| | Imidacloprid | | | | | | | | | |
| | 300 OD | | | | | | | | | |
| T13 | Chlorpyrifos | 2.0 | ml | 16.73 | 4.32 | 74.78 | 3.56 | 80.57 | 13.27 | 14.69 |
| | 50.00% + | | | | | | | | | |
| | Cypermethrin | | | | | | | | | |
| | 05.00% EC | | | | | | | | | |

| | | | | | | | | | |
|---|---|---|---|---|---|---|---|---|---|
| T14 | Control | — | 15.92 | 17.13 | 0.00 | 18.32 | 0.00 | 11.32 | 0.00 |

| | | | | | | | |
|---|---|---|---|---|---|---|---|
| SE± | 1.22 | 1.99 | — | 1.24 | — | 2.24 | — |
| C.D. (0.05) | NS | 5.98 | — | 3.70 | — | 6.72 | — |

### Conclusion:

1. The results of the trial revealed that an application of Embodiment 3@2 ml/l recorded the maximum % reduction in whiteflies population of 81.49% and 86.63% in 1^{st} and 2^{nd} spray over the control, respectively.
2. The Embodiment 3 exhibited the highest 24.23% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 67: Bio-Efficacy of Bio-Insecticides (Embodiment) and Synthetic Insecticides Against Sweet Orange Whiteflies (Dialeurodes citri)

### Methodology:

The field experimental trial was conducted to study the bio-efficacy of different bio-insecticide and synthetic insecticides against sweet orange whiteflies during kharif season 2022-2023 at Kay Bee Research and Development Farm, Maharashtra, India. The experiment was laid out by using randomized block design with three replication and fourteen treatments following spacings of 6 m and 6 m between row to row and plant to plant respectively. Each treatment consisted of 20 plants. Recommended agronomic practices were followed raise the sweet orange crop. Observations on whiteflies population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 69
Effect of Bio-Insecticide and Synthetic Insecticides on Whiteflies Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction in | | Reduction in | | Increase |
| | | Dose | | whiteflies | | Whiteflies | | whiteflies | | in Yield |
| Tr. | | ml or | | before | No. of | Population | No. of | Population | Yield | over |
| No. | Treatments | gm/L | | spray | whiteflies | over control | whiteflies | over control | (t/ha) | control |
| T1 | Embodiment 1 | 0.5 | ml | 13.26 | 4.32 | 70.91 | 3.10 | 79.12 | 19.29 | 15.38 |
| T2 | Embodiment 1 | 1.0 | ml | 11.83 | 3.68 | 75.20 | 2.70 | 81.82 | 19.70 | 17.17 |
| T3 | Embodiment 1 | 2.0 | ml | 10.86 | 3.04 | 79.49 | 2.22 | 85.04 | 20.48 | 20.32 |
| T4 | Embodiment 3 | 0.5 | ml | 10.30 | 4.25 | 71.36 | 3.10 | 79.11 | 19.09 | 14.52 |
| T5 | Embodiment 3 | 1.0 | ml | 10.76 | 3.59 | 75.84 | 2.62 | 82.38 | 19.40 | 15.88 |
| T6 | Embodiment 3 | 2.0 | ml | 10.82 | 3.24 | 78.14 | 2.37 | 84.06 | 20.55 | 20.58 |
| T7 | Embodiment 4 | 0.5 | ml | 12.45 | 4.19 | 71.77 | 3.06 | 79.41 | 18.97 | 13.98 |
| T8 | Embodiment 4 | 1.0 | ml | 13.89 | 3.56 | 76.01 | 2.60 | 82.50 | 19.37 | 15.75 |
| T9 | Embodiment 4 | 2.0 | ml | 12.00 | 2.96 | 80.05 | 2.16 | 85.45 | 20.70 | 21.17 |
| T10 | Acephate 50% + | 2.0 | g | 11.86 | 4.30 | 71.04 | 3.14 | 78.88 | 19.10 | 14.55 |
| | Imidacloprid | | | | | | | | | |
| | 1.8% SP | | | | | | | | | |
| T11 | Pyriproxyfen | 1.5 | ml | 12.73 | 4.44 | 70.08 | 3.24 | 78.18 | 19.14 | 14.75 |
| | 05.00% + | | | | | | | | | |
| | Fenpropathrin | | | | | | | | | |
| | 15.00% EC | | | | | | | | | |
| T12 | Beta- | 1.0 | ml | 10.74 | 4.36 | 70.59 | 3.19 | 78.55 | 19.22 | 15.07 |
| | Cyfluthrin + | | | | | | | | | |
| | Imidacloprid | | | | | | | | | |
| | 300 OD | | | | | | | | | |
| T13 | Chlorpyrifos | 2.0 | ml | 12.21 | 4.10 | 72.38 | 2.99 | 79.86 | 19.26 | 15.26 |
| | 50.00% + | | | | | | | | | |
| | Cypermethrin | | | | | | | | | |
| | 05.00% EC | | | | | | | | | |

| | | | | | | | | | |
|---|---|---|---|---|---|---|---|---|---|
| T14 | Control | — | 11.43 | 14.84 | 0.00 | 14.85 | 0.00 | 16.32 | 0.00 |

| | | | | | |
|---|---|---|---|---|---|
| SE± | 0.91 | 1.57 | 2.12 | — | 1.89 |
| C.D. (0.05) | NS | 4.69 | 6.36 | — | 5.67 |

### Conclusion:

1. The results of the trial revealed that an application of Embodiment 4@2 ml/l recorded the maximum % reduction in whiteflies population of 80.05% and 85.45% in 1st and 2^{nd} spray over the control, respectively.
2. The Embodiment 4 exhibited the highest 21.17% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 68: Bio-Efficacy of Bio-Insecticides (Embodiment) and Synthetic Insecticides Against Tomato Whiteflies (Bemisia tabaci)

Methodology: The field experimental trial was conducted to study the bio-efficacy of different bio-insecticide and synthetic insecticides against tomato whiteflies during rabi season 2022-2023 at Kay Bee Research and Development Farm, Maharashtra, India. The experiment was laid out by using randomized block design with three replication and fourteen treatments following spacings of 90 cm and 30 cm between rows and plants respectively. Each treatment consisted of an area of 5×4 m. Recommended agronomic practices were followed raise the Tomato crop. Observations on whiteflies population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 70
Effect of Bio-Insecticide and Synthetic Insecticides on Whiteflies Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction in | | Reduction in | | Increase |
| | | Dose | | whiteflies | | Whiteflies | | whiteflies | | in Yield |
| Tr. | | ml or | | before | No. of | Population | No. of | Population | Yield | over |
| No. | Treatments | gm/L | | spray | whiteflies | over control | whiteflies | over control | (t/ha) | control |
| T1 | Embodiment 1 | 0.5 | ml | 16.59 | 4.54 | 72.80 | 3.69 | 79.16 | 39.99 | 14.43 |
| T2 | Embodiment 1 | 1.0 | ml | 15.10 | 3.87 | 76.81 | 3.61 | 79.61 | 42.48 | 19.44 |
| T3 | Embodiment 1 | 2.0 | ml | 13.09 | 3.20 | 80.82 | 2.54 | 85.66 | 44.82 | 23.65 |
| T4 | Embodiment 3 | 0.5 | ml | 13.51 | 4.47 | 73.22 | 4.22 | 76.16 | 40.08 | 14.62 |
| T5 | Embodiment 3 | 1.0 | ml | 13.99 | 3.77 | 77.41 | 3.40 | 80.80 | 42.00 | 18.52 |
| T6 | Embodiment 3 | 2.0 | ml | 14.05 | 3.41 | 79.56 | 2.62 | 85.21 | 44.19 | 22.56 |
| T7 | Embodiment 4 | 0.5 | ml | 11.71 | 4.52 | 72.94 | 4.20 | 76.25 | 40.47 | 15.44 |
| T8 | Embodiment 4 | 1.0 | ml | 12.22 | 3.90 | 76.63 | 3.65 | 79.38 | 41.46 | 17.46 |
| T9 | Embodiment 4 | 2.0 | ml | 13.82 | 3.27 | 80.40 | 2.67 | 84.93 | 43.66 | 21.62 |
| T10 | Acephate 50% + | 2.0 | g | 12.61 | 4.52 | 72.92 | 3.93 | 77.80 | 40.44 | 15.38 |
| | Imidacloprid | | | | | | | | | |
| | 1.8% SP | | | | | | | | | |
| T11 | Pyriproxyfen | 1.5 | ml | 12.99 | 4.67 | 72.02 | 4.13 | 76.67 | 40.11 | 14.68 |
| | 05.00% + | | | | | | | | | |
| | Fenpropathrin | | | | | | | | | |
| | 15.00% EC | | | | | | | | | |
| T12 | Beta- | 1.0 | ml | 13.29 | 4.59 | 72.50 | 3.93 | 77.80 | 41.10 | 16.74 |
| | Cyfluthrin + | | | | | | | | | |
| | Imidacloprid | | | | | | | | | |
| | 300 OD | | | | | | | | | |
| T13 | Chlorpyrifos | 2.0 | ml | 15.50 | 4.31 | 74.17 | 3.69 | 79.16 | 39.81 | 14.04 |
| | 50.00% + | | | | | | | | | |
| | Cypermethrin | | | | | | | | | |
| | 05.00% EC | | | | | | | | | |

| | | | | | | | | | |
|---|---|---|---|---|---|---|---|---|---|
| T14 | Control | — | 14.69 | 16.70 | 0.00 | 17.69 | 0.00 | 34.22 | 0.00 |

| | | | | | | |
|---|---|---|---|---|---|---|
| SE± | 1.14 | 2.14 | — | 1.98 | — | 2.87 |
| C.D. (0.05) | NS | 6.40 | — | 5.95 | — | 8.62 |

### Conclusion:

1. The results of the trial revealed that an application of Embodiment 1@2 ml/l recorded the maximum % reduction in whiteflies population of 80.82% and 85.66% in 1st and 2^{nd} spray over the control, respectively.
2. The Embodiment 1 exhibited the highest 23.65% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 69: Bio-Efficacy of Bio-Insecticides (Embodiment) and Synthetic Insecticides Against Cotton Mealy Bugs (Phenacoccus Solenopsis Tinsley)

Methodology: The field experimental trial was conducted to study the bio-efficacy of different bio-insecticide and synthetic insecticides against cotton mealy bugs during kharif season 2022-2023 at Kay Bee Research and Development Farm, Maharashtra, India. The experiment was laid out by using randomized block design with three replication and fourteen treatments following spacings of 120 cm and 60 cm between rows and plants respectively. Each treatment consisted of an area of 5×4 m. Recommended agronomic practices were followed raise the Cotton crop. Observations on mealy bugs population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 71
Effect of Bio-Insecticide and Synthetic Insecticides on mealy bugs Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction in | | Reduction in | | Increase |
| | | Dose | | mealy bugs | | mealy bugs | | mealy bugs | | in Yield |
| Tr. | | ml or | | before | No. of | Population | No. of | Population | Yield | over |
| No. | Treatments | gm/L | | spray | mealy bugs | over control | mealy bugs | over control | (t/ha) | control |
| T1 | Embodiment 2 | 0.5 | ml | 17.31 | 5.77 | 76.15 | 5.76 | 78.67 | 19.78 | 11.73 |
| T2 | Embodiment 2 | 1.0 | ml | 15.09 | 4.13 | 82.93 | 4.12 | 84.74 | 22.01 | 20.67 |
| T3 | Embodiment 2 | 2.0 | ml | 15.77 | 3.45 | 85.74 | 3.12 | 88.44 | 23.31 | 25.10 |
| T4 | Embodiment 3 | 0.5 | ml | 18.12 | 5.45 | 77.47 | 5.43 | 79.89 | 20.13 | 13.26 |
| T5 | Embodiment 3 | 1.0 | ml | 19.12 | 4.44 | 81.65 | 4.36 | 83.85 | 21.76 | 19.76 |
| T6 | Embodiment 3 | 2.0 | ml | 13.33 | 3.78 | 84.37 | 3.77 | 86.04 | 22.87 | 23.66 |
| T7 | Embodiment 6 | 0.5 | ml | 21.34 | 5.09 | 78.96 | 5.05 | 81.30 | 20.38 | 14.33 |
| T8 | Embodiment 6 | 1.0 | ml | 20.59 | 4.37 | 81.93 | 4.30 | 84.07 | 21.45 | 18.60 |
| T9 | Embodiment 6 | 2.0 | ml | 16.67 | 3.76 | 84.46 | 3.35 | 87.59 | 22.97 | 23.99 |
| T10 | Buprofezin | 2 | ml | 17.20 | 4.55 | 81.19 | 4.55 | 83.15 | 21.01 | 16.90 |
| | 25% SC | | | | | | | | | |
| T11 | Spirotetramat | 1 | ml | 22.88 | 4.56 | 81.15 | 4.53 | 83.22 | 20.89 | 16.42 |
| | 15.31% w/w | | | | | | | | | |
| | OD | | | | | | | | | |
| T12 | Buprofezin | 2.5 | g | 20.22 | 4.67 | 80.69 | 4.65 | 82.78 | 20.67 | 15.53 |
| | 20% + Acephate | | | | | | | | | |
| | 50% w/w WP | | | | | | | | | |
| T13 | Chloropyriphos | 2 | ml | 20.17 | 4.69 | 80.61 | 4.67 | 82.70 | 20.43 | 14.54 |
| | 50% + Cypermethrin | | | | | | | | | |
| | 5% EC | | | | | | | | | |

| | | | | | | | | | |
|---|---|---|---|---|---|---|---|---|---|
| T14 | Control | — | 21.11 | 24.19 | 0.00 | 27.00 | 0.00 | 17.46 | 0.00 |

| | | | | |
|---|---|---|---|---|
| SE± | 1.24 | 1.36 | 1.67 | 2.08 |
| C.D. (0.05) | NS | 4.08 | 5.01 | 6.24 |

### Conclusion:

1. The results of the trial revealed that an application of Embodiment 3@2 ml/l recorded the maximum % reduction in mealy bug population of 85.74% and 88.44% in 1st and 2^{nd} spray over the control, respectively.
2. The Embodiment 3 exhibited the highest 25.10% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 70: Bio-Efficacy of Bio-Insecticides (Embodiment) and Synthetic Insecticides Against Grapes Mealy Bugs (Maconellicoccus Hirsutus)

Methodology: The field experimental trial was conducted to study the bio-efficacy of different bio-insecticide and synthetic insecticides against grapes mealy bugs during rabi season 2022-2023 at Kay Bee Research and Development Farm, Maharashtra, India. The experiment was laid out by using randomized block design with three replication and fourteen treatments following spacings of 3 m×1.5 m between rows and plants respectively. Recommended agronomic practices were followed raise the grapes crop. Observations on mealy bugs population were taken on randomly selected five plants. Three bunches/plant were labelled to record Mealy Bug population. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 72
Effect of Bio-Insecticide and Synthetic Insecticides on mealy bugs Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction in | | Reduction in | | Increase |
| | | Dose | | mealy bugs | | mealy bugs | | mealy bugs | | in Yield |
| Tr. | | ml or | | before | No. of | Population | No. of | Population | Yield | over |
| No. | Treatments | gm/L | | spray | mealy bugs | over control | mealy bugs | over control | (t/ha) | control |
| T1 | Embodiment 2 | 0.5 | ml | 32.46 | 8.98 | 78.90 | 7.22 | 83.84 | 16.78 | 14.06 |
| T2 | Embodiment 2 | 1.0 | ml | 38.02 | 7.43 | 82.54 | 4.89 | 89.06 | 17.65 | 18.30 |
| T3 | Embodiment 2 | 2.0 | ml | 36.07 | 5.23 | 87.71 | 2.45 | 94.52 | 19.12 | 24.58 |
| T4 | Embodiment 3 | 0.5 | ml | 33.45 | 8.87 | 79.16 | 7.12 | 84.07 | 16.98 | 15.08 |
| T5 | Embodiment 3 | 1.0 | ml | 37.56 | 7.10 | 83.32 | 4.21 | 90.58 | 18.11 | 20.38 |
| T6 | Embodiment 3 | 2.0 | ml | 35.12 | 5.92 | 86.09 | 3.33 | 92.55 | 18.87 | 23.58 |
| T7 | Embodiment 6 | 0.5 | ml | 31.25 | 9.11 | 78.59 | 7.42 | 83.40 | 16.75 | 13.91 |
| T8 | Embodiment 6 | 1.0 | ml | 35.26 | 7.23 | 83.01 | 4.78 | 89.30 | 17.92 | 19.53 |
| T9 | Embodiment 6 | 2.0 | ml | 36.78 | 6.23 | 85.36 | 3.56 | 92.03 | 18.55 | 22.26 |
| T10 | Buprofezin | 2 | ml | 32.45 | 9.34 | 78.05 | 8.23 | 81.58 | 16.44 | 12.29 |
| | 25% SC | | | | | | | | | |
| T11 | Spirotetramat | 1 | ml | 36.89 | 7.98 | 81.25 | 6.25 | 86.01 | 17.22 | 16.26 |
| | 15.31% w/w OD | | | | | | | | | |
| T12 | Buprofezin | 2.5 | g | 33.67 | 8.23 | 80.66 | 6.44 | 85.59 | 17.01 | 15.23 |
| | 20% + Acephate | | | | | | | | | |
| | 50 % w/w WP | | | | | | | | | |
| T13 | Chloropyriphos | 2 | ml | 34.78 | 9.25 | 78.27 | 8.68 | 80.58 | 16.24 | 11.21 |
| | 50% + Cypermethrin | | | | | | | | | |
| | 5% EC | | | | | | | | | |

| | | | | | | | | | |
|---|---|---|---|---|---|---|---|---|---|
| T14 | Control | — | 36.79 | 42.56 | 0.00 | 44.69 | 0.00 | 14.42 | 0.00 |

| | | | | |
|---|---|---|---|---|
| SE± | 0.63 | 1.25 | 1.63 | 1.89 |
| C.D. (0.05) | NS | 3.76 | 4.89 | 5.67 |

### Conclusion:

1. The results of the trial revealed that an application of Embodiment 2@2 ml/l recorded the maximum % reduction in mealy bug population of 87.71% and 94.52% in 1st and 2^{nd} spray over the control, respectively.
2. The Embodiment 2 exhibited the highest 24.58% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 71: Bio-Efficacy of Bio-Insecticides (Embodiment) and Synthetic Insecticides Against Papaya Mealy Bugs (Paracoccus marginatus)

Methodology: The field experimental trial was conducted to study the bio-efficacy of different bio-insecticide and synthetic insecticides against papaya mealy bugs during rabi season 2022-2023 at Kay Bee Research and Development Farm, Maharashtra, India. The experiment was laid out by using randomized block design with three replication and fourteen treatments following spacings of 1.2 m×1.2 m between rows and plants respectively. Recommended agronomic practices were followed raise the papaya crop. Observations on mealy bugs population were taken on randomly selected five plants. Three fruits/plant were labelled to record Mealy Bug population. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 73
Effect of Bio-Insecticide and Synthetic Insecticides on mealy bugs Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction in | | Reduction in | | Increase |
| | | Dose | | mealy bugs | | mealy bugs | | mealy bugs | | in Yield |
| Tr. | | ml or | | before | No. of | Population | No. of | Population | Yield | over |
| No. | Treatments | gm/L | | spray | mealy bugs | over control | mealy bugs | over control | (t/ha) | control |
| T1 | Embodiment 2 | 0.5 | ml | 16.90 | 5.42 | 80.72 | 5.41 | 85.76 | 29.25 | 17.20 |
| T2 | Embodiment 2 | 1.0 | ml | 15.86 | 4.97 | 82.32 | 4.35 | 88.55 | 30.19 | 19.77 |
| T3 | Embodiment 2 | 2.0 | ml | 17.86 | 4.01 | 85.73 | 2.40 | 93.68 | 31.87 | 24.00 |
| T4 | Embodiment 3 | 0.5 | ml | 21.46 | 6.05 | 78.48 | 6.00 | 84.21 | 28.91 | 16.22 |
| T5 | Embodiment 3 | 1.0 | ml | 16.77 | 5.04 | 82.07 | 4.94 | 87.00 | 29.78 | 18.67 |
| T6 | Embodiment 3 | 2.0 | ml | 18.88 | 4.40 | 84.35 | 2.82 | 92.58 | 31.76 | 23.73 |
| T7 | Embodiment 6 | 0.5 | ml | 18.89 | 6.11 | 78.26 | 6.08 | 84.00 | 28.51 | 15.05 |
| T8 | Embodiment 6 | 1.0 | ml | 17.56 | 4.73 | 83.17 | 3.97 | 89.55 | 30.81 | 21.39 |
| T9 | Embodiment 6 | 2.0 | ml | 16.11 | 3.98 | 85.84 | 2.17 | 94.29 | 32.24 | 24.88 |
| T10 | Buprofezin | 2 | ml | 17.11 | 5.34 | 81.00 | 5.23 | 86.24 | 29.71 | 18.48 |
| | 25% SC | | | | | | | | | |
| T11 | Spirotetramat | 1 | ml | 17.87 | 6.34 | 77.45 | 6.33 | 83.34 | 28.01 | 13.53 |
| | 15.31% w/w OD | | | | | | | | | |
| T12 | Buprofezin 20% + | 2.5 | g | 17.12 | 6.19 | 77.98 | 6.15 | 83.82 | 28.32 | 14.48 |
| | Acephate 50 | | | | | | | | | |
| | % w/w WP | | | | | | | | | |
| T13 | Chloropyriphos | 2 | ml | 16.79 | 6.67 | 76.27 | 6.59 | 82.66 | 27.93 | 13.28 |
| | 50% + Cypermethrin | | | | | | | | | |
| | 5% EC | | | | | | | | | |

| | | | | | | | | | |
|---|---|---|---|---|---|---|---|---|---|
| T14 | Control | — | 14.00 | 28.11 | 0.00 | 38.00 | 0.00 | 24.22 | 0.00 |

| | | | | |
|---|---|---|---|---|
| SE± | 0.68 | 1.21 | 1.75 | 2.03 |
| C.D. (0.05) | NS | 3.62 | 5.23 | 6.08 |

### Conclusion:

1. The results of the trial revealed that an application of Embodiment 6@2 ml/l recorded the maximum % reduction in mealy bug population of 85.84% and 94.29% in 1st and 2^{nd} spray over the control, respectively.
2. The Embodiment 6 exhibited the highest 24.88% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 72: Bio-Efficacy of Bio-Insecticides (Embodiment) and Synthetic Insecticides Against Cotton Red Mite (Tetranychus neocaledonicus)

Methodology: The field experimental trial was conducted to study the bio-efficacy of different bio-insecticide and synthetic insecticides against cotton mite during kharif season 2022-2023 at Kay Bee Research and Development Farm, Maharashtra, India. The experiment was laid out by using randomized block design with three replication and fourteen treatments following spacings of 120 cm and 60 cm between rows and plants respectively. Each treatment consisted of an area of 5×4 m. Recommended agronomic practices were followed raise the Cotton crop. Observations on red mite population were taken on randomly selected five plants with three leaves per plant located at upper, middle and lower portion of plant. Two sprays were taken & pest population was recorded as per standard method use before and after the application of by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 74
Effect of Bio-Insecticide and Synthetic Insecticides on red mite Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | red mites | | in red mite | | in red mite | | in Yield |
| Tr. | | ml or | | before | No. of | Population | No. of | Population | Yield | over |
| No. | Treatments | gm/L | | spray | red mite | over control | red mite | over control | (t/ha) | control |
| T1 | Embodiment 2 | 0.5 | ml | 17.34 | 5.16 | 79.62 | 3.85 | 85.72 | 17.27 | 19.57 |
| T2 | Embodiment 2 | 1.0 | ml | 18.16 | 4.00 | 84.20 | 2.61 | 90.32 | 18.15 | 23.47 |
| T3 | Embodiment 2 | 2.0 | ml | 17.87 | 3.89 | 84.64 | 2.40 | 91.10 | 18.56 | 25.16 |
| T4 | Embodiment 3 | 0.5 | ml | 18.54 | 5.79 | 77.13 | 4.56 | 83.09 | 16.47 | 15.66 |
| T5 | Embodiment 3 | 1.0 | ml | 19.77 | 4.34 | 82.86 | 3.09 | 88.54 | 18.05 | 23.05 |
| T6 | Embodiment 3 | 2.0 | ml | 20.33 | 3.62 | 85.70 | 2.21 | 91.81 | 19.42 | 28.48 |
| T7 | Embodiment 6 | 0.5 | ml | 18.33 | 4.99 | 80.29 | 3.69 | 86.32 | 17.87 | 22.27 |
| T8 | Embodiment 6 | 1.0 | ml | 20.89 | 4.81 | 81.00 | 3.34 | 87.62 | 18.02 | 22.92 |
| T9 | Embodiment 6 | 2.0 | ml | 17.48 | 3.39 | 86.61 | 2.11 | 92.18 | 20.31 | 31.61 |
| T10 | Propargite | 2.0 | g | 18.20 | 5.68 | 77.57 | 4.44 | 83.54 | 17.02 | 18.39 |
| | 57% EC | | | | | | | | | |
| T11 | Spiromesifen | 1.5 | ml | 18.89 | 5.64 | 77.73 | 4.36 | 83.83 | 17.03 | 18.44 |
| | 22.9% SC | | | | | | | | | |
| T12 | Chlorantraniliprole | 1.0 | ml | 19.77 | 5.97 | 76.42 | 4.61 | 82.91 | 16.18 | 14.15 |
| | 4.3% + Abamectin | | | | | | | | | |
| | 1.7% SC | | | | | | | | | |
| T13 | Spirotetramat | 2.0 | ml | 20.09 | 5.51 | 78.24 | 4.12 | 84.72 | 17.03 | 18.44 |
| | 11.01% + | | | | | | | | | |
| | Imidacloprid | | | | | | | | | |
| | 11.01% w/w | | | | | | | | | |
| | SC (240 SC) | | | | | | | | | |

| | | | | | | | | | |
|---|---|---|---|---|---|---|---|---|---|
| T14 | Control | — | 20.00 | 25.32 | 0.00 | 26.97 | 0.00 | 13.89 | 0.00 |

| | | | | |
|---|---|---|---|---|
| SE± | 0.80 | 0.48 | 0.98 | 1.57 |
| C.D. (0.05) | NS | 1.45 | 2.97 | 4.70 |

### Conclusion:

1. The results of the trial revealed that an application of Embodiment 3@2 ml/l recorded the maximum % reduction in red mite population of 86.61% and 92.18% in 1st and 2^{nd} spray over the control, respectively.
2. The Embodiment 3 exhibited the highest 31.61% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 73: Bio-Efficacy of Bio-Insecticides (Embodiment) and Synthetic Insecticides Against Sweet Orange Red Mite (Panonychus citri)

Methodology: The field experimental trial was conducted to study the bio-efficacy of different bio-insecticide and synthetic insecticides against sweet orange red mite during summer season 2022-2023 at Kay Bee Research and Development Farm, Maharashtra, India. The experiment was laid out by using randomized block design with three replication and fourteen treatments following spacings of 6 m and 6 m between rows and plants respectively. Each treatment consisted of 20 plants. Recommended agronomic practices were followed raise the sweet orange crop. Observations on red mite population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 75
Effect of Bio-Insecticide and Synthetic Insecticides on red mite Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | red mites | | in red mite | | in red mite | | in Yield |
| Tr. | | ml or | | before | No. of | Population | No. of | Population | Yield | over |
| No. | Treatments | gm/L | | spray | red mite | over control | red mite | over control | (t/ha) | control |
| T1 | Embodiment 2 | 0.5 | ml | 29.13 | 8.47 | 79.25 | 7.27 | 84.60 | 25.01 | 7.60 |
| T2 | Embodiment 2 | 1.0 | ml | 25.32 | 7.86 | 80.74 | 5.56 | 88.22 | 28.14 | 17.87 |
| T3 | Embodiment 2 | 2.0 | ml | 26.15 | 5.94 | 85.45 | 4.34 | 90.81 | 31.18 | 25.88 |
| T4 | Embodiment 3 | 0.5 | ml | 24.07 | 9.06 | 77.80 | 7.76 | 83.56 | 24.89 | 7.15 |
| T5 | Embodiment 3 | 1.0 | ml | 28.76 | 7.15 | 82.48 | 5.39 | 88.58 | 28.09 | 17.73 |
| T6 | Embodiment 3 | 2.0 | ml | 28.95 | 6.39 | 84.35 | 5.38 | 88.60 | 29.76 | 22.35 |
| T7 | Embodiment 6 | 0.5 | ml | 22.26 | 8.39 | 79.45 | 7.19 | 84.77 | 25.37 | 8.91 |
| T8 | Embodiment 6 | 1.0 | ml | 20.76 | 7.28 | 82.17 | 6.41 | 86.42 | 27.92 | 17.23 |
| T9 | Embodiment 6 | 2.0 | ml | 28.86 | 6.28 | 84.62 | 5.29 | 88.79 | 30.02 | 23.02 |
| T10 | Propargite | 2.0 | g | 25.01 | 7.95 | 80.52 | 6.59 | 86.04 | 27.13 | 14.82 |
| | 57% EC | | | | | | | | | |
| T11 | Spiromesifen | 1.5 | ml | 24.27 | 7.67 | 81.21 | 6.87 | 85.44 | 26.67 | 13.35 |
| | 22.9% SC | | | | | | | | | |
| T12 | Chlorantraniliprole | 1.0 | ml | 29.75 | 7.39 | 81.90 | 6.46 | 86.31 | 27.41 | 15.69 |
| | 4.3% + Abamectin | | | | | | | | | |
| | 1.7% SC | | | | | | | | | |
| T13 | Spirotetramat | 2.0 | ml | 24.87 | 10.46 | 74.38 | 8.66 | 81.65 | 24.67 | 6.32 |
| | 11.01% + | | | | | | | | | |
| | Imidacloprid | | | | | | | | | |
| | 11.01% w/w | | | | | | | | | |
| | SC (240 SC) | | | | | | | | | |

| | | | | | | | | | |
|---|---|---|---|---|---|---|---|---|---|
| T14 | Control | — | 28.10 | 40.82 | 0.00 | 47.20 | 0.00 | 23.11 | 0.00 |

| | | | | |
|---|---|---|---|---|
| SE± | 1.28 | 1.69 | 1.49 | 1.96 |
| C.D. (0.05) | N.S. | 5.07 | 4.48 | 5.89 |

### Conclusion:

1. The results of the trial revealed that an application of Embodiment 2@2 ml/l recorded the maximum % reduction in red mite population of 85.45% and 90.81% in 1st and 2^{nd} spray over the control, respectively.
2. The Embodiment 2 exhibited the highest 25.88% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 74: Bio-Efficacy of Bio-Insecticides (Embodiment) and Synthetic Insecticides Against Tomato Red Mite (Tetranychus evansi)

Methodology: The field experimental trial was conducted to study the bio-efficacy of different bio-insecticide and synthetic insecticides against tomato red mite during rabi season 2022-2023 at Kay Bee Research and Development Farm, Maharashtra, India. The experiment was laid out by using randomized block design with three replication and fourteen treatments following spacings of 90 cm and 30 cm between rows and plants respectively. Each treatment consisted of 5×4 m plots. Recommended agronomic practices were followed raise the tomato crop. Observations on red mite population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 76
Effect of Bio-Insecticide and Synthetic Insecticides on red mite Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | red mites | | in red mite | | in red mite | | in Yield |
| Tr. | | ml or | | before | No. of | Population | No. of | Population | Yield | over |
| No. | Treatments | gm/L | | spray | red mite | over control | red mite | over control | (t/ha) | control |
| T1 | Embodiment 2 | 0.5 | ml | 19.46 | 7.54 | 77.90 | 6.01 | 85.04 | 43.26 | 9.02 |
| T2 | Embodiment 2 | 1.0 | ml | 22.62 | 6.36 | 81.36 | 4.04 | 89.94 | 44.98 | 12.49 |
| T3 | Embodiment 2 | 2.0 | ml | 20.15 | 5.15 | 84.91 | 3.25 | 91.91 | 47.12 | 16.47 |
| T4 | Embodiment 3 | 0.5 | ml | 23.57 | 9.36 | 72.57 | 7.36 | 81.68 | 41.8 | 5.84 |
| T5 | Embodiment 3 | 1.0 | ml | 25.06 | 7.16 | 79.02 | 4.55 | 88.67 | 44.05 | 10.65 |
| T6 | Embodiment 3 | 2.0 | ml | 23.92 | 5.11 | 85.02 | 3.02 | 92.48 | 48.96 | 19.61 |
| T7 | Embodiment 6 | 0.5 | ml | 25.14 | 8.76 | 74.33 | 6.87 | 82.90 | 42.69 | 7.80 |
| T8 | Embodiment 6 | 1.0 | ml | 22.86 | 7.32 | 78.55 | 5.87 | 85.39 | 43.96 | 10.46 |
| T9 | Embodiment 6 | 2.0 | ml | 25.02 | 5.56 | 83.70 | 3.76 | 90.64 | 46.56 | 15.46 |
| T10 | Propargite | 2.0 | g | 19.92 | 9.26 | 72.86 | 7.15 | 82.20 | 42.41 | 7.19 |
| | 57% EC | | | | | | | | | |
| T11 | Spiromesifen | 1.5 | ml | 21.28 | 8.17 | 76.06 | 6.33 | 84.24 | 43.11 | 8.70 |
| | 22.9% SC | | | | | | | | | |
| T12 | Chlorantraniliprole | 1.0 | ml | 22.52 | 8.71 | 74.47 | 6.74 | 83.22 | 42.9 | 8.25 |
| | 4.3% + Abamectin | | | | | | | | | |
| | 1.7% SC | | | | | | | | | |
| T13 | Spirotetramat | 2.0 | ml | 20.66 | 10.23 | 70.02 | 7.66 | 80.93 | 41.52 | 5.20 |
| | 11.01% + | | | | | | | | | |
| | Imidacloprid | | | | | | | | | |
| | 11.01% w/w | | | | | | | | | |
| | SC (240 SC) | | | | | | | | | |

| | | | | | | | | | |
|---|---|---|---|---|---|---|---|---|---|
| T14 | Control | — | 23.46 | 34.12 | 0.00 | 40.17 | 0.00 | 39.36 | 0.00 |

| | | | | |
|---|---|---|---|---|
| SE± | 1.47 | 1.14 | 1.21 | 1.87 |
| C.D. (0.05) | N.S. | 3.42 | 3.63 | 5.61 |

### Conclusion:

1. The results of the trial revealed that an application of Embodiment 3@2 ml/l recorded the maximum % reduction in red mite population of 85.02% and 92.48% in 1^{st} and 2^{nd} spray over the control, respectively.
2. The Embodiment 3 exhibited the highest 19.61% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 75: Bio-Efficacy of Bio-Insecticides (Embodiment) and Synthetic Insecticides Against Chili Yellow Mite (Polyphagotarsonemus latus)

Methodology: The field experimental trial was conducted to study the bio-efficacy of different bio-insecticide and synthetic insecticides against chili yellow mite during rabi season 2023-2024 at Kay Bee Research and Development Farm, Maharashtra, India. The experiment was laid out by using randomized block design with three replication and fourteen treatments following spacings of 60 cm and 30 cm between rows and plants respectively. Each treatment consisted of 3.6×5 m plots. Recommended agronomic practices were followed raise the chili crop. Observations on yellow mite population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 77
Effect of Bio-Insecticide and Synthetic Insecticides on yellow mite Population & % Population Reduction.

| | | | | | 1^{st} spray | | 2^{nd} spray | | | |
|---|---|---|---|---|---|---|---|---|---|---|
| | | | | No. of | | % | | % | | % |
| | | | | yellow | | Reduction in | | Reduction in | | Increase |
| | | Dose | | mites | No. of | yellow mite | No. of | yellow mite | | in Yield |
| Tr. | | ml or | | before | yellow | Population | yellow | Population | Yield | over |
| No. | Treatments | gm/L | | spray | mite | over control | mite | over control | (t/ha) | control |
| T1 | Embodiment 2 | 0.5 | ml | 13.26 | 4.91 | 75.34 | 3.86 | 83.77 | 89.41 | 9.43 |
| T2 | Embodiment 2 | 1.0 | ml | 12.89 | 3.98 | 80.01 | 2.87 | 87.93 | 97.71 | 17.12 |
| T3 | Embodiment 2 | 2.0 | ml | 13.47 | 2.76 | 86.14 | 2.09 | 91.21 | 109.2 | 25.85 |
| T4 | Embodiment 3 | 0.5 | ml | 11.84 | 4.58 | 77.00 | 3.51 | 85.24 | 94.19 | 14.02 |
| T5 | Embodiment 3 | 1.0 | ml | 12.64 | 4.12 | 79.31 | 3.10 | 86.96 | 95.74 | 15.42 |
| T6 | Embodiment 3 | 2.0 | ml | 11.04 | 3.45 | 82.67 | 2.56 | 89.23 | 100.1 | 19.08 |
| T7 | Embodiment 6 | 0.5 | ml | 13.09 | 4.33 | 78.25 | 4.03 | 83.05 | 85.41 | 5.19 |
| T8 | Embodiment 6 | 1.0 | ml | 11.96 | 3.76 | 81.12 | 2.75 | 88.44 | 98.39 | 17.69 |
| T9 | Embodiment 6 | 2.0 | ml | 12.72 | 3.11 | 84.38 | 2.27 | 90.45 | 103.2 | 21.49 |
| T10 | Propargite | 2.0 | g | 13.55 | 4.78 | 75.99 | 3.78 | 84.10 | 91.62 | 11.61 |
| | 57% EC | | | | | | | | | |
| T11 | Spiromesifen | 1.5 | ml | 12.25 | 4.09 | 79.46 | 3.97 | 83.31 | 88.09 | 8.07 |
| | 22.9% SC | | | | | | | | | |
| T12 | Chlorantraniliprole | 1.0 | ml | 13.10 | 4.98 | 74.99 | 3.93 | 83.47 | 88.95 | 8.96 |
| | 4.3% + Abamectin | | | | | | | | | |
| | 1.7% SC | | | | | | | | | |
| T13 | Spirotetramat | 2.0 | ml | 14.30 | 4.64 | 76.70 | 3.69 | 84.48 | 92.75 | 12.69 |
| | 11.01% + | | | | | | | | | |
| | Imidacloprid | | | | | | | | | |
| | 11.01% w/w | | | | | | | | | |
| | SC (240 SC) | | | | | | | | | |

| | | | | | | | | | |
|---|---|---|---|---|---|---|---|---|---|
| T14 | Control | — | 13.26 | 19.91 | 0.00 | 23.78 | 0.00 | 80.98 | 0.00 |

| | | | | |
|---|---|---|---|---|
| SE± | 1.02 | 1.11 | 1.34 | 2.11 |
| C.D. (0.05) | NS | 3.33 | 4.01 | 6.35 |

### Conclusion:

1. The results of the trial revealed that an application of Embodiment 2@2 ml/l recorded the maximum % reduction in yellow mite population of 86.14% and 91.21% in 1^{st} and 2^{nd} spray over the control, respectively.
2. The Embodiment 2 exhibited the highest 25.85% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 76: Bio-Efficacy of Bio-Insecticides (Embodiment) and Synthetic Insecticides Against Cucumber Yellow Mite (Polyphagotarsonemus latus)

Methodology: The field experimental trial was conducted to study the bio-efficacy of different bio-insecticide and synthetic insecticides against cucumber yellow mite during rabi season 2022-2023 at Kay Bee Research and Development Farm, Maharashtra, India. The experiment was laid out by using randomized block design with three replication and fourteen treatments following spacings of 100 cm and 50 cm between rows and plants respectively. Each treatment consisted of 5×5 m plots. Recommended agronomic practices were followed raise the cucumber crop. Observations on yellow mite population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 78
Effect of Bio-Insecticide and Synthetic Insecticides on yellow mite Population & % Population Reduction.

| | | | | | 1^{st} spray | | 2^{nd} spray | | | |
|---|---|---|---|---|---|---|---|---|---|---|
| | | | | No. of | | % | | % | | % |
| | | | | yellow | | Reduction in | | Reduction in | | Increase |
| | | Dose | | mites | No. of | yellow mite | No. of | yellow mite | | in Yield |
| Tr. | | ml or | | before | yellow | Population | yellow | Population | Yield | over |
| No. | Treatments | gm/L | | spray | mite | over control | mite | over control | (t/ha) | control |
| T1 | Embodiment 2 | 0.5 | ml | 19.15 | 4.39 | 80.97 | 4.05 | 84.49 | 108.47 | 6.74 |
| T2 | Embodiment 2 | 1.0 | ml | 22.18 | 3.70 | 83.96 | 3.26 | 87.51 | 120.73 | 16.21 |
| T3 | Embodiment 2 | 2.0 | ml | 21.76 | 3.21 | 86.09 | 2.78 | 89.35 | 129.77 | 22.05 |
| T4 | Embodiment 3 | 0.5 | ml | 21.92 | 4.45 | 80.71 | 4.13 | 84.18 | 107.81 | 6.17 |
| T5 | Embodiment 3 | 1.0 | ml | 18.24 | 3.63 | 84.27 | 3.12 | 88.05 | 123.89 | 18.35 |
| T6 | Embodiment 3 | 2.0 | ml | 21.38 | 2.98 | 87.08 | 2.24 | 91.42 | 142.17 | 28.85 |
| T7 | Embodiment 6 | 0.5 | ml | 21.45 | 4.07 | 82.36 | 3.78 | 85.52 | 114.33 | 11.52 |
| T8 | Embodiment 6 | 1.0 | ml | 19.22 | 3.42 | 85.18 | 2.98 | 88.59 | 127.65 | 20.75 |
| T9 | Embodiment 6 | 2.0 | ml | 20.21 | 3.15 | 86.35 | 2.48 | 90.50 | 133.85 | 24.42 |
| T10 | Propargite | 2.0 | g | 21.29 | 4.18 | 81.88 | 3.80 | 85.45 | 112.09 | 9.75 |
| | 57% EC | | | | | | | | | |
| T11 | Spiromesifen | 1.5 | ml | 19.97 | 3.91 | 83.05 | 3.50 | 86.60 | 118.83 | 14.87 |
| | 22.9% SC | | | | | | | | | |
| T12 | Chlorantraniliprole | 1.0 | ml | 19.65 | 4.02 | 82.57 | 3.56 | 86.37 | 116.99 | 13.53 |
| | 4.3% + Abamectin | | | | | | | | | |
| | 1.7% SC | | | | | | | | | |
| T13 | Spirotetramat | 2.0 | ml | 20.02 | 4.30 | 81.36 | 3.94 | 84.91 | 109.79 | 7.86 |
| | 11.01% + | | | | | | | | | |
| | Imidacloprid | | | | | | | | | |
| | 11.01% w/w | | | | | | | | | |
| | SC (240 SC) | | | | | | | | | |

| | | | | | | | | | |
|---|---|---|---|---|---|---|---|---|---|
| T14 | Control | — | 19.46 | 23.07 | 0.00 | 26.11 | 0.00 | 101.16 | 0.00 |

| | | | | |
|---|---|---|---|---|
| SE± | 2.14 | 1.98 | 2.01 | 2.47 |
| C.D. (0.05) | NS | 5.94 | 6.03 | 7.49 |

### Conclusion:

1. The results of the trial revealed that an application of Embodiment 3@2 ml/l recorded the maximum % reduction in yellow mite population of 87.08% and 91.42% in 1^{st} and 2^{nd} spray over the control, respectively.
2. The Embodiment 3 exhibited the highest 28.85% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 77: Bio-Efficacy of Bio-Insecticides (Embodiment) and Synthetic Insecticide Against Potato Yellow Mite (Polyphagotarsonemus latus)

Methodology: The field experimental trial was conducted to study the bio-efficacy of different bio-insecticide and synthetic insecticides against Potato yellow mite during rabi season 2023-2024 at Kay Bee Research and Development Farm, Maharashtra, India. The experiment was laid out by using randomized block design with three replication and fourteen treatments following spacings of 60 cm and 60 cm between rows and plants respectively. Each treatment consisted of 7.87×5 m plots. Recommended agronomic practices were followed raise the potato crop. Observations on yellow mite population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 79
Effect of Bio-Insecticide and Synthetic Insecticides on yellow mite Population & % Population Reduction.

| | | | | | 1^{st} spray | | 2^{nd} spray | | | |
|---|---|---|---|---|---|---|---|---|---|---|
| | | | | No. of | | % | | % | | % |
| | | | | yellow | | Reduction in | | Reduction in | | Increase |
| | | Dose | | mites | No. of | yellow mite | No. of | yellow mite | | in Yield |
| Tr. | | ml or | | before | yellow | Population | yellow | Population | Yield | over |
| No. | Treatments | gm/L | | spray | mite | over control | mite | over control | (t/ha) | control |
| T1 | Embodiment 2 | 0.5 | ml | 15.13 | 4.12 | 78.59 | 3.59 | 84.51 | 19.25 | 7.32 |
| T2 | Embodiment 2 | 1.0 | ml | 15.22 | 2.86 | 85.14 | 2.55 | 88.99 | 20.74 | 13.98 |
| T3 | Embodiment 2 | 2.0 | ml | 15.71 | 2.67 | 86.12 | 2.27 | 90.20 | 21.75 | 17.98 |
| T4 | Embodiment 3 | 0.5 | ml | 14.96 | 3.59 | 81.34 | 3.09 | 86.66 | 19.66 | 9.26 |
| T5 | Embodiment 3 | 1.0 | ml | 15.87 | 3.10 | 83.89 | 2.68 | 88.43 | 20.01 | 10.84 |
| T6 | Embodiment 3 | 2.0 | ml | 15.33 | 2.61 | 86.43 | 2.14 | 90.76 | 22.98 | 22.37 |
| T7 | Embodiment 6 | 0.5 | ml | 14.86 | 3.28 | 82.95 | 2.74 | 88.17 | 19.98 | 10.71 |
| T8 | Embodiment 6 | 1.0 | ml | 15.61 | 2.99 | 84.46 | 2.59 | 88.82 | 20.55 | 13.19 |
| T9 | Embodiment 6 | 2.0 | ml | 15.78 | 2.41 | 87.47 | 2.08 | 91.02 | 24.17 | 26.19 |
| T10 | Propargite | 2.0 | g | 15.48 | 3.46 | 82.02 | 2.82 | 87.83 | 19.75 | 9.67 |
| | 57% EC | | | | | | | | | |
| T11 | Spiromesifen | 1.5 | ml | 15.83 | 3.78 | 80.35 | 3.25 | 85.97 | 19.5 | 8.51 |
| | 22.9% SC | | | | | | | | | |
| T12 | Chlorantraniliprole | 1.0 | ml | 14.33 | 4.30 | 77.65 | 3.78 | 83.69 | 19.12 | 6.69 |
| | 4.3% + Abamectin | | | | | | | | | |
| | 1.7% SC | | | | | | | | | |
| T13 | Spirotetramat | 2.0 | ml | 14.79 | 3.91 | 79.68 | 3.44 | 85.15 | 19.3 | 7.56 |
| | 11.01% + | | | | | | | | | |
| | Imidacloprid | | | | | | | | | |
| | 11.01% w/w | | | | | | | | | |
| | SC (240 SC) | | | | | | | | | |

| | | | | | | | | | |
|---|---|---|---|---|---|---|---|---|---|
| T14 | Control | — | 15.98 | 19.24 | 0.00 | 23.17 | 0.00 | 17.84 | 0.00 |

| | | | | |
|---|---|---|---|---|
| SE± | 0.63 | 1.09 | 1.87 | 1.97 |
| C.D. (0.05) | NS | 3.25 | 5.60 | 5.90 |

### Conclusion:

1. The results of the trial revealed that an application of Embodiment 6@2 ml/l recorded the maximum % reduction in yellow mite population of 87.47% and 91.02% in 1^{st} and 2^{nd} spray over the control, respectively.
2. The Embodiment 6 exhibited the highest 26.19% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 78: Bio-Efficacy of Bio-Insecticides (Embodiment) and Synthetic Insecticides Against Diamond Back Moth (DBM) (Plutella xylostella) on Broccoli

Methodology: The field experimental trial was conducted to study the bio-efficacy of different bio-insecticides and synthetic insecticides against broccoli DBM during rabi season 2022-2023 at Kay Bee Research and Development Farm, Maharashtra, India. The experiment was laid out by using randomized block design with three replications and seventeen treatments following spacings of 45 cm and 30 cm between rows and plants respectively. Each treatment consisted of an area of 5×4 m. Recommended agronomic practices were followed to raise the broccoli crop. Observations on DBM larval population were taken on randomly selected five plants. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 80
Effect of Bio-Insecticides and Synthetic Insecticides on larval
Population, % Population Reduction and Yield in Broccoli

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | Larva | | in Larva | | in Larva | | in Yield |
| Tr. | | ml or | | before | No. of | Population | No. of | Population | Yield | over |
| No. | Treatments | gm/L | | spray | Larva | over control | Larva | over control | (t/ha) | control |
| T1 | Embodiment 4 | 0.5 | ml | 8.30 | 3.74 | 74.49 | 3.05 | 80.10 | 21.04 | 9.03 |
| T2 | Embodiment 4 | 1.0 | ml | 7.44 | 2.83 | 80.70 | 1.99 | 87.02 | 22.21 | 13.82 |
| T3 | Embodiment 4 | 2.0 | ml | 8.54 | 2.11 | 85.61 | 1.12 | 92.69 | 22.78 | 15.98 |
| T4 | Embodiment 5 | 0.5 | ml | 7.01 | 3.54 | 75.85 | 2.90 | 81.08 | 21.46 | 10.81 |
| T5 | Embodiment 5 | 1.0 | ml | 7.48 | 2.66 | 81.86 | 1.82 | 88.13 | 22.35 | 14.36 |
| T6 | Embodiment 5 | 2.0 | ml | 7.98 | 1.94 | 86.77 | 0.99 | 93.54 | 23.45 | 18.38 |
| T7 | Embodiment 6 | 0.5 | ml | 7.50 | 3.80 | 74.08 | 3.18 | 79.26 | 20.78 | 7.89 |
| T8 | Embodiment 6 | 1.0 | ml | 9.30 | 2.84 | 80.63 | 2.02 | 86.82 | 21.56 | 11.22 |
| T9 | Embodiment 6 | 2.0 | ml | 8.40 | 2.14 | 85.40 | 1.16 | 92.43 | 22.02 | 13.08 |
| T10 | Embodiment 10 | 0.5 | ml | 7.09 | 3.68 | 74.90 | 2.92 | 80.95 | 21.14 | 9.46 |
| T11 | Embodiment 10 | 1.0 | ml | 7.70 | 2.72 | 81.45 | 1.91 | 87.54 | 21.88 | 12.52 |
| T12 | Embodiment 10 | 2.0 | ml | 9.00 | 2.04 | 86.08 | 1.02 | 93.35 | 23.11 | 17.18 |
| T13 | Emamectin | 0.12 | gm | 8.08 | 3.85 | 73.74 | 3.22 | 79.00 | 20.12 | 4.87 |
| | benzoate 5% + | | | | | | | | | |
| | Lufenuron | | | | | | | | | |
| | 40% WG | | | | | | | | | |
| T14 | Indoxacarb | 1.5 | ml | 9.40 | 3.65 | 75.10 | 3.45 | 77.50 | 21.12 | 9.38 |
| | 5% + Fipronil | | | | | | | | | |
| | 5% W/w SC | | | | | | | | | |
| T15 | Chlorantraniliprole | 0.5 | ml | 8.70 | 3.68 | 74.90 | 3.35 | 78.15 | 20.85 | 8.20 |
| | (10%) + | | | | | | | | | |
| | Lambdacyhalothrin(5%) | | | | | | | | | |
| | ZC | | | | | | | | | |
| T16 | Chlorantraniliprole | 0.3 | ml | 8.85 | 3.73 | 74.56 | 3.42 | 77.69 | 20.46 | 6.45 |
| | 18.5% SC | | | | | | | | | |

| | | | | | | | | | |
|---|---|---|---|---|---|---|---|---|---|
| T17 | Control | — | 10.05 | 14.66 | 0.00 | 15.33 | 0.00 | 19.14 | 0.00 |

| | | | | |
|---|---|---|---|---|
| SE± | 0.88 | 1.46 | 1.69 | 1.84 |
| C.D. (0.05) | NS | 4.38 | 5.07 | 5.52 |

### Conclusion:

1. The results of the trial revealed that an application of Embodiment 5@2 ml/l recorded the maximum % reduction in larval population of 93.54% in 2^{nd} spray over the control, respectively.
2. The Embodiment 5@2 ml/l exhibited the highest 18.38% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 79: Bio-Efficacy of Bio-Insecticides (Embodiment) and Synthetic Insecticides Against Diamond Back Moth (DBM) (Plutella xylostella) on Cabbage

Methodology: The field experimental trial was conducted to study the bio-efficacy of different bio-insecticide and synthetic insecticides against cabbage DBM during rabi season 2022-2023 at Kay Bee Research and Development Farm, Maharashtra, India. The experiment was laid out by using randomized block design with three replications and seventeen treatments following spacings of 60 cm and 45 cm between rows and plants respectively. Each treatment consisted of an area of 5 m×4 m. Recommended agronomic practices were followed to raise the cabbage crop. Observations on DBM larval population were taken on randomly selected five plants. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 81
Effect of Bio-Insecticides and Synthetic Insecticides on larval
Population, % Population Reduction and Yield in Cabbage.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | Larva | | in Larva | | in Larva | | in Yield |
| Tr. | | ml or | | before | No. of | Population | No. of | Population | Yield | over |
| No. | Treatments | gm/L | | spray | Larva | over control | Larva | over control | (t/ha) | control |
| T1 | Embodiment 4 | 0.5 | ml | 7.12 | 3.41 | 75.83 | 3.12 | 79.42 | 26.68 | 10.98 |
| T2 | Embodiment 4 | 1.0 | ml | 8.24 | 2.75 | 80.51 | 2.08 | 86.28 | 26.78 | 11.31 |
| T3 | Embodiment 4 | 2.0 | ml | 6.22 | 2.08 | 85.26 | 1.78 | 88.26 | 28.31 | 16.11 |
| T4 | Embodiment 5 | 0.5 | ml | 9.28 | 3.55 | 74.84 | 3.32 | 78.10 | 26.67 | 10.95 |
| T5 | Embodiment 5 | 1.0 | ml | 8.24 | 2.63 | 81.36 | 2.3 | 84.83 | 28.12 | 15.54 |
| T6 | Embodiment 5 | 2.0 | ml | 6.28 | 1.90 | 86.53 | 1.32 | 91.29 | 29.61 | 19.79 |
| T7 | Embodiment 6 | 0.5 | ml | 6.25 | 3.38 | 76.05 | 2.9 | 80.87 | 27.08 | 12.30 |
| T8 | Embodiment 6 | 1.0 | ml | 7.25 | 2.74 | 80.58 | 2.01 | 86.74 | 26.95 | 11.87 |
| T9 | Embodiment 6 | 2.0 | ml | 9.18 | 1.80 | 87.24 | 1.28 | 91.56 | 30.80 | 22.89 |
| T10 | Embodiment 10 | 0.5 | ml | 7.22 | 3.45 | 75.55 | 3.18 | 79.02 | 26.78 | 11.31 |
| T11 | Embodiment 10 | 1.0 | ml | 6.28 | 2.65 | 81.22 | 2.2 | 85.49 | 27.61 | 13.98 |
| T12 | Embodiment 10 | 2.0 | ml | 8.26 | 1.95 | 86.18 | 1.65 | 89.12 | 28.67 | 17.16 |
| T13 | Emamectin | 0.12 | gm | 9.28 | 3.75 | 73.42 | 3.46 | 77.18 | 26.37 | 9.94 |
| | benzoate 5% + | | | | | | | | | |
| | Lufenuron | | | | | | | | | |
| | 40% WG | | | | | | | | | |
| T14 | Indoxacarb | 1.5 | ml | 8.24 | 3.64 | 74.20 | 3.36 | 77.84 | 26.44 | 10.17 |
| | 5% + Fipronil | | | | | | | | | |
| | 5% W/w SC | | | | | | | | | |
| T15 | Chlorantraniliprole | 0.5 | ml | 6.28 | 3.54 | 74.91 | 3.3 | 78.23 | 26.64 | 10.85 |
| | (10%) + | | | | | | | | | |
| | Lambdacyhalothrin(5%) | | | | | | | | | |
| | ZC | | | | | | | | | |
| T16 | Chlorantraniliprole | 0.3 | ml | 7.25 | 3.76 | 73.35 | 3.57 | 76.45 | 25.90 | 8.30 |
| | 18.5% SC | | | | | | | | | |

| | | | | | | | | | |
|---|---|---|---|---|---|---|---|---|---|
| T17 | Control | — | 10.00 | 14.11 | 0.00 | 15.16 | 0.00 | 23.75 | 0.00 |

| | | | | |
|---|---|---|---|---|
| SE± | 0.80 | 1.25 | 1.57 | 1.78 |
| C.D. (0.05) | NS | 3.75 | 4.71 | 5.34 |

### Conclusion:

1. The results of the trial revealed that an application of Embodiment 6@2 ml/l recorded the maximum % reduction in larval population of 91.56% in 2^{nd} spray over the control, respectively.
2. The Embodiment 6@2 ml/l exhibited the highest 22.89% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 80: Bio-Efficacy of Bio-Insecticides (Embodiment) and Synthetic Insecticides Against Diamond Back Moth (DBM) (Plutella xylostella) on Cauliflower

Methodology: The field experimental trial was conducted to study the bio-efficacy of different bio-insecticide and synthetic insecticides against cauliflower DBM during rabi season 2022-2023 at Kay Bee Research and Development Farm, Maharashtra, India. The experiment was laid out by using randomized block design with three replications and seventeen treatments following spacings of 60 cm and 45 cm between rows and plants respectively. Each treatment consisted of an area of 5×4 m. Recommended agronomic practices were followed to raise the cauliflower crop. Observations on DBM larval population were taken on randomly selected five plants. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 82
Effect of Bio-Insecticides and Synthetic Insecticides on larval
Population, % Population Reduction and Yield in Cauliflower.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | Larva | | in Larva | | in Larva | | in Yield |
| Tr. | | ml or | | before | No. of | Population | No. of | Population | Yield | over |
| No. | Treatments | gm/L | | spray | Larva | over control | Larva | over control | (t/ha) | control |
| T1 | Embodiment 4 | 0.5 | ml | 8.10 | 3.31 | 77.42 | 2.88 | 81.02 | 23.92 | 14.34 |
| T2 | Embodiment 4 | 1.0 | ml | 7.24 | 2.62 | 82.13 | 1.90 | 87.48 | 24.80 | 17.38 |
| T3 | Embodiment 4 | 2.0 | ml | 8.34 | 1.79 | 87.79 | 1.04 | 93.14 | 25.45 | 19.49 |
| T4 | Embodiment 5 | 0.5 | ml | 6.98 | 3.68 | 74.90 | 3.21 | 78.84 | 22.90 | 10.52 |
| T5 | Embodiment 5 | 1.0 | ml | 7.28 | 2.85 | 80.56 | 2.21 | 85.43 | 23.25 | 11.87 |
| T6 | Embodiment 5 | 2.0 | ml | 7.78 | 2.01 | 86.29 | 1.24 | 91.83 | 24.14 | 15.12 |
| T7 | Embodiment 6 | 0.5 | ml | 7.30 | 3.48 | 76.26 | 1.97 | 87.01 | 23.56 | 13.03 |
| T8 | Embodiment 6 | 1.0 | ml | 9.10 | 2.67 | 81.79 | 2.02 | 86.68 | 24.54 | 16.50 |
| T9 | Embodiment 6 | 2.0 | ml | 8.20 | 1.88 | 87.18 | 1.06 | 93.01 | 25.35 | 19.17 |
| T10 | Embodiment 10 | 0.5 | ml | 6.89 | 3.58 | 75.58 | 3.02 | 80.09 | 23.54 | 12.96 |
| T11 | Embodiment 10 | 1.0 | ml | 7.50 | 2.78 | 81.04 | 2.10 | 86.16 | 23.90 | 14.27 |
| T12 | Embodiment 10 | 2.0 | ml | 8.80 | 1.95 | 86.70 | 1.14 | 92.49 | 24.92 | 17.78 |
| T13 | Emamectin | 0.12 | gm | 7.98 | 3.70 | 74.76 | 3.22 | 78.77 | 23.95 | 14.45 |
| | benzoate 5% + | | | | | | | | | |
| | Lufenuron | | | | | | | | | |
| | 40% WG | | | | | | | | | |
| T14 | Indoxacarb 5% + | 1.5 | ml | 9.20 | 3.90 | 73.40 | 3.45 | 77.26 | 22.81 | 10.17 |
| | Fipronil 5% | | | | | | | | | |
| | W/w SC | | | | | | | | | |
| T15 | Chlorantraniliprole | 0.5 | ml | 8.50 | 3.82 | 73.94 | 3.35 | 77.92 | 23.61 | 13.21 |
| | (10%) + | | | | | | | | | |
| | Lambdacyhalothrin(5%) | | | | | | | | | |
| | ZC | | | | | | | | | |
| T16 | Chlorantraniliprole | 0.3 | ml | 8.65 | 3.88 | 73.53 | 3.42 | 77.46 | 23.24 | 11.83 |
| | 18.5% SC | | | | | | | | | |

| | | | | | | | | | |
|---|---|---|---|---|---|---|---|---|---|
| T17 | Control | — | 9.95 | 14.66 | 0.00 | 15.17 | 0.00 | 20.49 | 0.00 |

| | | | | |
|---|---|---|---|---|
| SE± | 0.92 | 1.34 | 1.63 | 1.72 |
| C.D. (0.05) | NS | 4.02 | 4.89 | 5.16 |

### Conclusion:

1. The results of the trial revealed that an application of Embodiment 4@2 ml/l recorded the maximum % reduction in larval population of 93.14% in 2^{nd} spray over the control, respectively.
2. The Embodiment 4@2 ml/l exhibited the highest 19.49% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 81: Bio-Efficacy of Bio-Insecticides (Embodiment) and Synthetic Insecticides Against Cotton Earias vittella

Methodology: The field experimental trial was conducted to study the bio-efficacy of different bio-insecticide and synthetic insecticides against Earias vittella of cotton during kharif season 2021-2022 at Kay Bee Research and Development Farm, Maharashtra, India. The experiment was laid out by using randomized block design with three replication and seventeen treatments following spacings of 90 cm and 90 cm between rows and plants, respectively. Each treatment consisted of an area of 4.5×5 m. Recommended agronomic practices were followed raise the cotton crop. Observations on larval population were taken on randomly selected ten plants. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 83
Effect of Bio-Insecticide and Synthetic Insecticides on larval Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | Larva | | in Larval | | in Larval | | in Yield |
| Tr. | | ml or | | before | No. of | Population | No. of | Population | Yield | over |
| No. | Treatments | gm/L | | spray | Larva | over control | Larva | over control | (qtl/ha) | control |
| T1 | Embodiment 4 | 0.5 | ml | 10.98 | 4.65 | 75.94 | 4.22 | 81.84 | 24.67 | 14.55 |
| T2 | Embodiment 4 | 1.0 | ml | 11.54 | 3.05 | 84.22 | 3.02 | 87.01 | 25.59 | 17.62 |
| T3 | Embodiment 4 | 2.0 | ml | 13.22 | 2.86 | 85.20 | 1.77 | 92.38 | 26.89 | 21.61 |
| T4 | Embodiment 5 | 0.5 | ml | 12.1 | 4.61 | 76.15 | 4.46 | 80.81 | 24.53 | 14.06 |
| T5 | Embodiment 5 | 1.0 | ml | 12.74 | 3.44 | 82.20 | 3.24 | 86.06 | 25.5 | 17.33 |
| T6 | Embodiment 5 | 2.0 | ml | 11.99 | 2.89 | 85.05 | 2.87 | 87.65 | 28.34 | 25.62 |
| T7 | Embodiment 6 | 0.5 | ml | 10.21 | 4.63 | 76.05 | 4.56 | 80.38 | 24.37 | 13.50 |
| T8 | Embodiment 6 | 1.0 | ml | 13.45 | 3.24 | 83.24 | 3.12 | 86.57 | 25.73 | 18.07 |
| T9 | Embodiment 6 | 2.0 | ml | 14.67 | 3.14 | 83.76 | 2.96 | 87.26 | 27.74 | 24.01 |
| T10 | Embodiment 10 | 0.5 | ml | 13.45 | 4.76 | 75.38 | 3.92 | 83.13 | 24.44 | 13.75 |
| T11 | Embodiment 10 | 1.0 | ml | 13.08 | 3.67 | 81.01 | 3.45 | 85.15 | 25.01 | 15.71 |
| T12 | Embodiment 10 | 2.0 | ml | 14.23 | 2.99 | 84.53 | 2.78 | 88.04 | 26.39 | 20.12 |
| T13 | Chlorantraniliprole | 0.3 | ml | 12.46 | 4.42 | 77.13 | 3.87 | 83.35 | 25.36 | 16.88 |
| | 18.5% SC | | | | | | | | | |
| T14 | Emamectin | 0.4 | gm | 13.19 | 4.89 | 74.70 | 3.99 | 82.83 | 24.72 | 14.72 |
| | Benzoate 5% SG | | | | | | | | | |
| T15 | Spinetoram | 0.9 | ml | 14.01 | 4.58 | 76.31 | 3.88 | 83.30 | 25.33 | 16.78 |
| | 11.7% SC | | | | | | | | | |
| T16 | Chlorpyriphos 50% + | 1 | ml | 12.88 | 4.48 | 76.82 | 4.24 | 81.76 | 23.97 | 12.06 |
| | Cypermethrin 5% EC | | | | | | | | | |

| | | | | | | | | | |
|---|---|---|---|---|---|---|---|---|---|
| T17 | Control | — | 12.78 | 19.33 | 0.00 | 23.24 | 0.00 | 21.08 | 0.00 |

| | | | | |
|---|---|---|---|---|
| SE± | 1.24 | 1.87 | 1.48 | 2.41 |
| C.D. (0.05) | NS | 5.61 | 4.44 | 7.24 |

### Conclusion:

1. The results of the trial revealed that an application of Embodiment 4@2 ml/l and Embodiment 4@2 ml/l recorded the maximum % reduction in larval population of 85.20% & 92.38% in 1^{st} and 2^{nd} spray over the control, respectively.
2. The Embodiment 5@2 ml/l exhibited the highest 25.62% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 82: Bio-Efficacy of Bio-Insecticides (Embodiment) and Synthetic Insecticides Against Okra Earias vittella

Methodology: The field experimental trial was conducted to study the bio-efficacy of different bio-insecticide and synthetic insecticides against Earias vittella of okra during rabi season 2021-2022 at Kay Bee Research and Development Farm, Maharashtra, India. The experiment was laid out by using randomized block design with three replication and seventeen treatments following spacings of 45 cm and 30 cm between rows and plants, respectively. Each treatment consisted of an area of 3.6×5 m. Recommended agronomic practices were followed raise the okra crop. Observations on larval population were taken on randomly selected ten plants. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 84
Effect of Bio-Insecticide and Synthetic Insecticides on larval Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | Larva | | in Larval | | in Larval | | in Yield |
| Tr. | | ml or | | before | No. of | Population | No. of | Population | Yield | over |
| No. | Treatments | gm/L | | spray | Larva | over control | Larva | over control | (qtl/ha) | control |
| T1 | Embodiment 4 | 0.5 | ml | 4.64 | 1.68 | 75.07 | 1.37 | 80.65 | 89.67 | 10.52 |
| T2 | Embodiment 4 | 1.0 | ml | 4.2 | 1.26 | 81.31 | 1.07 | 84.89 | 95.01 | 15.55 |
| T3 | Embodiment 4 | 2.0 | ml | 5.88 | 0.96 | 85.76 | 0.76 | 89.27 | 96.45 | 16.81 |
| T4 | Embodiment 5 | 0.5 | ml | 4.76 | 1.50 | 77.74 | 1.40 | 80.23 | 88.99 | 9.83 |
| T5 | Embodiment 5 | 1.0 | ml | 5.4 | 1.28 | 81.01 | 1.13 | 84.04 | 93.11 | 13.82 |
| T6 | Embodiment 5 | 2.0 | ml | 4.65 | 0.95 | 85.91 | 0.58 | 91.81 | 98.67 | 18.68 |
| T7 | Embodiment 6 | 0.5 | ml | 5.87 | 1.65 | 75.52 | 1.47 | 79.24 | 90.03 | 10.87 |
| T8 | Embodiment 6 | 1.0 | ml | 6.11 | 1.08 | 83.98 | 0.99 | 86.02 | 93.68 | 14.35 |
| T9 | Embodiment 6 | 2.0 | ml | 7.33 | 0.98 | 85.46 | 0.70 | 90.11 | 95.12 | 15.64 |
| T10 | Embodiment 10 | 0.5 | ml | 6.11 | 1.69 | 74.93 | 1.52 | 78.53 | 89.44 | 10.29 |
| T11 | Embodiment 10 | 1.0 | ml | 5.74 | 1.29 | 80.86 | 1.09 | 84.60 | 94.24 | 14.86 |
| T12 | Embodiment 10 | 2.0 | ml | 6.89 | 1.07 | 84.12 | 0.71 | 89.97 | 97.11 | 17.37 |
| T13 | Chlorantraniliprole | 0.3 | ml | 5.12 | 1.39 | 79.38 | 1.33 | 81.21 | 90.36 | 11.20 |
| | 18.5% SC | | | | | | | | | |
| T14 | Emamectin | 0.4 | gm | 5.85 | 1.66 | 75.37 | 1.39 | 80.37 | 88.45 | 9.28 |
| | Benzoate 5% SG | | | | | | | | | |
| T15 | Spinetoram | 0.9 | ml | 6.67 | 1.54 | 77.15 | 1.34 | 81.07 | 90.33 | 11.17 |
| | 11.7% SC | | | | | | | | | |
| T16 | Chlorpyriphos 50% + | 1 | ml | 5.54 | 1.46 | 78.34 | 1.45 | 79.52 | 87.89 | 8.70 |

| | | | | | | | | | |
|---|---|---|---|---|---|---|---|---|---|
| | Cypermethrin 5% EC | | | | | | | | |
| T17 | Control | — | 5.44 | 6.74 | 0.00 | 7.08 | 0.00 | 80.24 | 0.00 |

| | | | | |
|---|---|---|---|---|
| SE± | 1.58 | 1.69 | 1.54 | 2.47 |
| C.D. (0.05) | NS | 5.08 | 4.62 | 7.40 |

### Conclusion:

1. The results of the trial revealed that an application of Embodiment 5@2 ml/l recorded the maximum % reduction in larval population of 85.91% & 91.81% in 1ª and 2ªd spray over the control, respectively.
2. The Embodiment 5@2 ml/l exhibited the highest 18.68% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 83: Bio-Efficacy of Bio-Insecticides (Embodiment) and Synthetic Insecticides Against Tomato Earias vittella

Methodology: The field experimental trial was conducted to study the bio-efficacy of different bio-insecticide and synthetic insecticides against Earias vittella of tomato during rabi season 2021-2022 at Kay Bee Research and Development Farm, Maharashtra, India. The experiment was laid out by using randomized block design with three replication and seventeen treatments following spacings of 90 cm and 45 cm between rows and plants, respectively. Each treatment consisted of an area of 6×5 m. Recommended agronomic practices were followed raise the tomato crop. Observations on larval population were taken on randomly selected ten plants. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 85
Effect of Bio-Insecticide and Synthetic Insecticides on larval Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | Larva | | in Larval | | in Larval | | in Yield |
| Tr. | | ml or | | before | No. of | Population | No. of | Population | Yield | over |
| No. | Treatments | gm/L | | spray | Larva | over control | Larva | over control | (qtl/ha) | control |
| T1 | Embodiment 4 | 0.5 | ml | 9.64 | 2.72 | 75.89 | 2.34 | 80.66 | 301.02 | 13.55 |
| T2 | Embodiment 4 | 1.0 | ml | 9.2 | 2.04 | 81.91 | 1.63 | 86.53 | 310.00 | 16.05 |
| T3 | Embodiment 4 | 2.0 | ml | 10.88 | 1.56 | 86.17 | 1.00 | 91.74 | 318.10 | 18.19 |
| T4 | Embodiment 5 | 0.5 | ml | 9.76 | 2.67 | 76.33 | 2.2 | 81.82 | 298.00 | 12.67 |
| T5 | Embodiment 5 | 1.0 | ml | 10.4 | 2.05 | 81.83 | 1.62 | 86.61 | 304.11 | 14.43 |
| T6 | Embodiment 5 | 2.0 | ml | 9.65 | 1.63 | 85.55 | 1.12 | 90.74 | 315.18 | 17.43 |
| T7 | Embodiment 6 | 0.5 | ml | 10.87 | 2.65 | 76.51 | 2.05 | 83.06 | 291.00 | 10.57 |
| T8 | Embodiment 6 | 1.0 | ml | 11.11 | 1.94 | 82.80 | 1.61 | 86.69 | 312.00 | 16.59 |
| T9 | Embodiment 6 | 2.0 | ml | 12.33 | 1.44 | 87.23 | 1.06 | 91.24 | 320.18 | 18.72 |
| T10 | Embodiment 10 | 0.5 | ml | 11.11 | 2.69 | 76.15 | 2.41 | 80.08 | 294.00 | 11.48 |
| T11 | Embodiment 10 | 1.0 | ml | 10.74 | 2.14 | 81.03 | 1.81 | 85.04 | 307.22 | 15.29 |
| T12 | Embodiment 10 | 2.0 | ml | 11.89 | 1.58 | 85.99 | 1.18 | 90.25 | 322.05 | 19.19 |
| T13 | Chlorantraniliprole | 0.3 | ml | 10.12 | 2.33 | 79.34 | 2.13 | 82.40 | 303.10 | 14.14 |
| | 18.5% SC | | | | | | | | | |
| T14 | Emamectin | 0.4 | gm | 10.85 | 2.62 | 76.77 | 2.29 | 81.07 | 302.24 | 13.90 |
| | Benzoate 5% SG | | | | | | | | | |
| T15 | Spinetoram | 0.9 | ml | 11.67 | 2.46 | 78.19 | 2.22 | 81.65 | 298.22 | 12.74 |
| | 11.7% SC | | | | | | | | | |
| T16 | Chlorpyriphos 50% + | 1 | ml | 10.54 | 2.68 | 76.24 | 2.56 | 78.84 | 304.00 | 14.39 |
| | Cypermethrin 5% EC | | | | | | | | | |

| | | | | | | | | | |
|---|---|---|---|---|---|---|---|---|---|
| T17 | Control | — | 10.44 | 11.28 | 0.00 | 12.10 | 0.00 | 260.24 | 0.00 |

| | | | | |
|---|---|---|---|---|
| SE± | 1.02 | 1.38 | 1.72 | 2.13 |
| C.D. (0.05) | NS | 4.14 | 5.16 | 6.39 |

### Conclusion:

1. The results of the trial revealed that an application of Embodiment 6@2 ml/l and Embodiment 4@2 ml/l recorded the maximum % reduction in larval population of 87.23% & 91.74% in 1^{st} and 2^{nd} spray over the control, respectively.
2. The Embodiment 10@2 ml/l exhibited the highest 19.19% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 84: Bio-Efficacy of Bio-Insecticides (Embodiment) and Synthetic Insecticides Against Chickpea Helicoverpa armigera

Methodology: The field experimental trial was conducted to study the bio-efficacy of different bio-insecticide and synthetic insecticides against Helicoverpa armigera of Chickpea during rabi season 2022-2023 at Kay Bee Research and Development Farm, Maharashtra, India. The experiment was laid out by using randomized block design with three replication and seventeen treatments following spacings of 30 cm and 10 cm between rows and plants respectively. Each treatment consisted of an area of 1.8×3 m. Recommended agronomic practices were followed raise the chickpea crop. Observations on larval population were taken on randomly selected ten plants. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 86
Effect of Bio-Insecticide and Synthetic Insecticides on larval Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | Larva | | in Larval | | in Larval | | in Yield |
| Tr. | | ml or | | before | No. of | Population | No. of | Population | Yield | over |
| No. | Treatments | gm/L | | spray | Larva | over control | Larva | over control | (qtl/ha) | control |
| T1 | Embodiment 4 | 0.5 | ml | 3.64 | 1.68 | 75.07 | 1.32 | 81.17 | 11.67 | 8.31 |
| T2 | Embodiment 4 | 1.0 | ml | 3.2 | 1.26 | 81.31 | 1.11 | 84.17 | 12.21 | 12.37 |
| T3 | Embodiment 4 | 2.0 | ml | 4.1 | 0.96 | 85.76 | 0.56 | 92.01 | 14.01 | 23.63 |
| T4 | Embodiment 5 | 0.5 | ml | 3.76 | 1.42 | 78.93 | 1.21 | 82.74 | 10.99 | 2.64 |
| T5 | Embodiment 5 | 1.0 | ml | 4.1 | 1.28 | 81.01 | 1.09 | 84.45 | 13.01 | 17.76 |
| T6 | Embodiment 5 | 2.0 | ml | 3.65 | 0.95 | 85.91 | 0.69 | 90.16 | 13.80 | 22.46 |
| T7 | Embodiment 6 | 0.5 | ml | 4.87 | 1.37 | 79.67 | 1.29 | 81.60 | 11.37 | 5.89 |
| T8 | Embodiment 6 | 1.0 | ml | 4.11 | 1.08 | 83.98 | 0.98 | 86.02 | 12.77 | 16.21 |
| T9 | Embodiment 6 | 2.0 | ml | 4.87 | 0.98 | 85.46 | 0.73 | 89.59 | 13.70 | 21.90 |
| T10 | Embodiment 10 | 0.5 | ml | 5.11 | 1.69 | 74.93 | 1.62 | 76.89 | 11.44 | 6.47 |
| T11 | Embodiment 10 | 1.0 | ml | 4.74 | 1.29 | 80.86 | 1.13 | 83.88 | 13.15 | 18.63 |
| T12 | Embodiment 10 | 2.0 | ml | 5.18 | 1.07 | 84.12 | 0.62 | 91.16 | 13.53 | 20.92 |
| T13 | Chlorantraniliprole | 0.3 | ml | 4.12 | 1.31 | 80.56 | 1.22 | 82.60 | 12.36 | 13.43 |
| | 18.5% SC | | | | | | | | | |
| T14 | Emamectin | 0.4 | gm | 4.85 | 1.56 | 76.85 | 1.48 | 78.89 | 11.72 | 8.70 |
| | Benzoate 5% SG | | | | | | | | | |
| T15 | Spinetoram | 0.9 | ml | 5.67 | 1.39 | 79.38 | 1.28 | 81.74 | 12.33 | 13.22 |
| | 11.7% SC | | | | | | | | | |
| T16 | Chlorpyriphos 50% + | 1 | ml | 4.54 | 1.46 | 78.34 | 1.29 | 81.60 | 11.99 | 10.76 |

| | | | | | | | | | |
|---|---|---|---|---|---|---|---|---|---|
| | Cypermethrin 5% EC | | | | | | | | |
| T17 | Control | — | 4.44 | 6.74 | 0.00 | 7.01 | 0.00 | 10.70 | 0.00 |

| | | | | |
|---|---|---|---|---|
| SE± | 1.02 | 0.97 | 2.01 | 2.57 |
| C.D. (0.05) | NS | 2.91 | 6.03 | 7.71 |

### Conclusion:

1. The results of the trial revealed that an application of Embodiment 5@2 ml/l and Embodiment 4@2 ml/l recorded the maximum % reduction in larval population of 85.91% & 92.01% in 1^{st} and 2^{nd} spray over the control, respectively.
2. The Embodiment 4@2 ml/l exhibited the highest 23.63% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 85: Bio-Efficacy of Bio-Insecticides (Embodiment) and Synthetic Insecticides Against Cotton Helicoverpa armigera

Methodology: The field experimental trial was conducted to study the bio-efficacy of different bio-insecticide and synthetic insecticides against Helicoverpa armigera of Cotton during kharif season 2022-2023 at Kay Bee Research and Development Farm, Maharashtra, India. The experiment was laid out by using randomized block design with three replication and seventeen treatments following spacings of 90 cm and 90 cm between rows and plants respectively. Each treatment consisted of an area of 5×4 m. Recommended agronomic practices were followed raise the cotton crop. Observations on larval population were taken on randomly selected ten plants. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 87
Effect of Bio-Insecticide and Synthetic Insecticides on larval Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | Larva | | in Larval | | in Larval | | in Yield |
| Tr. | | ml or | | before | No. of | Population | No. of | Population | Yield | over |
| No. | Treatments | gm/L | | spray | Larva | over control | Larva | over control | (qtl/ha) | control |
| T1 | Embodiment 4 | 0.5 | ml | 12.3 | 4.47 | 77.81 | 4.45 | 80.85 | 26.44 | 13.92 |
| T2 | Embodiment 4 | 1.0 | ml | 13.2 | 3.34 | 83.42 | 3.15 | 86.45 | 27.16 | 16.20 |
| T3 | Embodiment 4 | 2.0 | ml | 14.87 | 2.86 | 85.80 | 1.87 | 91.95 | 29.08 | 21.73 |
| T4 | Embodiment 5 | 0.5 | ml | 12.47 | 4.88 | 75.77 | 3.87 | 83.35 | 26.21 | 13.16 |
| T5 | Embodiment 5 | 1.0 | ml | 14.2 | 3.44 | 82.92 | 3.24 | 86.06 | 27.18 | 16.26 |
| T6 | Embodiment 5 | 2.0 | ml | 13.22 | 3.1 | 84.61 | 3.09 | 86.70 | 27.87 | 18.34 |
| T7 | Embodiment 6 | 0.5 | ml | 11.22 | 4.33 | 78.50 | 4.22 | 81.84 | 26.05 | 12.63 |
| T8 | Embodiment 6 | 1.0 | ml | 14.51 | 3.24 | 83.91 | 3.12 | 86.57 | 27.41 | 16.96 |
| T9 | Embodiment 6 | 2.0 | ml | 14.8 | 3.14 | 84.41 | 2.96 | 87.26 | 28.56 | 20.31 |
| T10 | Embodiment 10 | 0.5 | ml | 14.26 | 5.08 | 74.78 | 4.44 | 80.90 | 26.12 | 12.86 |
| T11 | Embodiment 10 | 1.0 | ml | 13.78 | 3.67 | 81.78 | 3.45 | 85.15 | 27.39 | 16.90 |
| T12 | Embodiment 10 | 2.0 | ml | 16.6 | 3.01 | 85.05 | 2.99 | 87.13 | 28.06 | 18.89 |
| T13 | Chlorantraniliprole | 0.3 | ml | 14.8 | 4.34 | 78.45 | 3.77 | 83.78 | 25.99 | 12.43 |
| | 18.5% SC | | | | | | | | | |
| T14 | Emamectin | 0.4 | gm | 15.6 | 4.01 | 80.09 | 3.78 | 83.73 | 26.75 | 14.92 |
| | Benzoate 5% SG | | | | | | | | | |
| T15 | Spinetoram | 0.9 | ml | 13.8 | 4.48 | 77.76 | 4.24 | 81.76 | 27.12 | 16.08 |
| | 11.7% SC | | | | | | | | | |
| T16 | Chlorpyriphos 50% + | 1 | ml | 14.4 | 4.46 | 77.86 | 4.42 | 80.98 | 26.08 | 12.73 |
| | Cypermethrin 5% EC | | | | | | | | | |

| | | | | | | | | | |
|---|---|---|---|---|---|---|---|---|---|
| T17 | Control | — | 15.3 | 20.14 | 0.00 | 23.24 | 0.00 | 22.76 | 0.00 |

| | | | | |
|---|---|---|---|---|
| SE± | 1.23 | 1.52 | 1.78 | 2.24 |
| C.D. (0.05) | NS | 4.56 | 5.34 | 6.72 |

### Conclusion:

1. The results of the trial revealed that an application of Embodiment 4@2 ml/l recorded the maximum % reduction in larval population of 85.80% & 91.95% in 1^{st} and 2^{nd} spray over the control, respectively.
2. The Embodiment 4@2 ml/l exhibited the highest 21.73% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 86: Bio-Efficacy of Bio-Insecticides (Embodiment) and Synthetic Insecticides Against Pigeon Pea Helicoverpa armigera

Methodology: The field experimental trial was conducted to study the bio-efficacy of different bio-insecticide and synthetic insecticides against Helicoverpa armigera of pigeon pea during kharif season 2022-2023 at Kay Bee Research and Development Farm, Maharashtra, India. The experiment was laid out by using randomized block design with three replication and seventeen treatments following spacings of 90 cm and 30 cm between rows and plants, respectively. Each treatment consisted of an area of 4.5×5 m. Recommended agronomic practices were followed raise the pigeon pea crop. Observations on larval population were taken on randomly selected ten plants. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 88
Effect of Bio-Insecticide and Synthetic Insecticides on larval Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | Larva | | in Larval | | in Larval | | in Yield |
| Tr. | | ml or | | before | No. of | Population | No. of | Population | Yield | over |
| No. | Treatments | gm/L | | spray | Larva | over control | Larva | over control | (qtl/ha) | control |
| T1 | Embodiment 4 | 0.5 | ml | 4.1 | 1.46 | 77.40 | 1.45 | 80.64 | 21.67 | 13.71 |
| T2 | Embodiment 4 | 1.0 | ml | 4.14 | 1.25 | 80.65 | 1.13 | 84.91 | 22.21 | 15.80 |
| T3 | Embodiment 4 | 2.0 | ml | 4.56 | 0.81 | 87.46 | 0.79 | 89.45 | 24.01 | 22.12 |
| T4 | Embodiment 5 | 0.5 | ml | 3.88 | 1.35 | 79.10 | 1.34 | 82.11 | 21.30 | 12.21 |
| T5 | Embodiment 5 | 1.0 | ml | 3.42 | 1.23 | 80.96 | 1.08 | 85.58 | 23.01 | 18.73 |
| T6 | Embodiment 5 | 2.0 | ml | 4.13 | 0.75 | 88.39 | 0.71 | 90.52 | 23.80 | 21.43 |
| T7 | Embodiment 6 | 0.5 | ml | 3.56 | 1.43 | 77.86 | 1.16 | 84.51 | 21.37 | 12.49 |
| T8 | Embodiment 6 | 1.0 | ml | 3.87 | 1.12 | 82.66 | 0.96 | 87.18 | 22.77 | 17.87 |
| T9 | Embodiment 6 | 2.0 | ml | 4.02 | 0.93 | 85.60 | 0.74 | 90.12 | 23.70 | 21.10 |
| T10 | Embodiment 10 | 0.5 | ml | 4.78 | 1.76 | 72.76 | 1.58 | 78.91 | 21.44 | 12.78 |
| T11 | Embodiment 10 | 1.0 | ml | 5.12 | 1.27 | 80.34 | 1.05 | 85.98 | 23.15 | 19.22 |
| T12 | Embodiment 10 | 2.0 | ml | 5.09 | 0.76 | 88.24 | 0.70 | 90.65 | 23.53 | 20.53 |
| T13 | Chlorantraniliprole | 0.3 | ml | 4.73 | 1.36 | 78.95 | 1.15 | 84.65 | 22.36 | 16.37 |
| | 18.5% SC | | | | | | | | | |
| T14 | Emamectin | 0.4 | gm | 5.23 | 1.62 | 74.92 | 1.40 | 81.31 | 21.72 | 13.90 |
| | Benzoate 5% SG | | | | | | | | | |
| T15 | Spinetoram | 0.9 | ml | 5.46 | 1.42 | 78.02 | 1.23 | 83.58 | 22.33 | 16.26 |
| | 11.7% SC | | | | | | | | | |
| T16 | Chlorpyriphos 50% + | 1 | ml | 5.09 | 1.49 | 76.93 | 1.30 | 82.64 | 21.99 | 14.96 |
| | Cypermethrin 5% EC | | | | | | | | | |

| | | | | | | | | | |
|---|---|---|---|---|---|---|---|---|---|
| T17 | Control | — | 4.16 | 6.46 | 0.00 | 7.49 | 0.00 | 18.7 | 0.00 |

| | | | | |
|---|---|---|---|---|
| SE± | 1.02 | 1.38 | 1.72 | 2.13 |
| C.D. (0.05) | NS | 4.14 | 5.16 | 6.39 |

### Conclusion:

1. The results of the trial revealed that an application of Embodiment 5@2 ml/l and Embodiment 10@2 ml/l recorded the maximum % reduction in larval population of 88.39% & 90.65% in 1^{st} and 2^{nd} spray over the control, respectively.
2. The Embodiment 4@2 ml/l exhibited the highest 22.12% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 87: Bio-Efficacy of Bio-Insecticides (Embodiment) and Synthetic Insecticides Against Cabbage Spodoptera litura

Methodology: The field experimental trial was conducted to study the bio-efficacy of different bio-insecticide and synthetic insecticides against Spodoptera litura of Cabbage during rabi season 2022-2023 at Kay Bee Research and Development Farm, Maharashtra, India. The experiment was laid out by using randomized block design with three replication and seventeen treatments following spacings of 60 cm and 45 cm between rows and plants respectively. Each treatment consisted of an area of 3.6×4 m. Recommended agronomic practices were followed raise the cabbage crop. Observations on larval population were taken on randomly selected ten plants. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 89
Effect of Bio-Insecticide and Synthetic Insecticides on larval Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | Larva | | in Larval | | in Larval | | in Yield |
| Tr. | | ml or | | before | No. of | Population | No. of | Population | Yield | over |
| No. | Treatments | gm/L | | spray | Larva | over control | Larva | over control | (qtl/ha) | control |
| T1 | Embodiment 4 | 0.5 | ml | 5.52 | 1.68 | 76.92 | 1.61 | 80.17 | 35.14 | 2.90 |
| T2 | Embodiment 4 | 1.0 | ml | 5.89 | 1.29 | 82.28 | 1.13 | 86.08 | 38.87 | 12.22 |
| T3 | Embodiment 4 | 2.0 | ml | 7.12 | 0.87 | 88.05 | 0.71 | 91.26 | 40.88 | 16.54 |
| T4 | Embodiment 5 | 0.5 | ml | 6.42 | 1.65 | 77.34 | 1.52 | 81.28 | 37.00 | 7.78 |
| T5 | Embodiment 5 | 1.0 | ml | 6.36 | 1.19 | 83.65 | 1.16 | 85.71 | 38.76 | 11.97 |
| T6 | Embodiment 5 | 2.0 | ml | 5.72 | 0.89 | 87.77 | 0.77 | 90.52 | 41.02 | 16.82 |
| T7 | Embodiment 6 | 0.5 | ml | 7.23 | 1.69 | 76.79 | 1.59 | 80.42 | 37.12 | 8.08 |
| T8 | Embodiment 6 | 1.0 | ml | 7.56 | 1.07 | 85.30 | 0.99 | 87.81 | 39.67 | 13.99 |
| T9 | Embodiment 6 | 2.0 | ml | 8.13 | 0.88 | 87.91 | 0.69 | 91.50 | 40.89 | 16.56 |
| T10 | Embodiment 10 | 0.5 | ml | 7.56 | 1.55 | 78.71 | 1.34 | 83.50 | 36.73 | 7.11 |
| T11 | Embodiment 10 | 1.0 | ml | 7.88 | 1.33 | 81.73 | 1.14 | 85.96 | 39.16 | 12.87 |
| T12 | Embodiment 10 | 2.0 | ml | 8.12 | 1.01 | 86.13 | 0.75 | 90.76 | 40.12 | 14.96 |
| T13 | Chlorantraniliprole | 0.3 | ml | 6.67 | 1.6 | 78.02 | 1.42 | 82.51 | 37.1 | 8.03 |
| | 18.5% SC | | | | | | | | | |
| T14 | Emamectin | 0.4 | gm | 8.14. | 1.58 | 78.30 | 1.38 | 83.00 | 37.8 | 9.74 |
| | Benzoate 5% SG | | | | | | | | | |
| T15 | Spinetoram | 0.9 | ml | 6.54 | 1.59 | 78.16 | 1.19 | 85.34 | 36.8 | 7.28 |
| | 11.7% SC | | | | | | | | | |
| T16 | Chlorpyriphos 50% + | 1 | ml | 6.67 | 1.45 | 80.08 | 1.23 | 84.85 | 36.9 | 7.53 |
| | Cypermethrin 5% EC | | | | | | | | | |

| | | | | | | | | | |
|---|---|---|---|---|---|---|---|---|---|
| T17 | Control | — | 6.32 | 7.28 | 0.00 | 8.12 | 0.00 | 34.12 | 0.00 |

| | | | | |
|---|---|---|---|---|
| SE± | 1.35 | 2.18 | 2.31 | 3.57 |
| C.D. (0.05) | NS | 6.54 | 6.93 | 10.71 |

### Conclusion:

1. The results of the trial revealed that an application of Embodiment 4@2 ml/l and Embodiment 6@2 ml/l recorded the maximum % reduction in larval population of 88.05% & 91.50% in 1^{st} and 2^{nd} spray over the control, respectively.
2. The Embodiment 5@2 ml/l exhibited the highest 16.82% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 88: Bio-Efficacy of Bio-Insecticides (Embodiment) and Synthetic Insecticides Against Cotton Spodoptera litura

Methodology: The field experimental trial was conducted to study the bio-efficacy of different bio-insecticide and synthetic insecticides against Spodoptera litura of Cotton during kharif season 2023-2024 at Kay Bee Research and Development Farm, Maharashtra, India. The experiment was laid out by using randomized block design with three replication and seventeen treatments following spacings of 120 cm and 60 cm between rows and plants respectively. Each treatment consisted of an area of 5×4 m. Recommended agronomic practices were followed raise the cotton crop. Observations on larval population were taken on randomly selected ten plants. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 90
Effect of Bio-Insecticide and Synthetic Insecticides on larval Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | Larva | | in Larval | | in Larval | | in Yield |
| Tr. | | ml or | | before | No. of | Population | No. of | Population | Yield | over |
| No. | Treatments | gm/L | | spray | Larva | over control | Larva | over control | (qtl/ha) | control |
| T1 | Embodiment 4 | 0.5 | ml | 10.50 | 3.40 | 76.24 | 2.98 | 81.10 | 19.98 | 11.01 |
| T2 | Embodiment 4 | 1.0 | ml | 11.60 | 2.24 | 84.35 | 1.65 | 89.54 | 20.88 | 14.85 |
| T3 | Embodiment 4 | 2.0 | ml | 12.78 | 1.98 | 86.16 | 1.31 | 91.69 | 21.89 | 18.78 |
| T4 | Embodiment 5 | 0.5 | ml | 13.60 | 3.45 | 75.89 | 3.06 | 80.60 | 19.66 | 9.56 |
| T5 | Embodiment 5 | 1.0 | ml | 11.24 | 2.21 | 84.56 | 1.74 | 88.97 | 20.73 | 14.23 |
| T6 | Embodiment 5 | 2.0 | ml | 12.40 | 2.10 | 85.32 | 1.56 | 90.11 | 21.41 | 16.95 |
| T7 | Embodiment 6 | 0.5 | ml | 11.83 | 3.28 | 77.08 | 2.99 | 81.04 | 19.63 | 9.42 |
| T8 | Embodiment 6 | 1.0 | ml | 10.42 | 2.13 | 85.12 | 1.58 | 89.98 | 20.41 | 12.89 |
| T9 | Embodiment 6 | 2.0 | ml | 13.65 | 2.04 | 85.74 | 1.40 | 91.12 | 21.56 | 17.53 |
| T10 | Embodiment 10 | 0.5 | ml | 11.43 | 3.32 | 76.80 | 2.90 | 81.61 | 19.88 | 10.56 |
| T11 | Embodiment 10 | 1.0 | ml | 12.62 | 2.33 | 83.72 | 1.89 | 88.02 | 21.02 | 15.41 |
| T12 | Embodiment 10 | 2.0 | ml | 13.71 | 1.89 | 86.79 | 1.42 | 91.00 | 21.67 | 17.95 |
| T13 | Chlorantraniliprole | 0.3 | ml | 14.01 | 3.55 | 75.19 | 3.01 | 80.91 | 20.04 | 11.28 |
| | 18.5% SC | | | | | | | | | |
| T14 | Emamectin | 0.4 | gm | 13.82 | 3.01 | 78.97 | 2.54 | 83.89 | 19.56 | 9.10 |
| | Benzoate 5% SG | | | | | | | | | |
| T15 | Spinetoram | 0.9 | ml | 12.59 | 3.25 | 77.29 | 3.09 | 80.41 | 20.12 | 11.63 |
| | 11.7% SC | | | | | | | | | |
| T16 | Chlorpyriphos 50% + | 1 | ml | 11.40 | 3.56 | 75.12 | 2.78 | 82.37 | 19.70 | 9.75 |
| | Cypermethrin 5% EC | | | | | | | | | |

| | | | | | | | | | |
|---|---|---|---|---|---|---|---|---|---|
| T17 | Control | — | 12.30 | 14.31 | 0.00 | 15.77 | 0.00 | 17.78 | 0.00 |

| | | | | |
|---|---|---|---|---|
| SE± | 0.98 | 1.12 | 1.75 | 2.03 |
| C.D. (0.05) | NS | 3.35 | 5.25 | 6.09 |

### Conclusion:

1. The results of the trial revealed that an application of Embodiment 10@2 ml/l & Embodiment 4@2 ml/l recorded the maximum % reduction in larval population of 86.79% and 91.69% in 1^{st} and 2^{nd} spray over the control, respectively.
2. The Embodiment 4 exhibited the highest 18.78% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 89: Bio-Efficacy of Bio-Insecticides (Embodiment) and Synthetic Insecticides Against Soybean Spodoptera litura

Methodology: The field experimental trial was conducted to study the bio-efficacy of different bio-insecticide and synthetic insecticides against Spodoptera litura of Soybean during kharif season 2022-2023 at Kay Bee Research and Development Farm, Maharashtra, India. The experiment was laid out by using randomized block design with three replication and seventeen treatments following spacings of 40 cm and 10 cm between rows and plants, respectively. Each treatment consisted of an area of 1.2×5 m. Recommended agronomic practices were followed raise the soybean crop. Observations on larval population were taken on randomly selected ten plants. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 91
Effect of Bio-Insecticide and Synthetic Insecticides on larval Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction | | Reduction | | Increase |
| | | Dose | | Larva | | in Larval | | in Larval | | in Yield |
| Tr. | | ml or | | before | No. of | Population | No. of | Population | Yield | over |
| No. | Treatments | gm/L | | spray | Larva | over control | Larva | over control | (qtl/ha) | control |
| T1 | Embodiment 4 | 0.5 | ml | 11.3 | 4.34 | 78.45 | 4.16 | 82.67 | 19.98 | 11.01 |
| T2 | Embodiment 4 | 1.0 | ml | 12.2 | 3.15 | 84.36 | 3.01 | 87.46 | 20.88 | 14.85 |
| T3 | Embodiment 4 | 2.0 | ml | 14.78 | 2.41 | 88.03 | 2.11 | 91.21 | 21.89 | 18.78 |
| T4 | Embodiment 5 | 0.5 | ml | 12.65 | 4.88 | 75.77 | 4.86 | 79.76 | 19.66 | 9.56 |
| T5 | Embodiment 5 | 1.0 | ml | 13.24 | 3.38 | 83.22 | 3.33 | 86.13 | 20.73 | 14.23 |
| T6 | Embodiment 5 | 2.0 | ml | 12.8 | 3.10 | 84.61 | 2.44 | 89.84 | 21.41 | 16.95 |
| T7 | Embodiment 6 | 0.5 | ml | 14.18 | 4.31 | 78.60 | 4.13 | 82.80 | 19.63 | 9.42 |
| T8 | Embodiment 6 | 1.0 | ml | 12.42 | 3.18 | 84.21 | 3.06 | 87.26 | 20.41 | 12.89 |
| T9 | Embodiment 6 | 2.0 | ml | 13.28 | 3.14 | 84.41 | 2.37 | 90.13 | 21.56 | 17.53 |
| T10 | Embodiment 10 | 0.5 | ml | 12.88 | 5.08 | 74.78 | 4.90 | 79.59 | 19.88 | 10.56 |
| T11 | Embodiment 10 | 1.0 | ml | 13.23 | 3.39 | 83.17 | 3.11 | 87.05 | 21.02 | 15.41 |
| T12 | Embodiment 10 | 2.0 | ml | 14.37 | 3.01 | 85.05 | 2.83 | 88.21 | 21.67 | 17.95 |
| T13 | Chlorantraniliprole | 0.3 | ml | 14.77 | 4.29 | 78.70 | 4.09 | 82.97 | 20.04 | 11.28 |
| | 18.5% SC | | | | | | | | | |
| T14 | Emamectin | 0.4 | gm | 12.25 | 4.01 | 80.09 | 3.89 | 83.80 | 19.56 | 9.10 |
| | Benzoate 5% SG | | | | | | | | | |
| T15 | Spinetoram | 0.9 | ml | 12.89 | 4.48 | 77.76 | 4.42 | 81.59 | 20.12 | 11.63 |
| | 11.7% SC | | | | | | | | | |
| T16 | Chlorpyriphos 50% + | 1 | ml | 13.4 | 4.99 | 77.22 | 4.28 | 82.17 | 19.7 | 9.75 |
| | Cypermethrin 5% EC | | | | | | | | | |

| | | | | | | | | | |
|---|---|---|---|---|---|---|---|---|---|
| T17 | Control | — | 14.3 | 20.14 | 0.00 | 24.01 | 0.00 | 17.78 | 0.00 |

| | | | | |
|---|---|---|---|---|
| SE± | 0.97 | 1.78 | 1.98 | 2.45 |
| C.D. (0.05) | NS | 5.34 | 5.93 | 7.36 |

### Conclusion:

1. The results of the trial revealed that an application of Embodiment 4@2 ml/l recorded the maximum % reduction in larval population of 88.03% & 91.21% in 1^{st} and 2^{nd} spray over the control, respectively.
2. The Embodiment 4@2 ml/l exhibited the highest 18.78% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 90: Bio-Efficacy of Bio-Insecticides (Embodiment) and Synthetic Insecticides Against Chilli Thrips (Scirtothrips dorsalis)

Methodology: The field experimental trial was conducted to study the bio-efficacy of different bio-insecticide and synthetic insecticides against Chilli thrips during kharif season 2022-2023 at Kay Bee Research and Development Farm, Maharashtra, India. The experiment was laid out by using randomized block design with three replication and seventeen treatments following spacings of 60 cm and 50 cm between rows and plants respectively. Each treatment consisted of an area of 5×4 m. Recommended agronomic practices were followed raise the chilli crop. Observations on thrips population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 92
Effect of Bio-Insecticide and Synthetic Insecticides on Thrips Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | No. of | Reduction | No. of | Reduction | | Increase |
| | | Dose | | Thrisps | Thrisps | in Thrisps | Thrisps | in Thrisps | | in Yield |
| Tr. | | ml or | | before | after | Population | after | Population | Yield | over |
| No. | Treatments | gm/L | | spray | 1st spray | over control | 2nd spray | over control | (qtl/ha) | control |
| T1 | Embodiment 4 | 0.5 | ml | 18.25 | 5.65 | 77.46 | 4.70 | 81.99 | 176 | 13.64 |
| T2 | Embodiment 4 | 1 | ml | 18.54 | 4.63 | 81.53 | 2.98 | 88.58 | 183 | 16.94 |
| T3 | Embodiment 4 | 2 | ml | 17.12 | 2.95 | 90.67 | 1.43 | 94.52 | 191 | 20.42 |
| T4 | Embodiment 5 | 0.5 | ml | 18.50 | 5.72 | 77.18 | 4.95 | 81.03 | 175 | 13.14 |
| T5 | Embodiment 5 | 1 | ml | 18.87 | 4.00 | 84.04 | 3.44 | 86.82 | 186 | 18.28 |
| T6 | Embodiment 5 | 2 | ml | 18.02 | 2.57 | 89.75 | 1.83 | 92.99 | 189 | 19.58 |
| T7 | Embodiment 6 | 0.5 | ml | 17.90 | 5.40 | 78.46 | 4.84 | 81.46 | 173 | 12.14 |
| T8 | Embodiment 6 | 1 | ml | 18.41 | 3.67 | 85.36 | 3.67 | 85.17 | 185 | 17.84 |
| T9 | Embodiment 6 | 2 | ml | 18.54 | 2.44 | 90.27 | 2.38 | 90.88 | 190 | 20.00 |
| T10 | Embodiment 10 | 0.5 | ml | 17.17 | 5.80 | 76.86 | 5.10 | 80.46 | 174 | 12.64 |
| T11 | Embodiment 10 | 1 | ml | 18.33 | 4.28 | 82.93 | 3.99 | 84.71 | 182 | 16.48 |
| T12 | Embodiment 10 | 2 | ml | 18.21 | 2.34 | 88.23 | 2.23 | 91.46 | 188 | 19.15 |
| T13 | Spinetoram | 1 | ml | 17.87 | 6.10 | 75.67 | 5.64 | 78.39 | 169 | 10.06 |
| | 11.70% SC | | | | | | | | | |
| T14 | Tolfenpyrad | 2 | ml | 21.35 | 4.65 | 81.45 | 4.45 | 82.95 | 177 | 14.12 |
| | 15EC | | | | | | | | | |
| T15 | Fipronil 80WG | 0.1 | gm | 17.54 | 6.02 | 75.99 | 5.53 | 78.81 | 170 | 10.59 |
| T16 | Imidacloprid | 0.065 | gm | 20.12 | 6.05 | 75.87 | 5.76 | 77.93 | 168 | 9.52 |

| | | | | | | | | | |
|---|---|---|---|---|---|---|---|---|---|
| | 70WG | | | | | | | | |
| T17 | Control | — | 19.32 | 25.07 | 0.00 | 26.10 | 0.00 | 152 | 0.00 |

| | | | | |
|---|---|---|---|---|
| SE± | 1.12 | 0.98 | 1.32 | 1.24 |
| C.D. (0.05) | NS | 2.94 | 3.96 | 3.72 |

### Conclusion:

1. The results of the trial revealed that an application of Embodiment 4@2 ml/l recorded the maximum % reduction in thrips population of 90.67% and 94.52% in 1^{st} and 2^{nd} spray over the control, respectively.
2. The Embodiment 4 exhibited the highest 20.42% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 91: Bio-Efficacy of Bio-Insecticides (Embodiment) and Synthetic Insecticides Against Cotton Thrips (Thrips tabaci)

Methodology: The field experimental trial was conducted to study the bio-efficacy of different bio-insecticide and synthetic insecticides against Cotton thrips during kharif season 2022-2023 at Kay Bee Research and Development Farm, Maharashtra, India. The experiment was laid out by using randomized block design with three replication and seventeen treatments following spacings of 120 cm and 60 cm between rows and plants respectively. Each treatment consisted of an area of 5×4 m. Recommended agronomic practices were followed raise the cotton crop. Observations on thrips population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 93
Effect of Bio-Insecticide and Synthetic Insecticides on Thrips
Population, % Population Reduction and yield of seed cotton.

| | | | | | 1^{st} spray | | 2^{nd} spray | | | |
|---|---|---|---|---|---|---|---|---|---|---|
| | | | | | | % | | % | | % |
| | | | | No. of | No. of | Reduction | No. of | Reduction | | Increase |
| | | Dose | | Thrisps | Thrisps | in Thrisps | Thrisps | in Thrisps | | in Yield |
| Tr. | | ml or | | before | after | Population | after | Population | Yield | over |
| No. | Treatments | gm/L | | spray | 1st spray | over control | 2nd spray | over control | (qtl/ha) | control |
| T1 | Embodiment 4 | 0.5 | ml | 10.25 | 4.67 | 75.11 | 4.57 | 81.21 | 26.60 | 14.85 |
| T2 | Embodiment 4 | 1 | ml | 10.18 | 3.21 | 82.89 | 3.10 | 87.25 | 27.12 | 16.48 |
| T3 | Embodiment 4 | 2 | ml | 9.19 | 2.21 | 88.22 | 1.87 | 92.31 | 28.32 | 20.02 |
| T4 | Embodiment 5 | 0.5 | ml | 11.23 | 4.47 | 76.17 | 4.47 | 81.62 | 26.50 | 14.53 |
| T5 | Embodiment 5 | 1 | ml | 10.52 | 3.18 | 83.05 | 3.12 | 87.17 | 27.00 | 16.11 |
| T6 | Embodiment 5 | 2 | ml | 9.76 | 2.08 | 88.91 | 1.95 | 91.98 | 29.00 | 21.90 |
| T7 | Embodiment 6 | 0.5 | ml | 11.43 | 4.18 | 77.72 | 4.15 | 82.94 | 26.55 | 14.69 |
| T8 | Embodiment 6 | 1 | ml | 10.78 | 3.21 | 82.89 | 3.15 | 87.05 | 27.32 | 17.09 |
| T9 | Embodiment 6 | 2 | ml | 10.13 | 1.97 | 89.50 | 1.8 | 92.60 | 29.40 | 22.96 |
| T10 | Embodiment 10 | 0.5 | ml | 10.65 | 4.68 | 75.05 | 4.63 | 80.96 | 26.60 | 14.85 |
| T11 | Embodiment 10 | 1 | ml | 9.7 | 3.55 | 81.08 | 3.5 | 85.61 | 27.87 | 18.73 |
| T12 | Embodiment 10 | 2 | ml | 10.33 | 2.34 | 87.53 | 2.27 | 90.67 | 28.45 | 20.39 |
| T13 | Spinetoram | 1 | ml | 11.32 | 3.9 | 79.21 | 3.88 | 84.05 | 26.77 | 15.39 |
| | 11.70% SC | | | | | | | | | |
| T14 | Tolfenpyrad | 2 | ml | 11.76 | 4.65 | 75.21 | 4.64 | 80.92 | 25.67 | 11.76 |
| | 15EC | | | | | | | | | |
| T15 | Fipronil 80WG | 0.1 | gm | 10.27 | 4.56 | 75.69 | 4.52 | 81.41 | 25.89 | 12.51 |
| T16 | Imidacloprid | 0.065 | gm | 11.56 | 4.8 | 74.41 | 4.78 | 80.35 | 25 | 9.40 |
| | 70WG | | | | | | | | | |

| | | | | | | | | | |
|---|---|---|---|---|---|---|---|---|---|
| T17 | Control | — | 10.56 | 18.76 | 0.00 | 24.32 | 0.00 | 22.65 | 0.00 |

| | | | | |
|---|---|---|---|---|
| SE± | 0.78 | 1.20 | 2.11 | 2.45 |
| C.D. (0.05) | NS | 3.60 | 6.32 | 7.43 |

### Conclusion:

1. The results of the trial revealed that an application of Embodiment 6@2 ml/l recorded the maximum % reduction in thrips population of 89.50% and 92.60% in 1^{st} and 2^{nd} spray over the control, respectively.
2. The Embodiment 6 exhibited the highest 22.96% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 92: Bio-Efficacy of Bio-Insecticides (Embodiment) and Synthetic Insecticides Against Onion Thrips (Thrips tabaci)

Methodology: The field experimental trial was conducted to study the bio-efficacy of different bio-insecticide and synthetic insecticides against Onion thrips during rabi season 2022-2023 at Kay Bee Research and Development Farm, Maharashtra, India. The experiment was laid out by using randomized block design with three replication and seventeen treatments following spacings of 45 cm and 15 cm between rows and plants respectively. Each treatment consisted of an area of 4 m×3 m. Recommended agronomic practices were followed raise the Onion crop. Observations on thrips population were taken on randomly selected five plants. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 94
Effect of Bio-Insecticide and Synthetic Insecticides on Thrips
Population, % Population Reduction & yield of onion.

| | | | | | 1^{st} spray | | 2^{nd} spray | | | |
|---|---|---|---|---|---|---|---|---|---|---|
| | | | | | | % | | % | | % |
| | | | | No. of | No. of | Reduction | No. of | Reduction | | Increase |
| | | Dose | | Thrisps | Thrisps | in Thrisps | Thrisps | in Thrisps | | in Yield |
| Tr. | | ml or | | before | after | Population | after | Population | Yield | over |
| No. | Treatments | gm/L | | spray | 1st spray | over control | 2nd spray | over control | (qtl/ha) | control |
| T1 | Embodiment 4 | 0.5 | ml | 21.18 | 5.87 | 75.61 | 4.70 | 81.85 | 38.10 | 11.97 |
| T2 | Embodiment 4 | 1 | ml | 21.23 | 4.55 | 81.10 | 2.65 | 89.77 | 41.38 | 18.95 |
| T3 | Embodiment 4 | 2 | ml | 22.12 | 2.88 | 90.78 | 1.32 | 94.90 | 43.54 | 22.97 |
| T4 | Embodiment 5 | 0.5 | ml | 21.86 | 5.80 | 75.90 | 4.76 | 81.62 | 37.55 | 10.68 |
| T5 | Embodiment 5 | 1 | ml | 21.88 | 3.88 | 83.88 | 3.21 | 87.61 | 39.82 | 15.77 |
| T6 | Embodiment 5 | 2 | ml | 21.76 | 2.64 | 89.03 | 1.80 | 93.05 | 40.76 | 17.71 |
| T7 | Embodiment 6 | 0.5 | ml | 20.87 | 4.95 | 79.43 | 4.70 | 81.85 | 37.75 | 11.15 |
| T8 | Embodiment 6 | 1 | ml | 21.43 | 3.75 | 84.42 | 3.44 | 86.72 | 38.67 | 13.27 |
| T9 | Embodiment 6 | 2 | ml | 22.18 | 2.38 | 90.11 | 1.74 | 93.28 | 41.12 | 18.43 |
| T10 | Embodiment 10 | 0.5 | ml | 21.45 | 5.76 | 76.07 | 5.10 | 80.31 | 38.12 | 12.01 |
| T11 | Embodiment 10 | 1 | ml | 22.20 | 4.12 | 82.88 | 3.90 | 84.94 | 39.22 | 14.48 |
| T12 | Embodiment 10 | 2 | ml | 21.98 | 2.22 | 88.03 | 1.62 | 93.75 | 41.00 | 18.20 |
| T13 | Spinetoram | 1 | ml | 20.56 | 5.98 | 75.16 | 5.38 | 79.23 | 36.62 | 8.41 |
| | 11.70% SC | | | | | | | | | |
| T14 | Tolfenpyrad | 2 | ml | 22.48 | 5.96 | 75.24 | 5.40 | 79.15 | 36.89 | 9.08 |
| | 15EC | | | | | | | | | |
| T15 | Fipronil 80WG | 0.1 | gm | 21.60 | 4.22 | 82.47 | 4.18 | 83.86 | 38.21 | 12.22 |
| T16 | Imidacloprid | 0.065 | gm | 22.37 | 6.10 | 74.66 | 5.90 | 77.22 | 37.80 | 11.27 |

| | | | | | | | | | |
|---|---|---|---|---|---|---|---|---|---|
| | 70WG | | | | | | | | |
| T17 | Control | — | 21.78 | 24.07 | 0.00 | 25.90 | 0.00 | 33.54 | 0.00 |

| | | | | |
|---|---|---|---|---|
| SE± | 0.85 | 1.29 | 2.16 | 2.52 |
| C.D. (0.05) | NS | 3.87 | 6.48 | 7.56 |

### Conclusion:

1. The results of the trial revealed that an application of Embodiment 4@2 ml/l recorded the maximum % reduction in thrips population of 90.78% and 94.90% in 1^{st} and 2^{nd} spray over the control, respectively.
2. The Embodiment 4 exhibited the highest 22.97% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 93: Bio-Efficacy of Bio-Insecticides (Embodiment) and Synthetic Insecticides Against Brinjal Whiteflies (Bemisia tabaci)

Methodology: The field experimental trial was conducted to study the bio-efficacy of different bio-insecticide and synthetic insecticides against brinjal whiteflies during rabi season 2022-2023 at Kay Bee Research and Development Farm, Maharashtra, India. The experiment was laid out by using randomized block design with three replication and seventeen treatments following spacings of 90 cm and 90 cm between rows and plants respectively. Each treatment consisted of an area of 4.5×5 m. Recommended agronomic practices were followed raise the brinjal crop. Observations on whiteflies population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 95
Effect of Bio-Insecticide and Synthetic Insecticides on Whiteflies Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction in | | Reduction in | | Increase |
| | | Dose | | whiteflies | | whiteflies | | whiteflies | | in Yield |
| Tr. | | ml or | | before | No. of | Population | No. of | Population | Yield | over |
| No. | Treatments | gm/L | | spray | whiteflies | over control | whiteflies | over control | (qtl/ha) | control |
| T1 | Embodiment 4 | 0.5 | ml | 13.93 | 4.05 | 73.84 | 4.00 | 75.76 | 35.62 | 16.23 |
| T2 | Embodiment 4 | 1.0 | ml | 13.56 | 3.96 | 74.42 | 3.74 | 77.33 | 35.78 | 16.60 |
| T3 | Embodiment 4 | 2.0 | ml | 13.07 | 3.86 | 75.06 | 3.09 | 81.27 | 36.92 | 19.18 |
| T4 | Embodiment 5 | 0.5 | ml | 12.90 | 3.99 | 74.22 | 3.96 | 76.00 | 34.78 | 14.20 |
| T5 | Embodiment 5 | 1.0 | ml | 11.92 | 3.89 | 74.87 | 3.50 | 78.79 | 35.88 | 16.83 |
| T6 | Embodiment 5 | 2.0 | ml | 12.67 | 3.01 | 80.56 | 2.78 | 83.15 | 37.39 | 20.19 |
| T7 | Embodiment 6 | 0.5 | ml | 13.34 | 4.09 | 73.58 | 3.98 | 75.88 | 35.59 | 16.16 |
| T8 | Embodiment 6 | 1.0 | ml | 12.67 | 3.91 | 74.74 | 3.62 | 78.06 | 35.72 | 16.46 |
| T9 | Embodiment 6 | 2.0 | ml | 13.00 | 3.64 | 76.49 | 2.92 | 82.30 | 36.78 | 18.87 |
| T10 | Embodiment 10 | 0.5 | ml | 10.83 | 4.17 | 73.06 | 4.05 | 75.45 | 35.62 | 16.23 |
| T11 | Embodiment 10 | 1.0 | ml | 11.74 | 3.93 | 74.61 | 3.70 | 77.58 | 35.67 | 16.34 |
| T12 | Embodiment 10 | 2.0 | ml | 12.87 | 3.72 | 75.97 | 3.03 | 81.64 | 36.66 | 18.60 |
| T13 | Acephate 50% + | 2.0 | g | 12.47 | 4.03 | 73.97 | 3.97 | 75.94 | 35.64 | 16.27 |
| | Imidacloprid | | | | | | | | | |
| | 1.8% SP | | | | | | | | | |
| T14 | Pyriproxyfen | 1.5 | ml | 13.88 | 4.21 | 72.80 | 4.10 | 75.15 | 35.41 | 15.73 |
| | 05.00% + | | | | | | | | | |
| | Fenpropathrin | | | | | | | | | |
| | 15.00% EC | | | | | | | | | |
| T15 | Beta- | 1.0 | ml | 12.35 | 4.10 | 73.51 | 4.15 | 74.85 | 35.37 | 15.63 |
| | Cyfluthrin + | | | | | | | | | |
| | Imidacloprid | | | | | | | | | |
| | 300 OD | | | | | | | | | |
| T16 | Chlorpyrifos | 2.0 | ml | 11.94 | 4.15 | 73.19 | 4.12 | 75.03 | 35.54 | 16.04 |
| | 50.00% + | | | | | | | | | |
| | Cypermethrin | | | | | | | | | |
| | 05.00% EC | | | | | | | | | |

| | | | | | | | | | |
|---|---|---|---|---|---|---|---|---|---|
| T17 | Control | — | 13.82 | 15.48 | 0.00 | 16.50 | 0.00 | 29.84 | 0.00 |

| | | | | |
|---|---|---|---|---|
| SE± | 1.01 | 2.11 | 1.57 | 1.78 |
| C.D. (0.05) | NS | 6.34 | 4.71 | 5.35 |

### Conclusion:

1. The results of the trial revealed that an application of Embodiment 5@2 ml/l recorded the maximum % reduction in whiteflies population of 80.56% and 83.15% in 1^{st} and 2^{nd} spray over the control, respectively.
2. The Embodiment 5 exhibited the highest 20.19% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 94: Bio-Efficacy of Bio-Insecticides (Embodiment) and Synthetic Insecticides Against Potato Whiteflies (Bemisia tabaci)

Methodology: The field experimental trial was conducted to study the bio-efficacy of different bio-insecticide and synthetic insecticides against potato whiteflies during kharif season 2022-2023 at Kay Bee Research and Development Farm, Maharashtra, India. The experiment was laid out by using randomized block design with three replication and seventeen treatments following spacings of 60 cm and 60 cm between rows and plants respectively. Each treatment consisted of an area of 7.87×5 m. Recommended agronomic practices were followed raise the Potato crop. Observations on whiteflies population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{Population Count of Control Plot - Population Count of Treated Plot}{Population Count of Control Plot} * 100$$

### Results:

TABLE 96
Effect of Bio-Insecticide and Synthetic Insecticides on Whiteflies Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction in | | Reduction in | | Increase |
| | | Dose | | whiteflies | | whiteflies | | whiteflies | | in Yield |
| Tr. | | ml or | | before | No. of | Population | No. of | Population | Yield | over |
| No. | Treatments | gm/L | | spray | whiteflies | over control | whiteflies | over control | (qtl/ha) | control |
| T1 | Embodiment 4 | 0.5 | ml | 10.33 | 3.42 | 77.00 | 3.20 | 80.76 | 22.87 | 14.95 |
| T2 | Embodiment 4 | 1.0 | ml | 11.07 | 2.87 | 80.70 | 2.70 | 83.76 | 23.73 | 18.04 |
| T3 | Embodiment 4 | 2.0 | ml | 10.28 | 2.24 | 84.93 | 1.97 | 88.15 | 26.24 | 25.88 |
| T4 | Embodiment 5 | 0.5 | ml | 12.32 | 3.69 | 75.18 | 3.17 | 80.94 | 23.00 | 15.43 |
| T5 | Embodiment 5 | 1.0 | ml | 11.92 | 2.98 | 79.96 | 2.73 | 83.58 | 23.19 | 16.12 |
| T6 | Embodiment 5 | 2.0 | ml | 11.67 | 2.56 | 82.78 | 2.15 | 87.07 | 24.88 | 21.82 |
| T7 | Embodiment 6 | 0.5 | ml | 10.50 | 3.82 | 74.31 | 3.47 | 79.13 | 22.76 | 14.56 |
| T8 | Embodiment 6 | 1.0 | ml | 11.71 | 3.06 | 79.42 | 2.93 | 82.38 | 23.16 | 16.01 |
| T9 | Embodiment 6 | 2.0 | ml | 11.18 | 2.60 | 82.51 | 2.39 | 85.63 | 24.76 | 21.46 |
| T10 | Embodiment 10 | 0.5 | ml | 10.96 | 3.56 | 76.06 | 3.37 | 79.74 | 22.73 | 14.43 |
| T11 | Embodiment 10 | 1.0 | ml | 11.15 | 3.00 | 79.82 | 3.00 | 81.96 | 22.86 | 14.93 |
| T12 | Embodiment 10 | 2.0 | ml | 12.12 | 2.64 | 82.24 | 2.16 | 87.01 | 24.47 | 20.53 |
| T13 | Acephate 50% + | 2.0 | g | 13.08 | 3.17 | 78.68 | 3.10 | 81.36 | 22.89 | 15.03 |
| | Imidacloprid | | | | | | | | | |
| | 1.8% SP | | | | | | | | | |
| T14 | Pyriproxyfen | 1.5 | ml | 10.73 | 2.95 | 80.16 | 2.90 | 82.56 | 22.93 | 15.19 |
| | 05.00% + | | | | | | | | | |
| | Fenpropathrin | | | | | | | | | |
| | 15.00% EC | | | | | | | | | |
| T15 | Beta- | 1.0 | ml | 11.63 | 3.58 | 75.92 | 3.37 | 79.74 | 22.57 | 13.82 |
| | Cyfluthrin + | | | | | | | | | |
| | Imidacloprid | | | | | | | | | |
| | 300 OD | | | | | | | | | |
| T16 | Chlorpyrifos | 2.0 | ml | 10.29 | 3.08 | 79.29 | 3.01 | 81.90 | 22.80 | 14.69 |
| | 50.00% + | | | | | | | | | |
| | Cypermethrin | | | | | | | | | |
| | 05.00% EC | | | | | | | | | |

| | | | | | | | | | |
|---|---|---|---|---|---|---|---|---|---|
| T17 | Control | — | 12.78 | 14.87 | 0.00 | 16.63 | 0.00 | 19.45 | 0.00 |

| | | | | |
|---|---|---|---|---|
| SE± | 1.18 | 2.12 | 2.35 | 2.15 |
| C.D. (0.05) | NS | 6.36 | 7.04 | 6.43 |

### Conclusion:

1. The results of the trial revealed that an application of Embodiment 4@2 ml/l recorded the maximum % reduction in whiteflies population of 84.93% and 88.15% in 1^{st} and 2^{nd} spray over the control, respectively.
2. The Embodiment 4 exhibited the highest 25.88% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 95: Bio-Efficacy of Bio-Insecticides (Embodiment) and Synthetic Insecticides Against Watermelon Whiteflies (Bemisia tabaci)

Methodology: The field experimental trial was conducted to study the bio-efficacy of different bio-insecticide and synthetic insecticides against watermelon whiteflies during summer season 2022-2023 at Kay Bee Research and Development Farm, Maharashtra, India. The experiment was laid out by using randomized block design with three replication and seventeen treatments following spacings of 180 cm and 60 cm between rows and plants respectively. Each treatment consisted of an area of 8.5×5 m. Recommended agronomic practices were followed raise the watermelon crop. Observations on whiteflies population were taken on randomly selected five plants with three leaves per plant located at upper, middle and lower portion of vine. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{Population Count of Control Plot - Population Count of Treated Plot}{Population Count of Control Plot} * 100$$

### Results:

TABLE 97
Effect of Bio-Insecticide and Synthetic Insecticides on Whiteflies Population & % Population Reduction.

| | | | | | 1^{st} spray | | 2^{nd} spray | | | |
|---|---|---|---|---|---|---|---|---|---|---|
| | | | | | | % | | % | | % |
| | | | | No. of | | Reduction in | | Reduction in | | Increase |
| | | Dose | | whiteflies | | whiteflies | | whiteflies | | in Yield |
| Tr. | | ml or | | before | No. of | Population | No. of | Population | Yield | over |
| No. | Treatments | gm/L | | spray | whiteflies | over control | whiteflies | over control | (qtl/ha) | control |
| T1 | Embodiment 4 | 0.5 | ml | 12.64 | 5.61 | 66.84 | 5.44 | 68.69 | 36.41 | 16.86 |
| T2 | Embodiment 4 | 1 | ml | 13.29 | 5.32 | 68.56 | 5.16 | 70.31 | 37.24 | 18.72 |
| T3 | Embodiment 4 | 2 | ml | 12.73 | 5.10 | 69.86 | 4.95 | 71.54 | 37.89 | 20.11 |
| T4 | Embodiment 5 | 0.5 | ml | 13.17 | 5.52 | 67.38 | 5.35 | 69.19 | 36.58 | 17.25 |
| T5 | Embodiment 5 | 1 | ml | 12.95 | 5.36 | 68.32 | 5.20 | 70.09 | 37.28 | 18.80 |
| T6 | Embodiment 5 | 2 | ml | 11.99 | 5.02 | 70.33 | 4.87 | 71.98 | 38.02 | 20.38 |
| T7 | Embodiment 6 | 0.5 | ml | 13.88 | 5.49 | 67.55 | 5.33 | 69.36 | 36.78 | 17.70 |
| T8 | Embodiment 6 | 1 | ml | 11.90 | 5.29 | 68.74 | 5.13 | 70.48 | 37.32 | 18.89 |
| T9 | Embodiment 6 | 2 | ml | 13.68 | 4.90 | 71.04 | 4.75 | 72.65 | 38.83 | 22.04 |
| T10 | Embodiment 10 | 0.5 | ml | 12.34 | 5.40 | 68.09 | 5.24 | 69.86 | 37.02 | 18.23 |
| T11 | Embodiment 10 | 1 | ml | 12.51 | 5.20 | 69.27 | 5.04 | 70.98 | 37.74 | 19.79 |
| T12 | Embodiment 10 | 2 | ml | 14.00 | 4.82 | 71.51 | 4.68 | 73.10 | 40.37 | 25.02 |
| T13 | Acephate 50% + | 2.0 | g | 11.77 | 5.50 | 67.49 | 5.34 | 69.30 | 36.72 | 17.57 |
| | Imidacloprid | | | | | | | | | |
| | 1.8% SP | | | | | | | | | |
| T14 | Pyriproxyfen | 1.5 | ml | 13.66 | 5.39 | 68.14 | 5.23 | 69.92 | 36.82 | 17.79 |
| | 05.00% + | | | | | | | | | |
| | Fenpropathrin | | | | | | | | | |
| | 15.00% EC | | | | | | | | | |
| T15 | Beta- | 1.0 | ml | 11.84 | 5.71 | 66.25 | 5.54 | 68.13 | 35.49 | 14.71 |
| | Cyfluthrin + | | | | | | | | | |
| | Imidacloprid | | | | | | | | | |
| | 300 OD | | | | | | | | | |
| T16 | Chlorpyrifos | 2.0 | ml | 13.72 | 5.68 | 66.43 | 5.51 | 68.30 | 36.00 | 15.92 |

| | | | | | | | | | |
|---|---|---|---|---|---|---|---|---|---|
| | 50.00% + | | | | | | | | |
| | Cypermethrin | | | | | | | | |
| | 05.00% EC | | | | | | | | |
| T17 | Control | — | 12.78 | 16.92 | 0.00 | 17.38 | 0.00 | 30.27 | 0.00 |

| | | | | |
|---|---|---|---|---|
| SE± | 0.57 | 1.57 | 1.24 | 1.68 |
| C.D. (0.05) | NS | 4.72 | 3.71 | 5.03 |

### Conclusion:

1. The results of the trial revealed that an application of Embodiment 10@2 ml/l recorded the maximum % reduction in whiteflies population of 71.51% and 73.10% in 1^{st} and 2^{nd} spray over the control, respectively.
2. The Embodiment 10 exhibited the highest 25.02% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 96: Bio-Efficacy of Bio-Bactericide (Embodiment) and Synthetic Bactericides Against Cotton Bacterial Leaf Blight (Xanthomonas citri pv. Malvacearum)

Methodology: The field experimental trial was conducted to study the bio-efficacy of different Bio-bactericide and synthetic bactericides against Cotton BLB during kharif season 2022-2023 at Kay Bee Research and Development Farm, Maharashtra, India. The experiment was laid out by using randomized block design with three replication and eight treatments following spacings of 90 cm×90 cm between rows and plants respectively. Each treatment consisted of an area of 6 m×5 m. Recommended agronomic practices were followed raise the cotton crop. To record disease severity, A rating scale of 0-5 was used to score five plants from each treatment, avoiding border rows. The grades were assigned numerical ratings proportional to the diseased area. Two sprays were taken and observations recorded as per standard method use before and after the application of bactericide. The yield parameters were recorded at harvesting stage. The data were analyzed by applying standard statistical methods.

$$Percent Disease Index ( \% ) = \frac{Summation of all numerical ratings}{Total number of leaves examined \times maximum ratings} \times 100$$

### Results:

TABLE 98
Effect of Bio-bactericide and Synthetic Bactericides on Cotton BLB severity, % Disease Reduction and Yield in Cotton.

| | | | | | 1^{st} spray | | 2^{nd} spray | | | |
|---|---|---|---|---|---|---|---|---|---|---|
| | | | | | | % Disease | | % Disease | | |
| | | | | % Disease | % Disease | Reduction | % Disease | Reduction | | |
| | | | | Infection- | Infection | Over | Infection | Over | | % Increase |
| Tr. | | Dose ml | | Pre- | after | Control after | after | Control after | Yield | in Yield |
| No. | Treatments | or gm/L | | Spray | 1st spray | 1st spray | 2nd spray | 2nd spray | (qtl/ha) | over control |
| T1 | Embodiment 7 | 0.5 | ml | 35.32 | 28.45 | 51.20 | 12.15 | 82.69 | 25.08 | 8.37 |
| T2 | Embodiment 7 | 1 | ml | 36.21 | 27.65 | 52.57 | 9.15 | 86.97 | 25.77 | 10.83 |
| T3 | Embodiment 7 | 2 | ml | 35.66 | 22.10 | 62.09 | 5.45 | 92.24 | 28.50 | 19.37 |
| T4 | Kasugamycin | 2 | gm | 34.76 | 28.45 | 51.20 | 14.65 | 79.13 | 25.03 | 8.19 |
| | 5% + Copper | | | | | | | | | |
| | Oxychloride | | | | | | | | | |
| | 45% WP | | | | | | | | | |
| T5 | Copper | 2 | gm | 35.01 | 29.45 | 49.49 | 13.79 | 80.36 | 24.94 | 7.86 |
| | Oxychloride | | | | | | | | | |
| | 50WP | | | | | | | | | |
| T6 | Copper | 2 | gm | 34.65 | 28.66 | 50.84 | 14.98 | 78.66 | 25.01 | 8.12 |
| | Hydroxide | | | | | | | | | |
| | 53.8% DF | | | | | | | | | |
| T7 | Bromopol | 500 | PPM | 35.15 | 30.65 | 47.43 | 12.86 | 81.68 | 24.96 | 7.93 |

| | | | | | | | | | |
|---|---|---|---|---|---|---|---|---|---|
| T8 | Control | — | 34.74 | 58.30 | 0.00 | 70.20 | 0.00 | 22.98 | 0.00 |

| | | | | |
|---|---|---|---|---|
| SE± | 0.94 | 1.64 | 1.78 | 1.02 |
| C.D. (0.05) | NS | 4.92 | 5.34 | 3.06 |

### Conclusion:

1. The results of the trial revealed that an application of Embodiment 7@2 ml/l recorded the maximum % disease reduction in cotton BLB disease of 92.24% over the control.
2. The Embodiment 7 exhibited the highest 19.37% increase in yield over the control. Embodiment 7 reported phyto-tonic effects on plants.
3. The Embodiment 7 having dose of 2 and 1 ml recorded maximum % disease reduction in cotton BLB disease with increases in yield followed by rest of the treatments.

### Example 97: Bio-Efficacy of Bio-Bactericide (Embodiment) and Synthetic Bactericides Against Potato Bacterial Blight (BLB) (Ralstonia solanacearum)

Methodology: The field experimental trial was conducted to study the bio-efficacy of different Bio-bactericide and synthetic bactericides against Potato BLB during rabi season 2022-2023 at Kay Bee Research and Development Farm, Maharashtra, India. The experiment was laid out by using randomized block design with three replication and eight treatments following spacings of 60 cm×20 cm between rows and plants respectively. Each treatment consisted of an area of 5 m×4 m. Recommended agronomic practices were followed to raise the potato crop. To record disease severity, a rating scale of 0-5 was used to score five plants from each treatment, avoiding border rows. The grades were assigned numerical ratings proportional to the diseased area. Two sprays were taken and observations recorded as per standard method use before and after the application of bactericide. The yield parameters were recorded at harvesting stage. The data were analyzed by applying standard statistical methods.

$$Percent Disease Index ( \% ) = \frac{Summation of all numerical ratings}{Total number of leaves examined \times maximum ratings} \times 100$$

### Results:

TABLE 99
Effect of Bio-bactericide and Synthetic Bactericides on Potato BLB severity, % Disease Reduction and Yield of Potato.

| | | | | | 1^{st} spray | | 2^{nd} spray | | | |
|---|---|---|---|---|---|---|---|---|---|---|
| | | | | | | % Disease | | % Disease | | |
| | | | | % Disease | % Disease | Reduction | % Disease | Reduction | | |
| | | | | Infection- | Infection | Over | Infection | Over | | % Increase |
| Tr. | | Dose ml | | Pre- | after | Control after | after | Control after | Yield | in Yield |
| No. | Treatments | or gm/L | | Spray | 1st spray | 1st spray | 2nd spray | 2nd spray | (t/ha) | over control |
| T1 | Embodiment 7 | 0.5 | ml | 30.81 | 23.82 | 54.86 | 21.72 | 71.22 | 22.40 | 8.30 |
| T2 | Embodiment 7 | 1 | ml | 31.43 | 22.51 | 57.34 | 14.34 | 81.00 | 23.51 | 12.63 |
| T3 | Embodiment 7 | 2 | ml | 30.78 | 15.88 | 69.91 | 6.57 | 91.29 | 25.64 | 19.89 |
| T4 | Kasugamycin | 2 | gm | 31.55 | 22.46 | 57.44 | 21.85 | 71.05 | 22.34 | 8.06 |
| | 5% + Copper | | | | | | | | | |
| | Oxychloride | | | | | | | | | |
| | 45% WP | | | | | | | | | |
| T5 | Copper | 2 | gm | 31.25 | 22.92 | 56.57 | 22.10 | 70.72 | 21.89 | 6.17 |
| | Oxychloride | | | | | | | | | |
| | 50WP (2 gm/l) | | | | | | | | | |
| T6 | Copper | 2 | gm | 32.68 | 22.38 | 57.59 | 22.89 | 69.67 | 22.18 | 7.39 |
| | Hydroxide | | | | | | | | | |
| | 53.8% DF | | | | | | | | | |
| T7 | Bromopol | 500 | PPM | 31.46 | 24.49 | 53.59 | 21.79 | 71.13 | 22.24 | 7.64 |
| | (500 ppm) | | | | | | | | | |

| | | | | | | | | | |
|---|---|---|---|---|---|---|---|---|---|
| T8 | Control | — | 31.29 | 52.77 | 0.00 | 75.47 | 0.00 | 20.54 | 0.00 |

| | | | | |
|---|---|---|---|---|
| SE± | 1.11 | 1.42 | 1.68 | 0.89 |
| C.D. (0.05) | NS | 4.95 | 5.76 | 2.76 |

### Conclusion:

1. The results of the trial revealed that an application of Embodiment 7@2 ml/l recorded the maximum % disease reduction in potato BLB disease of 91.29% over the control.
2. The Embodiment 7 exhibited the highest 19.89% increase in yield over the control. Embodiment 7 reported phyto-tonic effects on plants.
3. The Embodiment 7 having dose of 2 and 1 ml recorded maximum % disease reduction in potato BLB disease with increases in yield followed by rest of the treatments.

### Example 98: Bio-Efficacy of Bio-Bactericide (Embodiment) and Synthetic Bactericides Against Rice Bacterial Blight (BLB) (Xanthomonas oryzae pv. Oryzae)

Methodology: The field experimental trial was conducted to study the bio-efficacy of different Bio-bactericide and synthetic bactericides against Rice BLB during kharif season 2022-2023 at Kay Bee Research and Development Farm, Maharashtra, India. The experiment was laid out by using randomized block design with three replication and eight treatments following spacings of 20 cm×15 cm between rows and plants respectively. Each treatment consisted of an area of 4 m×4.5 m. Recommended agronomic practices were followed raise the rice crop. To record disease severity, a rating scale of 0-5 was used to score five plants from each treatment, avoiding border rows. The grades were assigned numerical ratings proportional to the diseased area. Two sprays were taken and observations recorded as per standard method use before and after the application of Bactericides. The yield parameters were recorded at harvesting stage. The data were analyzed by applying standard statistical methods.

$$Percent Disease Index ( \% ) = \frac{Summation of all numerical ratings}{Total number of leaves examined \times maximum ratings} \times 100$$

### Results:

TABLE 100
Effect of Bio-bactericide and Synthetic Bactericides on Rice BLB severity, % Disease Reduction and Yield in Rice.

| | | | | | 1^{st} spray | | 2^{nd} spray | | | |
|---|---|---|---|---|---|---|---|---|---|---|
| | | | | | | % Disease | | % Disease | | |
| | | | | % Disease | % Disease | Reduction | % Disease | Reduction | | |
| | | | | Infection- | Infection | Over | Infection | Over | | % Increase |
| Tr. | | Dose ml | | Pre- | after | Control after | after | Control after | Yield | in Yield |
| No. | Treatments | or gm/L | | Spray | 1st spray | 1st spray | 2nd spray | 2nd spray | (t/ha) | over control |
| T1 | Embodiment 7 | 0.5 | ml | 32.64 | 22.51 | 61.14 | 18.33 | 75.74 | 4.10 | 8.54 |
| T2 | Embodiment 7 | 1 | ml | 33.25 | 20.47 | 64.66 | 14.65 | 80.61 | 4.16 | 9.86 |
| T3 | Embodiment 7 | 2 | ml | 33.69 | 15.53 | 73.19 | 11.12 | 85.28 | 4.64 | 19.18 |
| T4 | Kasugamycin | 2 | gm | 33.21 | 23.56 | 59.32 | 19.24 | 74.53 | 4.08 | 8.09 |
| | 5% + Copper | | | | | | | | | |
| | Oxychloride | | | | | | | | | |
| | 45% WP | | | | | | | | | |
| T5 | Copper | 2 | gm | 33.52 | 23.84 | 58.84 | 20.55 | 72.80 | 4.02 | 6.72 |
| | Oxychloride | | | | | | | | | |
| | 50WP | | | | | | | | | |
| T6 | Copper | 2 | gm | 34.78 | 22.46 | 61.22 | 19.98 | 73.55 | 4.07 | 7.86 |
| | Hydroxide | | | | | | | | | |
| | 53.8% DF | | | | | | | | | |
| T7 | Bromopol | 500 | PPM | 32.88 | 22.18 | 61.71 | 19.63 | 74.02 | 4.09 | 8.31 |

| | | | | | | | | | |
|---|---|---|---|---|---|---|---|---|---|
| T8 | Control | — | 33.95 | 57.92 | 0.00 | 75.55 | 0.00 | 3.75 | 0.00 |

| | | | | |
|---|---|---|---|---|
| SE± | 1.26 | 1.65 | 1.92 | 0.92 |
| C.D. (0.05) | NS | 4.95 | 5.76 | 2.76 |

### Conclusion:

1. The results of the trial revealed that an application of Embodiment 7@2 ml/l recorded the maximum % disease reduction in rice BLB disease of 85.28% over the control.
2. The Embodiment 7 exhibited the highest 19.18% increase in yield over the control. Embodiment 7 reported phyto-tonic effects on plants.
3. The Embodiment 7 having dose of 2 and 1 ml recorded maximum % disease reduction in rice BLB disease with increases in yield followed by rest of the treatments.

### Example 99: Bio-Efficacy of Bio-Bactericide (Embodiment) and Synthetic Bactericides Against Pomegranate Bacterial Leaf Blight (BLB-Xanthomonas axonopodis pv Punicae)

Methodology: The field experimental trial was conducted to study the bio-efficacy of different bio-bactericides and synthetic bactericides against pomegranate BLB during kharif season 2022-2023 at Kay Bee Research and Development Farm, Maharashtra, India. The experiment was laid out by using randomized block design with three replication and twelve treatments following spacings of 2.5×4.5 m between rows and plants respectively. Each treatment consisted of an area of 9.0×7.5 m. Recommended agronomic practices were followed raise the pomegranate crop. To record disease severity, A rating scale of 0-5 was used to score five plants from each treatment, avoiding border rows. The grades were assigned numerical ratings proportional to the diseased area. Two sprays were taken and observations recorded as per standard method use before and after the application of bactericide. The yield parameters were recorded at harvesting stage. The data were analyzed by applying standard statistical methods.

$$Percent Disease Index ( \% ) = \frac{Summation of all numerical ratings}{Total number of leaves examined \times maximum ratings} \times 100$$

### Results:

TABLE 101
Effect of Bio-Bactericide and Synthetic Bactericides on Pomegranate
BLB severity, % Disease Reduction & yield of pomegranate.

| | | | | | 1^{st} spray | | 2^{nd} spray | | % Disease | | % Increase |
|---|---|---|---|---|---|---|---|---|---|---|---|
| Tr. | | Dose ml | | Pre | 3^{rd} | 5^{th} | 3^{rd} | 5^{th} | Reduction | Yield | in yield |
| No. | Treatments | or gm/L | | spray | Day | day | Day | Day | over Control | (t/ha) | over control |
| T1 | Embodiment 7 | 0.5 | ml | 38.45 | 36.65 | 32.15 | 28.1 | 26.2 | 67.25 | 10.65 | 11.40 |
| T2 | Embodiment 7 | 1 | ml | 39.45 | 34.15 | 29.65 | 25.1 | 22.55 | 71.81 | 11.30 | 18.20 |
| T3 | Embodiment 7 | 2 | ml | 39.15 | 30.15 | 22.85 | 14.1 | 8.75 | 89.06 | 12.12 | 26.78 |
| T4 | Copper | 0.25% | | 38.65 | 36.65 | 30.15 | 26.14 | 25.66 | 67.92 | 10.75 | 12.45 |
| | oxychloride | | | | | | | | | | |
| T5 | Streptocycline | 500 | ppm | 38.45 | 34.1 | 30.13 | 28 | 25.75 | 67.81 | 10.47 | 9.52 |
| T6 | COC + | 0.25% + | | 39.15 | 33.55 | 29.45 | 27.1 | 24.15 | 69.81 | 10.85 | 13.49 |
| | Streptomycin | 500 ppm | | | | | | | | | |
| | sulphate | | | | | | | | | | |
| T7 | Bronopol | 500 | ppm | 38.45 | 36.68 | 32.15 | 28.75 | 26.65 | 66.68 | 10.55 | 10.36 |
| T8 | Agrimycin | 500 | ppm | 39.54 | 37.15 | 33.55 | 31.15 | 29.15 | 63.56 | 11.25 | 17.68 |
| T9 | Copper | 0.30% | | 38.65 | 35.45 | 33.15 | 31.2 | 30.75 | 61.56 | 11.13 | 16.42 |
| | Hydroxide | | | | | | | | | | |
| T10 | Kasugamycin + | 500 ppm + | | 38.15 | 34.15 | 31.15 | 29 | 28.85 | 64.35 | 10.98 | 14.85 |
| | COC | 0.25% | | | | | | | | | |
| T11 | Silixol | 1 | ml | 39.65 | 37.56 | 35.1 | 32 | 29.75 | 62.81 | 11.05 | 15.59 |

| | | | | | | | | | |
|---|---|---|---|---|---|---|---|---|---|
| T12 | Control | — | 38.65 | 54.15 | 60 | 68.4 | 80 | 00.00 | 9.56 |

| | | | | | | | |
|---|---|---|---|---|---|---|---|
| SE± | 1.53 | 1.87 | 1.48 | 1.88 | 1.59 | 2.51 | — |
| C.D. (0.05) | NS | 2.91 | 3.93 | 3.84 | 4.87 | 6.54 | — |

### Conclusion:

1. The results of the trial revealed that an application of Embodiment 7@2 ml/l recorded the maximum % disease reduction in pomegranate BLB disease of 89.06% over the control.
2. The Embodiment 7 exhibited the highest 26.78% increase in yield over the control. All the Embodiments reported phyto-tonic effects on plants.
3. The Embodiment having dose of 2 and 1 ml recorded maximum % disease reduction in pomegranate BLB disease with increases in yield followed by rest of the treatments.

### Example 100: Bio-Efficacy of Bio-Fungicides (Embodiment) and Synthetic Fungicides Against Wilt (Fusarium oxysporum f. Sp. vasinfectum) of Cotton

Methodology: The field experimental trial was conducted to study the bio-efficacy of different bio-fungicides and synthetic fungicides against wilt of Cotton during kharif season 2022-2023 at Kay Bee Research and Development Farm, Maharashtra, India. The experiment was laid out by using randomized block design with three replication and eight treatments following spacings of 0.9 m and 0.9 m between rows and plants respectively. Each treatment consisted of an area of 6×2.7 m. Recommended agronomic practices were followed raise the cotton crop. Observations on wilt disease were taken on selected fixed unit area for per treatment per replication. Two drenching were taken & disease incidence was recorded as per standard method use before and after the application of fungicides. The yield parameters were recorded at harvesting stage. The data were analyzed by applying standard statistical methods.

$$Disease Reduction over control ( \% ) = \frac{\% disease incidence of Control Plot - \% disease incidence of Treated Plot}{\% disease incidence of Control Plot} \times 100$$

### Results:

TABLE 102
Effect of Bio-Fungicides and Synthetic Fungicides on percent disease
incidence, % Disease Reduction & seed yield of cotton.

| | | | | | | | | | % Disease | | |
|---|---|---|---|---|---|---|---|---|---|---|---|
| | | | | | 1^{st} Drenching | | 2^{nd} Drenching | | reduction | | % Increase |
| Tr. | | Dose ml | | Pre | 10^{th} | 20^{th} | 30^{th} | 40^{th} | (2^{nd} drench) | Yield | in yield |
| No. | Treatments | or gm/L | | Drenching | day | day | day | day | over Control | (Qtl/ha) | over control |
| T1 | Embodiment 8 | 0.5 | ml | 10.0 | 10.6 | 10.7 | 10.9 | 11.2 | 62.16 | 23.4 | 14.53 |
| T2 | Embodiment 8 | 1.0 | ml | 10.5 | 10.7 | 10.9 | 11.0 | 11.0 | 62.84 | 25.5 | 21.57 |
| T3 | Embodiment 8 | 2.0 | ml | 10.3 | 10.5 | 10.5 | 10.5 | 10.5 | 64.53 | 27.4 | 27.01 |
| T4 | Thiophanate | 2.0 | gm | 10.6 | 11.3 | 116 | 11.9 | 12.9 | 56.42 | 21.4 | 6.54 |
| | Methyl | | | | | | | | | | |
| | 70% WP | | | | | | | | | | |
| T5 | Carbendazim | 1.5 | gm | 10.8 | 11.5 | 12.2 | 122 | 12.8 | 56.76 | 22.2 | 9.91 |
| | 12% + | | | | | | | | | | |
| | Mancozeb | | | | | | | | | | |
| | 63% WP | | | | | | | | | | |
| T6 | Thiophanate | 2.5 | ml | 104 | 11.1 | 11.3 | 11.6 | 12.5 | 57.77 | 23.6 | 15.25 |
| | methyl | | | | | | | | | | |
| | 450 g/l + | | | | | | | | | | |
| | Pyraclostrobin | | | | | | | | | | |
| | 50 g/l | | | | | | | | | | |
| | (w/v) FS | | | | | | | | | | |
| T7 | Carboxin | 3.0 | gm | 10.6 | 11.3 | 11.7 | 12.2 | 12.7 | 57.09 | 22.4 | 10.71 |
| | 37.5% + | | | | | | | | | | |
| | Thiram | | | | | | | | | | |
| | 37.5% DS | | | | | | | | | | |

| | | | | | | | | | | |
|---|---|---|---|---|---|---|---|---|---|---|
| T8 | Control | — | 101 | 16.2 | 193 | 22.8 | 29.6 | 0.00 | 20 | 0.00 |

| | | | | | | |
|---|---|---|---|---|---|---|
| SE± | 1.06 | 1.08 | 1.28 | 1.12 | 1.13 | 1.21 |
| C.D. (0.05) | NS | 3.24 | 3.84 | 3.36 | 3.39 | 3.65 |

### Conclusion:

1. The results of the trial revealed that an application of Embodiment 8@2 ml/l recorded the maximum % diseases reduction on wilt of 64.53% after 2^{nd} drenching over the control.
2. The Embodiment 8 exhibited the highest 27.01% increase in yield over the control. All the Embodiments reported phyto-tonic effects on plants.
3. All the Embodiments having dose of 2 and 1 ml recorded maximum reduction in % disease with increases in yield followed by rest of the treatments.

### Example 101: Bio-Efficacy of Bio-Fungicides (Embodiment) and Synthetic Fungicides Against Sheath Blight (Rhizoctonia solani) of Rice

Methodology: The field experimental trial was conducted to study the bio-efficacy of different bio-fungicides and synthetic fungicides against Sheath Blight of Rice during kharif season 2022-2023 at Kay Bee Research and Development Farm, Maharashtra, India. The experiment was laid out by using randomized block design with three replication and eight treatments following spacings of 20 cm and 15 cm between rows and plants respectively. Each treatment consisted of an area of 3.5×5 m. Recommended agronomic practices were followed raise the rice crop. Observations on sheath blight disease were taken on selected fixed unit area for per treatment per replication. Two sprays were taken & disease incidence was recorded as per standard method use before and after the application of fungicides. The yield parameters were recorded at harvesting stage. The data were analyzed by applying standard statistical methods.

$$Disease Reduction over control ( \% ) = \frac{\begin{matrix}\% disease incidence of Control Plot - \\ \% disease incidence of Treated Plot\end{matrix}}{\% disease incidence of Control Plot} \times 100$$

### Results:

TABLE 103
Effect of Bio-Fungicides and Synthetic Fungicides on percent disease
incidence, % Disease Reduction and yield of rice crop.

| | | | | | 1^{st}Spraying | | 2^{nd} Spraying | | % Disease | | % Increase |
|---|---|---|---|---|---|---|---|---|---|---|---|
| Tr. | | Dose ml | | Pre | 5^{th} | 10^{th} | 15^{th} | 20^{th} | reduction | Yield | in yield |
| No. | Treatments | or gm/L | | Spraying | day | day | Day | day | over Control | (Qtl/ha) | over control |
| T1 | Embodiment 8 | 0.5 | ml | 12.3 | 12.7 | 13.2 | 13.4 | 14.1 | 54.37 | 55.6 | 16.55 |
| T2 | Embodiment 8 | 1.0 | ml | 12.5 | 12.9 | 13.0 | 13.3 | 13.6 | 55.99 | 56.4 | 17.73 |
| T3 | Embodiment 8 | 2.0 | ml | 12.2 | 12.6 | 12.6 | 12.6 | 12.6 | 59.22 | 57.6 | 19.44 |
| T4 | Thiophanate | 2.0 | gm | 12.6 | 13.2 | 13.5 | 13.8 | 14.8 | 52.10 | 54.1 | 14.23 |
| | Methyl | | | | | | | | | | |
| | 70% WP | | | | | | | | | | |
| T5 | Carbendazim | 1.5 | gm | 12.1 | 13.4 | 13.8 | 13.8 | 14.7 | 52.43 | 54.3 | 14.55 |
| | 12% + | | | | | | | | | | |
| | Mancozeb | | | | | | | | | | |
| | 63% WP | | | | | | | | | | |
| T6 | Thiophanate | 2.5 | ml | 11.9 | 12.7 | 131 | 13.3 | 14.0 | 54.69 | 56 | 17.14 |
| | methyl | | | | | | | | | | |
| | 450 g/l + | | | | | | | | | | |
| | Pyraclostrobin | | | | | | | | | | |
| | 50 g/l (w/v) | | | | | | | | | | |
| | FS | | | | | | | | | | |
| T7 | Carboxin 37.5% + | 3.0 | gm | 12.5 | 13.7 | 13.9 | 13.9 | 14.4 | 53.40 | 54.6 | 15.02 |
| | Thiram 37.5% DS | | | | | | | | | | |

| | | | | | | | | | | |
|---|---|---|---|---|---|---|---|---|---|---|
| T8 | Control | — | 12.3 | 16.7 | 19.7 | 25.7 | 30.9 | 0.00 | 46.4 | 0.00 |

| | | | | | | |
|---|---|---|---|---|---|---|
| SE± | 0.98 | 1.02 | 1.20 | 1.17 | 1.22 | 1.23 |
| C.D. (0.05) | NS | 3.07 | 3.62 | 3.37 | 3.67 | 3.70 |

### Conclusion:

1. The results of the trial revealed that an application of Embodiment 8@2 ml/l recorded the maximum % diseases reduction on sheath blight of 59.22% after 2^{nd} spray over the control.
2. The Embodiment 8 exhibited the highest 19.44% increase in yield over the control. All the Embodiments reported phyto-tonic effects on plants.
3. All the Embodiments having dose of 2 and 1 ml recorded maximum reduction in % disease with increases in yield followed by rest of the treatments.

### Example 102: Bio-Efficacy of Bio-Fungicides (Embodiment) and Synthetic Fungicides Against Wilt (Fusarium oxysporum f. Sp. Lycopersici) of Tomato

Methodology: The field experimental trial was conducted to study the bio-efficacy of different bio-fungicides and synthetic fungicides against wilt of Tomato during kharif season 2022-2023 at Kay Bee Research and Development Farm, Maharashtra, India. The experiment was laid out by using randomized block design with three replication and eight treatments following spacings of 0.9 m and 0.3 m between rows and plants respectively. Each treatment consisted of an area of 3×1.8 m. Recommended agronomic practices were followed raise the tomato crop. Observations on wilt disease were taken on selected fixed unit area for per treatment per replication. Two drenching were taken & disease incidence was recorded as per standard method use before and after the application of fungicides. The yield parameters were recorded at harvesting stage. The data were analyzed by applying standard statistical methods.

$$Disease Reduction over control ( \% ) = \frac{\begin{matrix}\% disease incidence of Control Plot - \\ \% disease incidence of Treated Plot\end{matrix}}{\% disease incidence of Control Plot} \times 100$$

### Results:

TABLE 104
Effect of Bio-Fungicides and Synthetic Fungicides on percent disease
incidence, % Disease Reduction and yield of tomato crop.

| | | | | | | | | | % Disease | | |
|---|---|---|---|---|---|---|---|---|---|---|---|
| | | | | | 1^{st} Drenching | | 2^{nd} Drenching | | reduction | | % Increase |
| Tr. | | Dose ml | | Pre | 10^{th} | 20^{th} | 30^{th} | 40^{th} | (2^{nd} Drench) | Yield | in yield |
| No. | Treatments | or gm/L | | Drenching | day | day | Day | day | over Control | (t/ha) | over control |
| T1 | Embodiment 8 | 0.5 | ml | 10.20 | 10.80 | 10.90 | 11.00 | 11.10 | 61.32 | 46.30 | 15.33 |
| T2 | Embodiment 8 | 1.0 | ml | 10.70 | 10.90 | 11.00 | 11.10 | 11.20 | 60.98 | 47.50 | 17.47 |
| T3 | Embodiment 8 | 2.0 | ml | 10.50 | 10.70 | 10.80 | 10.80 | 10.80 | 62.37 | 48.20 | 18.67 |
| T4 | Thiophanate | 2.0 | gm | 10.80 | 11.50 | 11.60 | 11.80 | 12.20 | 57.49 | 43.70 | 10.30 |
| | Methyl | | | | | | | | | | |
| | 70% WP | | | | | | | | | | |
| T5 | Carbendazim | 1.5 | gm | 11.00 | 11.80 | 12.00 | 12.20 | 12.80 | 55.40 | 43.60 | 10.09 |
| | 12% + | | | | | | | | | | |
| | Mancozeb | | | | | | | | | | |
| | 63% WP | | | | | | | | | | |
| T6 | Thiophanate | 2.5 | ml | 10.60 | 11.20 | 11.40 | 11.60 | 12.00 | 58.19 | 45.60 | 14.04 |
| | methyl | | | | | | | | | | |
| | 450 g/l + | | | | | | | | | | |
| | Pyraclostrobin | | | | | | | | | | |
| | 50 g/l | | | | | | | | | | |
| | (w/v) FS | | | | | | | | | | |
| T7 | Carboxin | 3 | gm | 10.80 | 11.50 | 11.80 | 12.20 | 12.40 | 56.79 | 42.30 | 7.33 |
| | 37.5% + | | | | | | | | | | |
| | Thiram | | | | | | | | | | |
| | 37.5% DS | | | | | | | | | | |

| | | | | | | | | | | |
|---|---|---|---|---|---|---|---|---|---|---|
| T8 | Control | — | 10.30 | 16.30 | 18.30 | 22.60 | 28.70 | 0.00 | 39.20 | 0.00 |

| | | | | | | |
|---|---|---|---|---|---|---|
| SE± | 1.06 | 1.09 | 1.32 | 1.02 | 1.10 | 1.21 |
| C.D. (0.05) | NS | 3.28 | 3.97 | 3.07 | 3.35 | 3.65 |

### Conclusion:

1. The results of the trial revealed that an application of Embodiment 8@2 ml/l recorded the maximum % diseases reduction on wilt of 62.37% after 2^{nd} drenching over the control.
2. The Embodiment 8 exhibited the highest 18.67% increase in yield over the control. All the Embodiments reported phyto-tonic effects on plants.
3. All the Embodiments having dose of 2 and 1 ml recorded maximum reduction in % disease with increases in yield followed by rest of the treatments.

### Example 103: Bio-Efficacy of Bio-Nematicide (Embodiment) and Synthetic Nematicides Against Potato Nematodes (Gobodera Pallida)

Methodology: The field experimental trial was conducted to study the bio-efficacy of different bio-Nematicides and synthetic Nematicides against potato nematodes during rabi season 2022-2023 at Kay Bee Research and Development Farm, Maharashtra, India. The experiment was laid out by using randomized block design with three replication and eight treatments following spacing of 60 cm×20 cm between rows and plants respectively. Each treatment consisted of an area of 5×4 m. Recommended agronomic practices were followed raise the Potato crop. The soil population of cysts of G. pallida was observed. Observations recorded as per standard method in use before and after the application. The data were calculated by using standard statistical methods.

$$Decrease over control ( \% ) = \frac{Control Plot - Treated Plot}{Control Plot} \times 100$$

### Results:

TABLE 105
Effect of Bio-Nematicide and Synthetic Nematicides on Potato
Nematodes Population, % Reduction & yield of potato.

| | | Dose | | Initial Cyst | Final Cyst | Decrease | | Yield |
|---|---|---|---|---|---|---|---|---|
| Tr. | Treatment | (ml or | | Population/ | Population/ | over | Yield | % Increase |
| No | details | gm/lit.) | | 100 ml of soil | 100 ml of soil | Control | (t/Ha) | over control |
| 1 | Embodiment 8 | 0.5 | ml | 154.25 | 172.54 | 70.32 | 25.36 | 13.77 |
| 2 | Embodiment 8 | 1 | ml | 152.48 | 178.59 | 69.27 | 26.89 | 20.64 |
| 3 | Embodiment 8 | 2 | ml | 149.27 | 151.24 | 73.98 | 28.59 | 28.26 |
| 4 | Fluopyrum | 1.5 | ml | 185.69 | 198.25 | 65.89 | 27.18 | 21.94 |
| | 34.48% SC | | | | | | | |
| 5 | Paecilomyces | 10 | ml | 189.87 | 202.13 | 65.22 | 25.14 | 12.79 |
| | lilacinus | | | | | | | |
| 6 | Carbofuran | 3 | gm | 152.63 | 246.3 | 57.63 | 25.89 | 16.15 |

| | | | | | | | |
|---|---|---|---|---|---|---|---|
| | 3% CG | | | | | | |
| 7 | Fluensulfone | 1.5 gm/ | 183.23 | 220.78 | 62.02 | 27.01 | 21.18 |
| | 2% GR | plant | | | | | |
| 8 | Control | — | — | 581.25 | — | 22.29 | — |

| | | | | | |
|---|---|---|---|---|---|
| S.E. | — | 1.92 | — | — | — |
| C.D. 0.05% | — | 5.98 | — | — | — |

### Conclusion:

1. The results of the trial revealed that an application of Embodiment 8@2 ml/l recorded the maximum % reduction in potato nematodes cyst population of 73.98% over the control.
2. The Embodiment 8 exhibited the highest 28.26% increase in yield over the control. All the Embodiments reported phyto-tonic effects on plants.
3. The Embodiment having dose of 2 and 1 ml recorded maximum % reduction in potato nematodes with increases in yield followed by rest of the treatments.

### Example 104: Bio-Efficacy of Bio-Nematicide (Embodiment) and Synthetic Nematicides Against Soybean Nematodes (Heterodera glycines)

Methodology: The field experimental trial was conducted to study the bio-efficacy of different bio-Nematicides and synthetic Nematicides against soybean nematodes during kharif season 2022-2023 at Kay Bee Research and Development Farm, Maharashtra, India. The experiment was laid out by using randomized block design with three replication and eight treatments following spacing of 45 cm×5 cm between rows and plants respectively. Each treatment consisted of an area of 5×4 m. Recommended agronomic practices were followed raise the soybean crop. The soil population of cysts of H. glycines was observed. Observations recorded as per standard method in use before and after the application. The data were calculated by using standard statistical methods.

$$Decrease over control ( \% ) = \frac{Control Plot - Treated Plot}{Control Plot} \times 100$$

### Results:

TABLE 106
Effect of Bio-Nematicide and Synthetic Nematicides on Soybean
Nematodes Population, % Reduction & yield of soybean.

| | | Dose | | Initial Cyst | Final Cyst | % Decrease | | % Yield |
|---|---|---|---|---|---|---|---|---|
| Tr. | Treatment | (ml or | | Population/ | Population/ | over | Yield | increase |
| No. | details | gm/lit.) | | 100 ml of soil | 100 ml of soil | Control | (qtl/Ha) | over Control |
| 1 | Embodiment 8 | 0.5 | ml | 57.00 | 75.02 | 64.28 | 21.46 | 11.77 |
| 2 | Embodiment 8 | 1 | ml | 60.00 | 66.47 | 68.35 | 22.56 | 17.50 |
| 3 | Embodiment 8 | 2 | ml | 59.00 | 61.02 | 70.94 | 23.48 | 22.29 |
| 4 | Fluopyrum | 1.5 | ml | 57.00 | 77.78 | 62.96 | 20.46 | 6.56 |
| | 34.48% SC | | | | | | | |
| 5 | Paecilomyces | 10 | ml | 57.00 | 79.62 | 62.09 | 20.03 | 4.32 |
| | lilacinus | | | | | | | |
| 6 | Carbofuran | 3 | gm | 58.00 | 76.85 | 63.40 | 21.89 | 14.01 |
| | 3% CG | | | | | | | |

| | | | | | | | |
|---|---|---|---|---|---|---|---|
| 7 | Fluensulfone | 1.5 gm/ | 63.00 | 77.47 | 63.11 | 22.46 | 16.98 |
| | 2% GR | plant | | | | | |
| 8 | Control | — | 59.00 | 210 | | 19.2 | |

| | | |
|---|---|---|
| S.E. | 1.82 | — |
| C.D. 0.05% | 4.98 | — |

### Conclusion:

1. The results of the trial revealed that an application of Embodiment 8@2 ml/l recorded the maximum % reduction in soybean nematodes cyst population of 70.94% over the control.
2. The Embodiment 8 exhibited the highest 22.29% increase in yield over the control. All the Embodiments reported phyto-tonic effects on plants.
3. The Embodiment having dose of 2 and 1 gm recorded maximum % disease reduction in soybean nematodes with increases in yield followed by rest of the treatments.

### Example 105: Bio-Efficacy of Bio-Nematicide (Embodiment) and Synthetic Nematicides Against Wheat Nematodes (Meloidogyne graminocola)

Methodology: The field experimental trial was conducted to study the bio-efficacy of different bio-Nematicide and synthetic Nematicide against wheat nematodes during rabi season 2022-2023 at Kay Bee Research and Development Farm, Maharashtra, India. The experiment was laid out by using randomized block design with three replication and eight treatments following spacing of 20 cm between rows. Each treatment consisted of an area of 5×4 m. Recommended agronomic practices were followed raise the Wheat crop. The soil population of Nematodes of M. graminicola was observed. Observations recorded as per standard method in use before and after the application. The data were calculated by using standard statistical methods.

$$Decrease over control ( \% ) = \frac{Control Plot - Treated Plot}{Control Plot} \times 100$$

### Results:

TABLE 107
Effect of Bio-Nematicide and Synthetic Nematicide on
Wheat Nematodes Population, % Reduction & yield of wheat.
Nematode population/200 cc of soil

| | | | | | | | % Decrease | | % Increase |
|---|---|---|---|---|---|---|---|---|---|
| Tr. | Treatment | Dose | | Pre | | | over | Yield | in Yield |
| No | details | (ml/gm/lit.) | | Treatment | 7 DAT | 14 DAT | Control | (qtl/Ha) | over control |
| 1 | Embodiment 8 | 0.5 | ml | 427 | 213 | 151 | 72.50 | 36.58 | 16.79 |
| 2 | Embodiment 8 | 1 | ml | 436 | 217 | 148 | 73.04 | 37.54 | 19.86 |
| 3 | Embodiment 8 | 2 | ml | 416 | 208 | 102 | 81.42 | 39.12 | 24.90 |
| 4 | Fluopyrum | 1.5 | ml | 427 | 229 | 165 | 69.95 | 35.66 | 13.86 |
| | 34.48% SC | | | | | | | | |
| 5 | Paecilomyces | 10 | ml | 457 | 219 | 198 | 63.93 | 34.65 | 10.63 |
| | lilacinus | | | | | | | | |
| 6 | Carbofuran | 3 | gm | 419 | 239 | 166 | 69.76 | 34.15 | 9.04 |
| | 3% CG | | | | | | | | |

| | | | | | | | | |
|---|---|---|---|---|---|---|---|---|
| 7 | Fluensulfone | 1.5 gm/ | 421 | 265 | 198 | 63.93 | 36.00 | 14.94 |
| | 2% GR | plant | | | | | | |
| 8 | Control | — | 435 | 498 | 549 | 0.00 | 31.32 | |

| | | | | |
|---|---|---|---|---|
| S.E. | 2.23 | 2.34 | 2.86 | — |
| C.D. 0.05% | N.S. | 7.12 | 8.43 | — |

### Conclusion:

1. The results of the trial revealed that an application of Embodiment 8@2 ml/l recorded the maximum % reduction in wheat nematodes population of 81.42% over the control.
2. The Embodiment 8 exhibited the highest 24.90% increase in yield over the control. All the Embodiments reported phyto-tonic effects on plants.
3. The Embodiment having dose of 2 and 1 gm recorded maximum % reduction in wheat nematodes with increases in yield followed by rest of the treatments.

### Example 106: Bio-Efficacy of Bio-Insecticides (Embodiment) and Synthetic Insecticides Against Grape Thrips (Scirtothrips dorsalis)

Methodology: The field experimental trial was conducted to study the bio-efficacy of different bio-insecticide and synthetic insecticides against Grape thrips during Rabi season 2022-2023 at Kay Bee Research and Development Farm, Maharashtra, India. The experiment was laid out by using randomized block design with three replication and eight treatments following spacings of 4.5 m and 4.5 m between rows and plants respectively. Each treatment consisted of an area of 9 m×9 m. Recommended agronomic practices were followed raise the grape crop. Observations on thrips population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{Population Count of Control Plot - Population Count of Treated Plot}{Population Count of Control Plot} * 100$$

### Results:

TABLE 108
Effect of Bio-Insecticide and Synthetic Insecticides on Thrips
Population, % Population Reduction & Yield of Grapes

| | | | | | 1^{st} spray | | 2^{nd} spray | | | |
|---|---|---|---|---|---|---|---|---|---|---|
| | | | | No. of | | % Reduction | | % Reduction | | |
| | | Dose | | Thrips | | in Thrips | | in thrips | | % Increase |
| Tr. | | ml or | | before | No. of | population | No. of | population | Yield | in Yield |
| No. | Treatments | gm/L | | spray | thrips | over control | thrips | over control | (t/ha) | over control |
| T1 | Embodiment 2 | 0.5 | ml | 12.84 | 4.89 | 73.50 | 4.23 | 84.32 | 21.08 | 11.53 |
| T2 | Embodiment 2 | 1 | ml | 13.64 | 3.48 | 81.14 | 3.39 | 87.44 | 24.09 | 22.58 |
| T3 | Embodiment 2 | 2 | ml | 11.04 | 2.91 | 84.23 | 1.80 | 93.33 | 25.63 | 27.23 |
| T4 | Fluxametamide | 0.8 | ml | 12.64 | 5.17 | 71.98 | 4.26 | 84.21 | 20.57 | 9.33 |
| | 10EC | | | | | | | | | |
| T5 | Cyantraniliprole | 1.5 | ml | 13.34 | 5.78 | 68.67 | 4.55 | 83.14 | 20.18 | 7.58 |
| | 10.26% OD | | | | | | | | | |
| T6 | Fipronil | 0.15 | gm | 13.79 | 4.31 | 76.64 | 4.02 | 85.10 | 21.59 | 13.62 |
| | 80WG | | | | | | | | | |
| T7 | Tolfenpyrad | 2 | ml | 14.22 | 4.77 | 74.15 | 4.10 | 84.80 | 21.34 | 12.61 |
| | 15EC | | | | | | | | | |

| | | | | | | | | | |
|---|---|---|---|---|---|---|---|---|---|
| T8 | Control | — | 12.34 | 18.45 | 0.00 | 26.98 | 0.00 | 18.65 | 0.00 |

| | | | | |
|---|---|---|---|---|
| SE± | 0.78 | 1.02 | 1.12 | 1.89 |
| C.D. (0.05) | NS | 3.06 | 3.35 | 5.57 |

### Conclusion:

1. The results of the trial revealed that an application of Embodiment 2@2 ml/l recorded the maximum % reduction in thrips population of 84.23% and 93.33% in 1^{st} and 2^{nd} spray over the control, respectively.
2. The Embodiment 2 exhibited the highest 27.23% increase in yield over the control. Embodiment 2 reported phyto-tonic effects on plants.
3. Embodiment 2 having dose of 2 and 1 ml recorded maximum reduction in % insect population with increases in yield followed by rest of the treatments.

### Example 107: Bio-Efficacy of Bio-Insecticides (Embodiment) and Synthetic Insecticides Against Groundnut Thrips (Scirtothrips dorsalis)

Methodology: The field experimental trial was conducted to study the bio-efficacy of different bio-insecticide and synthetic insecticides against Groundnut thrips during kharif season 2022-2023 at Kay Bee Research and Development Farm, Maharashtra, India. The experiment was laid out by using randomized block design with three replication and eight treatments following spacings of 45 cm and 10 cm between rows and plants respectively. Each treatment consisted of an area of 4 m×2 m. Recommended agronomic practices were followed raise the groundnut crop. Observations on thrips population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{Population Count of Control Plot - Population Count of Treated Plot}{Population Count of Control Plot} * 100$$

### Results:

TABLE 109
Effect of Bio-Insecticide and Synthetic Insecticides on Thrips
Population, % Population Reduction & yield of groundnut.

| | | | | | 1^{st} spray | | 2^{nd} spray | | | |
|---|---|---|---|---|---|---|---|---|---|---|
| | | | | No. of | | % Reduction | | % Reduction | | |
| | | | | Thrips | | in thrips | | in thrips | | % Increase |
| Tr. | | Dose ml | | before | No. of | population | No. of | population | Yield | in Yield |
| No. | Treatments | or gm/L | | spray | thrips | over control | thrips | over control | (t/ha) | over control |
| T1 | Embodiment 2 | 0.5 | ml | 10.01 | 3.87 | 74.34 | 3.16 | 87.79 | 38.43 | 21.79 |
| T2 | Embodiment 2 | 1.0 | ml | 9.74 | 3.12 | 79.31 | 2.71 | 89.53 | 39.51 | 23.93 |
| T3 | Embodiment 2 | 2.0 | ml | 9.13 | 1.99 | 86.80 | 1.89 | 92.70 | 40.05 | 24.96 |
| T4 | Fluxametamide | 0.8 | ml | 8.12 | 4.67 | 69.03 | 3.50 | 86.48 | 37.26 | 19.34 |
| | 10EC | | | | | | | | | |
| T5 | Cyantraniliprole | 1.5 | ml | 8.55 | 3.57 | 76.33 | 2.89 | 88.84 | 38.84 | 22.61 |
| | 10.26% OD | | | | | | | | | |
| T6 | Fipronil | 0.15 | gm | 7.24 | 5.18 | 65.65 | 3.76 | 85.48 | 36.23 | 17.03 |
| | 80WG | | | | | | | | | |
| T7 | Tolfenpyrad | 2.0 | ml | 9.13 | 4.56 | 69.76 | 3.43 | 86.75 | 37.85 | 20.58 |
| | 15EC | | | | | | | | | |

| | | | | | | | | | |
|---|---|---|---|---|---|---|---|---|---|
| T8 | Control | — | 7.33 | 15.08 | 0.00 | 25.89 | 0.00 | 30.06 | 0.00 |

| | | | | |
|---|---|---|---|---|
| SE± | 1.24 | 0.98 | 1.01 | 1.12 |
| C.D. (0.05) | NS | 2.94 | 3.03 | 3.36 |

### Conclusion:

1. The results of the trial revealed that an application of Embodiment 2@2 ml/l recorded the maximum % reduction in thrips population of 86.80% and 92.70% in 1^{st} and 2^{nd} spray over the control, respectively.
2. The Embodiment 2 exhibited the highest 24.96% increase in yield over the control. Embodiment 2 reported phyto-tonic effects on plants.
3. All the Embodiments having dose of 2 and 1 ml recorded maximum reduction in % insect population with increases in yield followed by rest of the treatments.

### Example 108: Bio-Efficacy of Bio-Insecticides (Embodiment) and Synthetic Insecticides Against Tomato Thrips (Thrips tabaci)

Methodology: The field experimental trial was conducted to study the bio-efficacy of different bio-insecticide and synthetic insecticides against Tomato thrips during rabi season 2022-2023 at Kay Bee Research and Development Farm, Maharashtra, India. The experiment was laid out by using randomized block design with three replication and eight treatments following spacings of 90 cm and 60 cm between rows and plants respectively. Each treatment consisted of an area of 5 m×4 m. Recommended agronomic practices were followed raise the tomato crop. Observations on thrips population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{Population Count of Control Plot - Population Count of Treated Plot}{Population Count of Control Plot} * 100$$

### Results:

TABLE 110
Effect of Bio-Insecticide and Synthetic Insecticides on Thrips
Population, % Population Reduction & Yield of Tomato

| | | | | | 1^{st} spray | | 2^{nd} spray | | | |
|---|---|---|---|---|---|---|---|---|---|---|
| | | | | No. of | | % Reduction | | % Reduction | | |
| | | | | Thrips | | in Thrips | | in thrips | | % Increase |
| Tr. | | Dose ml | | before | No. of | population | No. of | population | Yield | in Yield |
| No. | Treatments | or gm/L | | spray | thrips | over control | thrips | over control | (t/ha) | over control |
| T1 | Embodiment 2 | 0.5 | ml | 13.78 | 5.15 | 75.74 | 4.78 | 83.00 | 39.91 | 11.83 |
| T2 | Embodiment 2 | 1 | ml | 13.51 | 3.88 | 81.72 | 3.67 | 86.94 | 42.18 | 16.57 |
| T3 | Embodiment 2 | 2 | ml | 12.90 | 3.11 | 85.35 | 2.01 | 92.85 | 43.10 | 18.35 |
| T4 | Fluxametamide | 0.8 | ml | 11.89 | 4.14 | 80.50 | 4.00 | 85.77 | 40.13 | 12.31 |
| | 10EC | | | | | | | | | |
| T5 | Cyantraniliprole | 1.5 | ml | 12.32 | 6.02 | 71.64 | 5.33 | 81.04 | 38.01 | 7.42 |
| | 10.26% OD | | | | | | | | | |
| T6 | Fipronil | 0.15 | gm | 11.01 | 5.41 | 74.52 | 4.97 | 82.32 | 38.56 | 8.74 |
| | 80WG | | | | | | | | | |
| T7 | Tolfenpyrad | 2 | ml | 12.90 | 5.04 | 76.26 | 4.15 | 85.24 | 40.00 | 12.03 |
| | 15EC | | | | | | | | | |

| | | | | | | | | | |
|---|---|---|---|---|---|---|---|---|---|
| T8 | Control | — | 11.10 | 21.23 | 0.00 | 28.11 | 0.00 | 35.19 | 0.00 |

| | | | | |
|---|---|---|---|---|
| SE± | 0.99 | 1.14 | 0.87 | 1.19 |
| C.D. (0.05) | NS | 3.43 | 2.60 | 3.57 |

### Conculsion:

1. The results of the trial revealed that an application of Embodiment 2@2 ml/l recorded the maximum % reduction in thrips population of 85.35% and 92.85% in 1^{st} and 2^{nd} spray over the control, respectively.
2. The Embodiment 2 exhibited the highest 18.35% increase in yield over the control. Embodiment 2 reported phy-tonic effects on plants.
3. All the Embodiments having dose of 2 and 1 ml recorded maximum reduction in % insect population with increases in yield followed by rest of the treatments.

### Example 109: Bio-Efficacy of Bio-Viricides (Embodiment) and Market Viricides Against Leaf Curl Virus of Chili (ChiLCV)

Methodology: The field experimental trial was conducted to study the bio-efficacy of different concentration of Bio-viricide (Embodiment) and market viricides against leaf curl virus of Chili during kharif season 2022-2023 at Kay Bee Research and Development Farm, Maharashtra, India. The experiment was laid out by using randomized block design with three replication and eight treatments following spacings of 50 cm and 60 cm between rows and plants respectively. Each treatment consisted of an area of 3.8×5 m. Recommended agronomic practices were followed raise the chili crop. Observations on leaf curl virus disease were taken on randomly selected ten plant per plot. Two sprays were taken & disease intensity was recorded as per standard method use before and after the application of viricides. The yield parameters were recorded at harvesting stage. The data were analyzed by applying standard statistical methods.

$$Disease Reduction over control ( \% ) = \frac{\begin{matrix}\% disease intensity of Control Plot - \\ \% disease intensity of Treated Plot\end{matrix}}{\% disease intensity of Control Plot} \times 100$$

### Results:

TABLE 111
Effect of different concentration of Bio-viricide (Embodiment) and market viricides
on percent disease intensity, % Disease Reduction & yield of chili crop.

| | | | | | 1^{st} spray | | 2^{nd} spray | | % Disease | | % Increase |
|---|---|---|---|---|---|---|---|---|---|---|---|
| Tr. | | Dose ml | | Pre | 5^{th} | 10^{th} | 5^{th} | 10^{th} | reduction | Yield | in yield |
| No. | Treatments | or gm/L | | spray | Day | day | Day | day | over Control | (t/ha) | over control |
| T1 | Embodiment 9 | 0.5 | ml | 31.15 | 27.89 | 25.12 | 22.65 | 16.72 | 75.46 | 4.52 | 16.81 |
| T2 | Embodiment 9 | 1.0 | ml | 29.10 | 26.12 | 22.67 | 18.16 | 12.34 | 81.88 | 4.72 | 20.34 |
| T3 | Embodiment 9 | 2.0 | ml | 31.65 | 25.76 | 21.23 | 14.12 | 8.14 | 88.05 | 4.91 | 23.42 |
| T4 | Thyro | 1.5 | gm | 30.17 | 29.33 | 25.33 | 21.76 | 17.65 | 74.09 | 4.61 | 18.44 |
| T5 | Kurax | 4.0 | ml | 31.54 | 28.77 | 24.57 | 19.43 | 14.77 | 78.32 | 4.32 | 12.96 |
| T6 | Tinto | 5.0 | ml | 31.77 | 29.34 | 25.46 | 20.6 | 18.45 | 72.92 | 4.21 | 10.69 |
| T7 | Virosol | 2.0 | ml | 30.15 | 29.58 | 25.87 | 21.53 | 17.65 | 74.09 | 4.19 | 10.26 |

| | | | | | | | | | | |
|---|---|---|---|---|---|---|---|---|---|---|
| T8 | Control | — | 31.10 | 38.73 | 46.78 | 57.41 | 68.12 | 0.00 | 3.76 | 0.00 |

| | | | | | | |
|---|---|---|---|---|---|---|
| SE± | 0.96 | 1.12 | 1.18 | 1.27 | 1.92 | 1.13 |
| C.D. (0.05) | NS | 3.36 | 3.55 | 3.81 | 5.76 | 3.39 |

### Conclusion:

1. The results of the trial revealed that an application of Embodiment 9@2 ml/l recorded the maximum % diseases reduction on leaf curl virus of 88.05% after 2^{nd} spray over the control.
2. The Embodiment 9 exhibited the highest 23.42% increase in yield over the control. All the Embodiments reported phyto-tonic effects on plants.
3. All the Embodiments having dose of 2 and 1 ml recorded maximum reduction in % disease with increases in yield followed by rest of the treatments.

### Example 110: Bio-Efficacy of Bio-Viricides (Embodiment) and Market Viricides Against Cucumber Mosaic Virus of Banana (CMV)

Methodology: The field experimental trial was conducted to study the bio-efficacy of different concentration of Bio-viricides (Embodiment) and market viricides against Cucumber mosaic virus of Banana during kharif season 2022-2023 at Kay Bee Research and Development Farm, Maharashtra, India. The experiment was laid out by using randomized block design with three replication and eight treatments following spacings of 1.5 m and 1.5 m between rows and plants respectively. Each treatment consisted of an area of 7.5×3 m. Recommended agronomic practices were followed raise the Banana crop. Observations on cucumber mosaic virus disease were taken on randomly selected five plant per plot. Two sprays were taken & disease intensity was recorded as per standard method use before and after the application of viricides. The yield parameters were recorded at harvesting stage. The data were analyzed by applying standard statistical methods.

$$Disease Reduction over control ( \% ) = \frac{\begin{matrix}\% disease intensity of Control Plot - \\ \% disease intensity of Treated Plot\end{matrix}}{\% disease intensity of Control Plot} \times 100$$

### Results:

TABLE 112
Effect of different concentration of Bio-viricide (Embodiment) and market viricides
on Percent Disease intensity, % Disease Reduction & yield of Banana crop.

| | | | | | 1^{st} spray | | 2^{nd} spray | | % Disease | | % Increase |
|---|---|---|---|---|---|---|---|---|---|---|---|
| Tr. | | Dose ml | | Pre | 3^{rd} | 5^{th} | 3^{rd} | 5^{th} | reduction | Yield | in yield |
| No. | Treatment | or gm/L | | spray | Day | day | Day | day | over Control | (t/ha) | over control |
| T1 | Embodiment 9 | 0.5 | ml | 38.40 | 36.68 | 32.17 | 27.98 | 18.87 | 75.81 | 58.2 | 12.03 |
| T2 | Embodiment 9 | 1.0 | ml | 37.48 | 32.28 | 29.56 | 25.43 | 14.70 | 81.15 | 62.3 | 17.82 |
| T3 | Embodiment 9 | 2.0 | ml | 38.54 | 28.10 | 22.77 | 14.65 | 8.54 | 89.05 | 65.6 | 21.95 |
| T4 | Thyro | 1.5 | gm | 38.68 | 36.76 | 30.28 | 26.38 | 22.34 | 71.36 | 57.5 | 10.96 |
| T5 | Kurax | 4 | ml | 37.57 | 32.34 | 25.56 | 24.6 | 23.44 | 69.95 | 56.3 | 9.06 |
| T6 | Tinto | 5.0 | ml | 37.15 | 31.58 | 26.87 | 19.43 | 19.33 | 75.22 | 56.1 | 8.73 |
| T7 | Virosol | 2.0 | ml | 38.86 | 31.75 | 24.55 | 19.88 | 17.55 | 77.50 | 60.7 | 15.65 |

| | | | | | | | | | | |
|---|---|---|---|---|---|---|---|---|---|---|
| T8 | Control | — | 37.46 | 48.25 | 55.60 | 68.40 | 78.00 | 0.00 | 51.2 | 0.00 |

| | | | | | | |
|---|---|---|---|---|---|---|
| SE± | 0.95 | 1.22 | 1.24 | 1.28 | 1.63 | 1.16 |
| C.D. (0.05) | NS | 3.66 | 3.72 | 3.84 | 4.89 | 3.49 |

### Conclusion:

1. The results of the trial revealed that an application of Embodiment 9@2 ml/l recorded the maximum % diseases reduction on cucumber mosaic virus of 89.05% after 2^{nd} spray over the control.
2. The Embodiment 9 exhibited the highest 21.95% increase in yield over the control. All the Embodiments reported phyto-tonic effects on plants.
3. All the Embodiments having dose of 2 and 1 ml recorded maximum reduction in % disease with increases in yield followed by rest of the treatments.

### Example 111: Bio-Efficacy of Bio-Viricides (Embodiment) and Market Viricides Against Soybean Mosaic Virus (SMV)

Methodology: The field experimental trial was conducted to study the bio-efficacy of different concentration of Bio-viricide (Embodiment) and market viricides against Soybean Mosaic Virus during kharif season 2022-2023 at Kay Bee Research and Development Farm, Maharashtra, India. The experiment was laid out by using randomized block design with three replication and eight treatments following spacings of 45 cm and 10 cm between rows and plants respectively. Each treatment consisted of an area of 5×4.5 m. Recommended agronomic practices were followed raise the Soybean crop. Observations on mosaic virus disease were taken on randomly selected ten plant per plot. Two sprays were taken & disease intensity was recorded as per standard method use before and after the application of viricides. The yield parameters were recorded at harvesting stage. The data were analyzed by applying standard statistical methods.

$$Disease Reduction over control ( \% ) = \frac{\begin{matrix}\% disease intensity of Control Plot - \\ \% disease intensity of Treated Plot\end{matrix}}{\% disease intensity of Control Plot} * 100$$

### Results:

TABLE 113
Effect of different concentration of Bio-viricide (Embodiment) and market viricides
on percent disease intensity, % Disease Reduction & yield of Soybean crop.

| | | | | | | | | | % | | % |
|---|---|---|---|---|---|---|---|---|---|---|---|
| | | | | | | | | | Disease | | Increase |
| | | Dose | | | 1^{st} spray | | 2^{nd} spray | | reduction | | in Yield |
| Tr. | | ml or | | Pre | 3^{rd} | 5^{th} | 3^{rd} | 5^{th} | over | Yield | over |
| No. | Treatments | gm/L | | Spray | day | day | day | day | Control | (t/ha) | control |
| T1 | Embodiment 9 | 0.5 | ml | 31.98 | 27.41 | 24.77 | 20.65 | 17.56 | 74.55 | 2.03 | 11.33 |
| T2 | Embodiment 9 | 1.0 | ml | 31.18 | 25.36 | 21.33 | 18.43 | 15.10 | 78.12 | 2.18 | 17.43 |
| T3 | Embodiment 9 | 2.0 | ml | 32.24 | 25.56 | 20.88 | 15.76 | 7.37 | 89.32 | 2.28 | 21.05 |
| T4 | Thyro | 1.5 | gm | 31.44 | 29.60 | 22.67 | 19.58 | 16.48 | 76.12 | 2.10 | 14.29 |
| T5 | Kurax | 4.0 | ml | 32.68 | 27.63 | 23.76 | 19.65 | 18.00 | 73.91 | 2.00 | 10.00 |
| T6 | Tinto | 5.0 | ml | 31.28 | 28.45 | 22.76 | 21.76 | 18.87 | 72.65 | 1.98 | 9.09 |
| T7 | Virosol | 2.0 | ml | 31.66 | 29.47 | 25.77 | 21.68 | 18.22 | 73.59 | 1.99 | 9.55 |

| | | | | | | | | | | |
|---|---|---|---|---|---|---|---|---|---|---|
| T8 | Control | — | 32.56 | 39.00 | 49.66 | 59.80 | 69.00 | 0.00 | 1.80 | 0.00 |

| | | | | | | |
|---|---|---|---|---|---|---|
| SE± | 1.02 | 1.17 | 1.19 | 1.22 | 1.24 | 1.23 |
| C.D. (0.05) | NS | 3.51 | 3.57 | 3.66 | 3.72 | 3.71 |

### Conclusion:

1. The results of the trial revealed that an application of Embodiment 9@2 ml/l recorded the maximum % diseases reduction on soybean mosaic virus of 89.32% after 2^{nd} spray over the control.
2. The Embodiment 9 exhibited the highest 21.05% increase in yield over the control. All the Embodiments reported phyto-tonic effects on plants.
3. All the Embodiments having dose of 2 and 1 ml recorded maximum reduction in % disease with increases in yield followed by rest of the treatments.

### Example 112: Bio-Efficacy of Bio-Insecticides (Embodiment) and Synthetic Insecticides Against Chili Whiteflies (Bemisia tabaci)

Methodology: The field experimental trial was conducted to study the bio-efficacy of different bio-insecticide and synthetic insecticides against chili whiteflies during rabi season 2022-2023 at Kay Bee Research and Development Farm, Maharashtra, India. The experiment was laid out by using randomized block design with three replication and eight treatments following spacings of 60 cm and 45 cm between rows and plants respectively. Each treatment consisted of an area of 5×4 m. Recommended agronomic practices were followed raise the chili crop. Observations on whiteflies population were taken on randomly selected five plants with three leaves per plant located at upper, middle and lower portion of plant. Two sprays were taken & pest population was recorded as per standard method use before and after the application of by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 114
Effect of Bio-Insecticide and Synthetic Insecticides on Whiteflies Population & % Population Reduction.

| | | | | No. of | 1^{st} spray | | 2^{nd} spray | | | |
|---|---|---|---|---|---|---|---|---|---|---|
| | | | | white | | % Reduction | | % Reduction | | % Increase |
| | | Dose | | flies | No. of | in Whiteflies | No. of | in Whiteflies | | in Yield |
| Tr. | | ml or | | before | white | Population | white | Population | Yield | over |
| No. | Treatments | gm/L | | spray | flies | over control | flies | over control | (qtl/ha) | control |
| T1 | Embodiment 9 | 0.5 | ml | 9.77 | 2.89 | 77.49 | 2.64 | 80.76 | 168.00 | 9.30 |
| T2 | Embodiment 9 | 1.0 | ml | 10.82 | 2.64 | 79.44 | 2.37 | 82.73 | 173.65 | 12.25 |
| T3 | Embodiment 9 | 2.0 | ml | 9.28 | 2.32 | 81.93 | 2.18 | 84.11 | 184.37 | 17.36 |
| T4 | Acephate 50% + | 2.0 | g | 10.98 | 3.07 | 76.09 | 2.60 | 81.05 | 167.83 | 9.21 |
| | Imidacloprid | | | | | | | | | |
| | 1.8% SP | | | | | | | | | |
| T5 | Pyriproxyfen | 1.5 | ml | 10.42 | 2.90 | 77.41 | 2.83 | 79.37 | 163.76 | 6.96 |
| | 05.00% + | | | | | | | | | |
| | Fenpropathrin | | | | | | | | | |
| | 15.00% EC | | | | | | | | | |
| T6 | Beta-Cyfluthrin + | 1.0 | ml | 10.90 | 3.00 | 76.64 | 2.68 | 80.47 | 161.95 | 5.92 |
| | Imidacloprid | | | | | | | | | |
| | 300 OD | | | | | | | | | |
| T7 | Chlorpyrifos | 2.0 | ml | 10.72 | 2.97 | 76.87 | 2.83 | 79.37 | 159.77 | 4.63 |
| | 50.00% + | | | | | | | | | |
| | Cypermethrin | | | | | | | | | |
| | 05.00% EC | | | | | | | | | |

| | | | | | | | | | |
|---|---|---|---|---|---|---|---|---|---|
| T8 | Control | — | 10.66 | 12.84 | 0.00 | 13.72 | 0.00 | 152.37 | 0.00 |

| | | | | |
|---|---|---|---|---|
| SE± | 0.47 | 0.87 | 1.21 | 2.34 |
| C.D. (0.05) | NS | 2.61 | 3.62 | 7.03 |

### Conclusion:

1. The results of the trial revealed that an application of Embodiment 9@2 ml/l recorded the maximum % reduction in whiteflies population of 81.93% and 84.11% in 1^{st} and 2^{nd} spray over the control, respectively.
2. The Embodiment 9 exhibited the highest 17.36% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 113: Bio-Efficacy of Bio-Insecticides (Embodiment) and Synthetic Insecticides Against Cucumber Whiteflies (Bemisia tabaci)

Methodology: The field experimental trial was conducted to study the bio-efficacy of different bio-insecticide and synthetic insecticides against cucumber whiteflies during rabi season 2022-2023 at Kay Bee Research and Development Farm, Maharashtra, India. The experiment was laid out by using randomized block design with three replication and eight treatments following spacings of 100 cm and 50 cm between rows and plants respectively. Each treatment consisted of an area of 5×5 m. Recommended agronomic practices were followed raise the cucumber crop. Observations on whiteflies population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 115
Effect of Bio-Insecticide and Synthetic Insecticides on Whiteflies Population & % Population Reduction.

| | | | | No. of | 1^{st} spray | | 2^{nd} spray | | | |
|---|---|---|---|---|---|---|---|---|---|---|
| | | | | white | | % Reduction | | % Reduction | | % Increase |
| | | Dose | | flies | No. of | in Whiteflies | No. of | in Whiteflies | | in Yield |
| Tr. | | ml or | | before | white | Population | white | Population | Yield | over |
| No. | Treatments | gm/L | | spray | flies | over control | flies | over control | (qtl/ha) | control |
| T1 | Embodiment 9 | 0.5 | ml | 12.00 | 2.92 | 78.34 | 2.58 | 83.32 | 179.59 | 15.17 |
| T2 | Embodiment 9 | 1.0 | ml | 11.74 | 2.85 | 78.86 | 2.47 | 84.03 | 184.32 | 17.34 |
| T3 | Embodiment 9 | 2.0 | ml | 11.40 | 2.64 | 80.42 | 2.27 | 85.33 | 192.73 | 20.95 |
| T4 | Acephate 50% + | 2.0 | g | 10.98 | 3.88 | 71.22 | 2.60 | 83.19 | 177.92 | 14.37 |
| | Imidacloprid | | | | | | | | | |
| | 1.8% SP | | | | | | | | | |
| T5 | Pyriproxyfen | 1.5 | ml | 11.97 | 2.90 | 78.49 | 2.83 | 81.71 | 172.42 | 11.64 |
| | 05.00% + | | | | | | | | | |
| | Fenpropathrin | | | | | | | | | |
| | 15.00% EC | | | | | | | | | |
| T6 | Beta-Cyfluthrin + | 1.0 | ml | 10.90 | 3.00 | 77.74 | 2.94 | 81.00 | 170.78 | 10.79 |
| | Imidacloprid 300 | | | | | | | | | |
| | OD | | | | | | | | | |
| T7 | Chlorpyrifos | 2.0 | ml | 10.61 | 2.96 | 78.04 | 2.94 | 81.00 | 175.92 | 13.40 |
| | 50.00% + | | | | | | | | | |
| | Cypermethrin | | | | | | | | | |
| | 05.00% EC | | | | | | | | | |

| | | | | | | | | | |
|---|---|---|---|---|---|---|---|---|---|
| T8 | Control | — | 11.92 | 13.48 | 0.00 | 15.47 | 0.00 | 152.35 | 0.00 |

| | | | | |
|---|---|---|---|---|
| SE± | 1.08 | 2.31 | 1.48 | 1.67 |
| C.D. (0.05) | NS | 6.92 | 4.45 | 5.00 |

### Conclusion:

1. The results of the trial revealed that an application of Embodiment 9@2 ml/l recorded the maximum % reduction in whiteflies population of 80.42% and 85.33% in 1^{st} and 2^{nd} spray over the control, respectively.
2. The Embodiment 9 exhibited the highest 20.95% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 114: Bio-Efficacy of Bio-Insecticides (Embodiment) and Synthetic Insecticides Against Soybean Whiteflies (Bemisia tabaci)

Methodology: The field experimental trial was conducted to study the bio-efficacy of different bio-insecticide and synthetic insecticides against soybean whiteflies during kharif season 2022-2023 at Kay Bee Research and Development Farm, Maharashtra, India. The experiment was laid out by using randomized block design with three replication and eight treatments following spacings of 40 cm and 10 cm between rows and plants respectively. Each treatment consisted of an area of 1.2×5 m. Recommended agronomic practices were followed raise the soybean crop. Observations on whiteflies population were taken on randomly selected five plants with three leaves per plant located at upper, middle and lower portion of plant. Two sprays were taken & pest population was recorded as per standard method use before and after the application of Insecticide. The yield parameters were recorded at harvesting stage. The data were analyzed by applying standard statistical methods.

$$Reduction over control ( \% ) = \frac{\begin{matrix}Population Count of Control Plot - \\ Population Count of Treated Plot\end{matrix}}{Population Count of Control Plot} * 100$$

### Results:

TABLE 116
Effect of Bio-Insecticide and Synthetic Insecticides on Whiteflies
Population, % Population Reduction & yield of soybean

| | | | | No. of | 1^{st} spray | | 2^{nd} spray | | | |
|---|---|---|---|---|---|---|---|---|---|---|
| | | | | white | | % Reduction | | % Reduction | | % Increase |
| | | Dose | | flies | No. of | in Whiteflies | No. of | in Whiteflies | | in Yield |
| Tr. | | ml or | | before | white | Population | white | Population | Yield | over |
| No. | Treatments | gm/L | | spray | flies | over control | flies | over control | (qtl/ha) | control |
| T1 | Embodiment 9 | 0.5 | ml | 7.18 | 2.48 | 74.64 | 2.35 | 78.08 | 22.16 | 15.75 |
| T2 | Embodiment 9 | 1.0 | ml | 7.22 | 2.33 | 76.18 | 2.22 | 79.29 | 23.92 | 21.95 |
| T3 | Embodiment 9 | 2.0 | ml | 6.93 | 2.04 | 79.14 | 2.00 | 81.34 | 24.58 | 24.04 |
| T4 | Acephate 50% + | 2.0 | g | 6.94 | 2.51 | 74.34 | 2.40 | 77.61 | 22.14 | 15.67 |
| | Imidacloprid | | | | | | | | | |
| | 1.8% SP | | | | | | | | | |
| T5 | Pyriproxyfen | 1.5 | ml | 7.34 | 2.58 | 73.62 | 2.51 | 76.59 | 21.98 | 15.06 |
| | 05.00% + | | | | | | | | | |
| | Fenpropathrin | | | | | | | | | |
| | 15.00% EC | | | | | | | | | |
| T6 | Beta- | 1.0 | ml | 6.82 | 2.64 | 73.01 | 2.57 | 76.03 | 22.07 | 15.41 |
| | Cyfluthrin + | | | | | | | | | |
| | Imidacloprid | | | | | | | | | |
| | 300 OD | | | | | | | | | |
| T7 | Chlorpyrifos | 2.0 | ml | 7.05 | 2.72 | 72.19 | 2.66 | 75.19 | 22.04 | 15.29 |
| | 50.00% + | | | | | | | | | |
| | Cypermethrin | | | | | | | | | |
| | 05.00% EC | | | | | | | | | |

| | | | | | | | | | |
|---|---|---|---|---|---|---|---|---|---|
| T8 | Control | — | 7.18 | 9.78 | 0.00 | 10.72 | 0.00 | 18.67 | 0.00 |

| | | | | |
|---|---|---|---|---|
| SE± | 0.87 | 1.58 | 2.01 | 2.45 |
| C.D. (0.05) | NS | 4.71 | 6.02 | 7.35 |

### Conclusion:

1. The results of the trial revealed that an application of Embodiment 9@2 ml/l recorded the maximum % reduction in whiteflies population of 79.14% and 81.34% in 1^{st} and 2^{nd} spray over the control, respectively.
2. The Embodiment 9 exhibited the highest 24.04% increase in yield over the control. All the Embodiments reported phyto-tonic effects on plants.
3. All the Embodiments having dose of 2 and 1 ml recorded maximum reduction in % insect population with increases in yield followed by rest of the treatments.

### Example 115: Bio-Efficacy of Bio-Bactericide (Embodiment) and Synthetic Bactericides Against Capsicum Wilt (Ralstonia solanacearum)

Methodology: The field experimental trial was conducted to study the bio-efficacy of different bio-bactericides and synthetic bactericides against Capsicum Wilt during kharif season 2022-2023 at Kay Bee Research and Development Farm, Maharashtra, India. The experiment was laid out by using randomized block design with three replication and twelve treatments following spacings of 60×45 cm between rows and plants respectively. Each treatment consisted of an area of 2.5×2.5 m. Recommended agronomic practices were followed raise the capsicum crop. The data were calculated by using standard statistical methods. To record disease Incidence following formula used.

$$Per cent Disease Incidence ( \% ) = \frac{N umber of infected plant}{Total number of Plant} \times 100$$

### Results:

TABLE 117
Effect of Bio-Bactericide and Synthetic Bactericides on Capsicum Wilt incidence & % Disease Reduction.

| | | Dose | | | 1^{st} Drench | | 2^{nd} Drench | | % Disease | | % Increase |
|---|---|---|---|---|---|---|---|---|---|---|---|
| Tr. | | ml or | | Pre- | 10^{th} | 20^{th} | 10^{th} | 20^{th} | Reduction | Yield | over |
| No. | Treatments | gm/L | | Drench | day | day | day | day | over Control | (t/ha) | control |
| T1 | Embodiment 12 | 0.5 | gm | 12.33 | 15.63 | 19.53 | 25.85 | 30.82 | 55.97 | 17.65 | 12.78 |
| T2 | Embodiment 12 | 1 | gm | 12.75 | 14.81 | 18.85 | 23.75 | 28.12 | 59.82 | 17.89 | 14.31 |
| T3 | Embodiment 12 | 2 | gm | 11.50 | 12.78 | 13.33 | 15.00 | 17.20 | 75.54 | 18.94 | 21.02 |
| T4 | Thiophanate | 1.5 | gm | 12.00 | 15.44 | 21.07 | 28.45 | 35.07 | 49.90 | 17.11 | 9.33 |
| | Methyl 70% WP | | | | | | | | | | |
| T5 | Thiophanate | 2 | gm | 12.25 | 17.45 | 25.66 | 31.53 | 34.50 | 50.71 | 17.22 | 10.03 |
| | Methyl 45% + | | | | | | | | | | |
| | Pyraclostrobin 5% | | | | | | | | | | |
| T6 | Mancozeb 75% WP | 2.5 | gm | 12.00 | 18.85 | 26.47 | 32.69 | 37.85 | 45.92 | 17.25 | 10.22 |
| T7 | Carbendazim | 1.5 | gm | 12.33 | 16.41 | 24.35 | 30.81 | 35.65 | 49.07 | 18.01 | 15.08 |
| | 50% WP | | | | | | | | | | |
| T8 | Mancozeb | 3 | gm | 12.60 | 18.69 | 23.81 | 29.65 | 33.85 | 51.64 | 17.89 | 14.31 |
| | 63% + | | | | | | | | | | |
| | Carbendazim | | | | | | | | | | |
| | 12% WP | | | | | | | | | | |
| T9 | Cymoxanil | 2.5 | gm | 12.50 | 18.63 | 27.53 | 34.63 | 38.75 | 44.64 | 16.98 | 8.50 |
| | 8% + | | | | | | | | | | |
| | Mancozeb | | | | | | | | | | |
| | 64% WP | | | | | | | | | | |
| T10 | Metalaxyl | 2.5 | gm | 12.00 | 19.81 | 26.85 | 32.66 | 38.40 | 45.14 | 17.45 | 11.50 |
| | 4% + Mancozeb | | | | | | | | | | |
| | 64% WP | | | | | | | | | | |
| T11 | Chlorothalonil | 2 | gm | 11.50 | 20.78 | 28.19 | 36.78 | 42.65 | 39.07 | 17.87 | 14.19 |
| | 75% Wp | | | | | | | | | | |

| | | | | | | | | | | |
|---|---|---|---|---|---|---|---|---|---|---|
| T12 | Control | — | 11.75 | 25.00 | 38.00 | 56.78 | 70.00 | 00.00 | 15.65 | 00.00 |

| | | | | | | |
|---|---|---|---|---|---|---|
| SE(m)± | 1.96 | 1.45 | 1.40 | 1.15 | 1.55 | 1.75 |
| CD(P = 0.05) | NS | 3.95 | 4.60 | 3.50 | 5.70 | 5.30 |

### Conclusion:

1. The results of the trial revealed that an application of Embodiment 12@2 gm/l recorded the maximum % disease reduction in capsicum wilt disease of 75.54% over the control.
2. The Embodiment 12 exhibited the highest 21.02% increase in yield over the control. All the Embodiments reported phyto-tonic effects on plants.
3. The Embodiment having dose of 2 gm and 1 gm recorded maximum % disease reduction in capsicum wilt disease with increases in yield followed by rest of the treatments.

### Example 116: Bio-Efficacy of Bio-Bactericide (Embodiment) and Synthetic Bactericides Against Cotton Bacterial Leaf Blight (BLB-Xanthomonas citri pv. Malvacearum)

Methodology: The field experimental trial was conducted to study the bio-efficacy of different bio-bactericides and synthetic bactericides against Cotton BLB during kharif season 2022-2023 at Kay Bee Research and Development Farm, Maharashtra, India. The experiment was laid out by using randomized block design with three replication and twelve treatments following spacings of 60×30 cm between rows and plants respectively. Each treatment consisted of an area of 5×5 m. Recommended agronomic practices were followed raise the Cotton crop. To record disease severity, A rating scale of 0-5 was used to score five plants from each treatment, avoiding border rows. The grades were assigned numerical ratings proportional to the diseased area. Two sprays were taken and observations recorded as per standard method use before and after the application of Bactericide. The yield parameters were recorded at harvesting stage. The data were analyzed by applying standard statistical methods.

$$Per cent Disease Index ( \% ) = \frac{S ummation of all numerical ratings}{Total number of leaves examined \times maximum ratings} \times 100$$

### Results:

TABLE 118
Effect of Bio-Bactericide and Synthetic Bactericides on cotton
BLB severity, % Disease Reduction & Yield of Cotton

| | | | | | | | | | % Disease | | |
|---|---|---|---|---|---|---|---|---|---|---|---|
| | | Dose | | | 1^{st} spray | | 2^{nd} spray | | Reduction | | % Increase |
| Tr. | | gm/ | | Pre | 5^{th} | 10^{th} | 5^{th} | 10^{th} | over | Yield | over |
| No. | Treatments | ml/l | | spray | Day | Day | Day | Day | Control | (qtl/ha) | control |
| T1 | Embodiment 12 | 0.5 | gm | 34.33 | 30.00 | 28.45 | 25.65 | 22.15 | 68.44 | 18.50 | 5.41 |
| T2 | Embodiment 12 | 1 | gm | 35.00 | 31.33 | 27.65 | 22.65 | 19.15 | 72.72 | 19.00 | 7.89 |
| T3 | Embodiment 12 | 2 | gm | 34.66 | 28.33 | 22.10 | 15.45 | 9.45 | 86.53 | 21.50 | 18.60 |
| T4 | Copper | 0.25% | | 34.75 | 30.00 | 28.45 | 23.65 | 21.36 | 69.57 | 18.50 | 5.41 |
| | oxychloride | | | | | | | | | | |
| T5 | Streptocycline | 500 | ppm | 35.00 | 31.26 | 29.45 | 26.56 | 24.45 | 65.17 | 19.30 | 9.33 |
| T6 | COC + | 0.25% + | | 34.66 | 30.00 | 28.66 | 25.45 | 24.65 | 64.88 | 20.00 | 12.50 |
| | Streptomycin | 500 | ppm | | | | | | | | |
| | sulphate | | | | | | | | | | |
| T7 | Bronopol | 500 | ppm | 35.00 | 31.33 | 27.10 | 25.60 | 23.60 | 66.38 | 20.30 | 13.79 |
| T8 | Agrimycin | 500 | ppm | 35.15 | 32.00 | 30.65 | 28.55 | 25.15 | 64.17 | 20.00 | 12.50 |
| T9 | Copper | 0.30% | | 34.85 | 31.00 | 29.75 | 27.45 | 26.45 | 62.32 | 19.00 | 7.89 |
| | Hydroxide | | | | | | | | | | |
| T10 | Kasugamycin + | 500 | ppm + | 35.20 | 32.00 | 30.45 | 28.56 | 26.32 | 62.50 | 19.30 | 9.33 |
| | COC | 0.25% | | | | | | | | | |
| T11 | Silixol | 1 | ml | 35.25 | 33.00 | 31.60 | 29.00 | 28.62 | 59.23 | 20.00 | 12.50 |

| | | | | | | | | | | |
|---|---|---|---|---|---|---|---|---|---|---|
| T12 | Control | — | 34.75 | 45.33 | 58.30 | 68.75 | 70.20 | 00.00 | 17.50 | 0.00 |

| | | | | | | | |
|---|---|---|---|---|---|---|---|
| SE (m)± | 0.95 | 2.09 | 1.70 | 1.40 | 1.35 | 1.85 | — |
| C.D. (0.05) | NS | 4.75 | 5.15 | 4.20 | 4.10 | 3.75 | — |

### Conclusion:

1. The results of the trial revealed that an application of Embodiment 12@2 gm/l recorded the maximum % disease reduction in Cotton BLB disease of 86.53% over the control.
2. The Embodiment 12 exhibited the highest 18.60% increase in yield over the control. All the Embodiments reported phyto-tonic effects on plants.
3. The Embodiment having dose of 2 and 1 gm recorded maximum % disease reduction in Cotton BLB disease with increases in yield followed by rest of the treatments.

### Example 117: Bio-Efficacy of Bio-Bactericide (Embodiment) and Synthetic Bactericides Against Citrus Canker (Xanthomonas citri pv. Citri)

Methodology: The field experimental trial was conducted to study the bio-efficacy of different bio-bactericides and synthetic bactericides against Citrus Canker during kharif season 2022-2023 at Kay Bee Research and Development Farm, Maharashtra, India. The experiment was laid out by using randomized block design with three replication and twelve treatments following spacings of 3×3 m between rows and plants respectively. Each treatment consisted of an area of 10×10 m. Recommended agronomic practices were followed raise the citrus crop. To record disease severity, A rating scale of 0-5 was used to score five plants from each treatment, avoiding border rows. The grades were assigned numerical ratings proportional to the diseased area. Two sprays were taken and observations recorded as per standard method use before and after the application of bactericide. The yield parameters were recorded at harvesting stage. The data were analyzed by applying standard statistical methods.

$$Per cent Disease Index ( \% ) = \frac{S ummation of all numerical ratings}{Total number of leaves examined \times maximum ratings} \times 100$$

### Results:

TABLE 119
Effect of Bio-Bactericide and Synthetic Bactericides on Citrus
Canker severity, % Disease Reduction & yield of citrus.

| | | | | | | | | | % Disease | | % Increase |
|---|---|---|---|---|---|---|---|---|---|---|---|
| | | Dose | | | 1^{st} spray | | 2^{nd} spray | | Reduction | | in yield |
| Tr. | | ml or | | Pre | 5^{rd} | 10^{th} | 5^{rd} | 10^{th} | over | Yield | over |
| No. | Treatments | gm/L | | spray | Day | day | day | Day | Control | (t/ha) | control |
| T 1 | Embodiment 12 | 0.5 | gm | 41.45 | 38.56 | 34.45 | 28.65 | 22.65 | 72.37 | 8.50 | 5.88 |
| T 2 | Embodiment 12 | 1 | gm | 41.55 | 35.45 | 31.15 | 27.15 | 20.15 | 75.42 | 9.00 | 11.11 |
| T 3 | Embodiment 12 | 2 | gm | 41.85 | 31.15 | 22.15 | 15.75 | 7.75 | 90.54 | 10.50 | 20.00 |
| T 4 | Copper | 0.25% | | 40.52 | 39.56 | 34.15 | 29.65 | 23.65 | 71.15 | 9.20 | 13.04 |
| T 5 | Streptocycline | 500 | ppm | 41.10 | 38.55 | 37.75 | 31.16 | 28.16 | 65.65 | 8.75 | 8.57 |
| T 6 | COC + | 0.25% + | | 42.15 | 37.45 | 33.45 | 28.95 | 24.95 | 63.47 | 9.30 | 13.98 |
| | Streptomycin | 500 | ppm | | | | | | | | |
| | sulphate | | | | | | | | | | |
| T 7 | Bronopol | 500 | ppm | 41.75 | 38.48 | 33.15 | 27.45 | 22.45 | 72.62 | 8.30 | 3.61 |
| T 8 | Agrimycin | 500 | ppm | 39.57 | 34.18 | 31.10 | 29.16 | 26.16 | 68.09 | 9.50 | 15.79 |
| T 9 | Copper | 0.30% | | 41.45 | 37.65 | 33.15 | 28.10 | 24.10 | 70.60 | 9.30 | 13.98 |
| | Hydroxide | | | | | | | | | | |
| T 10 | Kasugamycin + | 500 | ppm + | 40.76 | 36.54 | 31.10 | 29.00 | 26.00 | 68.29 | 9.50 | 15.79 |
| | COC | 0.25% | | | | | | | | | |
| T 11 | Silixol | 1 | ml | 41.25 | 39.10 | 33.00 | 28.30 | 24.30 | 70.36 | 9.75 | 17.95 |

| | | | | | | | | | | |
|---|---|---|---|---|---|---|---|---|---|---|
| T 12 | Control | — | 41.60 | 50.80 | 65.32 | 72.00 | 82.00 | 00.00 | 8.00 | 0.00 |

| | | | | | | |
|---|---|---|---|---|---|---|
| SE(m)± | 1.73 | 1.83 | 1.89 | 1.69 | 1.85 | 1.65 |
| CD(P = 0.05) | NS | 3.73 | 4.91 | 3.81 | 5.70 | 5.60 |

### Conclusion:

1. The results of the trial revealed that an application of Embodiment 12@2 gm/l recorded the maximum disease reduction in Citrus Canker disease of 90.54% over the control.
2. The Embodiment 12 exhibited the highest 20.00% increase in yield over the control. All the Embodiments reported phyto-tonic effects on plants.
3. The Embodiment having dose of 2 gm and 1 gm recorded maximum % disease reduction in Citrus Canker disease with increases in yield followed by rest of the treatments.

### Example 118: Bio-Efficacy of Bio-Fungicides (Embodiment) and Synthetic Fungicides Against Early Blight (Alternaria solani) of Potato

Methodology: The field experimental trial was conducted to study the bio-efficacy of different bio-fungicides and synthetic fungicides against early blight of Potato during kharif season 2022-2023 at Kay Bee Research and Development Farm, Maharashtra, India. The experiment was laid out by using randomized block design with three replication and eight treatments following spacings of 60 cm and 60 cm between rows and plants respectively. Each treatment consisted of an area of 7.87×5 m. Recommended agronomic practices were followed raise the potato crop. Observations on early blight were taken on randomly selected five plants with three leaves per plant located at upper, middle and lower portion of plant. Two sprays were taken & disease intensity was recorded as per standard method use before and after the application of fungicides. The yield parameters were recorded at harvesting stage. The data were analyzed by applying standard statistical methods.

$$Disease Reduction over control ( \% ) = \frac{\begin{matrix}\% disease I ntensity of Control Plot - \\ \% disease I ntensity of Treated Plot\end{matrix}}{\% disease I ntensity of Control Plot} \times 100$$

### Results:

TABLE 120
Effect of Bio-Fungicides and Synthetic Fungicides on percent disease
intensity, % Disease Reduction & yield of potato crop.

| | | | | | | | | | % Disease | | % Increase |
|---|---|---|---|---|---|---|---|---|---|---|---|
| | | Dose | | | 1^{st} Spraying | | 2^{nd} Spraying | | reduction | | in yield |
| Tr. | | ml or | | Pre- | 3^{rd} | 5^{th} | 7^{th} | 10^{th} | over | Yield | over |
| No. | Treatments | gm/L | | Spraying | day | day | day | day | Control | (t/ha) | control |
| T1 | Embodiment 12 | 0.5 | gm | 18.9 | 18.8 | 18.4 | 17.1 | 12.8 | 77.06 | 25.8 | 13.95 |
| T2 | Embodiment 12 | 1.0 | gm | 19.2 | 18.6 | 17.5 | 12.3 | 8.5 | 84.77 | 26.6 | 16.54 |
| T3 | Embodiment 12 | 2.0 | gm | 20.2 | 18.1 | 15.9 | 8.7 | 5.3 | 90.50 | 27.9 | 20.43 |
| T4 | Trifloxystrobin | 2.5 | gm | 19.7 | 18.6 | 18.3 | 16.3 | 12.1 | 78.32 | 26.1 | 14.94 |
| | 25% WP + | | | | | | | | | | |
| | Tebuconazole | | | | | | | | | | |
| | 50% WP | | | | | | | | | | |
| T5 | Azoxystrobin | 1.0 | ml | 19.5 | 19.5 | 19.1 | 18.1 | 16.1 | 71.15 | 25.6 | 13.28 |
| | 18.2% + | | | | | | | | | | |
| | Difenoconazole | | | | | | | | | | |
| | 11.4% SC | | | | | | | | | | |
| T6 | Hexaconazole | 2.0 | gm | 18.8 | 18.8 | 18.5 | 18.2 | 17.2 | 69.18 | 25.3 | 12.25 |
| | 4% + | | | | | | | | | | |
| | Zineb 68% WG | | | | | | | | | | |
| T7 | Kresoxim | 1.5 | ml | 19.7 | 19.7 | 19.6 | 19.2 | 18.2 | 67.38 | 25.1 | 11.55 |
| | methyl | | | | | | | | | | |
| | 44.3 SC | | | | | | | | | | |

| | | | | | | | | | | |
|---|---|---|---|---|---|---|---|---|---|---|
| T8 | Control | — | 19.3 | 24.7 | 33.6 | 45.4 | 55.8 | 0.00 | 22.2 | 0.00 |

| | | | | | | |
|---|---|---|---|---|---|---|
| SE± | 1.14 | 1.45 | 1.17 | 1.15 | 1.67 | 1.97 |
| C.D. (0.05) | NS | 4.37 | 3.52 | 3.45 | 5.01 | 5.91 |

### Conclusion:

1. The results of the trial revealed that an application of Embodiment 12@2 gm/lit recorded the maximum % diseases reduction on early blight of 90.50% after 2^{nd} spray over the control.
2. The Embodiment 12 exhibited the highest 20.43% increase in yield over the control. All the Embodiments reported phyto-tonic effects on plants.
3. All the Embodiments having dose of 2 and 1 gm recorded maximum reduction in % disease with increases in yield followed by rest of the treatments.

### Example 119: Bio-Efficacy of Bio-Fungicides (Embodiment) and Synthetic Fungicides Against Blast (Pyricularia Oryzae) of Rice

Methodology: The field experimental trial was conducted to study the bio-efficacy of different bio-fungicides and synthetic fungicides against Blast of Rice during kharif season 2022-2023 at Kay Bee Research and Development Farm, Maharashtra, India. The experiment was laid out by using randomized block design with three replication and eight treatments following spacings of 20 cm and 15 cm between rows and plants respectively. Each treatment consisted of an area of 3.5×5 m. Recommended agronomic practices were followed raise the Rice crop. Observations on blast disease were taken on randomly selected ten hills or plants per plot. Two sprays were taken & disease intensity was recorded as per standard method use before and after the application of fungicides. The yield parameters were recorded at harvesting stage. The data were analyzed by applying standard statistical methods.

$$Disease Reduction over control ( \% ) = \frac{\begin{matrix}\% disease I ntensity of Control Plot - \\ \% disease I ntensity of Treated Plot\end{matrix}}{\% disease I ntensity of Control Plot} \times 100$$

### Results:

TABLE 121
Effect of Bio-Fungicides and Synthetic Fungicides on percent
disease intensity, % Disease Reduction & yield of rice crop.

| | | | | | | | | | % Disease | | % Increase |
|---|---|---|---|---|---|---|---|---|---|---|---|
| | | Dose | | | 1^{st} Spraying | | 2^{nd} Spraying | | reduction | | in yield |
| Tr. | | ml or | | Pre | 3^{rd} | 5^{th} | 7^{th} | 10^{th} | over | Yield | over |
| No. | Treatments | gm/L | | Spraying | day | day | day | day | Control | (Qtl/ha) | control |
| T1 | Embodiment 12 | 0.5 | gm | 15.7 | 14.7 | 13.6 | 13.2 | 12.8 | 66.55 | 57.6 | 21.53 |
| T2 | Embodiment 12 | 1.0 | gm | 16.2 | 14.6 | 13.3 | 12.3 | 10.8 | 71.78 | 59.4 | 23.91 |
| T3 | Embodiment 12 | 2.0 | gm | 16.1 | 14.3 | 12.6 | 11.5 | 9.5 | 75.18 | 60.6 | 25.41 |
| T4 | Trifloxystrobin | 2.5 | gm | 15.6 | 14.9 | 13.4 | 13.1 | 11.2 | 70.73 | 58.1 | 22.20 |
| | 25% WP + | | | | | | | | | | |
| | Tebuconazole | | | | | | | | | | |
| | 50% WP | | | | | | | | | | |
| T5 | Azoxystrobin | 1.0 | ml | 16.1 | 16.1 | 15.9 | 15.0 | 14.5 | 62.11 | 56.8 | 20.42 |
| | 18.2% + | | | | | | | | | | |
| | Difenoconazole | | | | | | | | | | |
| | 11.4% SC | | | | | | | | | | |
| T6 | Hexaconazole | 2.0 | gm | 16.8 | 16.1 | 15.0 | 14.9 | 14.8 | 61.33 | 50.77 | 10.97 |
| | 4% + Zineb | | | | | | | | | | |
| | 68% WG | | | | | | | | | | |
| T7 | Kresoxim | 1.5 | ml | 15.8 | 15.6 | 15.5 | 15.4 | 15.1 | 60.54 | 48.8 | 7.38 |
| | methyl 44.3 | | | | | | | | | | |
| | SC | | | | | | | | | | |
| T8 | Control | | | 16.3 | 19.3 | 25.6 | 29.7 | 38.3 | 0.00 | 45.2 | 0.00 |

| | | | | | | |
|---|---|---|---|---|---|---|
| SE± | 1.08 | 1.40 | 1.15 | 1.17 | 1.60 | 1.85 |
| C.D. (0.05) | NS | 4.25 | 4.12 | 4.34 | 4.87 | 5.57 |

### Conclusion:

1. The results of the trial revealed that an application of Embodiment 12@2 gm/lit. recorded the maximum % diseases reduction on blast disease of 75.18% after 2^{nd} spray over the control.
2. The Embodiment 12 exhibited the highest 25.41% increase in yield over the control. All the Embodiments reported phyto-tonic effects on plants.
3. All the Embodiments having dose of 2 and 1 gm recorded maximum reduction in % disease with increases in yield followed by rest of the treatments.

### Example 120: Bio-Efficacy of Bio-Fungicides (Embodiment) and Synthetic Fungicides Against Yellow Sigatoka (Mycosphaerella musicola) of Banana

Methodology: The field experimental trial was conducted to study the bio-efficacy of different bio-fungicides and synthetic fungicides against Yellow Sigatoka of Banana during kharif season 2022-2023 at Kay Bee Research and Development Farm, Maharashtra, India. The experiment was laid out by using randomized block design with three replication and eight treatments following spacings of 1.5 m and 1.5 m between rows and plants respectively. Each treatment consisted of an area of 7.5×3 m. Recommended agronomic practices were followed raise the banana crop. Observations on yellow sigatoka disease were taken on randomly selected five plant with three leaves per plant located at upper, middle and lower portion of plants per plot. Two sprays were taken & disease intensity was recorded as per standard method use before and after the application of fungicides. The yield parameters were recorded at harvesting stage. The data were analyzed by applying standard statistical methods.

$$Disease Reduction over control ( \% ) = \frac{\begin{matrix}\% disease intensity of Control Plot - \\ \% disease intensity of Treated Plot\end{matrix}}{\% disease intensity of Control Plot} \times 100$$

### Results:

TABLE 122
Effect of Bio-Fungicides and Synthetic Fungicides on percent disease
intensity, % Disease Reduction & yield of banana crop.

| | | | | | | | | | % Disease | | % Increase |
|---|---|---|---|---|---|---|---|---|---|---|---|
| | | Dose | | | 1^{st} Spraying | | 2^{nd} Spraying | | reduction | | in yield |
| Tr. | | ml or | | Pre | 3^{rd} | 5^{th} | 7^{th} | 10^{th} | over | Yield | over |
| No. | Treatments | gm/L | | Spraying | day | day | day | day | Control | (t/ha) | control |
| T1 | Embodiment 12 | 0.5 | gm | 17.8 | 17.1 | 16.8 | 15.4 | 12.8 | 77.62 | 64.2 | 13.08 |
| T2 | Embodiment 12 | 1.0 | gm | 18.5 | 17.8 | 16.2 | 13.5 | 8.7 | 84.79 | 68.3 | 18.30 |
| T3 | Embodiment 12 | 2.0 | gm | 17.6 | 15.6 | 14.2 | 10.1 | 5.8 | 89.86 | 70.3 | 20.63 |
| T4 | Trifloxystrobin | 2.5 | gm | 18.7 | 17.0 | 16.7 | 14.7 | 11.4 | 80.07 | 65.7 | 15.07 |
| | 25% WP + | | | | | | | | | | |
| | Tebuconazole | | | | | | | | | | |
| | 50% WP | | | | | | | | | | |
| T5 | Azoxystrobin | 1.0 | ml | 18.6 | 17.6 | 16.8 | 15.6 | 13.8 | 75.87 | 63.5 | 12.13 |
| | 18.2% + | | | | | | | | | | |
| | Difenoconazole | | | | | | | | | | |
| | 11.4% SC | | | | | | | | | | |
| T6 | Hexaconazole | 2.0 | gm | 17.8 | 17.7 | 17.1 | 16.8 | 14.6 | 74.48 | 61.6 | 9.42 |
| | 4% + | | | | | | | | | | |
| | Zineb 68% WG | | | | | | | | | | |
| T7 | Kresoxim | 1.5 | ml | 18.6 | 18.2 | 17.8 | 17.1 | 14.9 | 73.95 | 60.9 | 8.37 |
| | methyl 44.3 SC | | | | | | | | | | |

| | | | | | | | | | | |
|---|---|---|---|---|---|---|---|---|---|---|
| T8 | Control | — | 17.7 | 25.6 | 35.7 | 46.8 | 57.2 | 0.00 | 55.8 | 0.00 |

| | | | | | | |
|---|---|---|---|---|---|---|
| SE± | 0.97 | 1.14 | 1.16 | 1.22 | 1.78 | 1.34 |
| C.D. (0.05) | NS | 3.44 | 3.50 | 3.66 | 5.34 | 4.02 |

### Conclusion:

1. The results of the trial revealed that an application of Embodiment 12@2 gm/lit recorded the maximum % diseases reduction on yellow sigatoka of 89.86% after 2^{nd} spray over the control.
2. The Embodiment 12 exhibited the highest 20.63% increase in yield over the control. All the Embodiments reported phyto-tonic effects on plants.
3. All the Embodiments having dose of 2 and 1 gm recorded maximum reduction in % disease with increases in yield followed by rest of the treatments.

### Example 121: Bio-Efficacy of Bio-Nematicide (Embodiment) and Synthetic Nematicides Against Citrus Nematodes (Tylenchulus semipenetrans)

Methodology: The field experimental trial was conducted to study the bio-efficacy of different bio-nematicides and synthetic nematicides against Citrus Nematodes during kharif season 2022-2023 at Kay Bee Research and Development Farm, Maharashtra, India. The experiment was laid out by using randomized block design with three replication and eight treatments following spacing of 6×6 m between rows and plants respectively. Recommended agronomic practices were followed raise the Citrus crop. The soil population of juveniles of T. semiprnatrans was determined using Cobb's decanting and sieving method (modified), followed by Baermann's funnel technique. Observations recorded as per standard method in use before and after the application. The data were calculated by using standard statistical methods.

$$Decrease over control ( \% ) = \frac{C ontrol Plot - Treated Plot}{Control Plot} * 100$$

### Results:

TABLE 123
Effect of Bio-Nematicide and Synthetic Nematicides on Citrus
Nematodes Population, % Reduction and yield of citrus.
Nematode population/200 cc of soil

| | | Dose | | | | | Decrease | | % Increase |
|---|---|---|---|---|---|---|---|---|---|
| Tr. | Treatment | (ml or | | Pre | 7 | 14 | over | Yield | over |
| No. | details | gm/lit.) | | Treatment | DAT | DAT | Control | (t/Ha) | Control |
| 1 | Embodiment 12 | 0.5 | gm | 2798 | 1399 | 816 | 73.25 | 9.11 | 10.96 |
| 2 | Embodiment 12 | 1 | gm | 2896 | 1298 | 753 | 75.31 | 10.12 | 23.26 |
| 3 | Embodiment 12 | 2 | gm | 2992 | 1229 | 602 | 80.26 | 10.55 | 28.50 |
| 4 | Fluopyrum | 1.5 | ml | 2794 | 1555 | 836 | 72.59 | 9.45 | 15.10 |
| | 34.48% SC | | | | | | | | |
| 5 | Paecilomyces | 10 | ml | 2699 | 1603 | 820 | 73.11 | 9.01 | 9.74 |
| | lilacinus | | | | | | | | |
| 6 | Carbofuran | 3 | gm | 2758 | 1630 | 892 | 70.75 | 9.09 | 10.72 |
| | 3% CG | | | | | | | | |

| | | | | | | | | |
|---|---|---|---|---|---|---|---|---|
| 7 | Fluensulfone | 10 gm/d | 2881 | 1709 | 852 | 72.07 | 9.55 | 16.32 |
| | 2% GR | ripper | | | | | | |
| 8 | Control | — | 2889 | 2965 | 3050 | 0.00 | 8.21 | |

| | | | | |
|---|---|---|---|---|
| S.E. | 2.20 | 2.41 | 2.89 | — |
| C.D. 0.05% | N.S. | 7.64 | 8.81 | — |

### Conclusion:

1. The results of the trial revealed that an application of Embodiment 12@2 gm/l recorded the maximum % reduction in citrus nematodes population of 80.26% over the control.
2. The Embodiment 12 exhibited the highest 28.50% increase in yield over the control. All the Embodiments reported phyto-tonic effects on plants.
3. The Embodiment having dose of 2 and 1 gm recorded maximum % reduction in citrus nematodes with increases in yield followed by rest of the treatments.

### Example 122: Bio-Efficacy of Bio-Nematicide (Embodiment) and Synthetic Nematicides Against Rice Nematodes (Meloidogyne graminicola)

Methodology: The field experimental trial was conducted to study the bio-efficacy of different bio-Nematicide and synthetic nematicide against rice nematodes during kharif season 2022-2023 at Kay Bee Research and Development Farm, Maharashtra, India. The experiment was laid out by using randomized block design with three replication and eight treatments following spacing of 20×20 cm between rows and plants respectively. Each treatment consisted of an area of 5×5 m. Recommended agronomic practices were followed raise the rice crop. The soil population of juveniles of M. graminicola was determined using Cobb's decanting and sieving method (modified), followed by Baermann's funnel technique. Observations recorded as per standard method in use before and after the application. The data were calculated by using standard statistical methods.

$$Decrease over control ( \% ) = \frac{C ontrol Plot - Treated Plot}{Control Plot} * 100$$

### Results:

TABLE 124
Effect of Bio- Nematicide and Synthetic Nematicide
on Rice Nematodes Population & % Reduction.
Nematode population/200 cc of soil

| | | | | | | | | | % Increase |
|---|---|---|---|---|---|---|---|---|---|
| | | | | | | | % Decrease | | in yield |
| Tr. | Treatment | Dose | | Pre | 7 | 14 | over | Yield | over |
| No. | details | (gm/ml/lit.) | | Treatment | DAT | DAT | Control | (qtl/Ha) | Control |
| 1 | Embodiment 12 | 0.5 | gm | 551 | 298 | 169 | 73.30 | 37.23 | 11.53 |
| 2 | Embodiment 12 | 1 | gm | 532 | 242 | 142 | 77.57 | 39.46 | 18.21 |
| 3 | Embodiment 12 | 2 | gm | 498 | 216 | 126 | 80.09 | 42.27 | 26.63 |
| 4 | Fluopyrum | 1.5 | ml | 506 | 278 | 163 | 74.25 | 38.36 | 14.92 |
| | 34.48% SC | | | | | | | | |
| 5 | Paecilomyces | 10 | ml | 513 | 448 | 402 | 36.49 | 36.27 | 8.66 |
| | lilacinus | | | | | | | | |
| 6 | Carbofuran 3% | 3 | gm | 498 | 242 | 203 | 67.93 | 36.65 | 9.80 |
| | CG | | | | | | | | |
| 7 | Fluensulfone 2% | 1.5 | gm/plant | 525 | 259 | 173 | 72.67 | 37.89 | 13.51 |
| | GR | | | | | | | | |

| | | | | | | | | |
|---|---|---|---|---|---|---|---|---|
| 8 | Control | — | 539 | 598 | 633 | 0.00 | 33.38 | — |

| | | | | | | |
|---|---|---|---|---|---|---|
| S.E. | 2.2 | 2.44 | 2.92 | — | 1.58 | — |
| C.D. 0.05% | N.S. | 7.62 | 8.82 | — | 4.72 | — |

TABLE 125
Effect of Bio- Nematicide and Synthetic Nematicide
on reproduction of Nematodes in field.

| | | | | | | No. of | |
|---|---|---|---|---|---|---|---|
| | | | | No. of | % | egg | % |
| | | Dose | | Galls per | Decrease | masses/ | Decrease |
| Tr. | Treatment | (ml or | | root | over | root | over |
| No | details | gm/lit.) | | system | Control | system | Control |
| 1 | Embodiment 12 | 0.5 | gm | 25.33 | 65.07 | 11.23 | 66.34 |
| 2 | Embodiment 12 | 1 | gm | 19.89 | 72.57 | 8.61 | 74.19 |
| 3 | Embodiment 12 | 2 | gm | 14.12 | 80.53 | 6.89 | 79.35 |
| 4 | Fluopyrum 34.48% | 1.5 | ml | 21.69 | 70.09 | 9.58 | 71.28 |
| | SC | | | | | | |
| 5 | Paecilomyces | 10 | ml | 49.63 | 31.55 | 26.03 | 21.97 |
| | lilacinus | | | | | | |
| 6 | Carbofuran 3% CG | 3 | gm | 28.3 | 60.97 | 13.26 | 60.25 |
| 7 | Fluensulfone 2% GR | 1.5 | gm/plant | 23.54 | 67.54 | 10.5 | 68.53 |

| | | | | |
|---|---|---|---|---|
| 8 | Control | — | 72.51 | 33.36 |

| | | | | |
|---|---|---|---|---|
| S.E. | 1.69 | — | 1.92 | — |
| C.D. 0.05% | 5.12 | — | 5.98 | — |

### Conclusion:

1. The results of the trial revealed that an application of Embodiment 12@2 gm/l recorded the maximum % reduction in rice nematodes population of 80.09% over the control.
2. The results of the trial revealed that an application of Embodiment 12@2 gm/l recorded the maximum % reduction in reproduction of rice nematodes over the control.
3. The Embodiment 12 exhibited the highest 26.63% increase in yield over the control. All the Embodiments reported phyto-tonic effects on plants.
4. The Embodiment having dose of 2 and 1 gm recorded maximum % reduction in rice nematodes with increases in yield followed by rest of the treatments.

### Example 123: Bio-Efficacy of Bio-Nematicide (Embodiment) and Synthetic Nematicides Against Tomato Nematodes (Meloidogyne incognita)

Methodology: The field experimental trial was conducted to study the bio-efficacy of different bio-Nematicides and synthetic Nematicides against tomato nematodes during kharif season 2022-2023 at Kay Bee Research and Development Farm, Maharashtra, India. The experiment was laid out by using randomized block design with three replication and eight treatments following spacing of 30 cm×90 cm between rows and plants respectively. Each treatment consisted of an area 5×4 m. Recommended agronomic practices were followed raise the Tomato crop. The soil population of juveniles of M. incognita was determined using Cobb's decanting and sieving method (modified), followed by Baermann's funnel technique. Observations recorded as per standard method in use before and after the application. The data were calculated by using standard statistical methods.

$$Decrease over control ( \% ) = \frac{C ontrol Plot - Treated Plot}{Control Plot} * 100$$

### Results:

TABLE 126
Effect of Bio-Nematicide and Synthetic Nematicides on tomato
nematodes population, % Reduction and yield of tomato.
Nematode population/200 cc of soil

| | | | | | | | % Decrease | | % Increase |
|---|---|---|---|---|---|---|---|---|---|
| Tr. | Treatment | Dose | | Pre | 7 | 14 | over | Yield | over |
| No. | details | (ml/lit.) | | Treatment | DAT | DAT | control | (t/Ha) | control |
| 1 | Embodiment 12 | 0.5 | gm | 264 | 112 | 102 | 74.63 | 55.64 | 12.29 |
| 2 | Embodiment 12 | 1 | gm | 277 | 108 | 99 | 75.37 | 57.48 | 16.00 |
| 3 | Embodiment 12 | 2 | gm | 236 | 98 | 64 | 84.08 | 61.22 | 23.55 |
| 4 | Fluopyrum | 1.5 | ml | 212 | 119 | 98 | 75.62 | 54.12 | 9.22 |
| | 34.48% SC | | | | | | | | |
| 5 | Paecilomyces | 10 | ml | 255 | 246 | 242 | 39.80 | 51.23 | 3.39 |
| | lilacinus | | | | | | | | |
| 6 | Carbofuran | 3 | gm | 259 | 113 | 104 | 74.13 | 51.26 | 3.45 |
| | 3% CG | | | | | | | | |
| 7 | Fluensulfone | 1.5 | gm/plant | 261 | 110 | 101 | 74.88 | 54.68 | 10.35 |
| | 2% GR | | | | | | | | |

| | | | | | | | |
|---|---|---|---|---|---|---|---|
| 8 | Control | — | 259 | 312 | 402 | — | 49.55 |

| | | | | |
|---|---|---|---|---|
| S.E. | 2.23 | 2.44 | 2.92 | — |
| C.D. 0.05% | N.S. | 7.62 | 8.82 | — |

TABLE 127
Effect of Nematicide on reproduction of nematodes in field.

| | | | | | | No. of | |
|---|---|---|---|---|---|---|---|
| | | | | No. of | % | egg | % |
| | | | | Galls per | Decrease | masses/ | Decrease |
| Tr. | Treatment | Dose | | root | over | root | over |
| No | details | (ml/lit.) | | system | Control | system | Control |
| 1 | Embodiment 12 | 0.5 | gm | 182 | 59.47 | 142 | 58.36 |
| 2 | Embodiment 12 | 1 | gm | 155 | 65.48 | 119 | 65.10 |
| 3 | Embodiment 12 | 2 | gm | 104 | 76.84 | 75 | 78.01 |
| 4 | Fluopyrum | 1.5 | ml | 159 | 64.59 | 112 | 67.16 |
| | 34.48% SC | | | | | | |
| 5 | Paecilomyces | 10 | ml | 323 | 28.06 | 259 | 24.05 |
| | lilacinus | | | | | | |
| 6 | Carbofuran 3% | 3 | gm | 185 | 58.80 | 145 | 57.48 |
| | CG | | | | | | |
| 7 | Fluensulfone | 1.5 | gm/plant | 189 | 57.91 | 148 | 56.60 |
| | 2% GR | | | | | | |

| | | | | |
|---|---|---|---|---|
| 8 | Control | — | 449 | 341 |

| | | | | |
|---|---|---|---|---|
| S.E. | 1.43 | — | 1.62 | — |
| C.D. 0.05% | 1.23 | — | 4.82 | — |

### Conclusion:

1. The results of the trial revealed that an application of Embodiment 12@2 gm/l recorded the maximum % reduction in Tomato Nematodes population of 84.08% over the control.
2. The results of the trial revealed that an application of Embodiment 12@2 gm/l recorded the maximum % reduction in reproduction of Tomato Nematodes over the control.
3. The Embodiment 12 exhibited the highest 23.55% increase in yield over the control. All the Embodiments reported phyto-tonic effects on plants.
4. The Embodiment having dose of 2 and 1 gm recorded maximum % reduction in tomato nematodes with increases in yield followed by rest of the treatments.

We claim:

1. A biopesticidal and bio-stimulant composition comprising two or more phytochemicals in the form of salts, solvates, hydrates, isomers or its enantiomers selected from the group consisting of:
i. Camphor at a concentration in a range of 0.001-7.0%, more preferably 3.5%;
ii. Eugenol at a concentration in a range of 0.001-10.0%, more preferably 8.0%;
iii. Citral at a concentration in a range of 0.001-15%, more preferably 12.5%;
iv. Thymol at a concentration in a range of 0.001-13%, more preferably 9.3%;
v. Piperine at a concentration in a range of 0.001-10%, more preferably 7.4%;
vi. Cuminaldehyde at a concentration in a range of 0.001-10%, more preferably 3.3%;
vii. Methyl chavicol at a concentration in a range of 0.001-9.0%, more preferably 5.0%;
viii. Swainsonine at a concentration in a range of 0.001-8.0%, more preferably 3.0%;
ix. Ferulic Acid at a concentration in a range of 0.001-8.0%, more preferably 4.0%;
x. Parthenin at a concentration in a range of 0.001-7.0%, more preferably 3.6%;
xi. Turmerones at a concentration in a range of 0.001-8.0%, more preferably 3.7%;
xii. Carvacrol at a concentration in a range of 0.001-10%, more preferably 7.3%;
xiii. D-limonene at a concentration in a range of 0.001-8.0%, more preferably 2.7%;
xiv. Gingerol at a concentration in a range of 0.001-8.0%, more preferably 6.8%;
xv. β-Asarone at a concentration in a range of 0.001-9.0%, more preferably 3.0%;
xvi. Menthol at a concentration in a range of 0.001-9.0%, more preferably 5.3%;
xvii. Capsaicin at a concentration in a range of 0.001-8.0%, more preferably 2.2%;
xviii. p-Cymene at a concentration in a range of 0.001-15%, more preferably 2.8%;
xix. Palmitic acid at a concentration in a range of 0.001-8.0%, more preferably 1.2%;
XX. Ellagic acid at a concentration in a range of 0.001-8.0%, more preferably 1.6%;
xxi. 2-undecanone at a concentration in a range of 0.001-8.0%, more preferably 2.4%;
xxii. Chavibetol at a concentration in a range of 0.001-7.0%, more preferably 1.0%;
xxiii. Thymoquinone at a concentration in a range of 0.001-8.0%, more preferably 1.0%;
xxiv. Berberine at a concentration in a range of 0.001-8.0%, more preferably 1.2%;
XXV. Isoquinoline at a concentration in a range of 0.001-9.0%, more preferably 2.0%;
xxvi. Alpha-pinene at a concentration in a range of 0.001-13%, more preferably 3.0%;
xxvii. 1,8 cineole at a concentration in a range of 0.001-7.0%, %, more preferably 2.8%; and
xxviii. camphene at a concentration in a range of 0.001-7.0%, more preferably 1.2%;
together with agriculturally acceptable excipients or additives.

2. The composition as claimed in claim 1, wherein said excipients are selected from:
i. Binders;
ii. Diluents;
iii. Surfactants selected from the group consisting of Sodium oleoyl amino fatty acid, Sodium dodecyl sulphate, Polyoxyl 35 hydrogenated castor oil, Sodium N methyl N-Oleyl taurate, Sodium alkyl naphthalene sulfonate and the like alone or mixtures thereof in range of 0.1-15%, more preferably 8.0%;
iv. Emulsifiers selected from group consisting of Span 80, polysorbate 80, polysorbate 60, Gaur gum, ethoxylated castor oil, Polyorganosiloxane and the like alone or mixtures thereof in range of 0.1-13%, more preferably 7.0%;
v. Carriers selected from at least one substantially water-miscible co-solvent, preferably selected from the group of N-methylpyrrolidinone;
dimethylsulphoxide; dimethylfomamide C9; methyl ethyl ketone, Ethylene Glycol Diacetate, dimethylisosorbide isophorone; acetophenone; cyclohexanone;
Diacetone alcohol 1,3-dimethyl-2-imidazolidinone; ethylene, propylene, and butylene carbonates; lactate esters; Methyl oleate, dimethyl and diethylcarbonates;
alkylglycol ethers; glycols, including propylene, carbapol 940 and biodiesel and the like alone or mixtures thereof in range of 15-55%, more preferably 35%;
vi. Lubricants;
vii. pH adjusters;
viii. Colorants;
ix. Essential oils selected from the group consisting of seed oil of Essential oil of Ferula asafoetida, Orange oil, camphor, thyme, clove, pepper, spearmint, citronella, cassia, orange oil, star anise, cedar wood, peppermint, ginger, turmeric and bay leaf and the like alone or mixtures thereof in range of 0.1-15%, more preferably 6.0% and the like.

3. The composition as claimed in claim 1, wherein said solvents are selected from one or more water, Dimethyl sulfoxide (DMSO), Benzyl acetate, N-methyl pyrrolidinone, Diacetone alcohol, N-Ethyl-2 pyrrolidone (NEP) and the like alone or mixtures thereof in range of 15-55%, more preferably 30%.

4. The composition as claimed in claim 1, wherein said composition has a particle size in the range of 10-1000 nanometer, more preferably 1-100 nanometer.

5. The composition as claimed in claim 1, wherein said phytochemicals are extracted by the processes known in the art which include solvent extraction, Soxhlet extraction, Maceration, Steam/hydro distillation supercritical fluid extraction (SFE), ultrasound-assisted extraction (UAE), subcritical water extraction (SWE), and microwave-assisted extraction.

6. The composition as claimed in claim 1, wherein said composition comprises:
i. Eugenol in the range of 0.001 to 10%;
ii. Thymol in the range of 0.001 to 13%;
iii. Clove oil in the range of 0.1 to 15%;
iv. Poly sorbate 80 in the range of 0.1 to 13%;
v. Sodium oleoyl amino fatty acid (Surfactant) in the range of 0.1 to 15%;
vi. Dimethyl sulfoxide (DMSO) in the range of 10.0 to 45%; and
vii. Benzyl acetate in the range of 15.0 to 55%

7. The composition as claimed in claim 1, wherein said composition comprises:
i. Piperine in the range of 0.001 to 10%;
ii. Thymol in the range of 0.001 to 13%;
iii. Black pepper oil in the range of 0.1 to 15%;
iv. Span 80 in the range of 0.1 to 13%;
v. Sodium oleoyl amino fatty acid in the range of 0.1 to 15%;
vi. N-methyl pyrrolidinone in the range of 10.0 to 45%; and
vii. Benzyl acetate in the range of 15.0 to 55%

8. The composition as claimed in claim 1, wherein said composition comprises:
i. Citral in the range of 0.001 to 15%;
ii. Thymol in the range of 0.001 to 13%;
iii. Thyme oil in the range of 0.001 to 13%;
iv. Span 80 in the range of 0.1 to 13%;
v. Sodium oleoyl amino fatty acid in the range of 0.1 to 15%;
vi. N-methyl pyrrolidinone in the range of 10.0 to 45%; and
vii. Diacetone alcohol in the range of 15.0 to 55%

9. The composition as claimed in claim 1, wherein said composition comprises:
i. Citral in the range of 0.001 to 15%;
ii. Eugenol in the range of 0.001 to 13%;
iii. Basil oil in the range of 0.1 to 15%;
iv. polysorbate 80 (emulsifier) in the range of 0.1 to 13%;
v. Sodium oleoyl amino fatty acid in the range of 0.1 to 15%;
vi. N-methyl pyrrolidinone in the range of 10.0 to 45%; and
vii. Diacetone alcohol in the range of 15.0 to 55%

10. The composition as claimed in claim 1, wherein said composition comprises:
i. Camphor in the range of 0.001 to 10%;
ii. Thymol in the range of 0.001 to 13%;
iii. Camphor oil in the range of 0.1 to 15%;
iv. Polysorbate 60 in the range of 0.1 to 13%;
v. Sodium oleoyl amino fatty acid in the range of 0.1 to 15%;
vi. N-methyl pyrrolidinone in the range of 10.0 to 45%; and
vii. Diacetone alcohol in the range of 15.0 to 55%

11. The composition as claimed in claim 1, wherein said composition comprises:
i. Camphor in the range of 0.001 to 7%;
ii. Eugenol in the range of 0.001 to 10%;
iii. Thymol in the range of 0.001 to 13%;
iv. Piperine in the range of 0.001 to 8%;
v. Methyl chavicol in the range of 0.001 to 9%;
vi. Citral in the range of 0.001 to 15%;
vii. D-limonene in the range of 0.001 to 8%;
viii. Thymoquinone in the range of 0.001 to 8%;
ix. Capsaicin in the range of 0.001 to 8%;
x. Palmitic acid in the range of 0.001 to 8%;
xi. Essential oil of Ferula asafoetida in the range of 0.001 to 8%;
xii. Orange oil in the range of 0.1 to 15%;
xiii. Gaur gum in the range of 0.001 to 7.5%;
xiv. ethoxylated castor oil in the range of 0.001 to 10%;
xv. Sodium oleoyl amino fatty acid in the range of 0.1 to 15%
xvi. Dimethyl sulfoxide in the range of 10.0 to 35%; and
xvii. Benzyl acetate in the range of 10.0 to 35%

12. The composition as claimed in claim 1, wherein said composition comprises:
i. Camphor in the range of 0.001 to 7%;
ii. Eugenol in the range of 0.001 to 10%;
iii. Thymol in the range of 0.001 to 13%;
iv. Piperine in the range of 0.001 to 8%;
v. Methyl chavicol in the range of 0.001 to 9%;
vi. Citral in the range of 0.001 to 15%;
vii. D-limonene in the range of 0.001 to 8%;
viii. Thymoquinone in the range of 0.001 to 8%;
ix. Capsaicin in the range of 0.001 to 8%;
x. Palmitic acid in the range of 0.001 to 8%;
xi. Essential oil of Ferula asafoetida in the range of 0.001 to 8%;
xii. Gaur gum in the range of 0.001 to 7.5%;
xiii. ethoxylated castor oil in the range of 0.001 to 10%;
xiv. Sodium oleoyl amino fatty acid in the range of 0.1 to 15%
xv. Dimethyl sulfoxide in the range of 10.0 to 35%; and
xvi. Benzyl acetate in the range of 10.0 to 35%

13. The composition as claimed in claim 1, wherein said composition comprises:
i. Parthenin in the range of 0.001 to 7%;
ii. Carvacrol in the range of 0.001 to 10%;
iii. Thymol in the range of 0.001 to 13%;
iv. Gingerol in the range of 0.001 to 8%;
v. Menthol in the range of 0.001 to 9%;
vi. P-Cymene in the range of 0.001 to 15%;
vii. 2-Undecanone in the range of 0.001 to 8%;
viii. citral in the range of 0.001 to 15%;
ix. Ellagic acid in the range of 0.001 to 8%;
x. Swainsonine in the range of 0.001 to 8%;
xi. Polysorbate 80 in the range of 0.001 to 7.5%;
xii. ethoxylated castor oil in the range of 0.001 to 10%;
xiii. Sodium dodecyl sulfate in the range of 0.1 to 15%;
xiv. Dimethyl sulfoxide in the range of 10.0 to 35%; and
xv. N-methyl pyrrolidinone in the range of 10.0 to 35%

14. The composition as claimed in claim 1, wherein said composition comprises:
i. 1,8 cineole in the range of 0.001 to 7%;
ii. Eugenol in the range of 0.001 to 10%;
iii. Alpha-pine in the range of 0.001 to 13%;
iv. berberine in the range of 0.001 to 8%;
v. Isoquinoline in the range of 0.001 to 9%;
vi. camphor in the range of 0.001 to 15%;
vii. β-asarone in the range of 0.001 to 9%;
viii. Cuminaldehyde in the range of 0.001 to 10%;
ix. ar-Turmerone in the range of 0.001 to 8%;
x. Chavibetol in the range of 0.001 to 7%;
xi. Camphene in the range of 0.001 to 7%;
xii. Gaur gum in the range of 0.001 to 7.5%;
xiii. ethoxylated castor oil in the range of 0.001 to 10%;
xiv. Sodium oleoyl amino fatty acid in the range of 0.1 to 15%
xv. Dimethyl sulfoxide in the range of 10.0 to 35%; and
xvi. Benzyl acetate in the range of 10.0 to 35%.

15. The composition as claimed in claim 1, wherein said composition comprises:
i. Camphor in the range of 0.001 to 7%;
ii. Eugenol in the range of 0.001 to 10%;
iii. thymol in the range of 0.001 to 13%;
iv. piperine in the range of 0.001 to 8%;
v. Methyl chavicol in the range of 0.001 to 9%;
vi. Citral in the range of 0.001 to 15%;
vii. D-limonene in the range of 0.001 to 8%;
viii. thymoquinone in the range of 0.001 to 8%;
ix. capsaicin in the range of 0.001 to 8%;
x. Palmitic acid in the range of 0.001 to 8%;
xi. Essential oil of Ferula asafoetida in the range of 0.001 to 8%;
xii. Span 80 in the range of 0.001 to 7.5%;
xiii. Polyoxyl 35 hydrogenated castor oil in the range of 0.001 to 10%;
xiv. ethoxylated castor oil in the range of 0.001 to 10%
xv. Sodium oleoyl amino fatty acid in the range of 0.1 to 15%;
xvi. Dimethyl sulfoxide in the range of 10.0 to 35%;
xvii. Benzyl acetate in the range of 10.0 to 35%; and
xviii. water in the range of 10.0 to 75%.

16. The composition as claimed in claim 1, wherein said composition comprises:
i. Camphor in the range of 0.001 to 7%;
ii. Eugenol in the range of 0.001 to 10%;
iii. thymol in the range of 0.001 to 13%;
iv. piperine in the range of 0.001 to 8%;
v. Methyl chavicol in the range of 0.001 to 9%;
vi. Citral in the range of 0.001 to 15%;
vii. Essential oil of Ferula asafoetida in the range of 0.001 to 8%;
viii. Orange oil in the range of 0.1 to 15%;
ix. Gaur gum in the range of 0.001 to 7.5%;
x. ethoxylated castor oil in the range of 0.001 to 10%;
xi. Sodium oleoyl amino fatty acid in the range of 0.1 to 15%
xii. Dimethyl sulfoxide in the range of 10.0 to 35%; and
xiii. N-Ethyl-2 pyrrolidone (NEP) in the range of 10.0 to 35%.

17. The composition as claimed in claim 1, wherein said composition comprises:
i. Camphor in the range of 0.001 to 7%;
ii. Eugenol in the range of 0.001 to 10%;
iii. thymol in the range of 0.001 to 15%;
iv. piperine in the range of 0.001 to 12%;
v. Methyl chavicol in the range of 0.001 to 10%;
vi. Citral in the range of 0.001 to 15%;
vii. D-limonene in the range of 0.001 to 10%;
viii. Fumed silica in the range of 0.001 to 5.0%;
ix. Sodium N methyl N-Oleyl taurate in the range of 0.001 to 6.0%;
x. Polyorganosiloxane in the range of 0.001 to 7.0%;
xi. Sodium alkyl naphthalene sulfonate in the range of 0.001 to 15%;
xii. starch in the range of 0.01 to 25%; and
xiii. Anhydrous lactose in the range of 65.0 to 75.0%

18. A process for preparation of the biopesticidal and bio-stimulant composition comprising:
a. Dissolving the emulsifier selected from group consisting of Span 80, polysorbate 80, polysorbate 60, Gaur gum, ethoxylated castor oil, Polyorganosiloxane and the like and surfactant selected from the group consisting of Sodium oleoyl amino fatty acid, Sodium dodecyl sulphate, Polyoxyl 35 hydrogenated castor oil, Sodium N methyl N-Oleyl taurate, Sodium alkyl naphthalene sulfonate and the like alone or mixtures thereof in the solvent selected from one or more water, Dimethyl sulfoxide (DMSO), Benzyl acetate, N-methyl pyrrolidinone, Diacetone alcohol, N-Ethyl-2 pyrrolidone (NEP) and the like alone or mixtures thereof to make inert mixture and agitating with homogenizer until a uniform blend is formed;
b. Adding the phytochemicals to the blend formed in step (a) and homogenizing completely to make an emulsion concentration.
c. Stirring the mixture obtained in step (b) at 300-1000 RPM particularly at 350-800 RPM at 25-55° C. followed by homogenizing the mix at a speed of 3700˜27000 rpm to reduce the particle size;
d. Passing the homogenized mixture obtained in step (c) through in line shear pump with 1800 RPM to 5800 RPM to obtain the nano emulsion with particle size ranging from 10 to 1000 nano meter;
e. Passing the mixture obtained in step (d) through High-pressure homogenization at a speed of 4000 rpm to 10000 rpm and pressure up to 4,200 bar (60,000 psi) to obtain the particle size below 100 nano meters;
f. Passing the mixture obtained in step (e) through sparkler filter having seven layers of membrane filters with pore size less than 1-2 micron to achieve desired filtration; and
g. Recovering the final product.
OR
a. Blending the active ingredients with the excipients to form an uniform mixture;
b. Adding water to the mixture of step (a) and blending;
c. Transferring the wet mass of step (b) to a basket extruder and extruding the wet mass to a 0.8 mm screen and drying in a fluid bed followed by vacuum drying to obtain dry granules;
d. Separating the granules of step (c) to the desired range of 4 to 50 mesh; and
e. Recovering the final product.

19. The process as claimed in claim 18, wherein said process comprises:
(i) carriers selected from at least one substantially water-miscible co-solvent, preferably selected from the group of N-methylpyrrolidinone; dimethylsulphoxide; dimethylfomamide C9; methyl ethyl ketone, Ethylene Glycol Diacetate, dimethylisosorbide isophorone; acetophenone; cyclohexanone; Diacetone alcohol 1,3-dimethyl-2-imidazolidinone; ethylene, propylene, and butylene carbonates; lactate esters; Methyl oleate, dimethyl and diethylcarbonates; alkylglycol ethers; glycols, including propylene, carbapol 940 and biodiesel and the like alone or mixtures thereof;
(ii) essential oils selected from the group consisting of seed oil of Essential oil of Ferula asafoetida, Orange oil, camphor, thyme, clove, pepper, spearmint, citronella, cassia, orange oil, star anise, cedar wood, peppermint, ginger, turmeric and bay leaf and the like alone or mixtures thereof.

20. The process as claimed in claim 18, wherein further purification of Phyto ingredient is carried out by using liquid liquid extraction, various chromatograph techniques like silica gel chromatography, ion exchange chromatography and other purification like precipitation and crystallization.

21. The composition as claimed in claim 1, wherein said composition is provided at a concentration ranging between 0.5 to 3.5 ml/L.

22. The composition as claimed in claim 1, wherein said composition may be used with the active ingredient contained in other agents such as fungicides, bactericide, nematicide, plant growth regulators, synergists, fertilizers, soil improvers, animal feeds and the like or in conjunction with the known insecticidal or acaricidal active ingredient.

23. The composition as claimed in claim 1, wherein said composition may be applied by sprinkler application, sprayer application or drip application, more preferably by sprayer application such as foliar sprays, sprays to be applied to plants shoots and the like.

24. The composition as claimed in claim 1, wherein said composition is useful for controlling plant pests such as insects, nematodes, mites, snails, slugs, sucking pest, caterpillar, pathogenic fungus and bacteria and the like and improving yield of crop plants.

25. The composition as claimed in claim 1, wherein said composition exhibits biostimulant activity and thereby improves plant growth and crop yield.

26. The composition as claimed in claim 1, wherein the composition may be in the form of wettable powder, granule, powder, tablet, emulsion, water-soluble agent, suspension, granule wettable powder, flowable agent, microcapsule, aerosol, propellant, spray, fogging agent, heating transpiration agent, smoking agent, baiting agent or the like.

27. A method for controlling or killing of the agricultural insects/pests comprising applying said phytochemical composition as claimed in claim 1 to the plant or to the affected parts of the plants in suitable amount thereof.
